(19) United States
(12) Patent Application Publication
(10) Pub. No.: US 2015/0328803 A1
(43) Pub. Date: Nov. 19, 2015

(54) DEVICE FOR AND METHOD OF CONNECTING TWO ITEMS TOGETHER

(71) Applicant: George Roland Hill, Bramhall, Stockport, Cheshire (GB)

(72) Inventors: Stuart McKinlay Burns, Manchester (GB); Damian Paul Vesey, Hillgate, Stockport, Cheshire (GB); George Roland Hill, Bramhall, Stockport, Cheshire (GB)

(21) Appl. No.: 14/409,649

(22) PCT Filed: Feb. 25, 2013
(86) PCT No.: PCT/GB2013/050466

§ 371 Date: Dec. 19, 2014

Related U.S. Application Data
(60) Provisional application No. 61/603,037, filed on Feb. 24, 2012.

(51) Int. Cl. B29C 33/38; B29C 67/00; B29C 33/50

(52) U.S. Cl. CPC B29C 33/3857; B29C 33/50; B29C 67/0077; B29C 67/0066; B33Y 10/00

(57) ABSTRACT

A method of manufacturing a part of a device including a first part and a second part which are inter-engageable with one another, the first part having a first longitudinal axis and a connecting face which extends substantially transversely to the first longitudinal axis and includes an engagement formation which extends substantially axially, and the second part having a second longitudinal axis and a connecting face which extends substantially transversely to the second longitudinal axis and includes a receiving formation which extends substantially axially and in which the engagement formation of the first part is receivable, wherein each of the engagement formation and the receiving formation includes a substantially helicoidal surface which extends at least partially around the longitudinal axis of the respective part of the device, such that rotation of the two parts relative to one another about the longitudinal axes, when the two parts are substantially co-axially aligned, such that the connecting faces of the two parts face one another in a substantially axial direction, causes engagement of the engagement formation of the first part with the corresponding receiving formation of the second part, the method including: providing a mould including a body and a connecting face which includes engagement formations corresponding to those of one of the first and the second part of the device, wherein the connecting face is separable from the mould body, contacting the connecting face of the mould with a mouldable material, to produce engagement formations on a face of the mouldable material, so as to form the other part of the device, and separating the connecting face from the mould body to remove the moulded part of the device from the mould.

### CROSS REFERENCE

This application claims priority from U.S. provisional application 61/603,037 filed 24 Feb. 2012, which is a continuation-in-part of PCT application no. PCT/GB2011/051617, filed Aug. 26, 2011, titled “Device for and method of connecting two items together,” and claiming priority to GB application no. 1014263.6, filed Aug. 26, 2010, titled “Connector and method of connecting two items together,” the entire contents of which are hereby incorporated by reference herein.

### BACKGROUND OF THE INVENTION

1. Field of the Invention

The present invention relates generally to devices for connecting two items together.

2. Description of Related Art

A variety of different connectors have been used in the art to connect two items together (e.g., buttons, snaps, Velcro, bayonet-style connectors, snap-locking connectors).

It is known to connect items together by means of connectors or fasteners. Fasteners and connectors including threaded portions are known, for example screws, and screw caps.

A screw includes a body and a generally helicoidal projection which extends radially outwardly of the body, along a length of the body. A screw cap also includes a generally helicoidal projection having a first end and a second end, and which extends generally radially inwardly of the cap. The helicoidal projection of the cap is engageable with a corresponding projection which extends generally radially outwardly from a neck of a bottle (or other item). The helix of the neck of the bottle also has a first end and a second end.

In use, the second end of the helicoidal projection of the cap is positioned adjacent the first end of the helicoidal projection of the neck of the bottle. Relative rotation of the screw cap relative to the neck, about a generally central longitudinal axis, causes inter-engagement of the helicoidal projections. As the cap and the neck are rotated relative to one another, the length of each helicoidal projection which is engaged with the other helicoidal projection increases, until a first end of the helical projection of the cap is adjacent the first end of the helicoidal projection on the neck, and the second end of the helical projection of the cap is adjacent the second end of the helicoidal projection of the neck. An in use upper surface of the helicoidal projection of the cap abuts an in use lower surface of the helicoidal projection of the neck. Inter-engagement of the helical projections inhibits linear movement of the cap relative to the neck in a direction which is parallel to the longitudinal axis.

### SUMMARY OF EMBODIMENTS OF THE INVENTION

This invention relates to a device which may be used, and hereinafter is described principally in relation to its use, as a connector, and a method of manufacturing such a device. It will be understood that the device may be used for purposes other than as a connector, a number of which will be referred to below.

A disadvantage of various known threaded connections is that it is necessary for multiple relative revolutions of the two parts to be carried out in order to achieve a satisfactory connection which inhibits or prevents linear movement in the direction of the central, longitudinal axis.

According to a first aspect of the invention there is provided a method of manufacturing a part of a device including a first part and a second part which are inter-engageable with one another, the first part having a first longitudinal axis and a connecting face which extends substantially transversely to the first longitudinal axis and includes an engagement formation which extends substantially axially, and the second part having a second longitudinal axis and a connecting face which extends substantially transversely to the second longitudinal axis and includes a receiving formation which extends substantially axially and in which the engagement formation of the first part is receivable, wherein each of the engagement formation and the receiving formation includes a substantially helicoidal surface which extends at least partially around the longitudinal axis of the respective part of the device, such that rotation of the two parts relative to one another about the longitudinal axes, when the two parts are substantially co-axially aligned, such that the connecting faces of the two parts face one another in a substantially axial direction, causes engagement of the engagement formation of the first part with the corresponding receiving formation of the second part, the method including:
providing a mould including a body and a connecting face which includes engagement formations corresponding to those of one of the first and the second part of the device, wherein the connecting face is separable from the mould body,
contacting the connecting face of the mould with a mouldable material, to produce engagement formations on a face of the mouldable material, so as to form the other part of the device, and
separating the connecting face from the mould body to remove the moulded part of the device from the mould.

At least a part of the connecting face of the mould may be flexible, and flexed to separate the connecting face from the mould body.

Each of the connecting face and the body may include complementary threaded portions which are inter-engageable, and disengaging the threaded portions disengages the connecting face from the body.

The method may include removing the moulded part from the connecting face by rotating the moulded part and the connecting face relative to one another.

The method may include a step of hardening or curing the moulded part of the device.

The moulded part may be subsequently used as a mould for the other part of the device.

According to a second aspect of the invention, there is provided a method of connecting a first part of a device on a first item and a second part of the device on a second item, the first part of the device including a longitudinal axis, and a connecting face which extends substantially transversely to the longitudinal axis and has an engagement formation which extends substantially axially, and the second part including a longitudinal axis and a connecting face which extends in substantially transversely to the longitudinal axis of the second part, and has a receiving formation which extends substantially axially, and in which the engagement formation of the first part is receivable, wherein each of the engagement formation and the receiving formation includes a substantially helicoidal surface which extends at least partially around the longitudinal axis of the respective part, the method including:
substantially aligning the longitudinal axes of the two parts of the device, such that the connecting faces of the two parts of the device face one another substantially axially, and
rotating the two parts of the device relative to one another about the longitudinal axes, such that the engagement formation of the first part is received in the receiving formation of the second part, the method further comprising:
prior to said alignment and rotation or the two parts, using a tool to rotationally drive the first part into an object, wherein the tool comprises a driving face that is complimentary to the connecting face of the first part such that mating of the connecting face of the first part and the driving face of the tool enables rotational force to be transferred from the tool to the first part,
wherein, when the connecting face of the first part and the driving face of the tool mate, the tool is still axially separable from the first part without requiring rotation of the tool relative to the first part.

According to a third aspect of the invention there is provided a method of manufacturing a part of a device including a first part and a second part which are inter-engageable with one another, the first part having a first longitudinal axis and a connecting face which extends substantially transversely to the first longitudinal axis and includes an engagement formation which extends substantially axially, and the second part having a second longitudinal axis and a connecting face which extends substantially transversely to the second longitudinal axis and includes a receiving formation which extends substantially axially and in which the engagement formation of the first part is receivable, wherein each of the engagement formation and the receiving formation includes a substantially helicoidal surface which extends at least partially around the longitudinal axis of the respective part of the device, such that rotation of the two parts relative to one another about the longitudinal axes, when the two parts are substantially co-axially aligned, such that the connecting faces of the two parts face one another in a substantially axial direction, causes engagement of the engagement formation of the first part with the corresponding receiving formation of the second part, the method including performing an additive process to build up the engagement formations of the part.

The additive process may be one of selective laser melting, photopolymer curing, atomic layer deposition and material “jetting”.

An advantage of one or more embodiments of such a device is that each part of the device may be shallow, and a large surface area of each part may be brought into engagement with the other part of the device quickly and easily, compared with the amount of time and effort required to achieve a similar degree of engagement with one or more known connectors/fasteners, for example a screw.

The engagement forces are distributed over a relatively large surface area relatively quickly. Thus, such a device is considered to have a “mechanical advantage” compared with one or more known connectors/fasteners.

The device according to one or more embodiments provides efficient load distribution and a secure connection, in view of the frictional engagement of a large proportion of the surface area of one part of the device with the other part of the connector.

Further features of one or more embodiments of the device are set out below.

These and other aspects of various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIG. 1 is a perspective view of a first embodiment of a device in accordance with the present invention;

FIG. 2 is a plan view of the device of FIG. 1;

FIG. 3 is a side cross-sectional view of the device of FIGS. 1 and 2, and with two parts of the device inter-engaged.

FIG. 4 is a perspective view of one engagement formation of a part of the device shown in FIG. 1;

FIG. 5 is a perspective view of a second embodiment of a device in accordance with the present invention;

FIG. 6 is a plan view of the device of FIG. 5;

FIG. 7 is a cross-sectional view of two parts of the device of FIG. 5, connected together;

FIG. 8 is a perspective view of a third embodiment of a device in accordance with the present invention;

FIG. 9 is a plan view of the device of FIG. 8;

FIG. 10 is a cross-sectional view of the device of FIGS. 8 and 9, with two parts of the device connected together;

FIG. 11 is a perspective view of a fourth embodiment of a device in accordance with the present invention;

FIG. 12 is a plan view of the device of FIG. 11;

FIG. 13 is a cross-sectional view of two parts of the device of FIGS. 11 and 12 connected together.

FIG. 14 is a perspective view of a device including electrical connections.

FIG. 15 is a plan view of the device of FIG. 14; and

FIG. 16 is a perspective view of two parts of a device including a connector having electrical connections.

FIG. 17 is a perspective view of a fifth embodiment of a device in accordance with the present invention;

FIG. 18 is a plan view of the device shown in FIG. 17;

FIGS. 19a and 19b are cross sectional views of the device of FIG. 17, with two parts of the device connected together;

FIG. 20 is a perspective view of a sixth embodiment of a device in accordance with the present invention, the device including a separate locking member;

FIG. 21 is a plan view of each part of the device of FIG. 20;

FIG. 22 is a cross-sectional view of the parts of the device connected together, with the locking device in place;

FIG. 23 is a perspective view of a seventh embodiment of the device of the present invention;

FIG. 24 is a plan view of the device of FIG. 23;

FIG. 25 is a cross-sectional view of two parts of the device connected together;

FIG. 26 is a perspective view of an eighth embodiment of the device of the present invention;

FIG. 27 is a plan view of the device of FIG. 26;

FIG. 28 is a cross-sectional view of two parts of the device connected together;

FIG. 29 is a perspective view of a ninth embodiment of the device of the present invention;

FIG. 30 is a plan view of the device of FIG. 29;

FIG. 31 is a cross-sectional view of two parts of the device connected together;

FIG. 32 is a perspective view of an tenth embodiment of the device of the present invention;

FIG. 33 is a plan view of the device of FIG. 32;

FIG. 34 is a cross-sectional view of two parts of the device connected together;

FIG. 35 is a perspective view of an eleventh embodiment of the device of the present invention;

FIG. 36 is a plan view of the device of FIG. 35;

FIG. 37 is a cross-sectional view of two parts of the device connected together;

FIG. 38 is a perspective view of a twelfth embodiment of the device of the present invention;

FIG. 39 is a plan view of the device of FIG. 38;

FIG. 40 is a cross-sectional view of two parts of the device connected together;

FIG. 41 is a perspective view of a thirteenth embodiment of the device of the present invention;

FIG. 42 is a plan view of the device of FIG. 41; and

FIG. 43 is a cross-sectional view of two parts of the device connected together;

FIG. 44 is a perspective view of a fourteenth embodiment of the invention;

FIG. 45 is a perspective view of a fifteenth embodiment of the invention;

FIG. 46 is a perspective view of a sixteenth embodiment of the invention;

FIG. 47 is a cross-sectional view of the embodiment shown in FIG. 46;

FIG. 48 is a perspective view of a seventeenth embodiment of the invention;

FIG. 49 is a perspective view of an eighteenth embodiment of the invention;

FIG. 51 is a cross-sectional view of the embodiment shown in FIG. 49.

FIGS. 52A-B are schematic representations of two parts of a connector and

FIGS. 52C-F are schematic representations of final orientations of the two parts.

FIGS. 53-88 are illustrative views of different embodiments of a connector.

FIG. 89 shows a connector for holding two pieces of material together.

FIGS. 90 and 91 show a connector in conjunction with a tool or a cap.

FIG. 92 shows a connector enabling a tool to engage a fixing.

FIG. 93 shows a connector in conjunction with a universal joint.

FIGS. 94-99 show a connector in conjunction with a bearing.

FIGS. 100-102 show a connector in conjunction with an actuator.

FIG. 103 shows a connector as part of a clutch.

FIG. 104 shows a connector as part of a drive mechanism.

FIG. 105 shows a connector as part of a “Kline” fitting.

FIG. 106 is a schematic representation of a connector.

FIG. 107 shows a connector as part of a container lid.

FIG. 108 shows a series of stackable connectors or devices.

FIG. 109 shows a connector as part of cap for a container.

FIG. 110 illustrates use of a connector to assemble components of a product.

FIG. 111 is a schematic representation of a connector suitable for use in holding a hinged lid on a receptacle.

FIG. 112 illustrates the use of a connector to connect tubular parts, or to connect tools to a vacuum cleaner.

FIG. 113 illustrates the use of a connector as a vacuum pump.

FIG. 114 shows a connector as part of a hydraulic system.

FIG. 115 shows a connector as part of a rotary pump.

FIG. 116 shows a connector used to align multiple parts of an assembly.

FIG. 117 shows a connector as part of a wire-stripping tool.

FIG. 118 shows a connector with visible markings to aid orientation.

FIG. 119 shows a connector as part of a fastener, for example a belt buckle.

FIGS. 120A and 120B illustrate a connector encasing a spring biased spool

FIG. 120C illustrates a series of inter-engaged connectors, each encasing a spring biased spool.

FIGS. 121 and 122 show a connector in conjunction with a machine tool.

FIG. 123 shows a connector as part of an electrically inducting apparatus

FIG. 124 is a schematic representation of a connector.

FIG. 125 shows a connector with a flexible part.

FIGS. 126 and 127 show a connector as part of a moulding tool.

FIG. 128 is a schematic representation of an embodiment of a connector.

FIG. 129 shows an embodiment of the invention in conjunction with a belt buckle.

FIG. 130 shows an embodiment of the invention in conjunction with a towing hitch (electrical or mechanical).

FIG. 131 shows an embodiment of the invention in conjunction with a tool belt.

FIG. 132 shows an embodiment of the invention connecting a leg to a piece of furniture.

FIG. 133 shows an embodiment of the invention as part of a sweeper or mop handle.

FIG. 134 shows an embodiment of the invention as part of a suitcase handle.

FIG. 135 shows an embodiment of the invention in conjunction with a sucker, for attaching an article to a smooth surface.

FIG. 136 shows an embodiment of the invention as part of a snooker cue.

FIG. 137 shows an embodiment of the invention in conjunction with a smoke alarm.

FIG. 138 shows an embodiment of the invention in conjunction with a shoe heel.

FIG. 139 shows an embodiment of the invention in conjunction with poker chips, to enable stacking.

FIG. 140 shows an embodiment of the invention in conjunction with a radio/torch.

FIG. 141 shows an embodiment of the invention in conjunction with a phone charger.

FIG. 142 shows an embodiment of the invention in conjunction with a pen/toothbrush holder.

FIG. 143 shows an embodiment of the invention in conjunction with a paint roller.

FIG. 144 shows an embodiment of the invention in conjunction with a paint brush.

FIG. 145 shows an embodiment of the invention in conjunction with a container lid.

FIG. 146 shows an embodiment of the invention in conjunction with a light bulb.

FIG. 147 shows an embodiment of the invention in conjunction with a key fob.

FIG. 148 shows an embodiment of the invention in conjunction with a kettle base.

FIG. 149 shows an embodiment of the invention in conjunction with a hinge.

FIG. 150 shows an embodiment of the invention in conjunction with a rake handle.

FIG. 151 shows an embodiment of the invention in conjunction with a docking station.

FIG. 152 shows an embodiment of the invention in conjunction with a bag strap.

FIG. 153 shows an embodiment of the invention in conjunction with a cylinder base.

FIG. 154 shows an embodiment of the invention in conjunction with a cup and saucer.

FIG. 155 shows an embodiment of the invention in conjunction with a clothes hook or coat hanger.

FIG. 156 shows an embodiment of the invention in conjunction with a clip.

FIG. 157 shows an embodiment of the invention in conjunction with a rock climbing wall hand hold.

FIG. 158 shows an embodiment of the invention in conjunction with a car rear view mirror.

FIG. 159 shows an embodiment of the invention in conjunction with a karabiner.

FIG. 160 shows an embodiment of the invention in conjunction with a tripod and camera.

FIG. 161 shows an embodiment of the invention in conjunction with a camera lens and camera.

FIG. 162 shows an embodiment of the invention in conjunction with a cable fastener.

FIG. 163 shows an embodiment of the invention in conjunction with a button.

FIG. 164 shows an embodiment of the invention in conjunction with a bottle top.

FIG. 165 shows an embodiment of the invention in conjunction with a boot stud.

FIG. 166 shows an embodiment of the invention in conjunction with a bike pedal.

FIG. 167 shows an embodiment of the invention in conjunction with a battery terminal/connector.

FIG. 168 shows an embodiment of the invention in conjunction with an audio speaker.

FIG. 169 shows an embodiment of the invention in conjunction with an air freshener.

FIG. 170 shows an embodiment of the invention in conjunction with a domestic connector with variable backing substrate—adhesive pad/hook and loop fastener/magnet.

FIG. 171 shows an embodiment of the invention in conjunction with a furniture foot.

FIG. 172 shows an embodiment of the invention in conjunction with an oversized handle.

FIG. 173 shows an embodiment of the invention in conjunction with a head torch.

FIG. 174 shows an embodiment of the invention in conjunction with a boot sole.

FIG. 175 shows an embodiment of the invention in conjunction with a bottle bottom.

FIG. 176 shows a spanner or wrench including a connector.

FIG. 177 is a representation showing symbols indicative of inter-engagement and orientation of parts of a connector.

FIG. 178 is a representation showing symbols indicative of inter-engagement of parts of a connector.

FIG. 179 shows an apparatus including a connector and a threaded locking device.

FIG. 180 shows an apparatus including a connector and an alternative threaded locking device.

### DETAILED DESCRIPTION OF EXEMPLARY EMBODIMENTS OF THE INVENTION

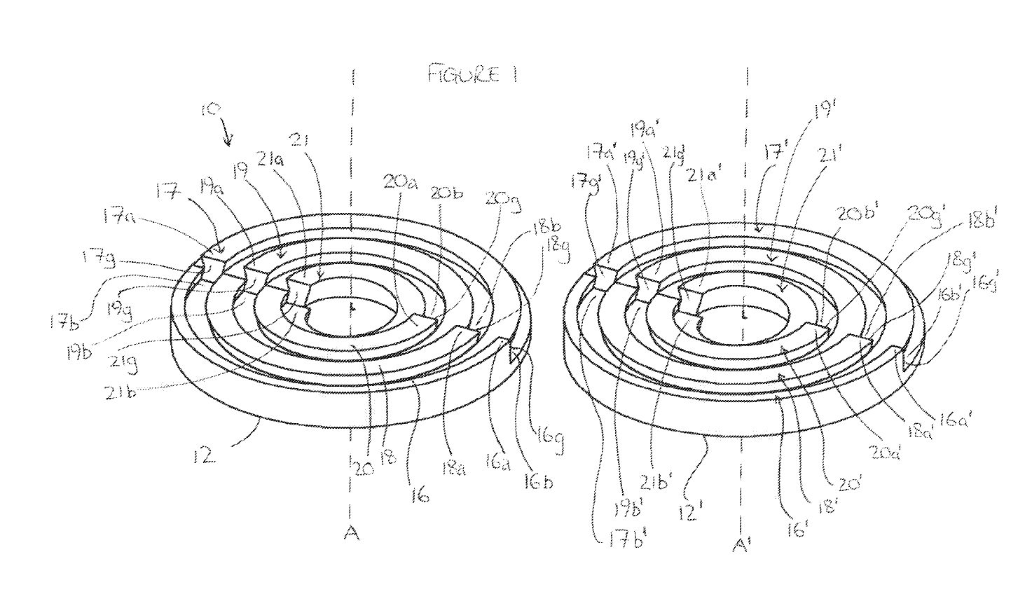

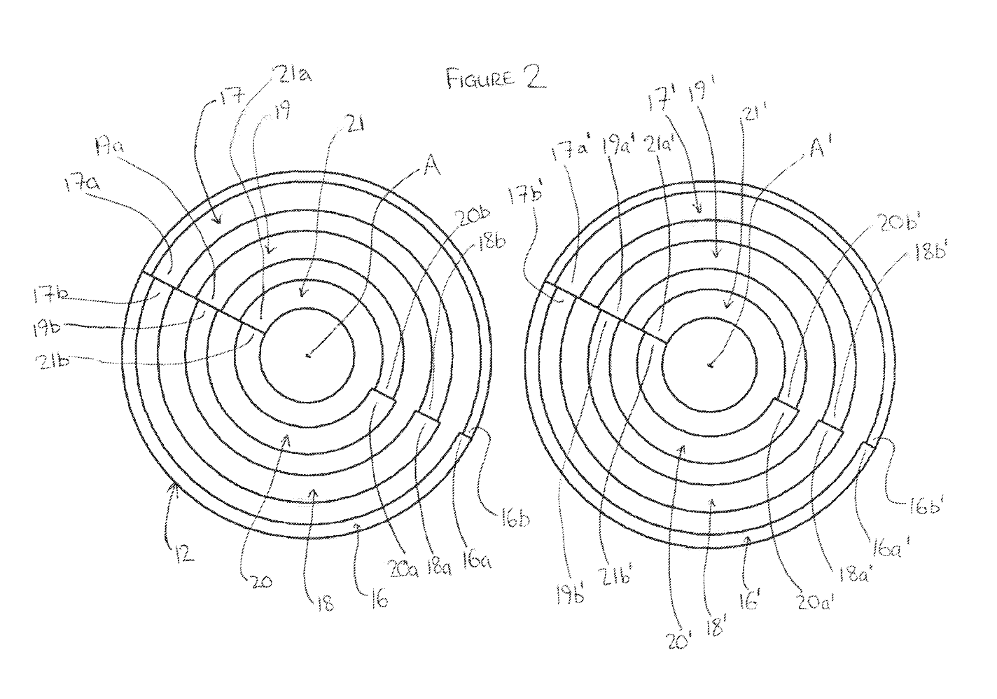

Referring to FIG. 1, there is shown a first embodiment of the invention. A connector 10 includes a first part 12 and a second part 12′. In this embodiment of the invention, the first part and the second part are identical to one another. The first part 12 and the second part 12′ each includes a plurality of engagement formations, 16, 17, 18, 19, 20 and 21, and the second part 12′ includes a plurality of engagement formations 16′, 17′, 18′, 19′, 20′ and 21′. Whilst in the example described herein, each part 12, 12′ includes six engagement formations 16-21 16′-21′, any number of engagement formations, including one, may be provided. Each of the engagement formations 16-21 and 16′-21′ is substantially annular and has a first end 16a, 17a, 18a, 19a, 20a, 21a, 16a′, 17a′, 18a′, 19a′, 20a′, 21a′, and a second end 16b, 17b, 18b, 19b, 20b, 21b, 22b, 16b′, 17b′, 18b′, 19b′, 20b′ and 21b′. Each engagement formation 16-21, 16′-21′ has a first portion which extends between the first end 16a-21a, 16a′-21a′ of the engagement formation 16-21, 16′-21′ and a mid-point thereof, and a second portion which extends between the mid point of the engagement formation 16-21, 16′-21′ and the second end 16b-21b, 16b′-21b′ thereof. The engagement formations 16-21 and 16′-21′ are concentric about respective central axes A, A′. Each part 12, 12′ has a connecting face which extends substantially transversely to the respective axis A, A′.

Each engagement formation 16-21 and 16′-21′ extends from the connecting face of the respective part 12, 12′ in the same general direction as the respective longitudinal axis A, A′, and is substantially parallel to the respective longitudinal axis A, A′. Thus, each engagement formation 16-21, 16′-21′ extends substantially axially.

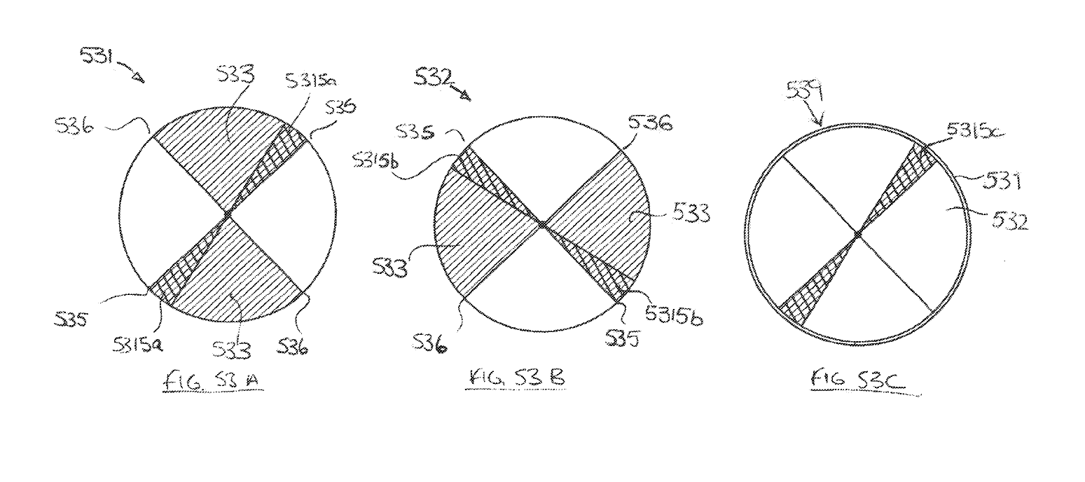

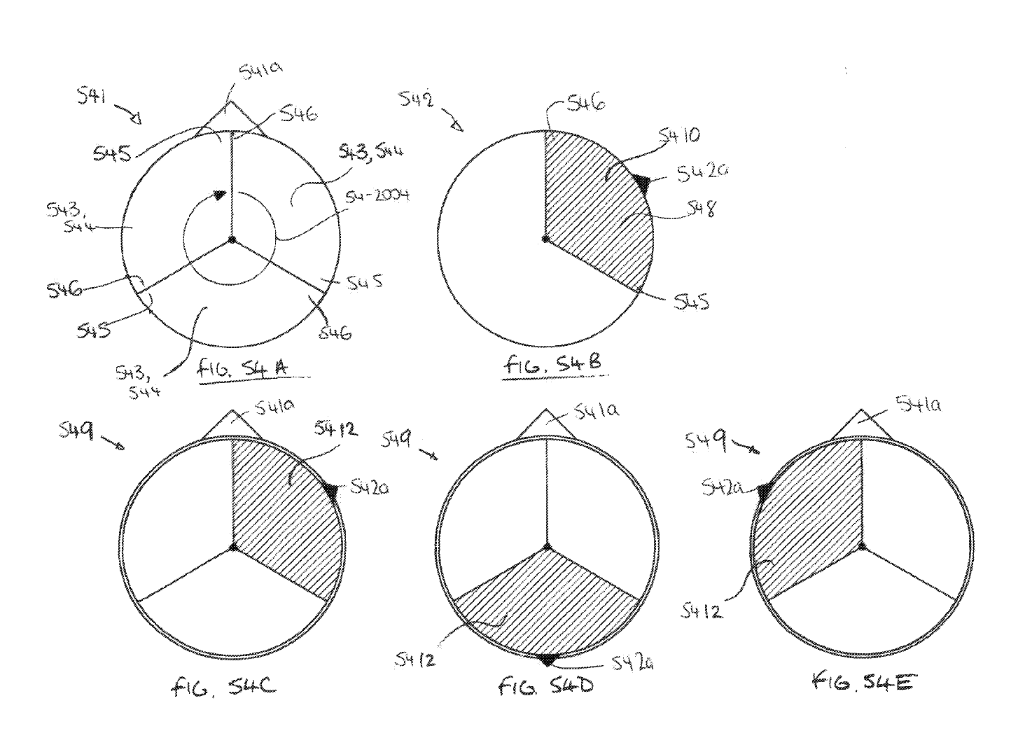

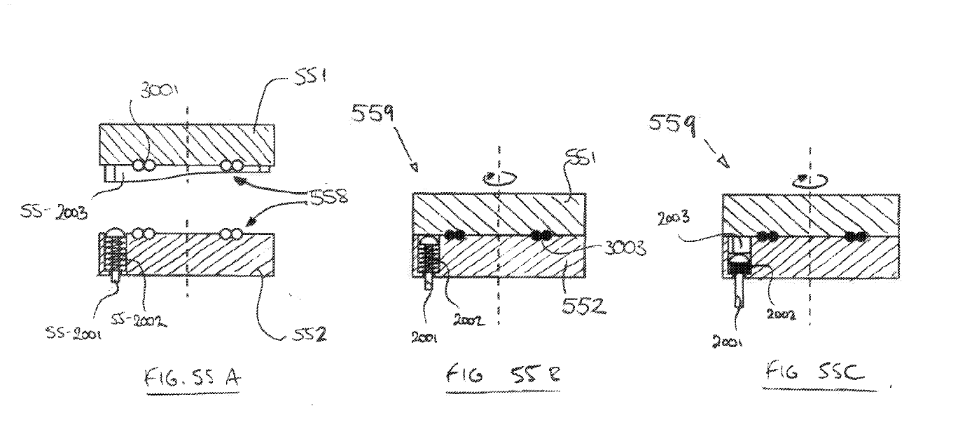

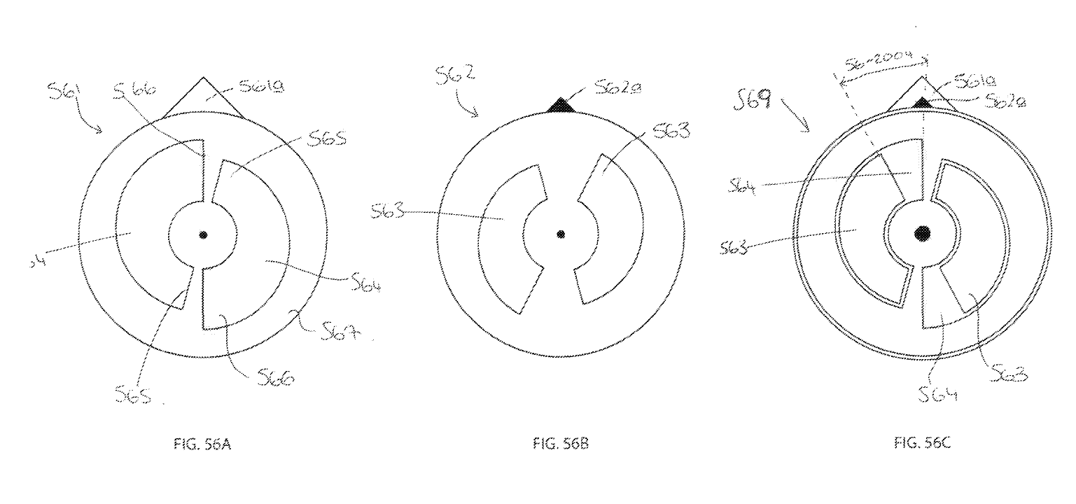

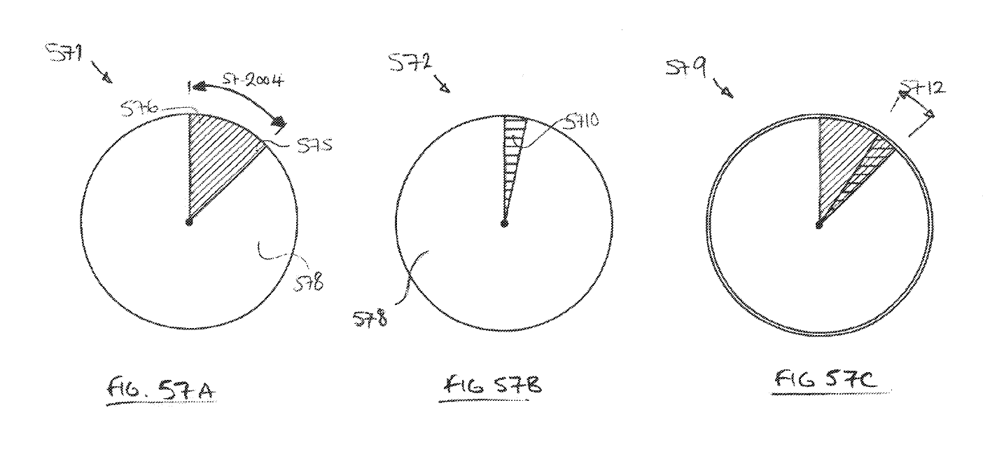

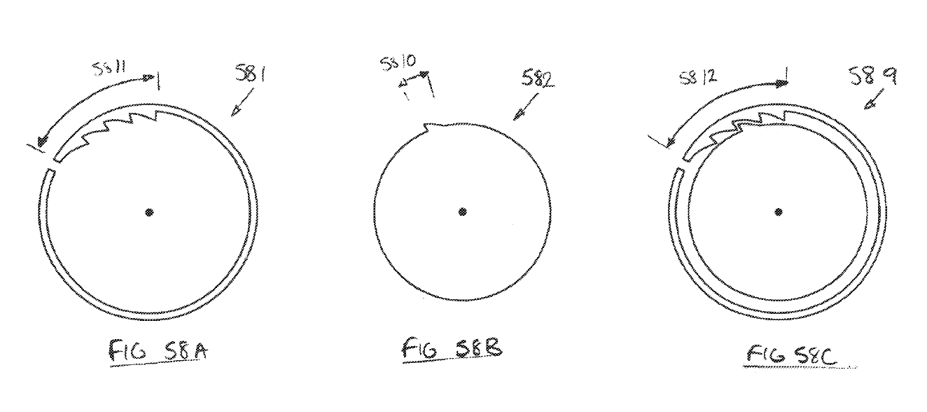

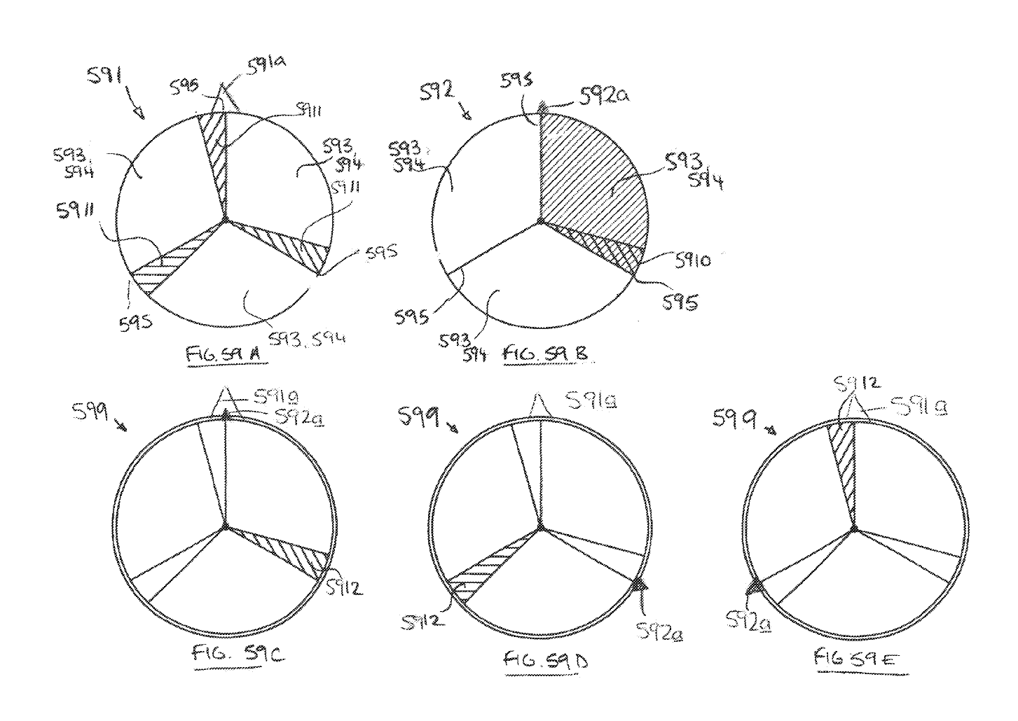

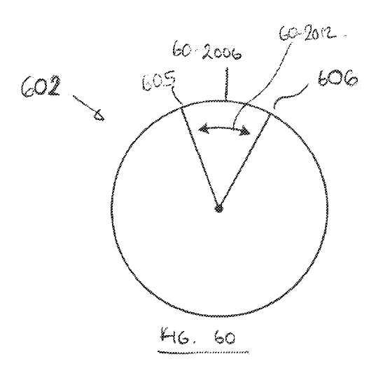

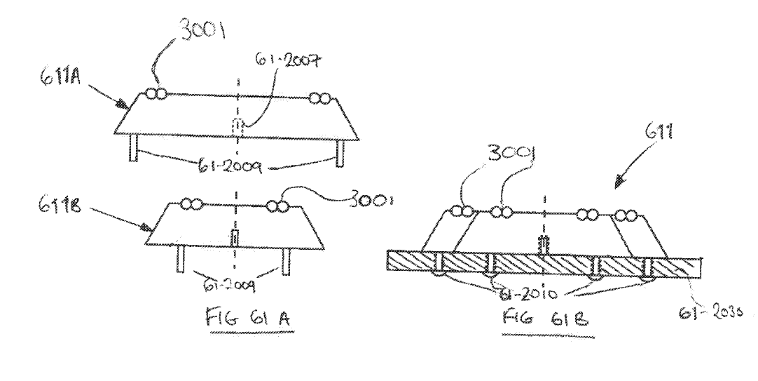

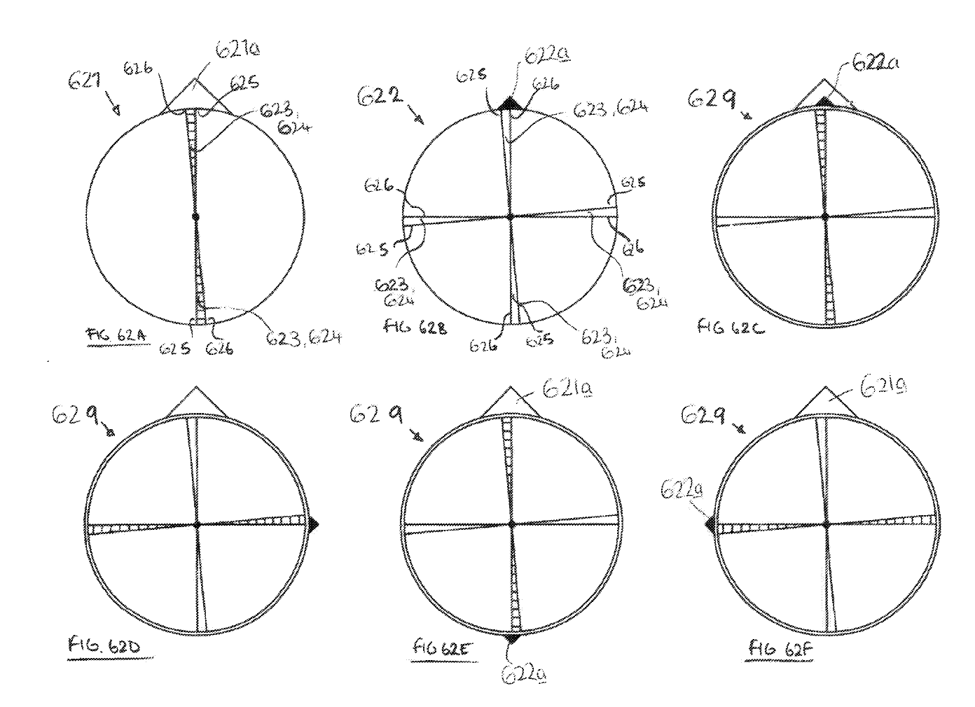

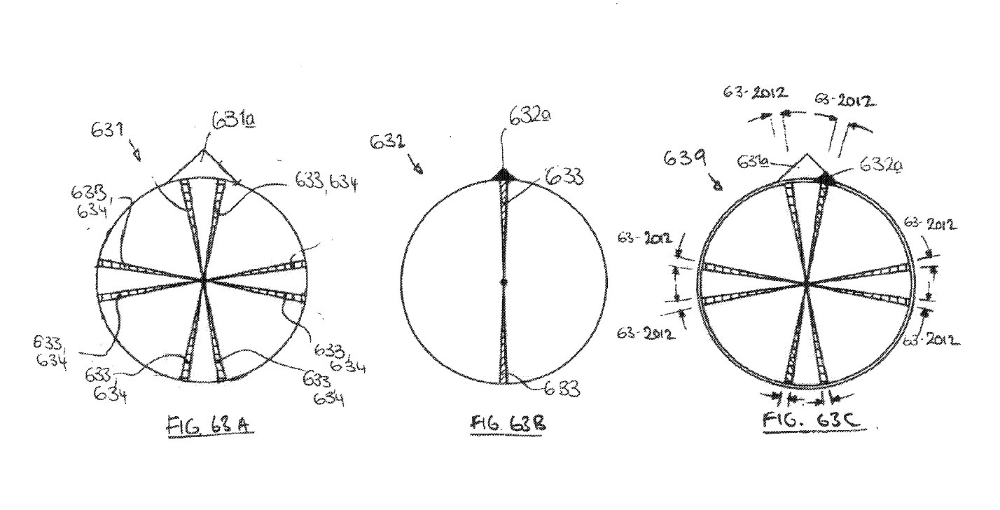

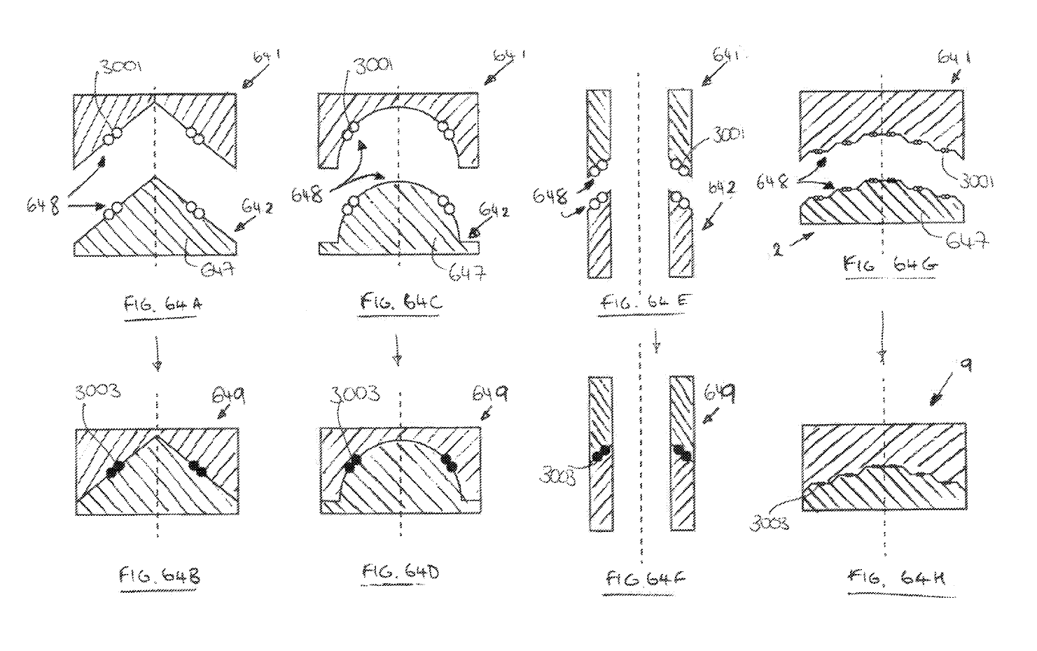

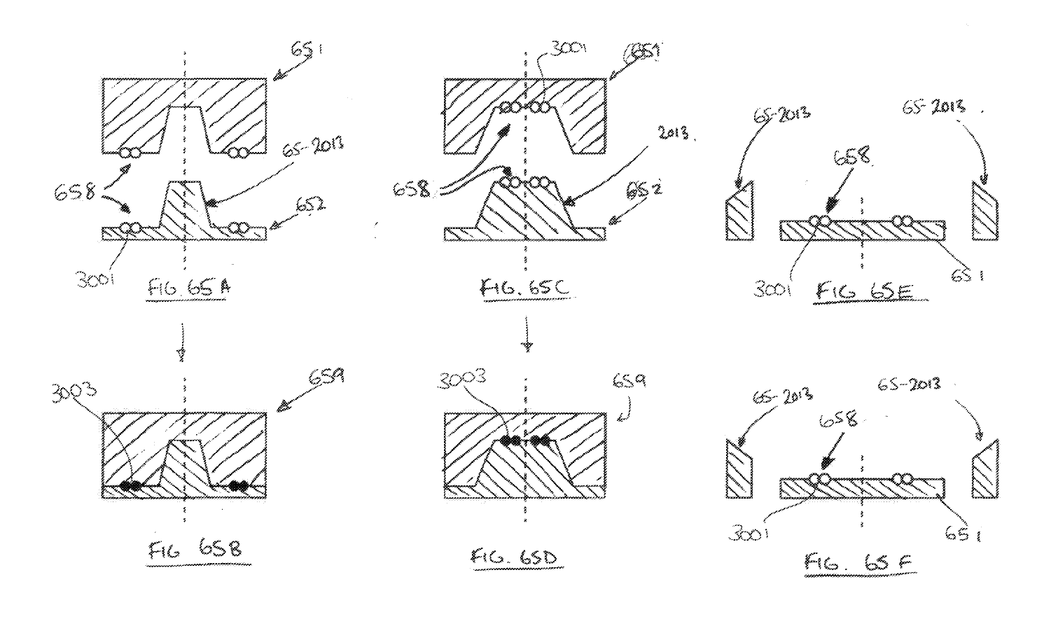

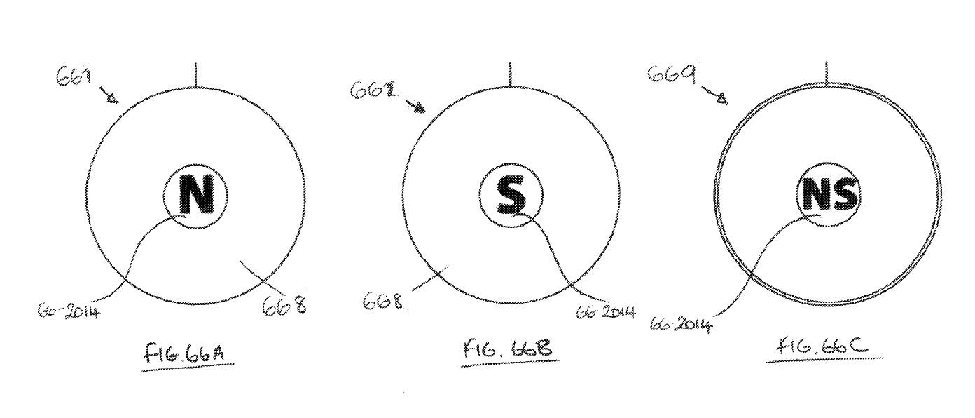

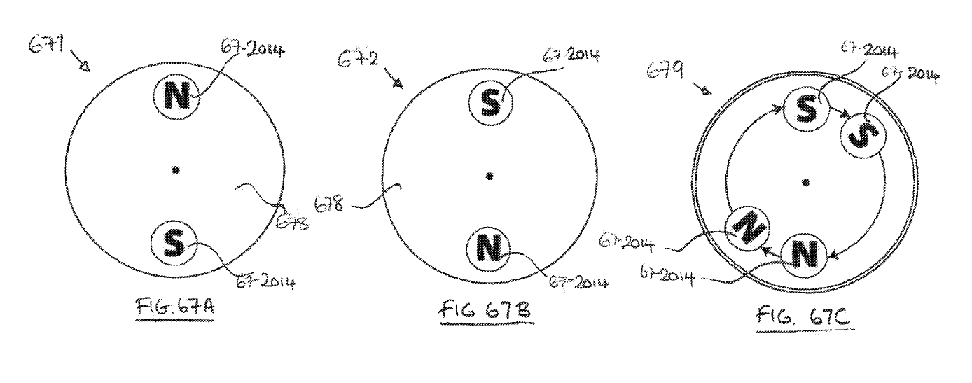

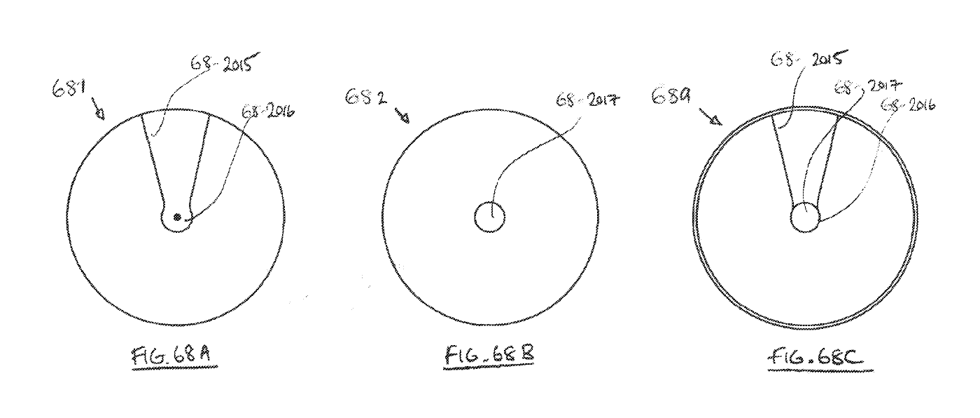

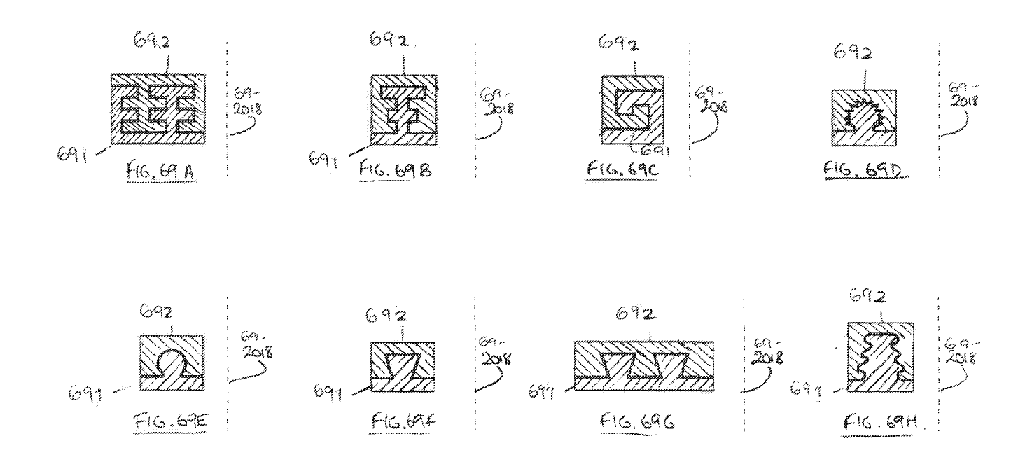

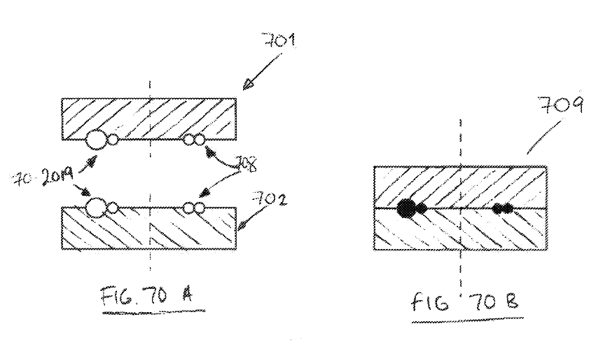

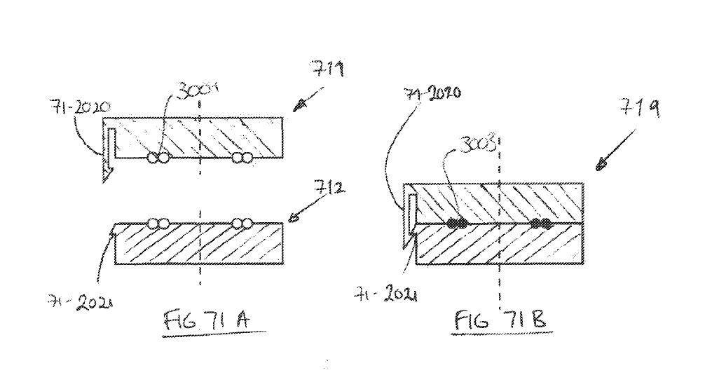

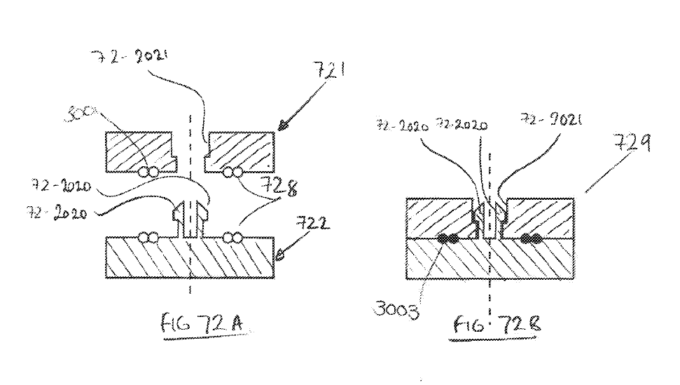

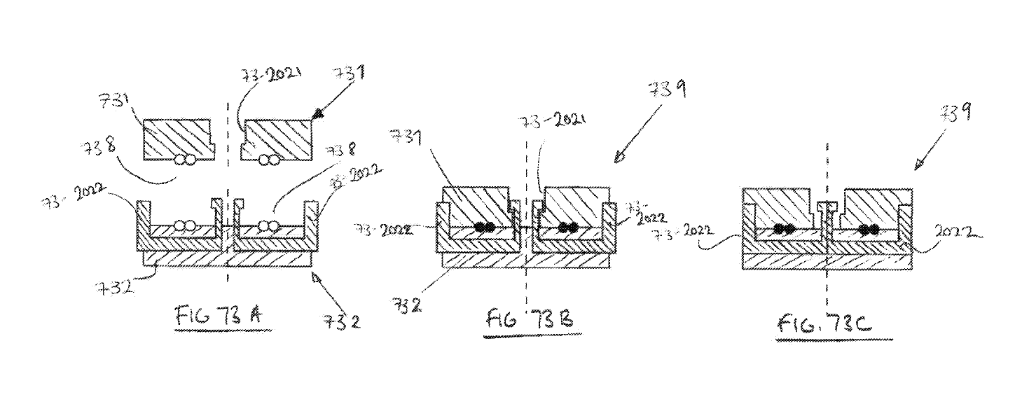

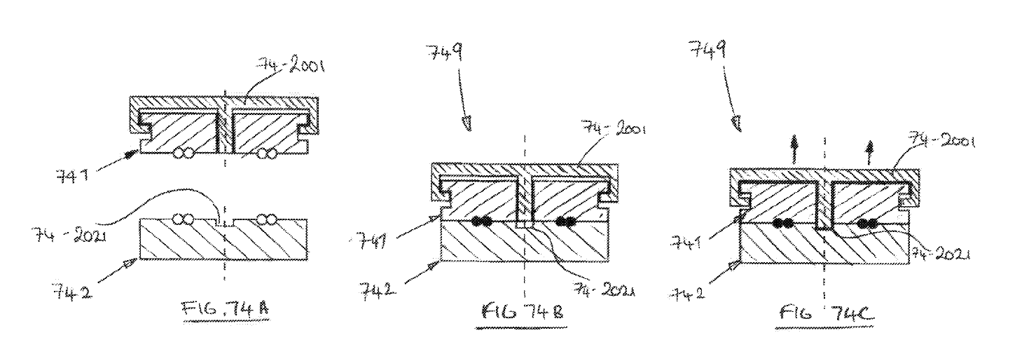

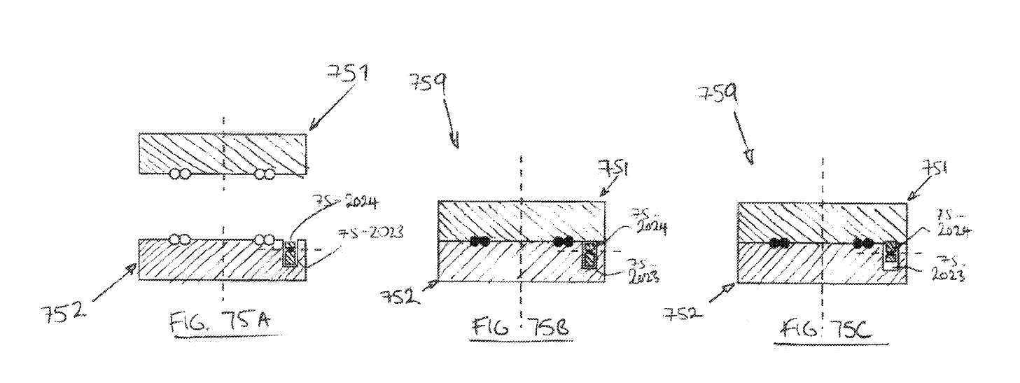

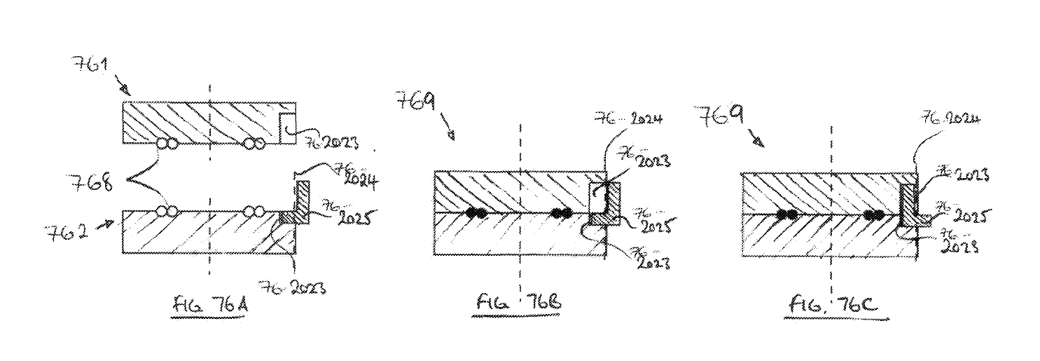

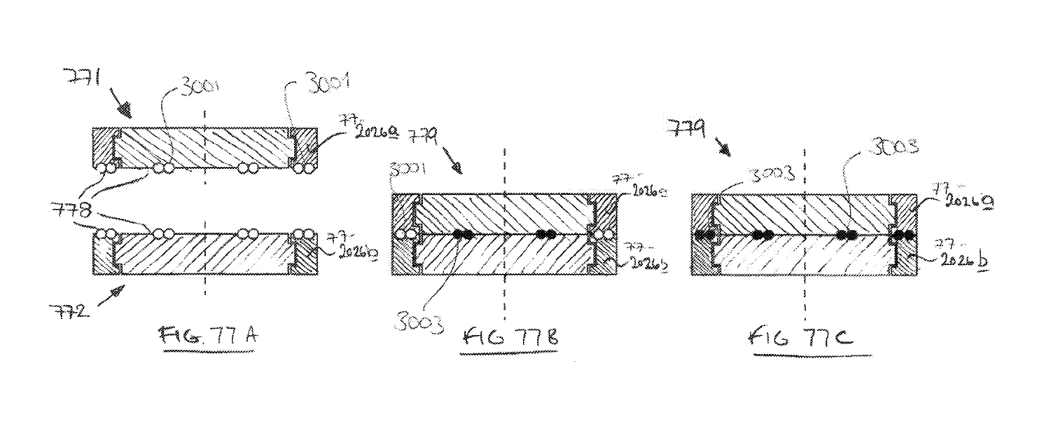

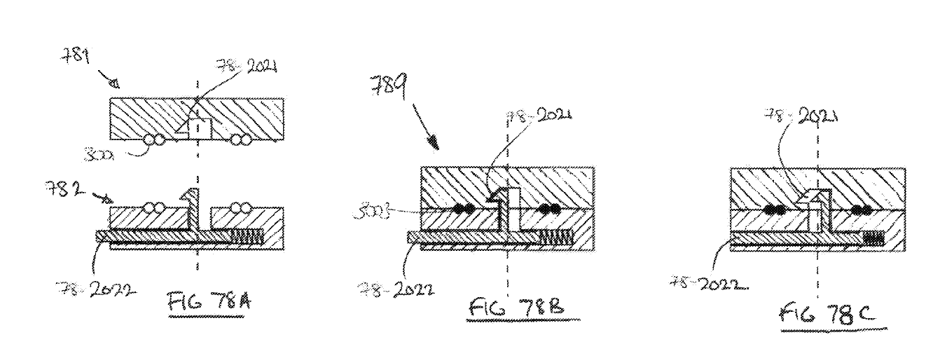

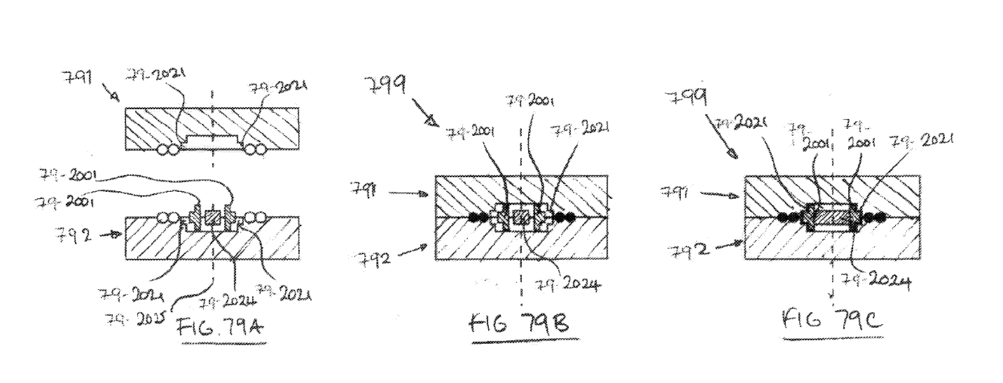

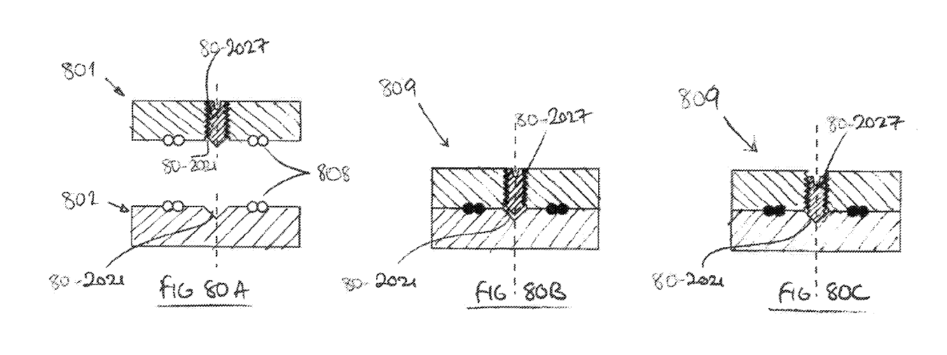

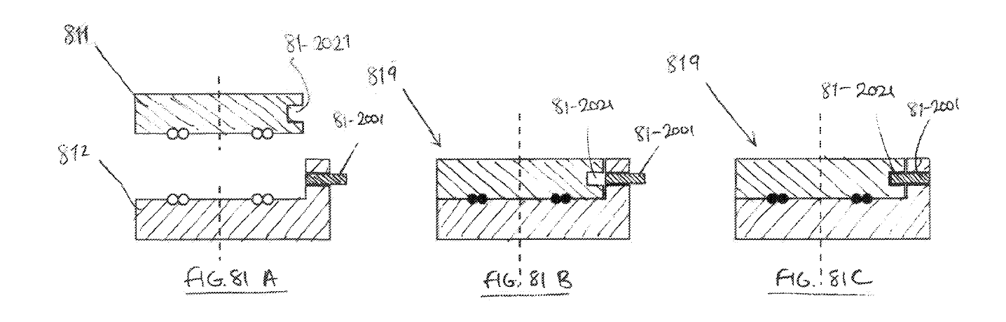

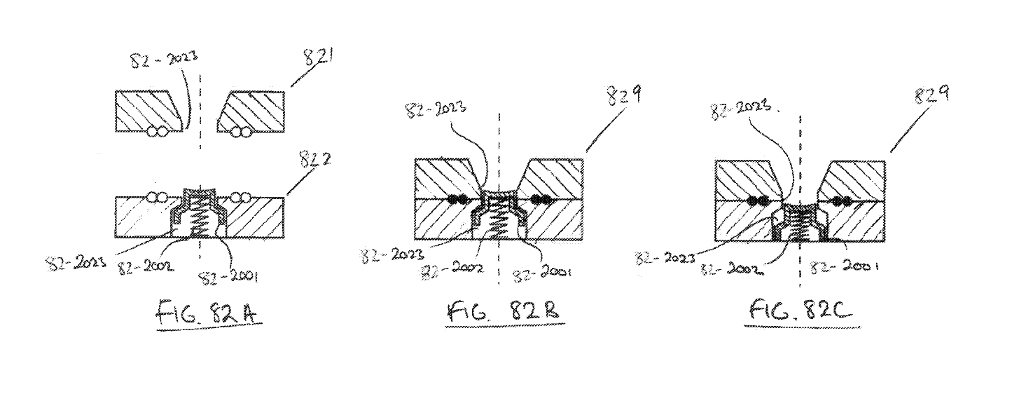

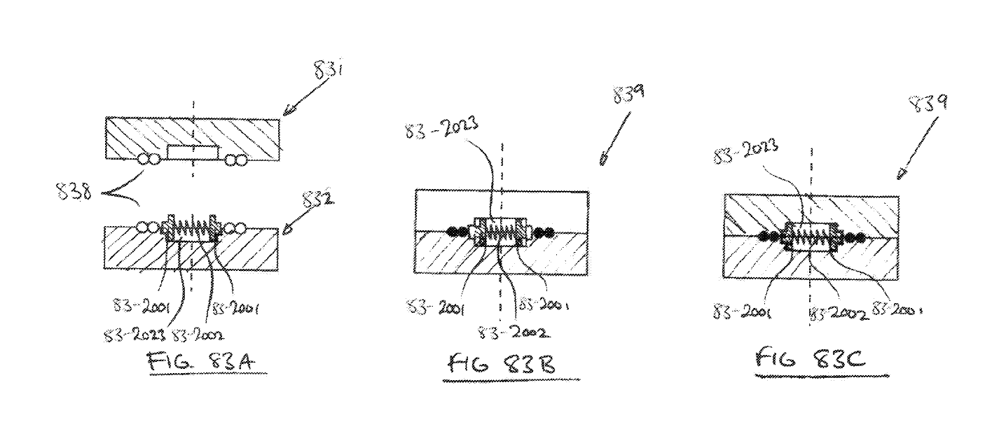

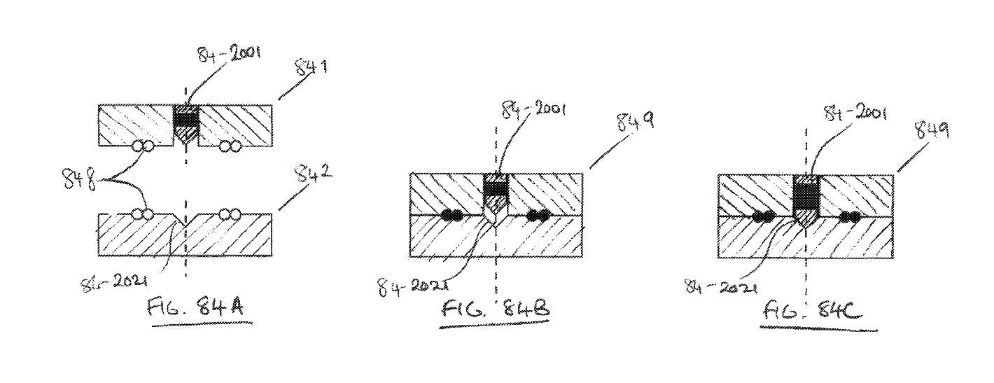

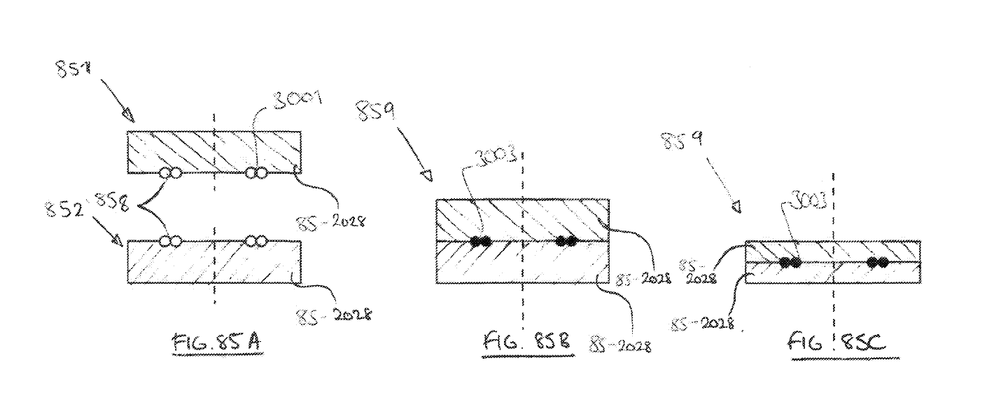

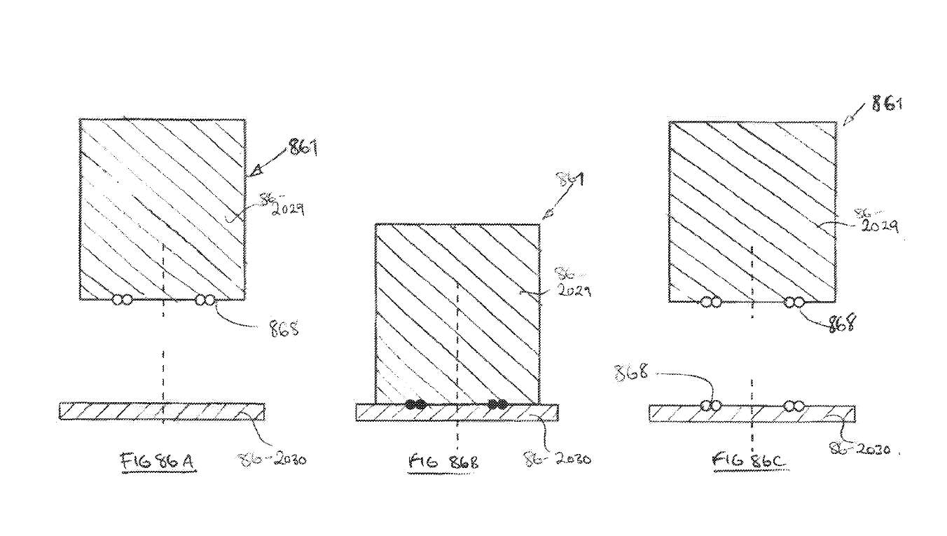

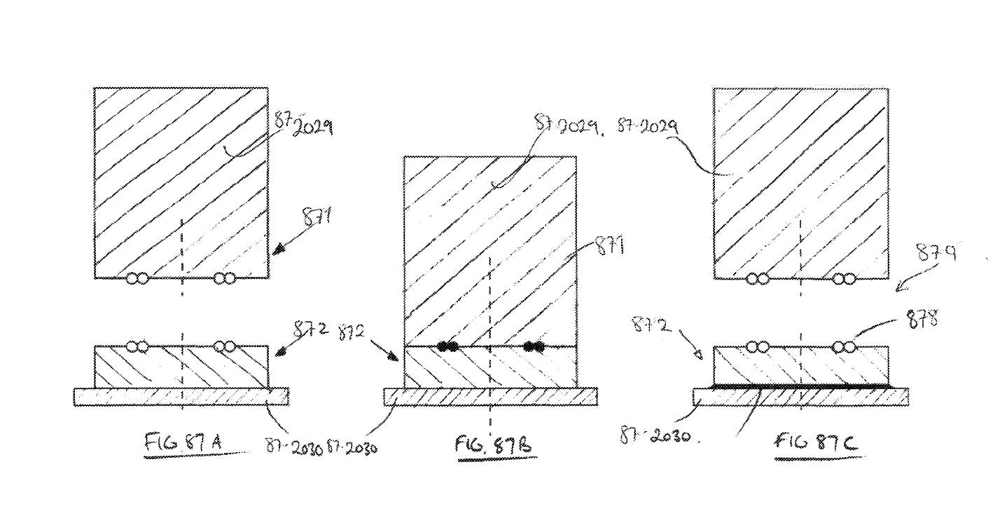

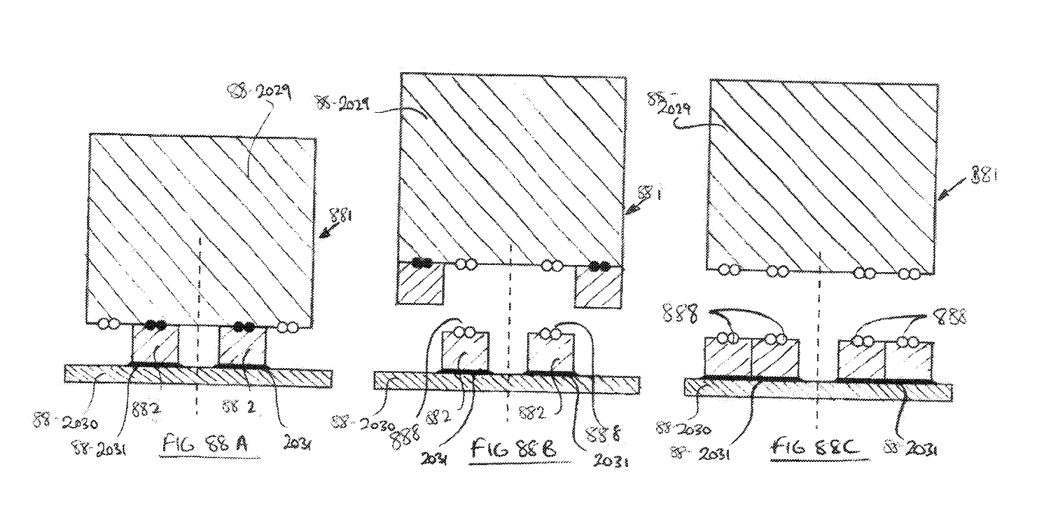

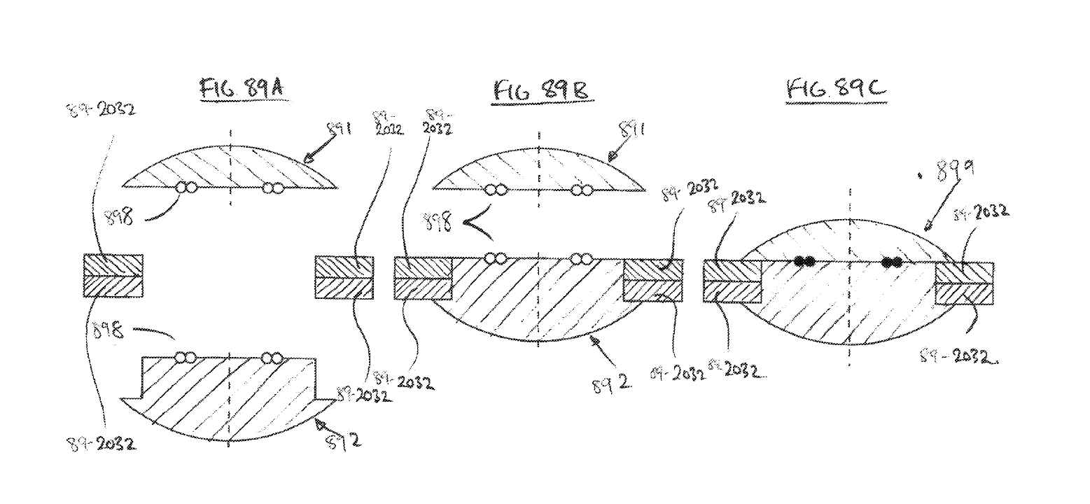

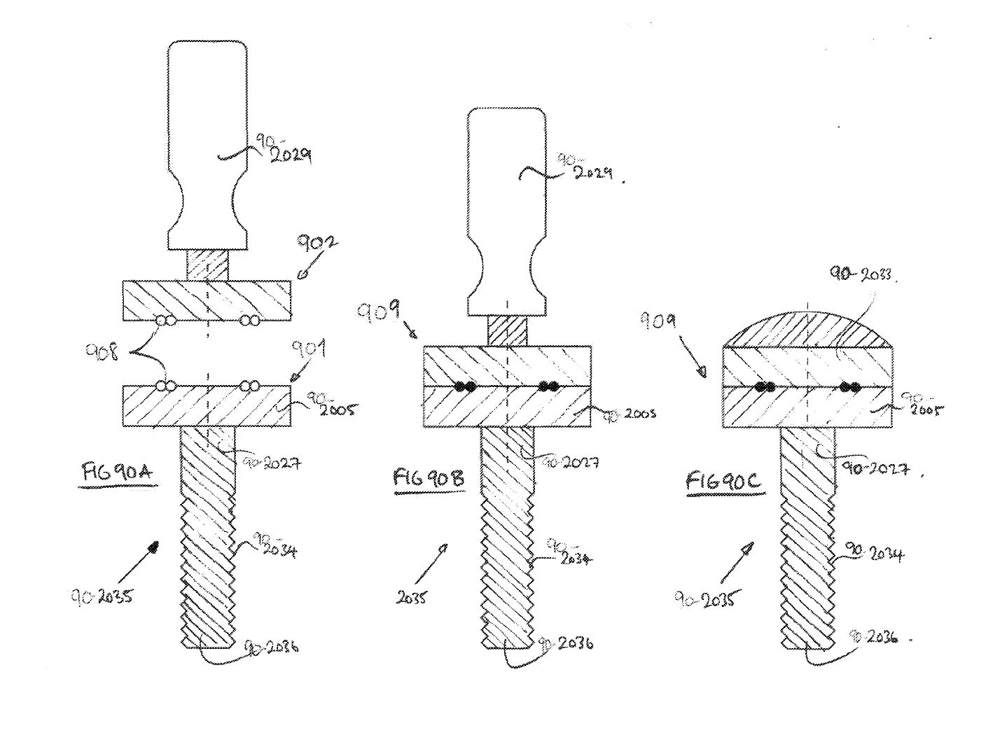

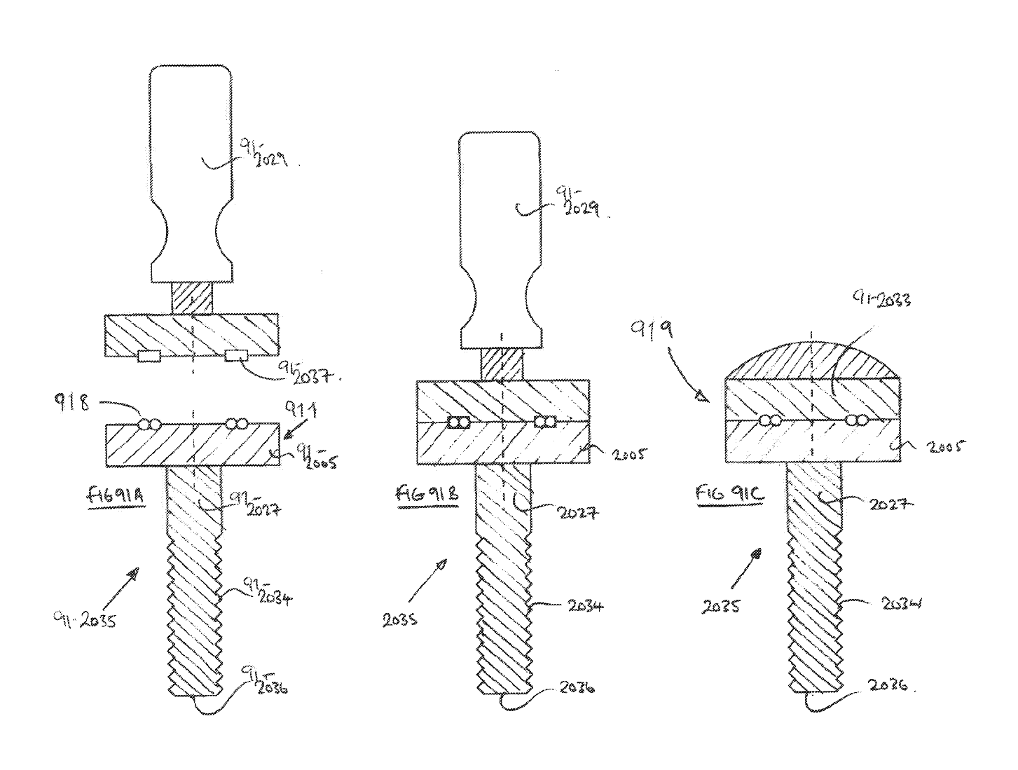

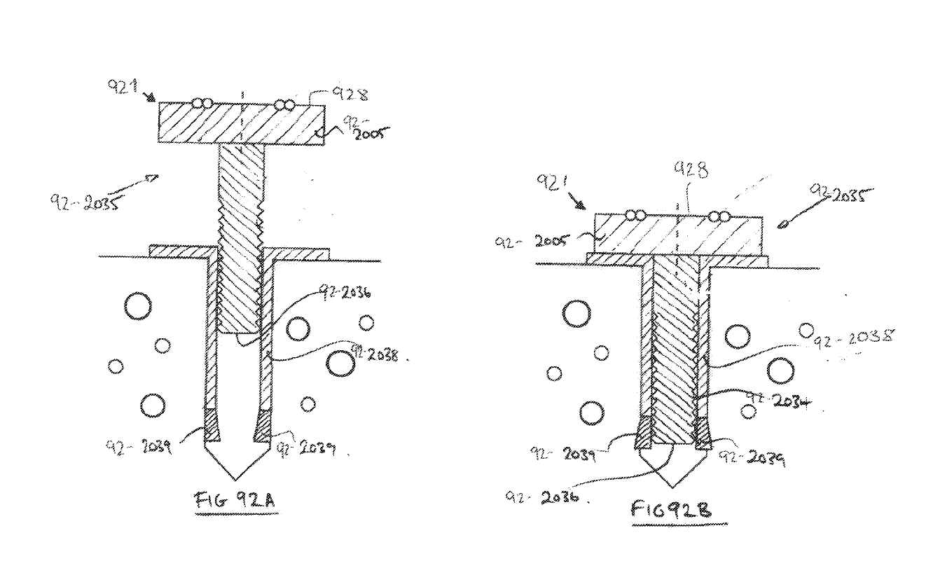

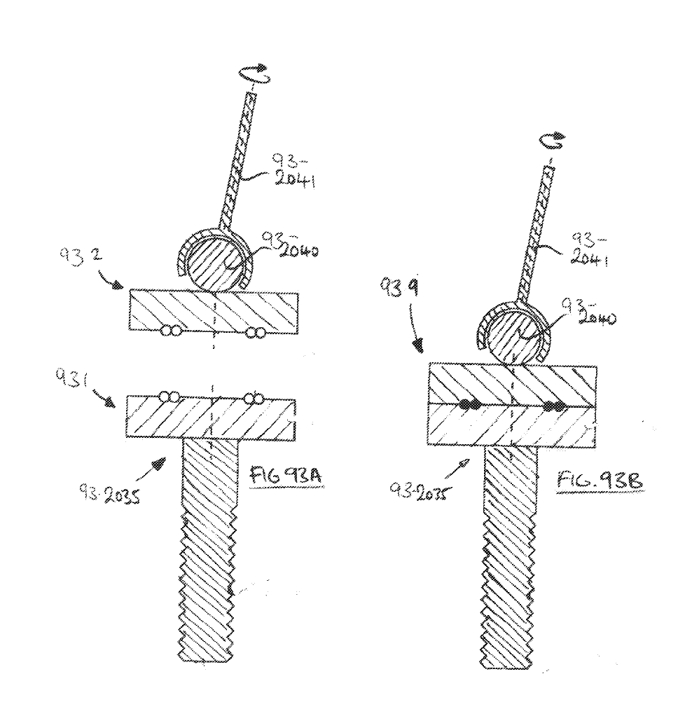

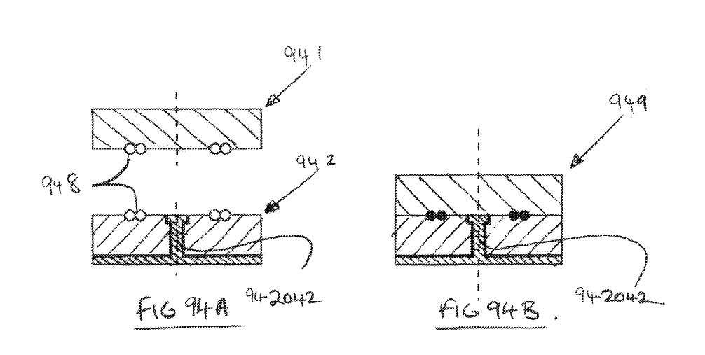

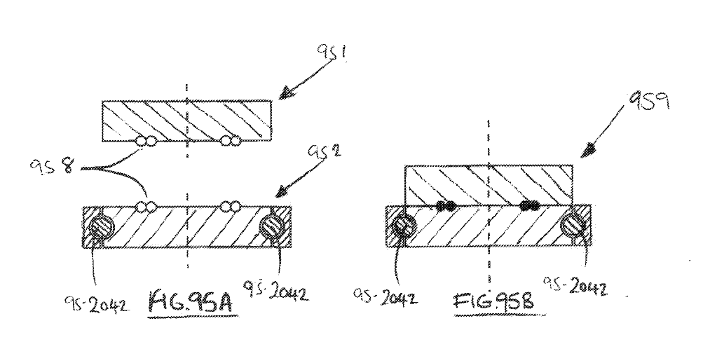

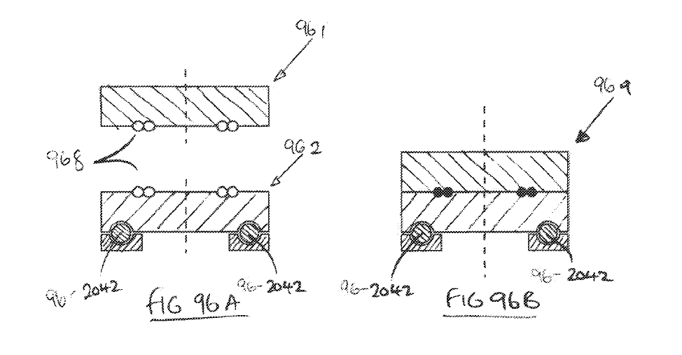

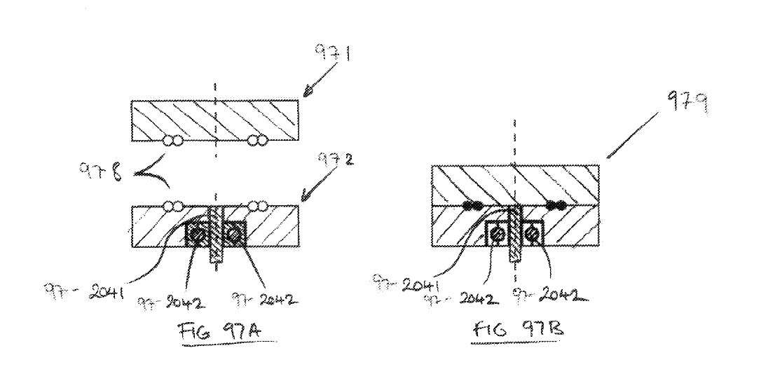

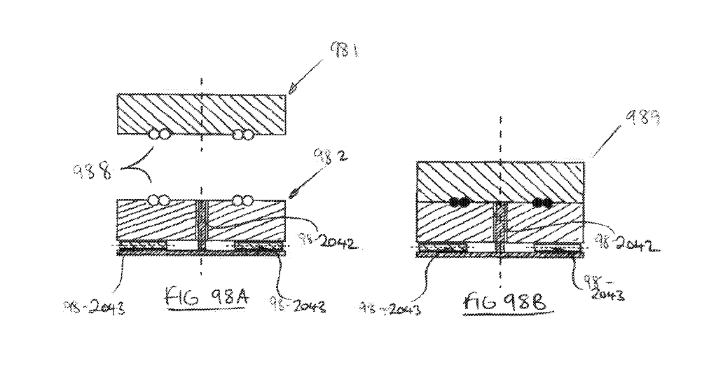

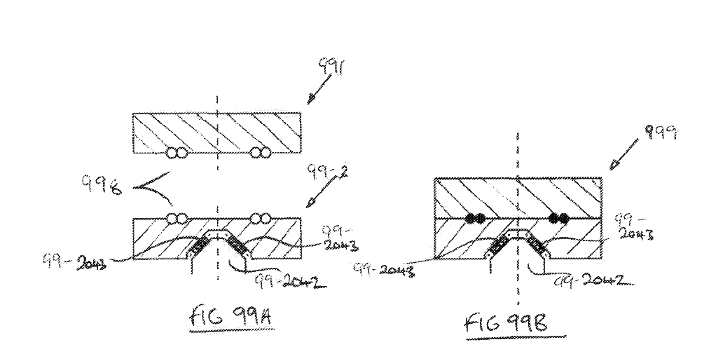

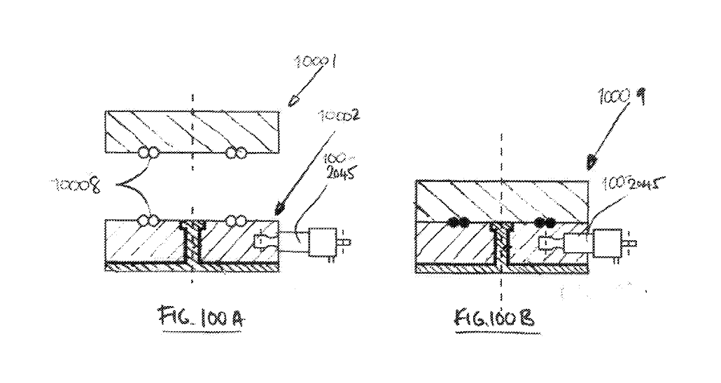

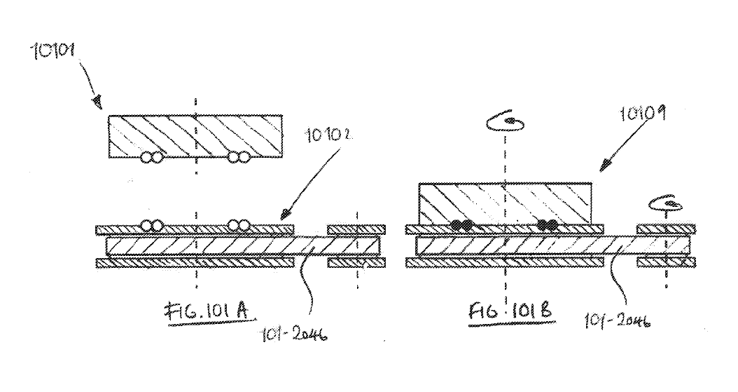

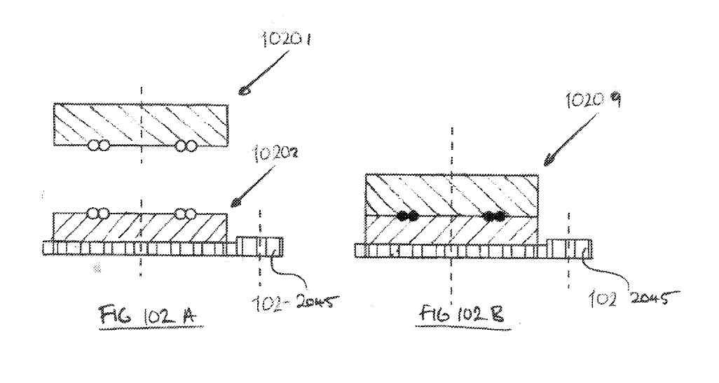

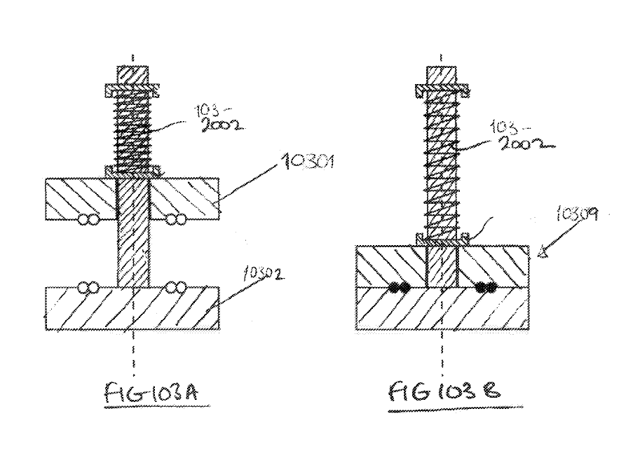

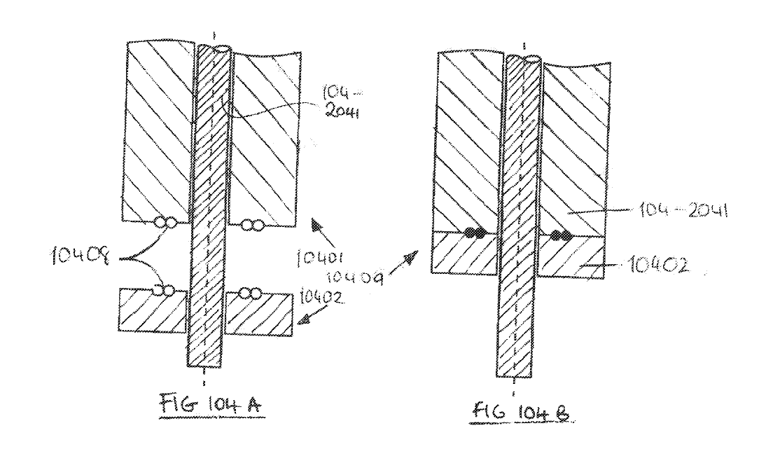

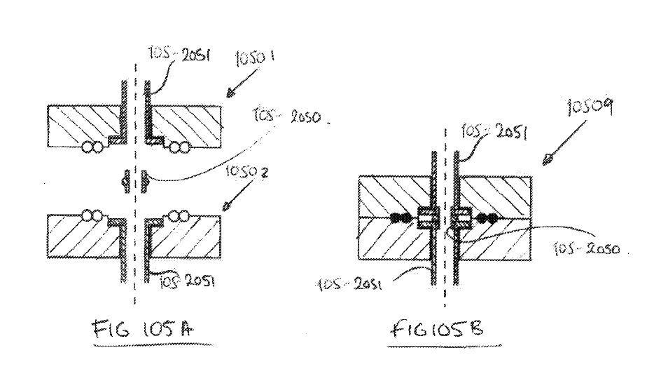

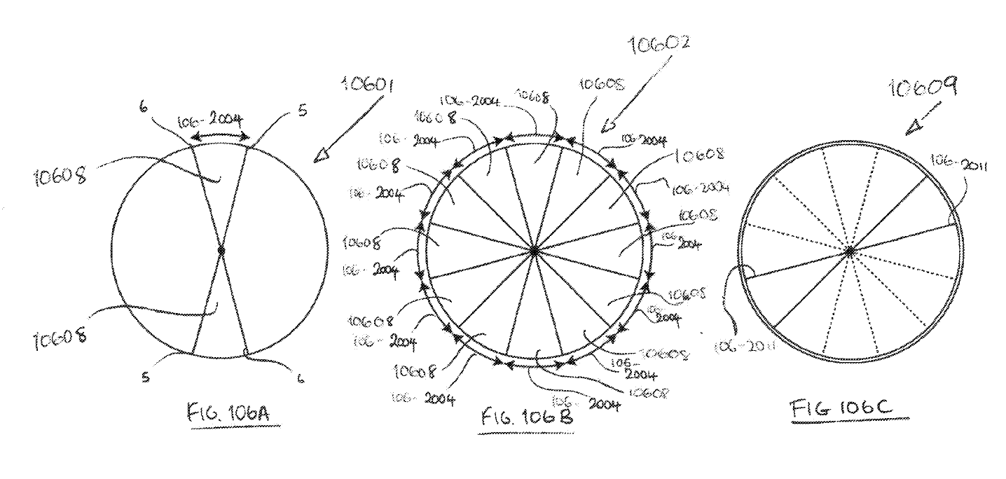

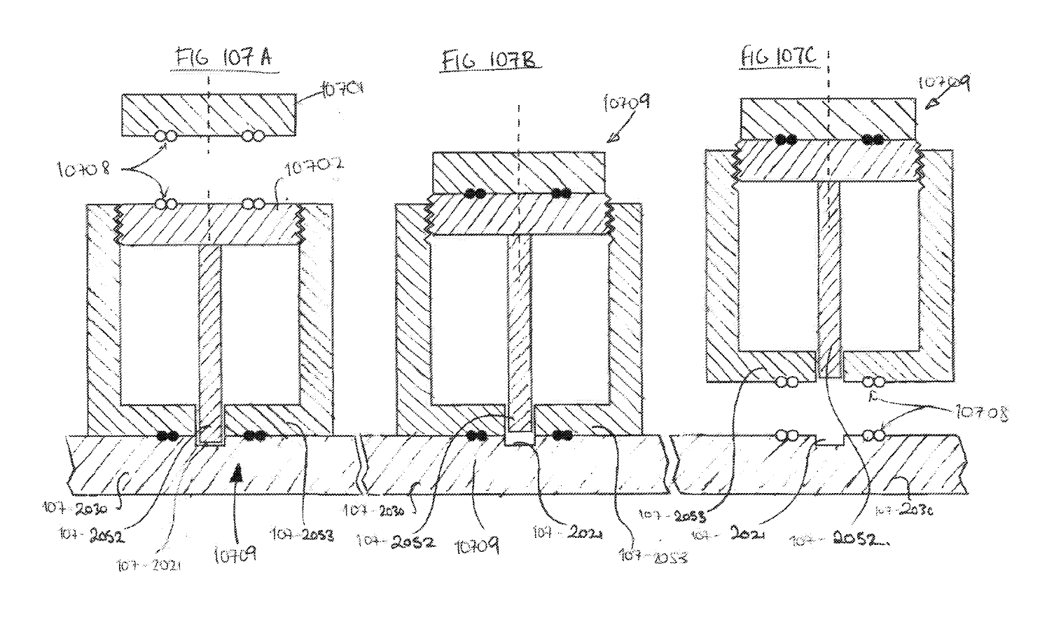

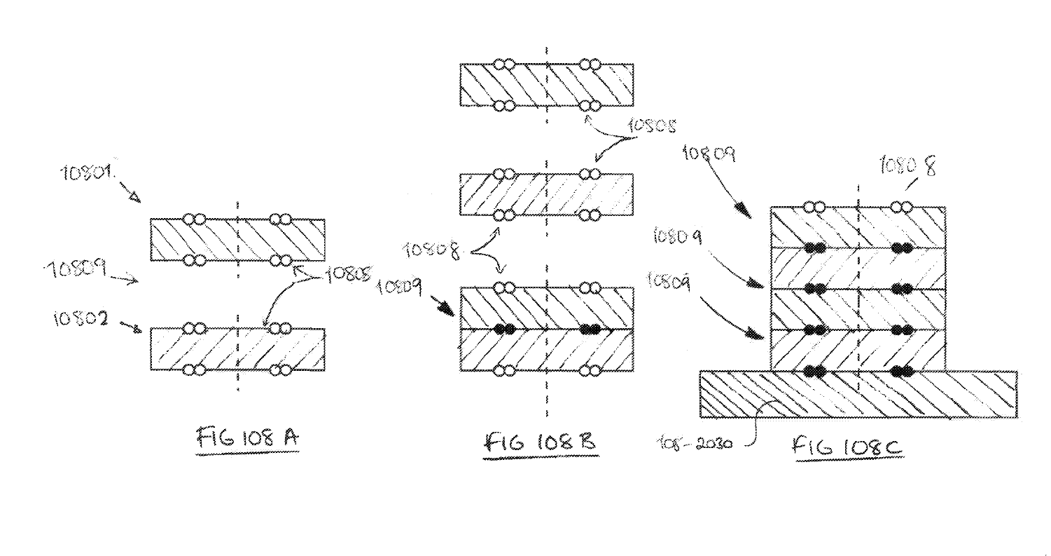

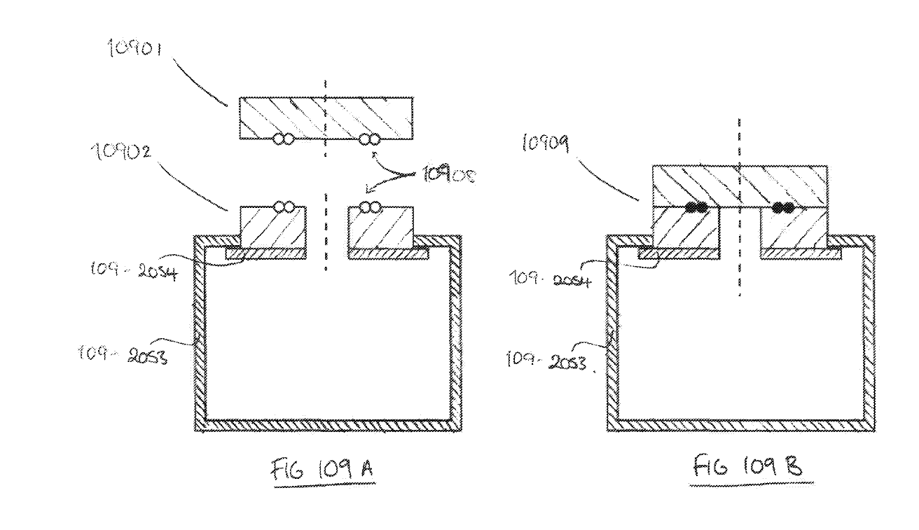

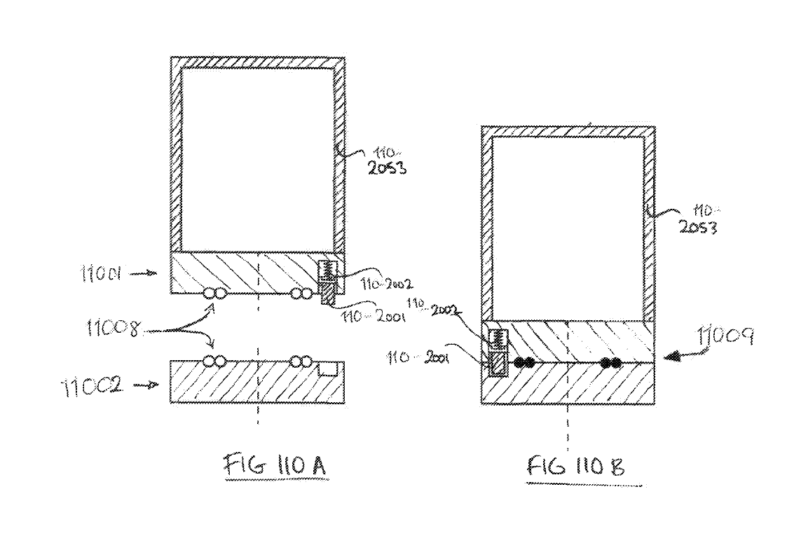

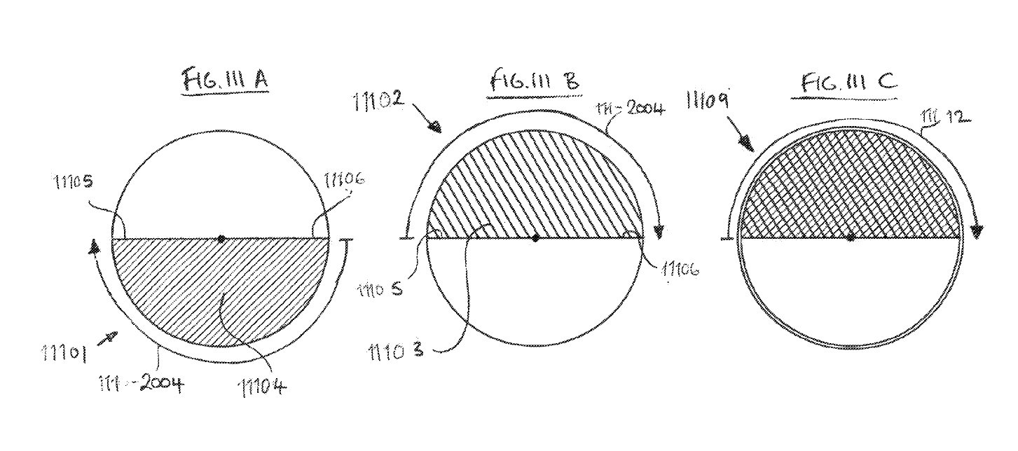

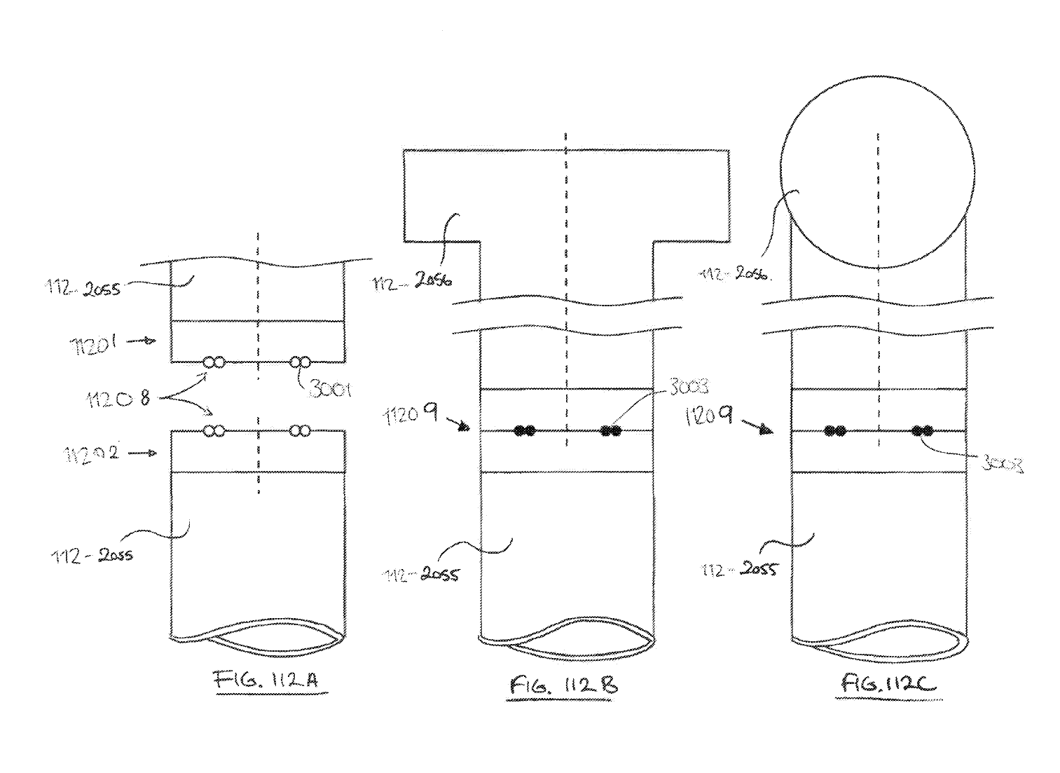

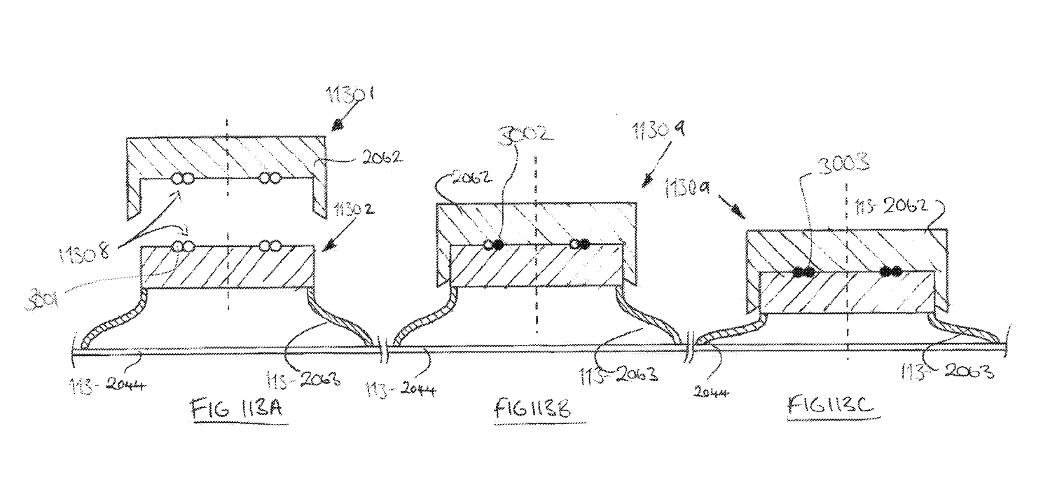

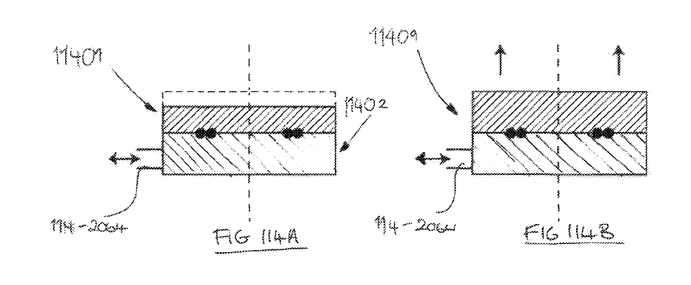

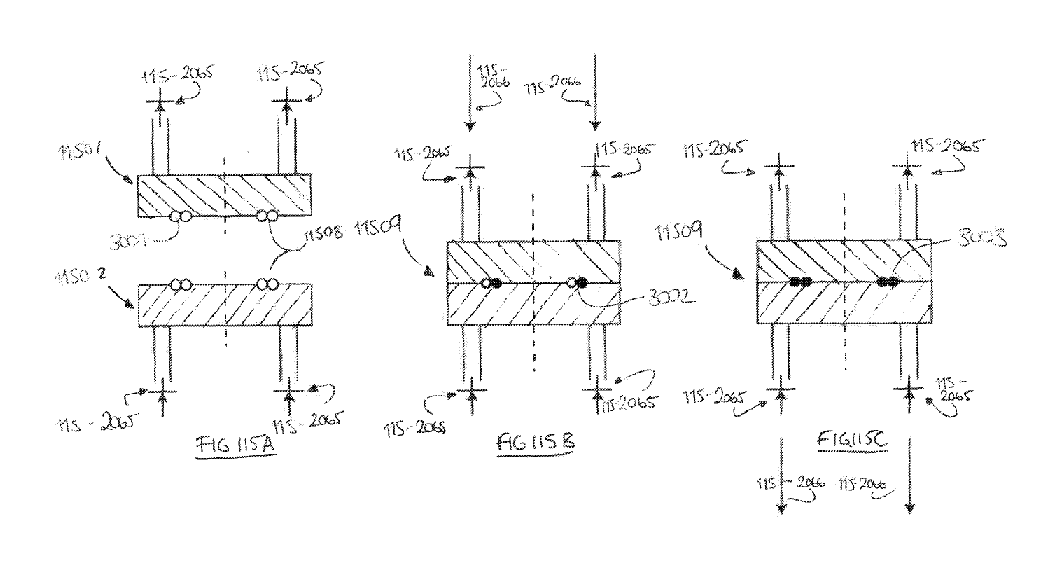

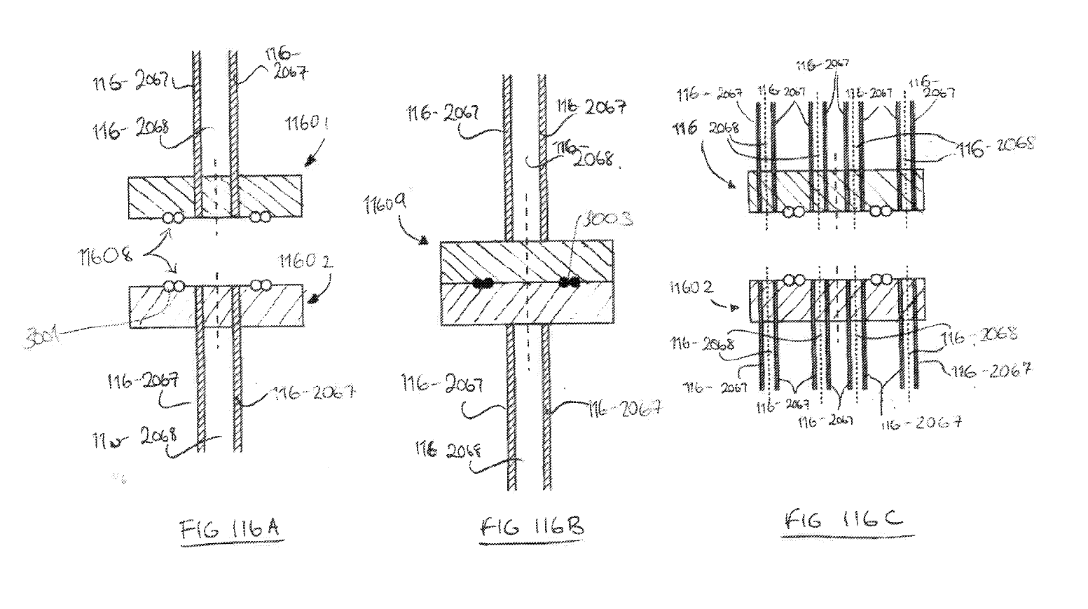

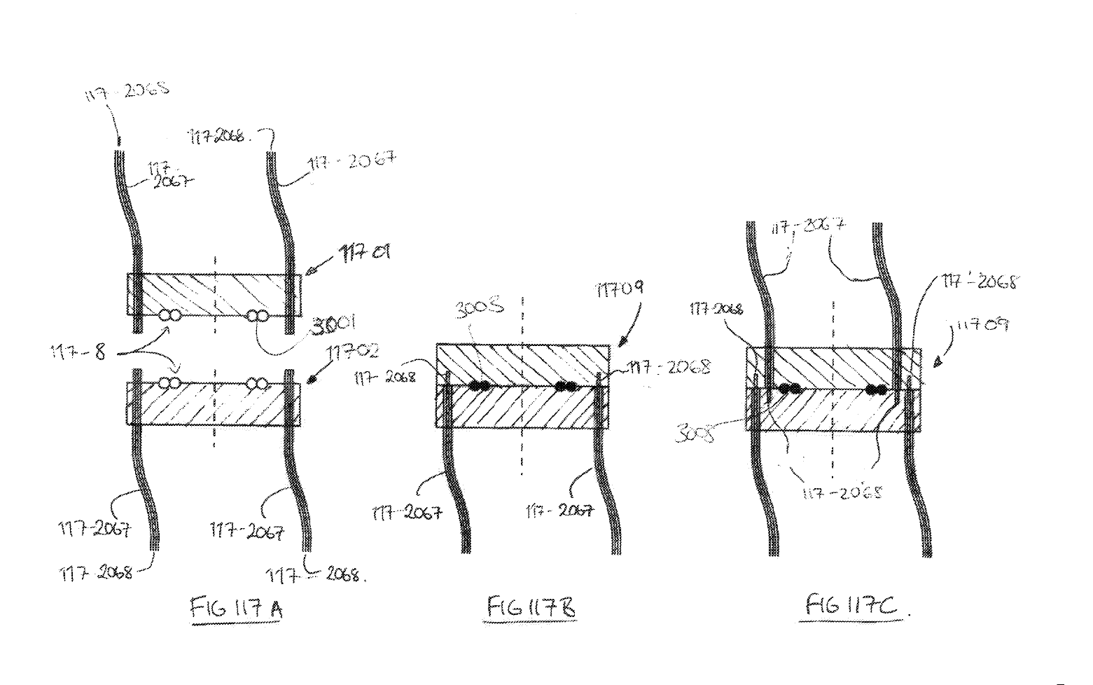

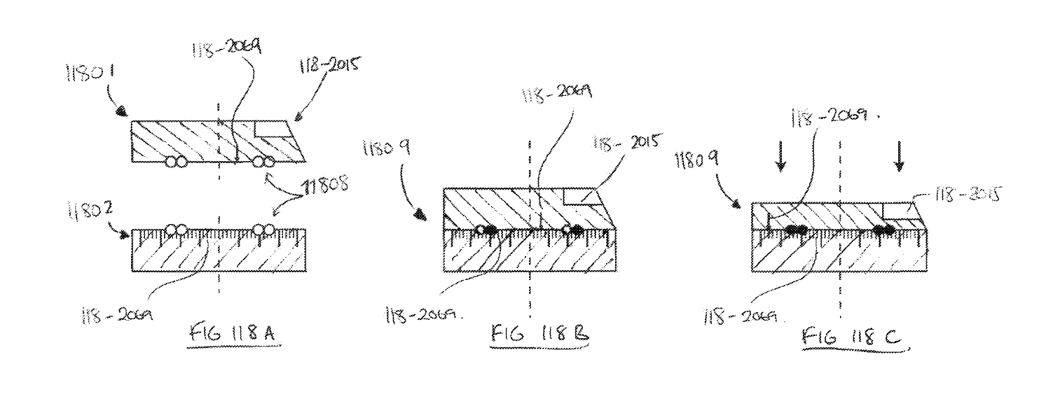

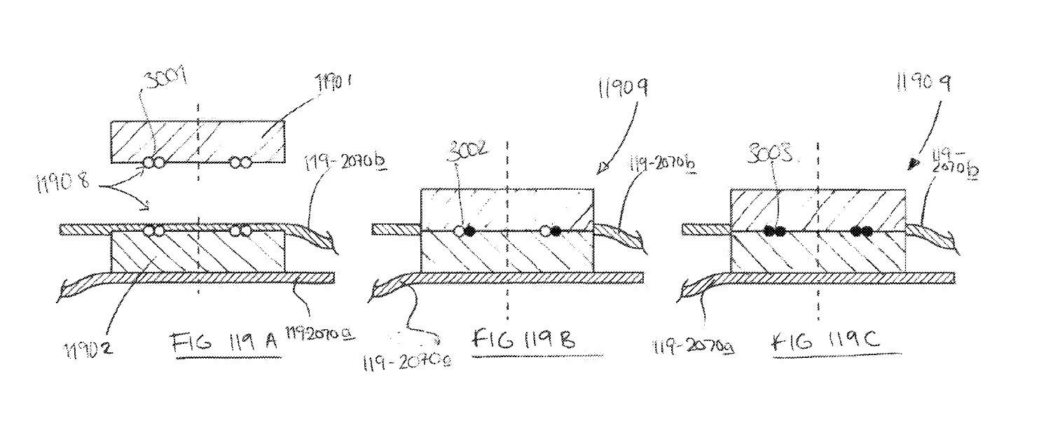

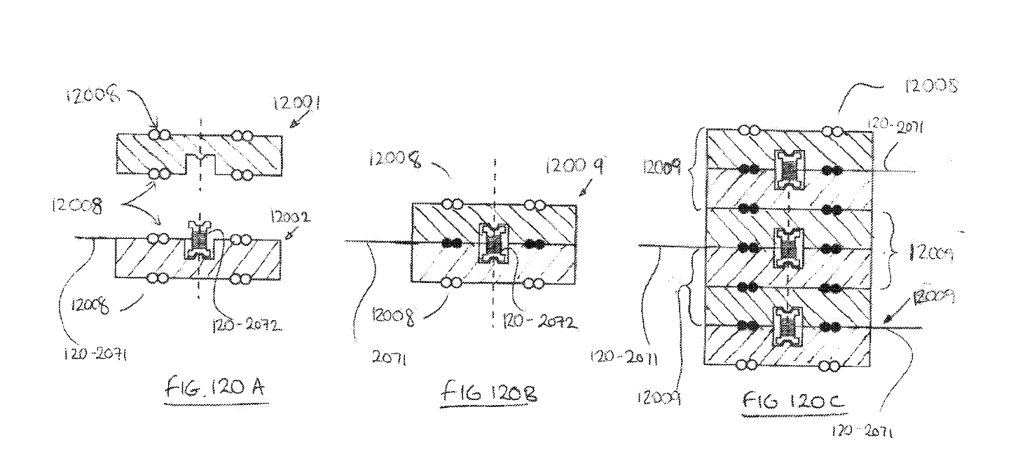

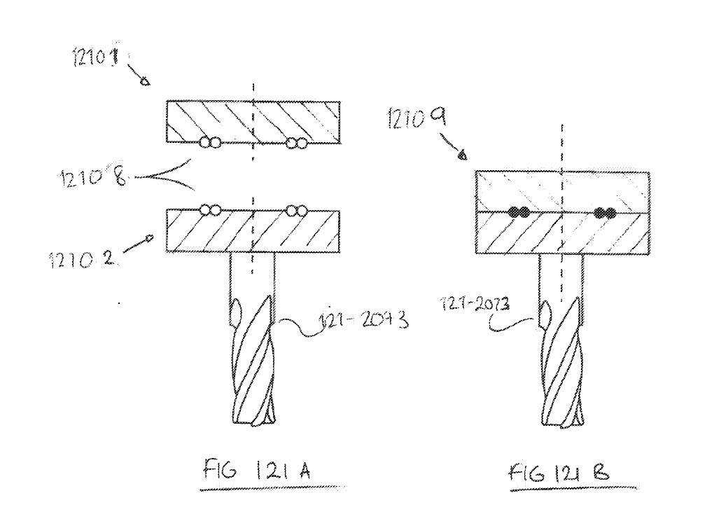

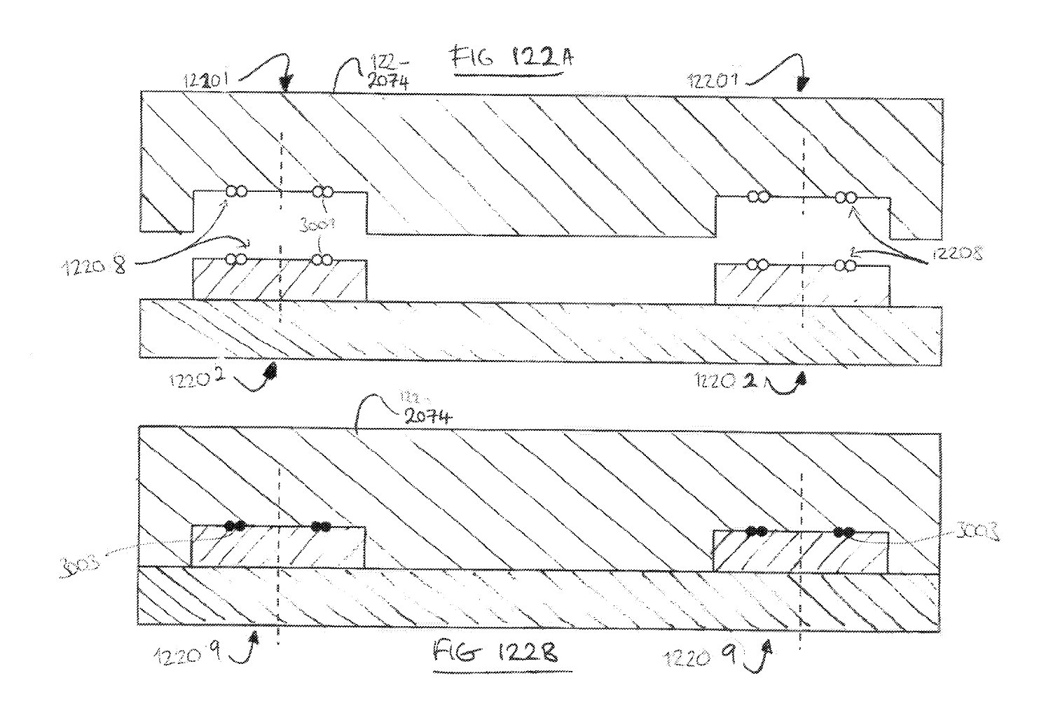

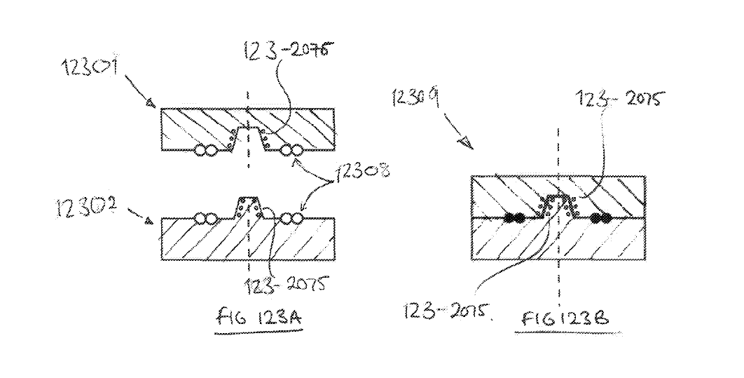

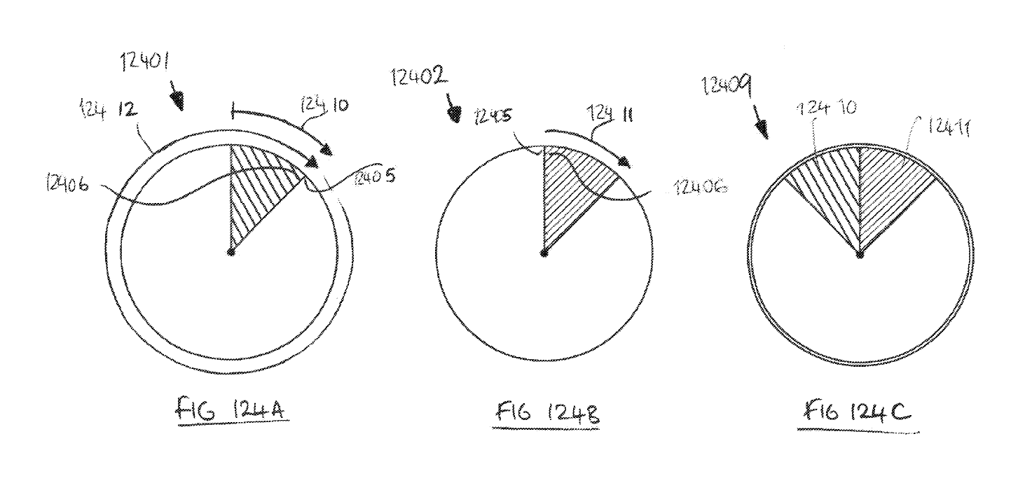

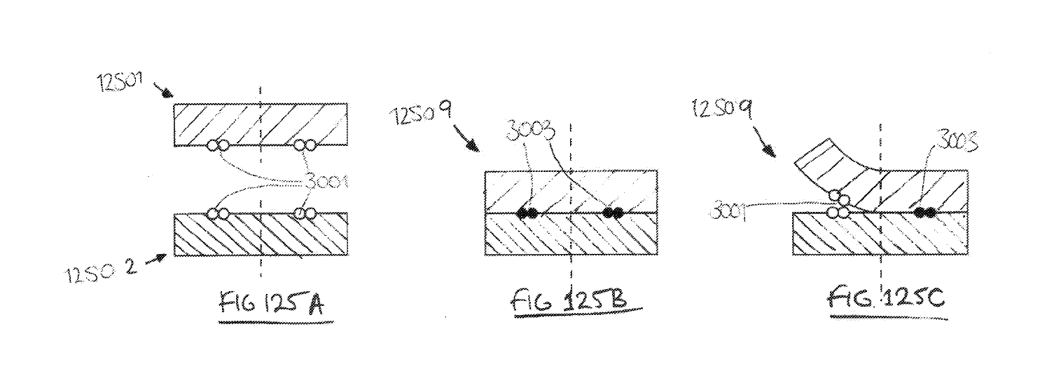

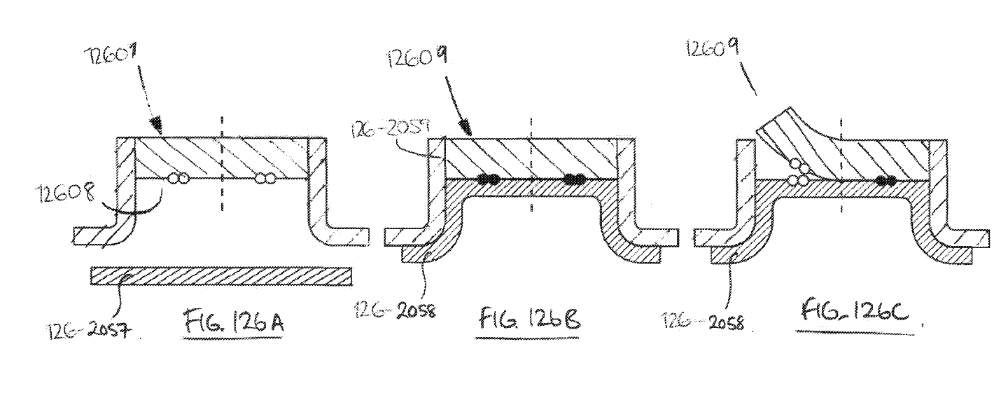

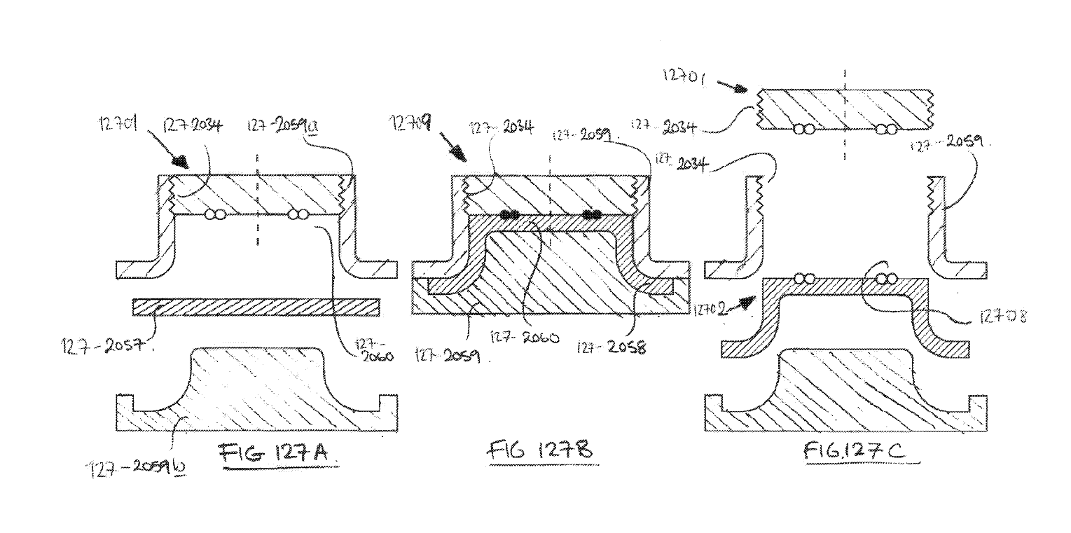

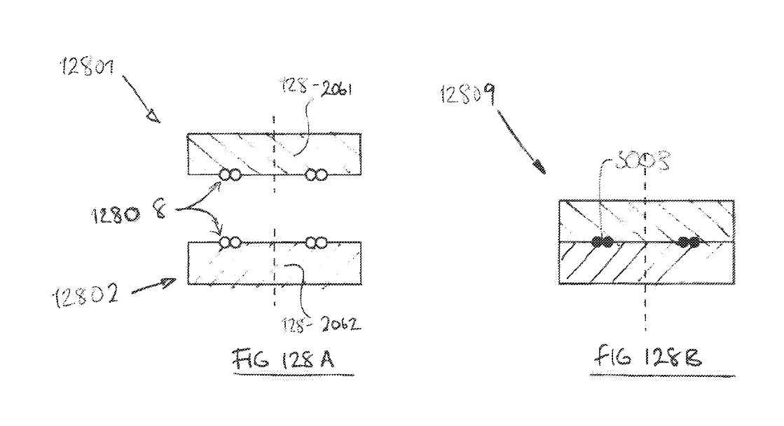

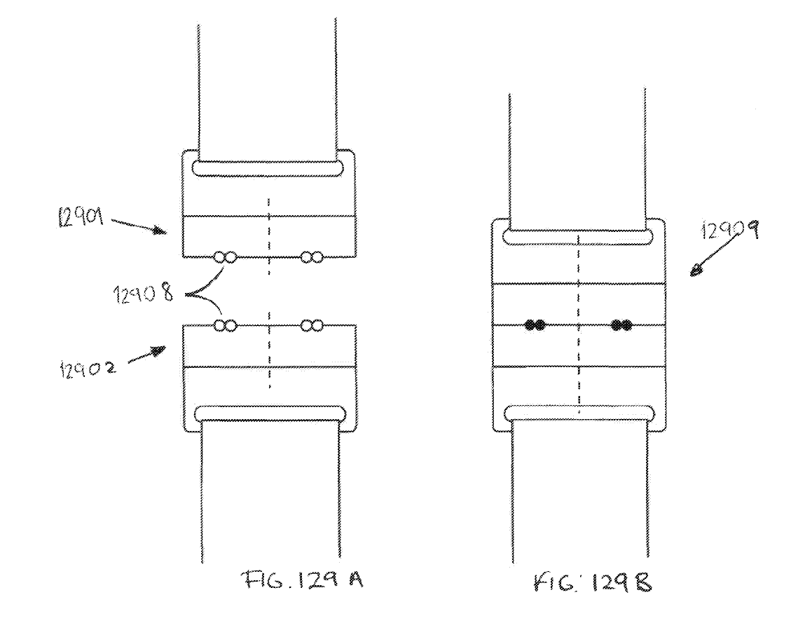

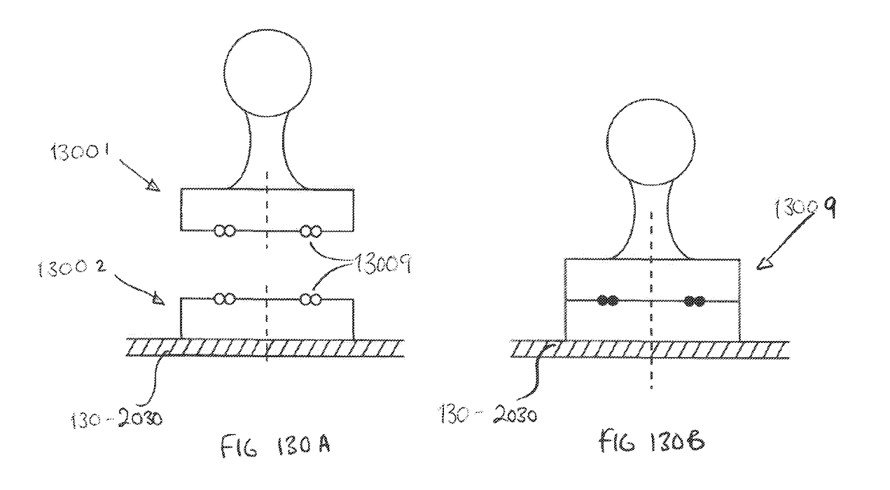

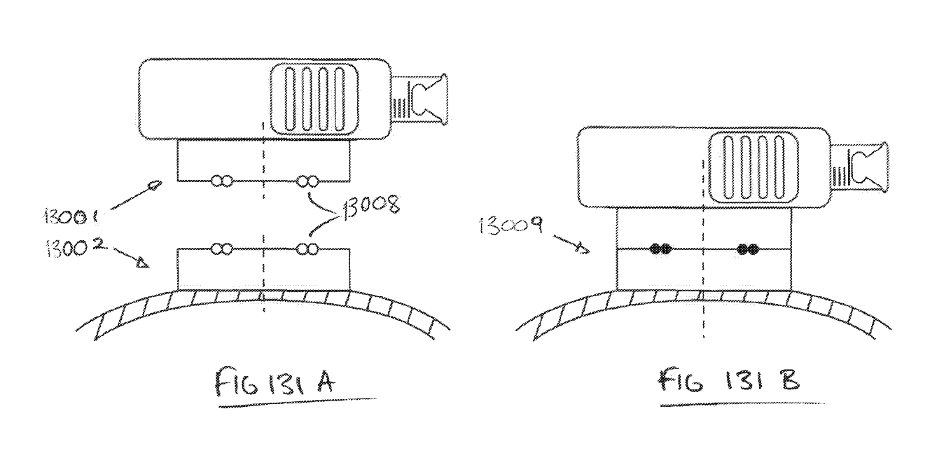

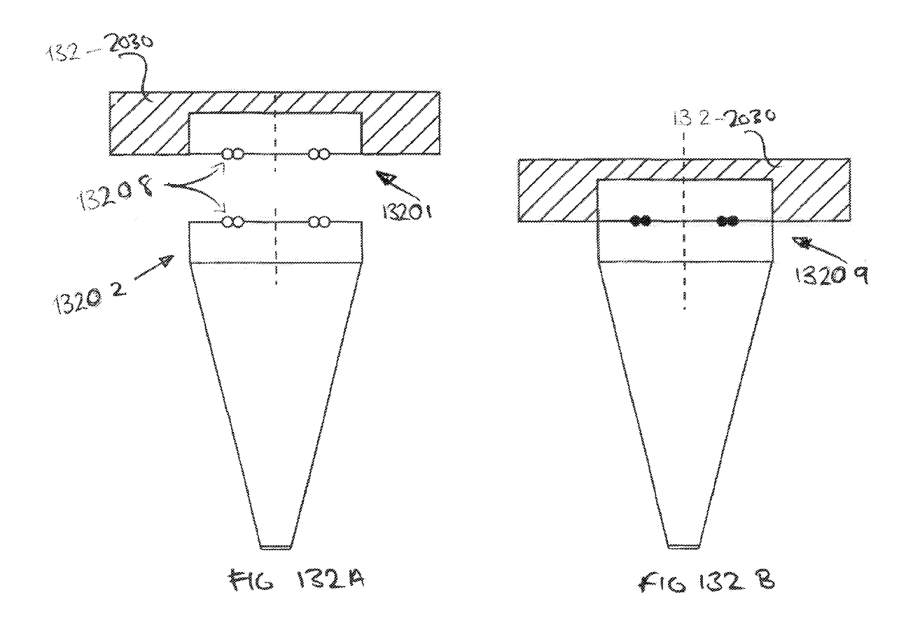

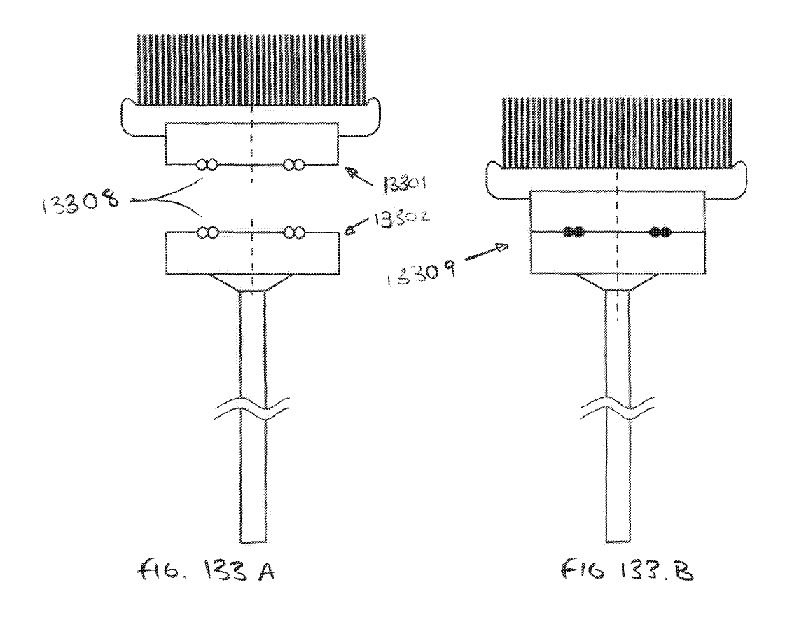

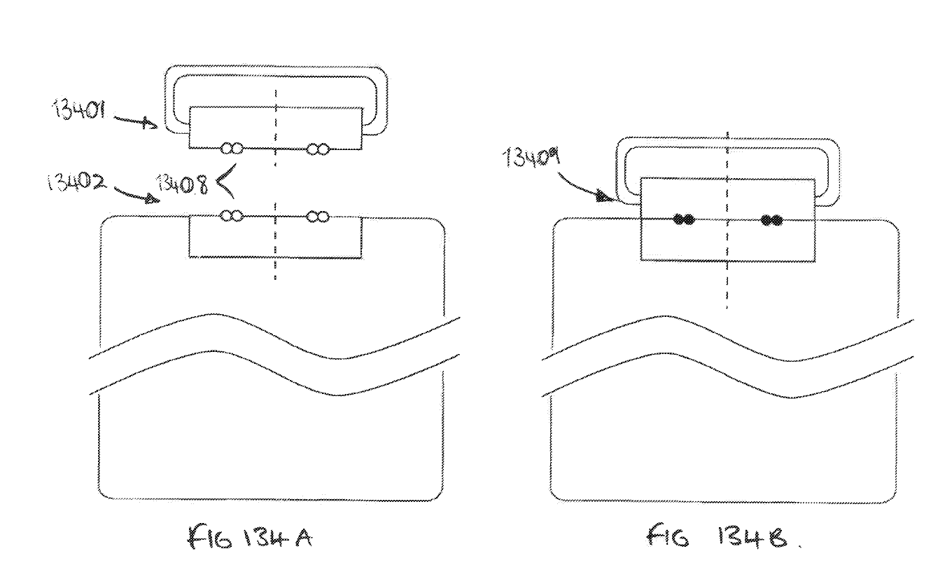

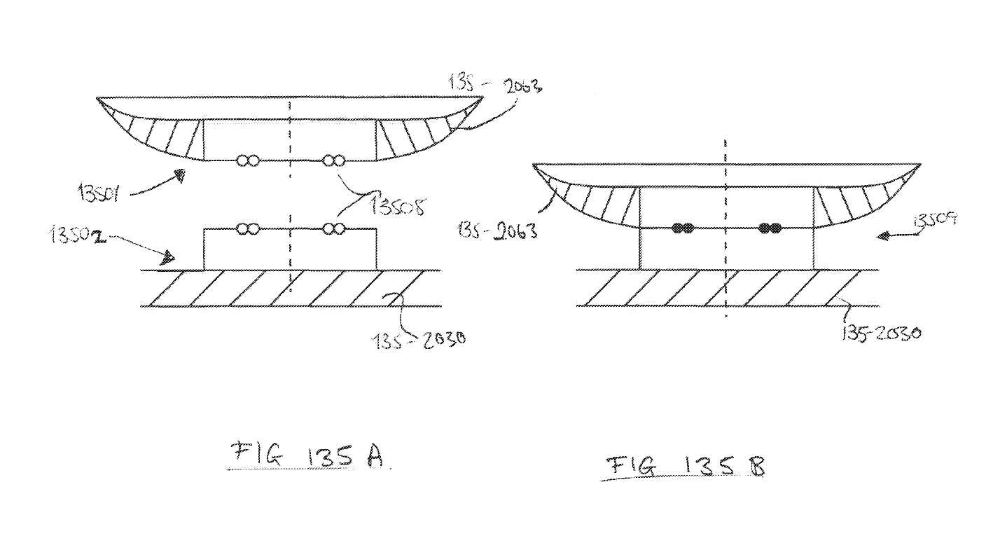

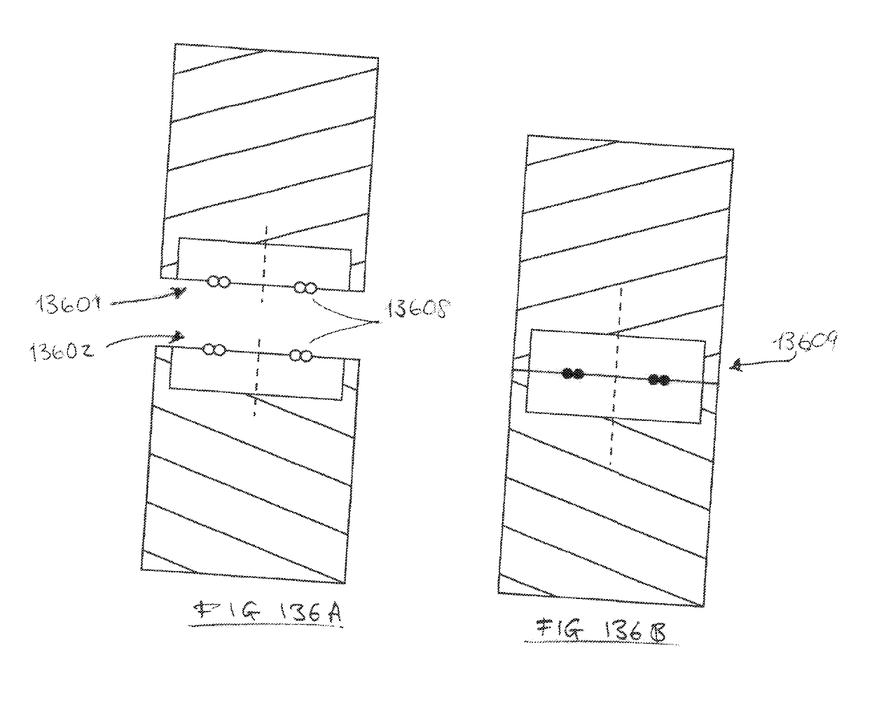

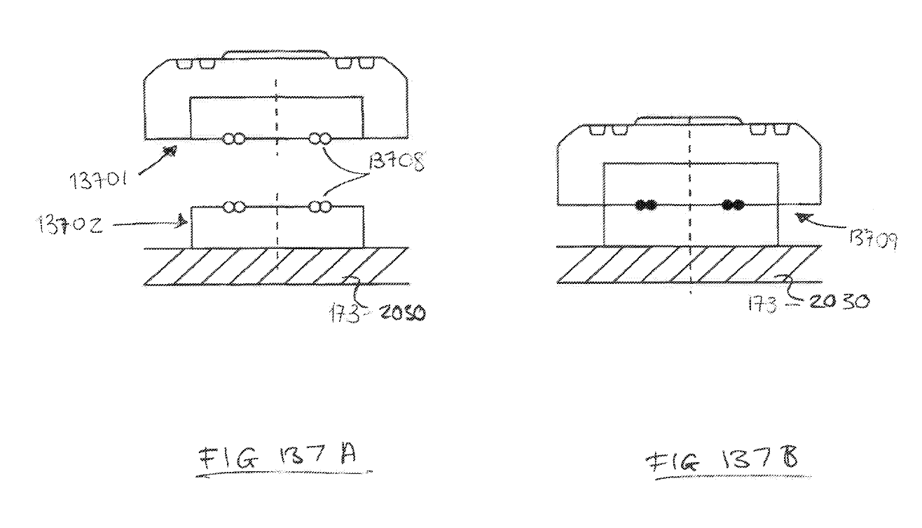

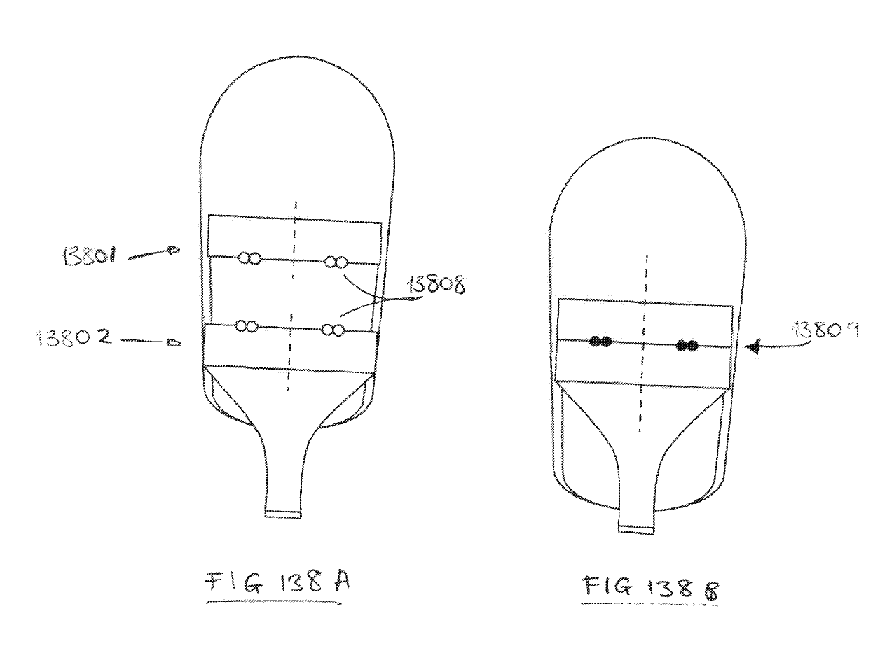

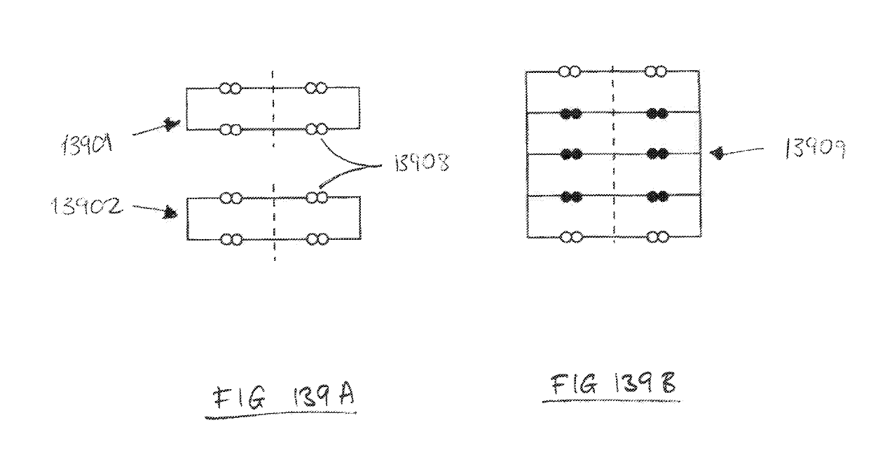

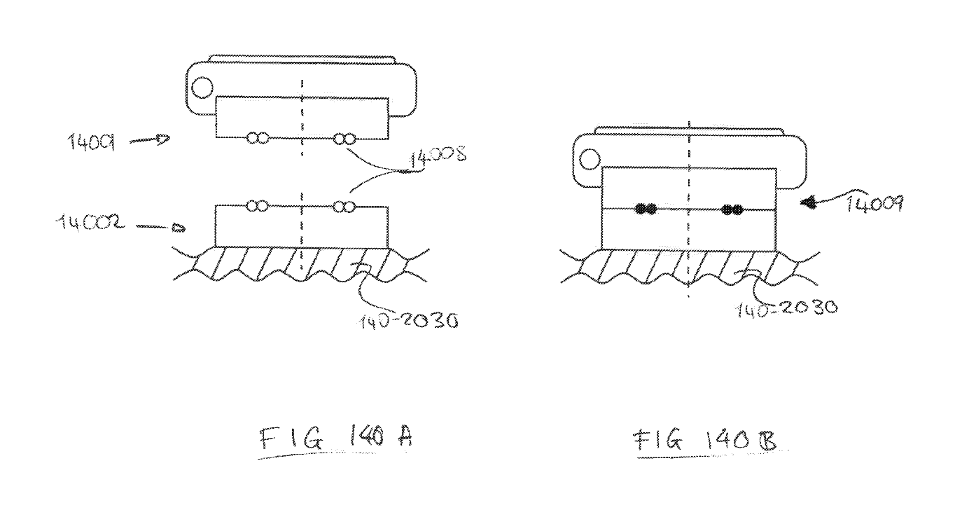

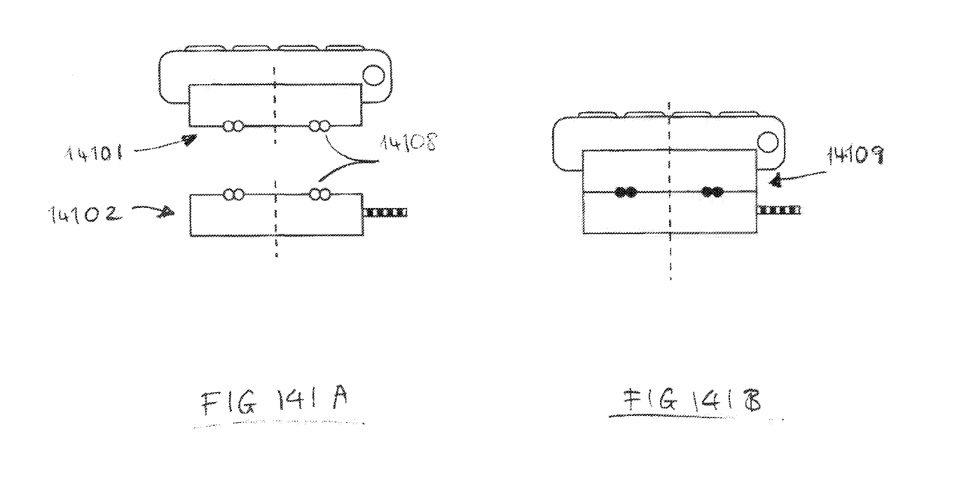

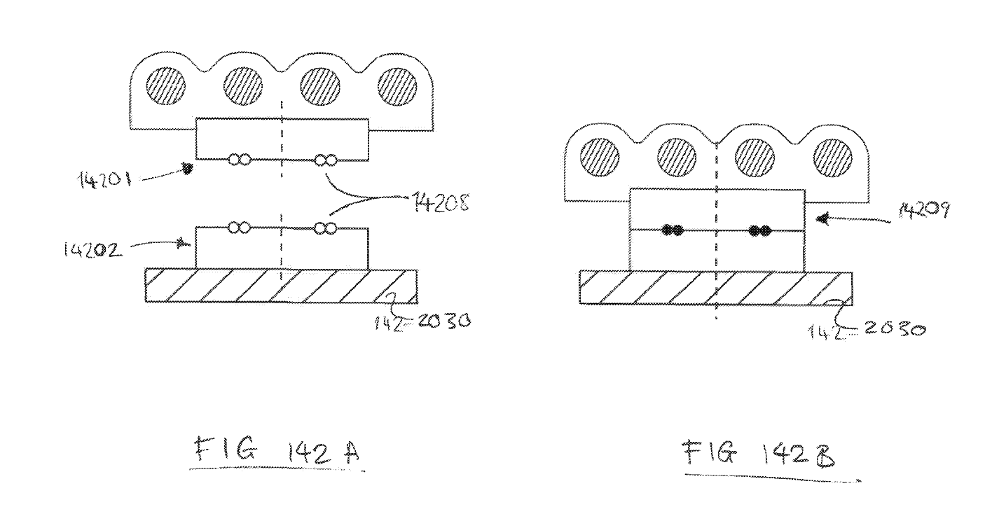

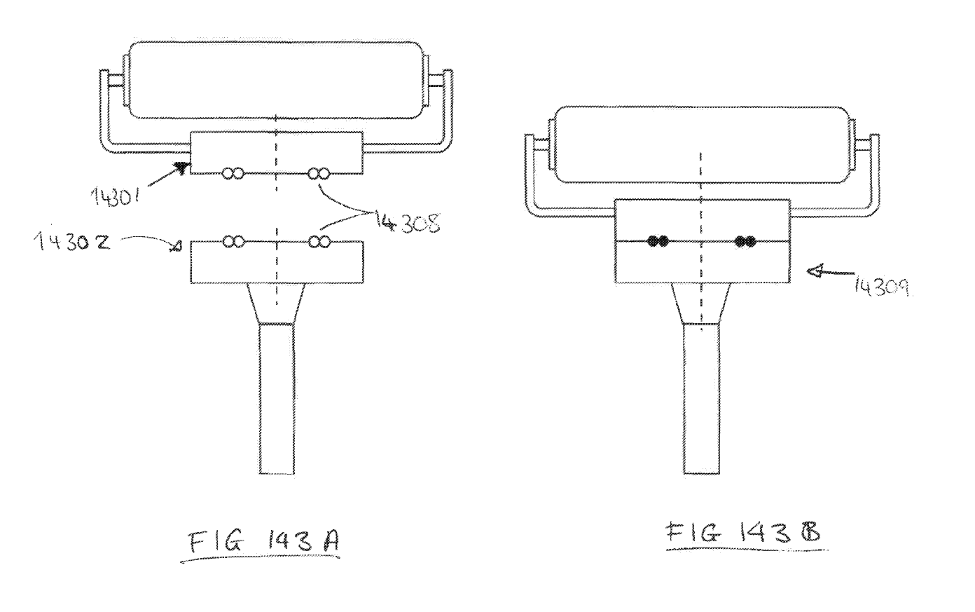

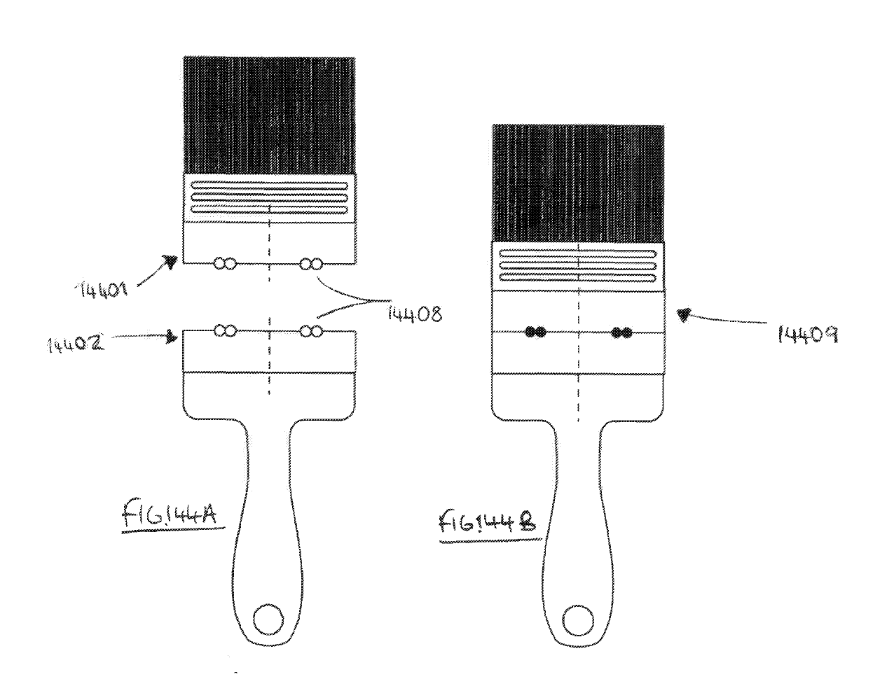

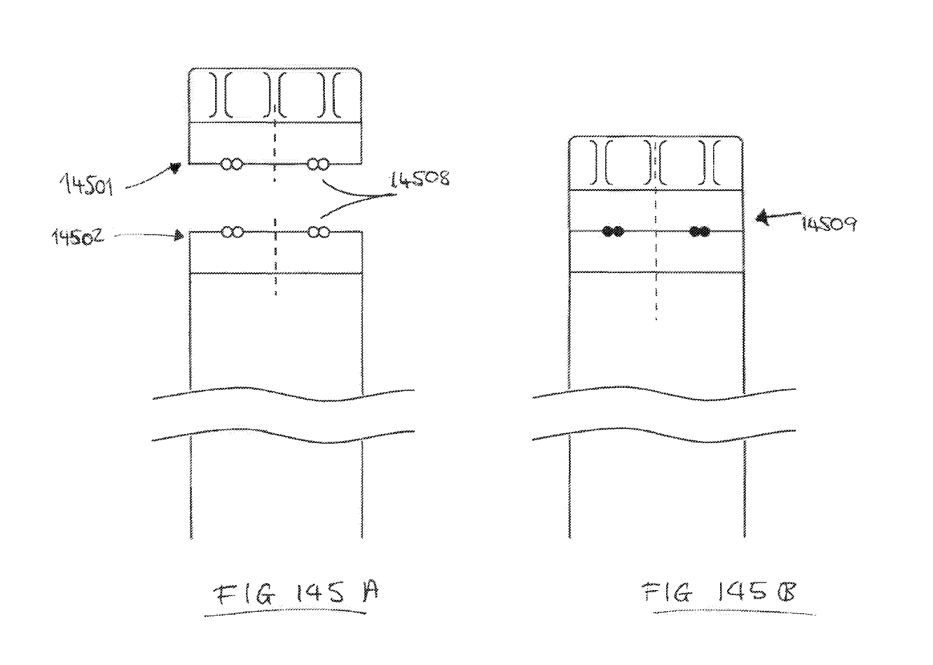

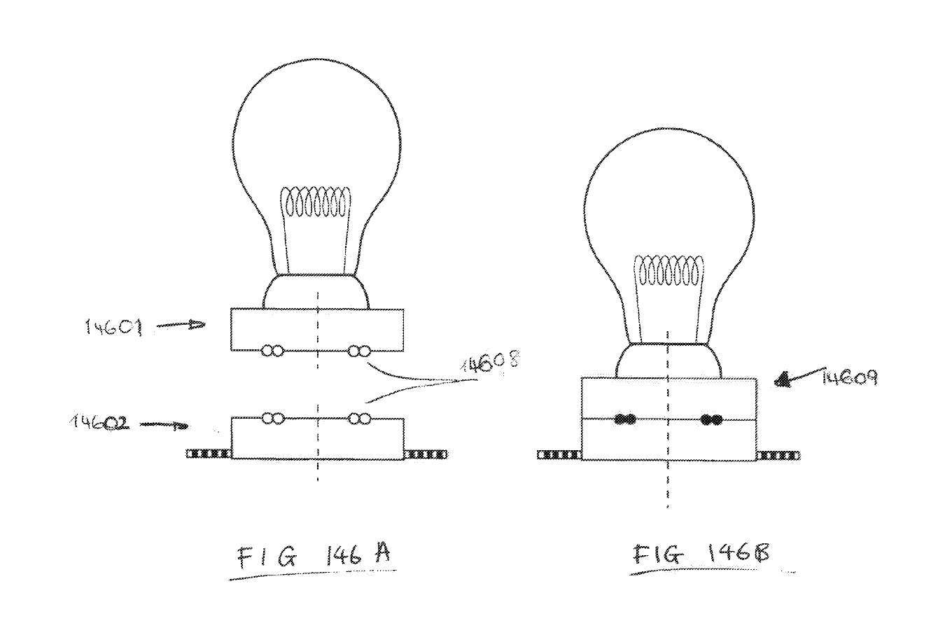

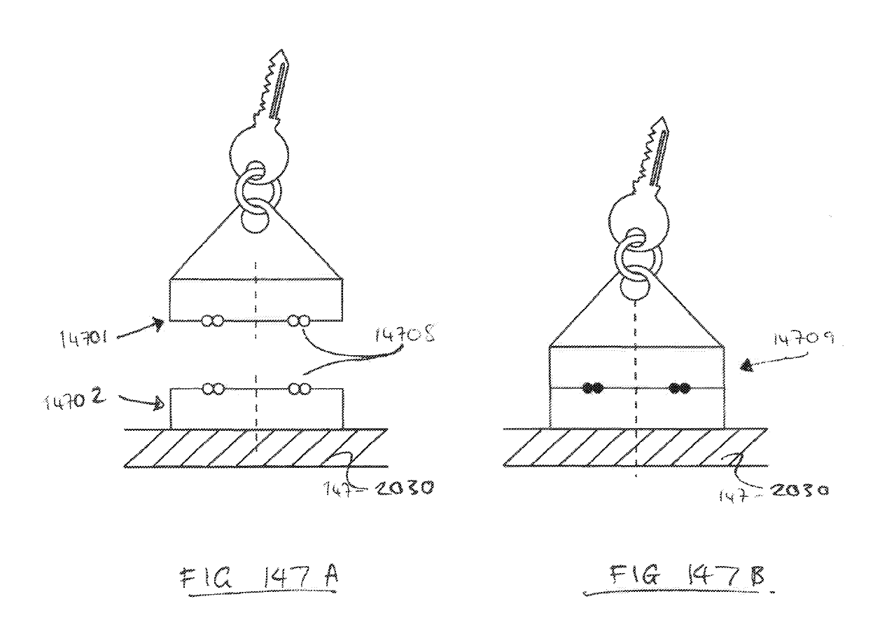

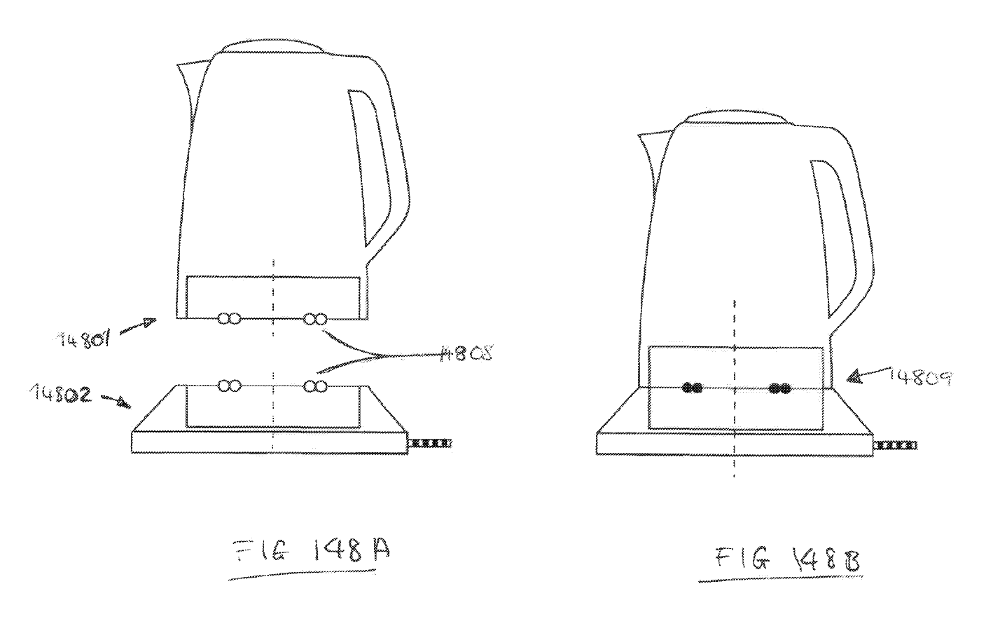

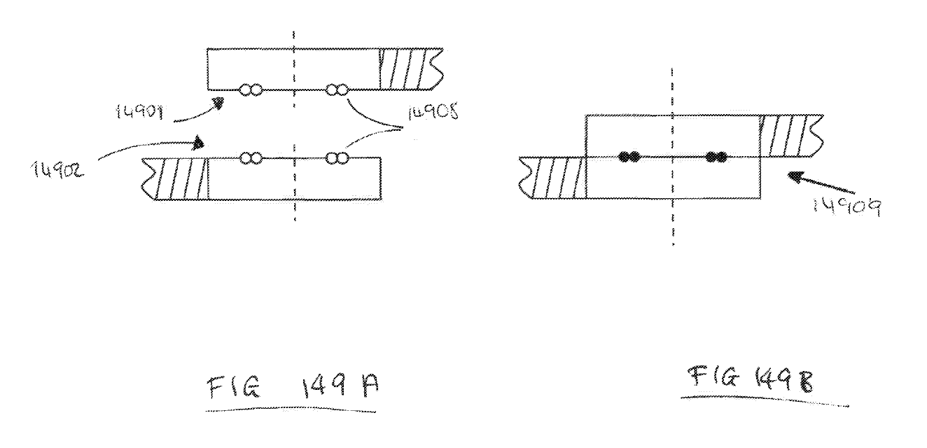

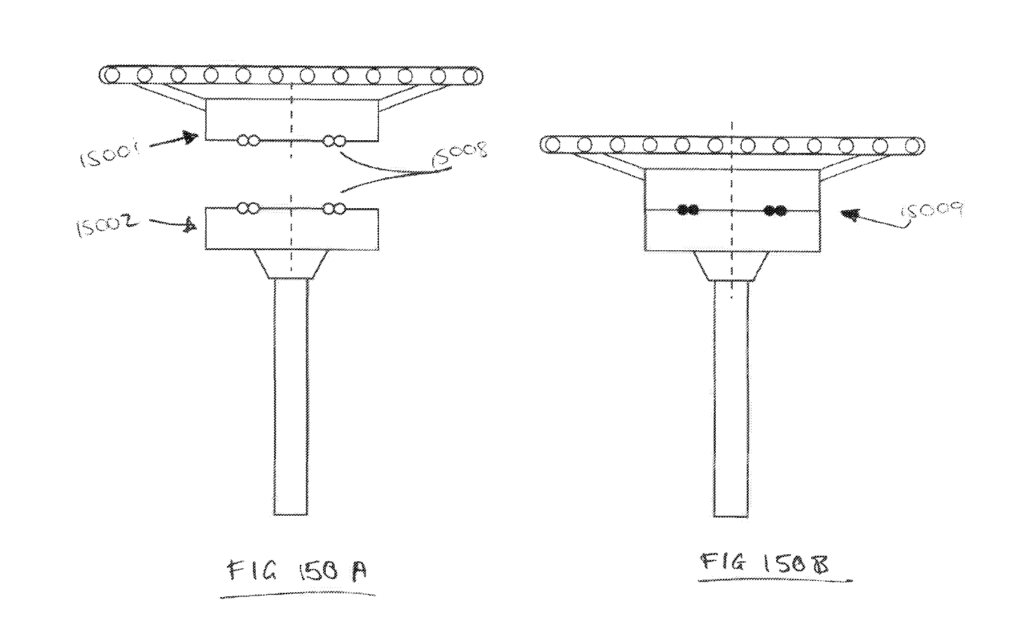

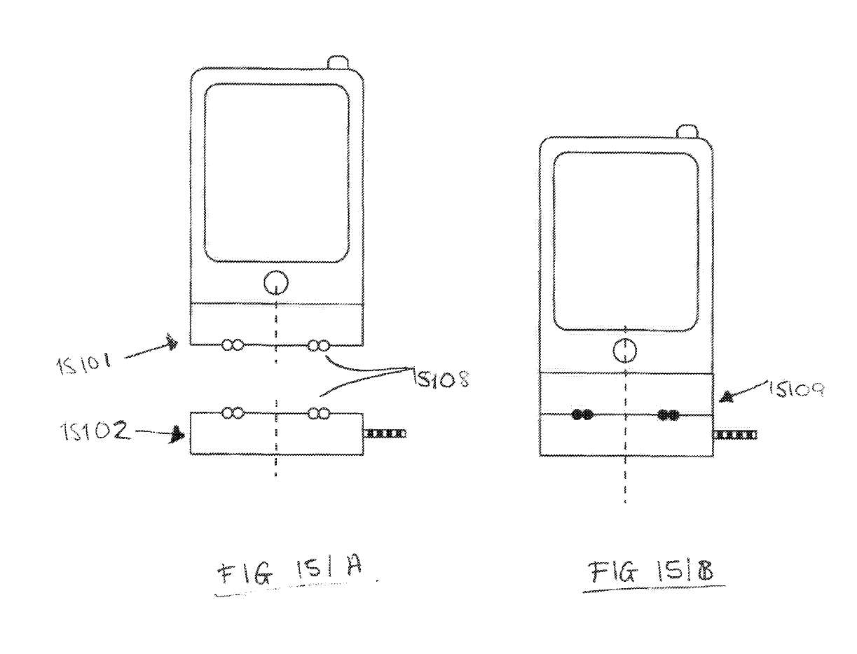

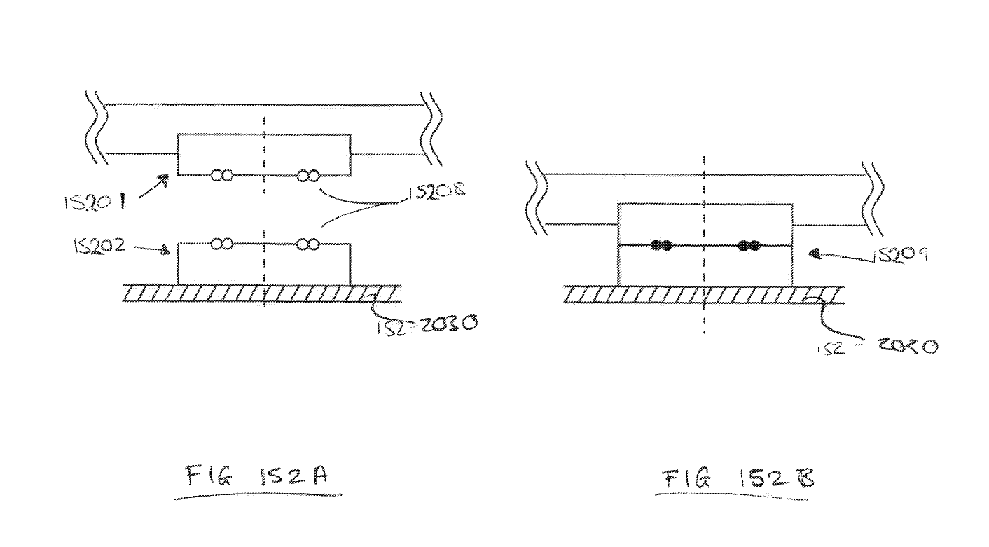

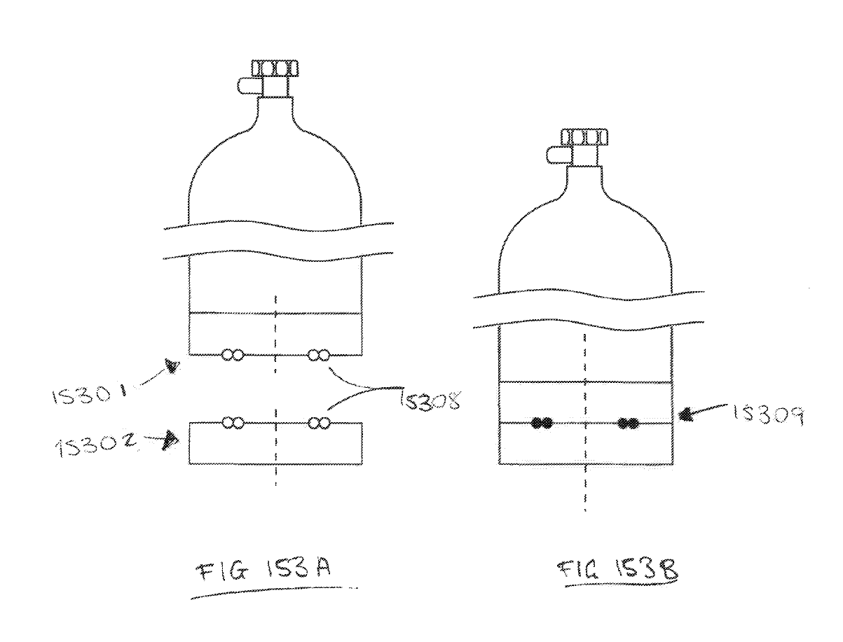

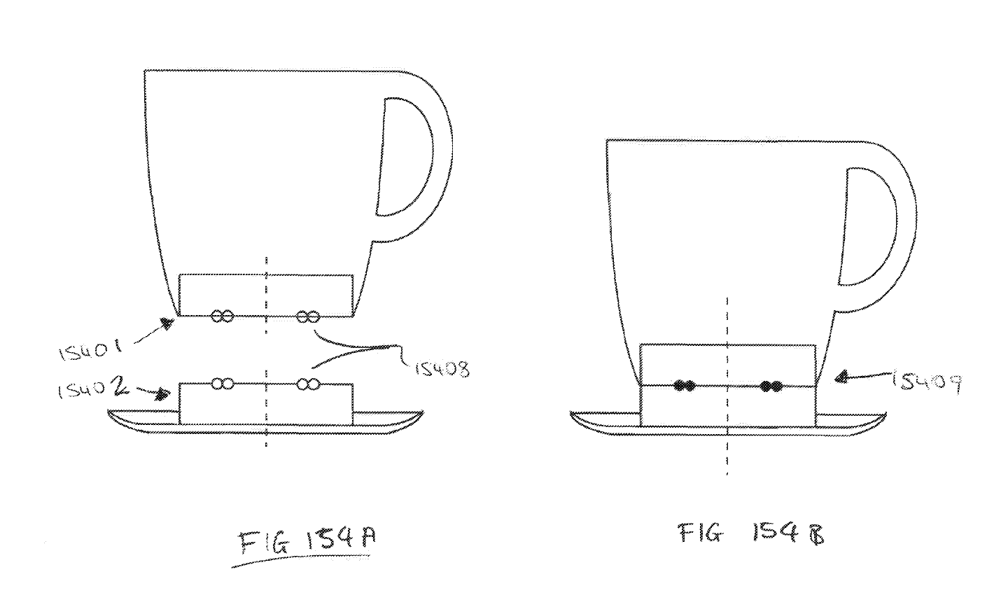

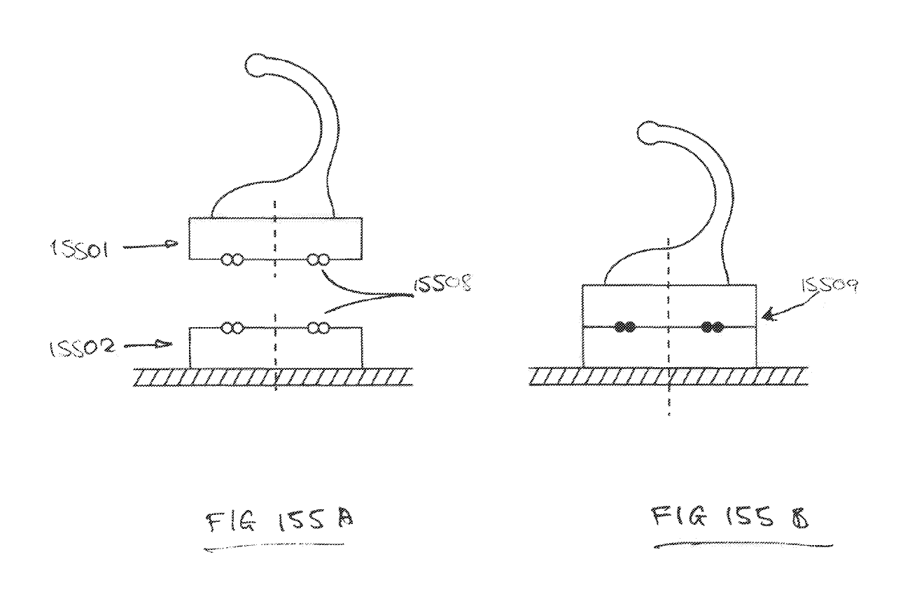

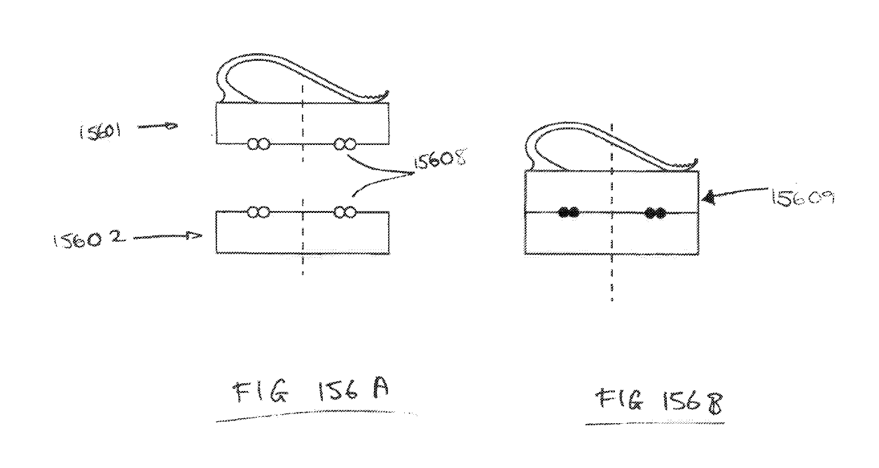

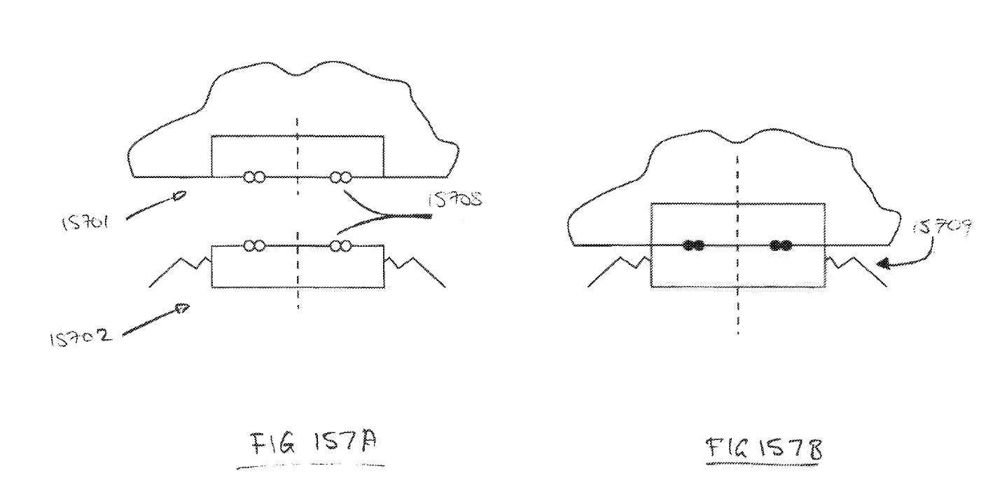

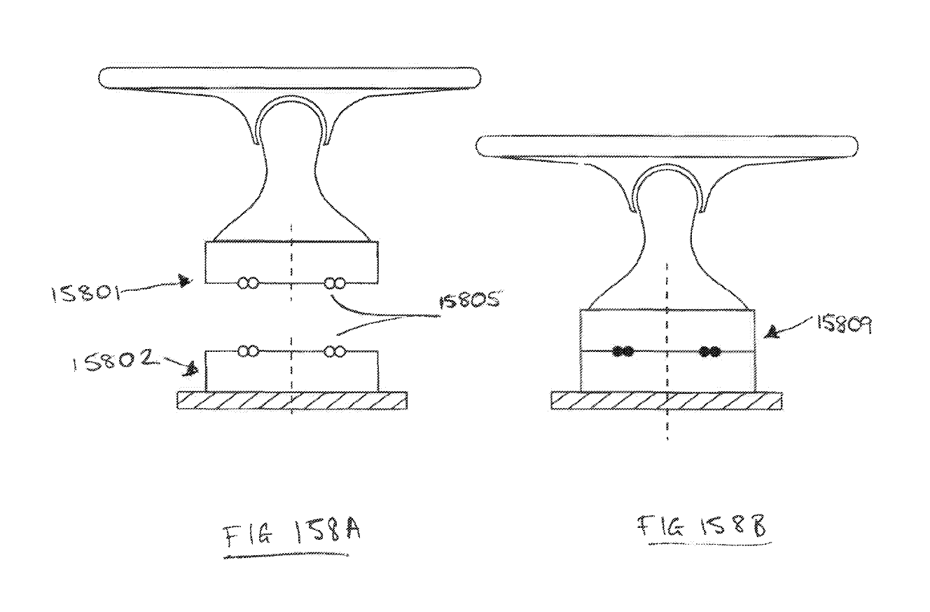

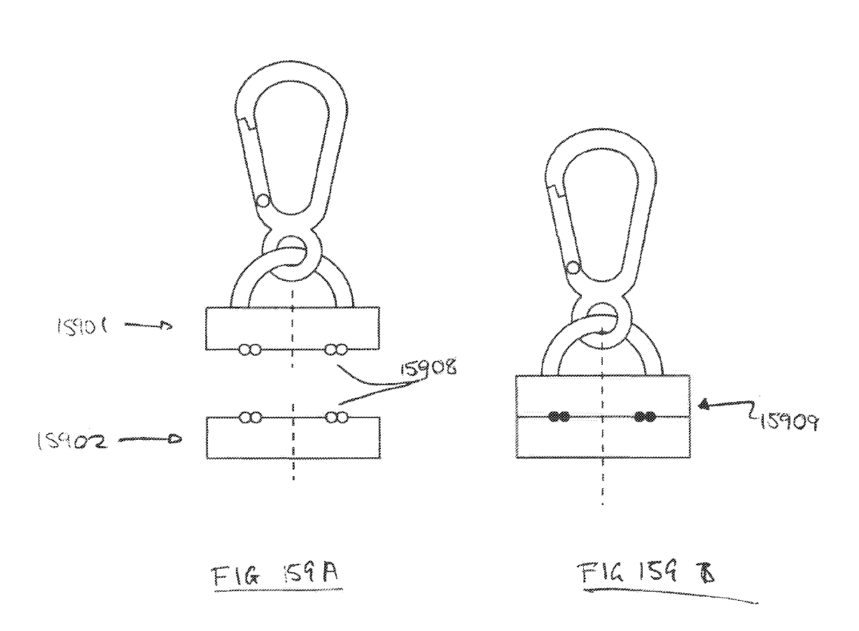

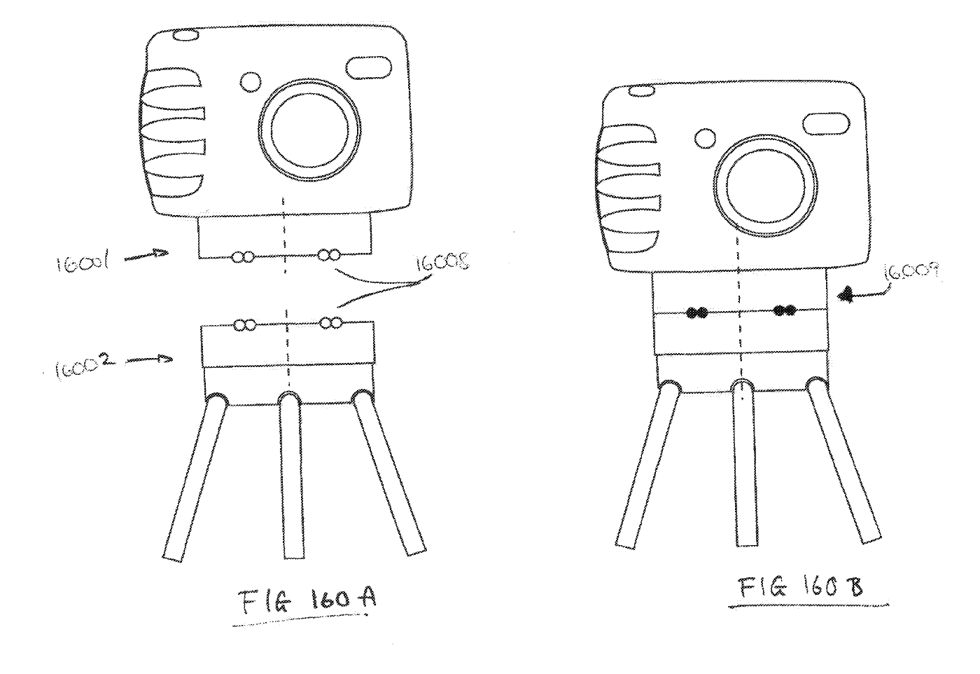

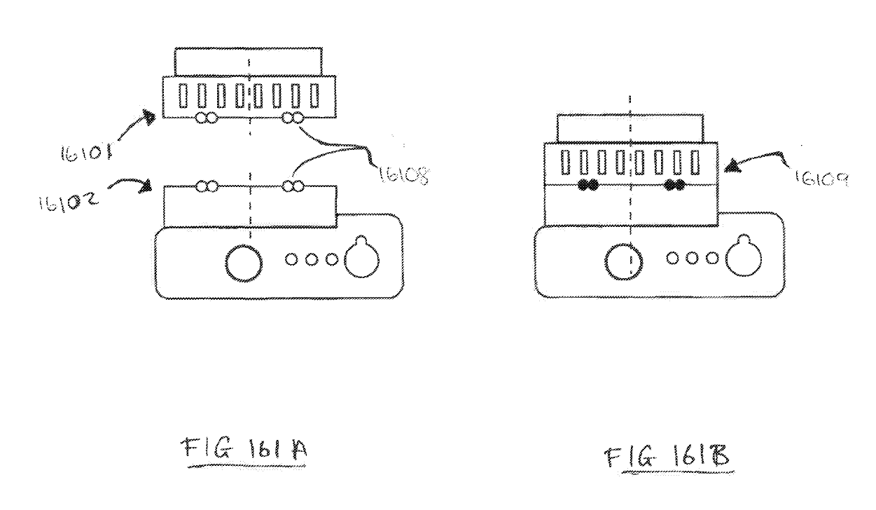

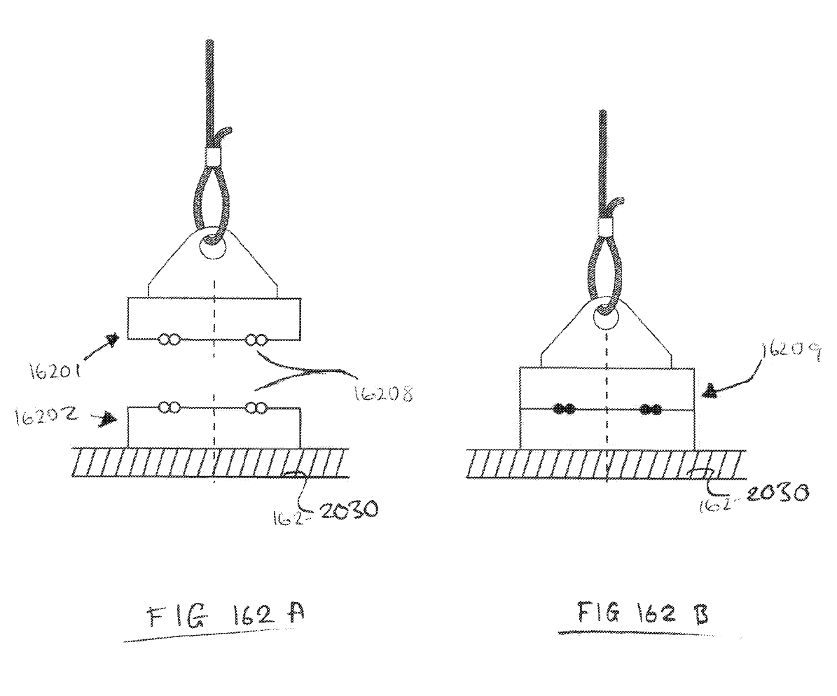

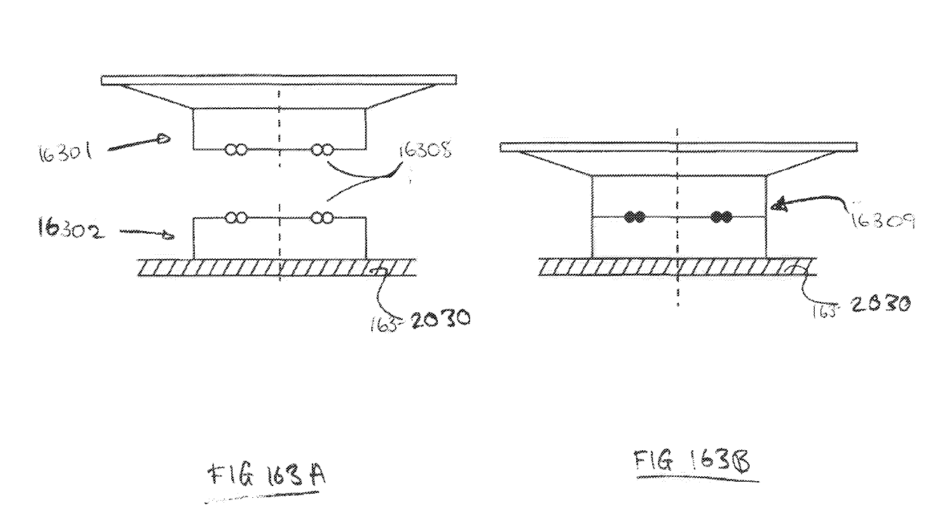

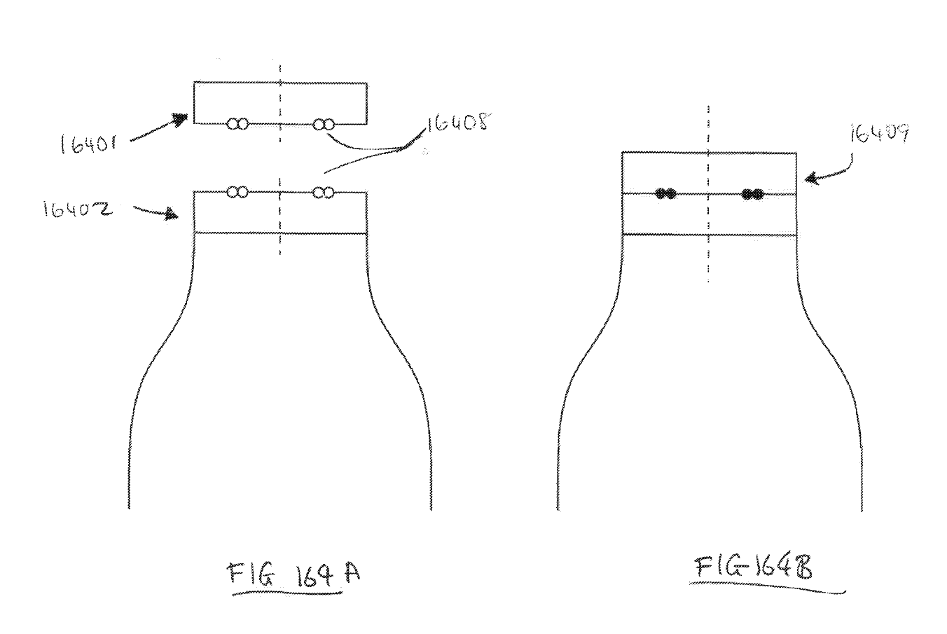

FIG. 4 shows one engagement formation 16 in isolation, such that the features of the engagement formation 16 can be seen more clearly. The engagement formation 16 is substantially helicoidal, and includes an upper substantially helicoidal surface 16c, a lower surface 16d, an inner circumferential wall 16e and an outer circumferential wall 16f. The inner and outer circumferential walls 16e, 16f are undercut, such that the engagement formation 16 has a substantially trapezoidal cross-section. It will be appreciated that this shape is exemplary only, and each engagement formation may be any shape, as desired. For example, the inner circumferential wall 16e, the upper surface 16c and the outer circumferential wall could form a series of continuous curves.

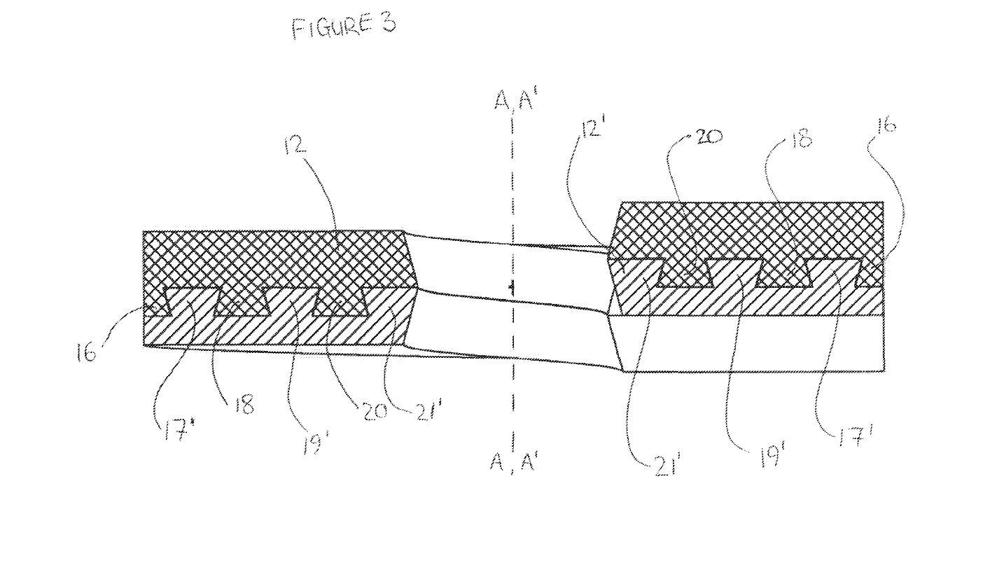

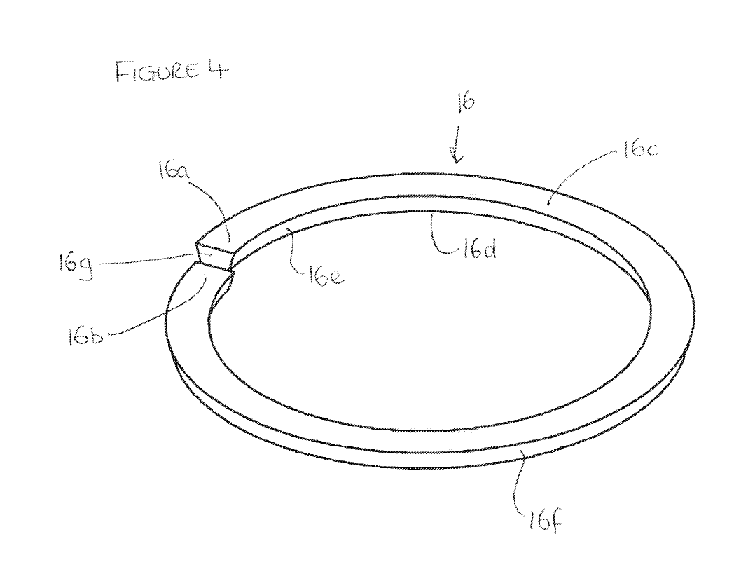

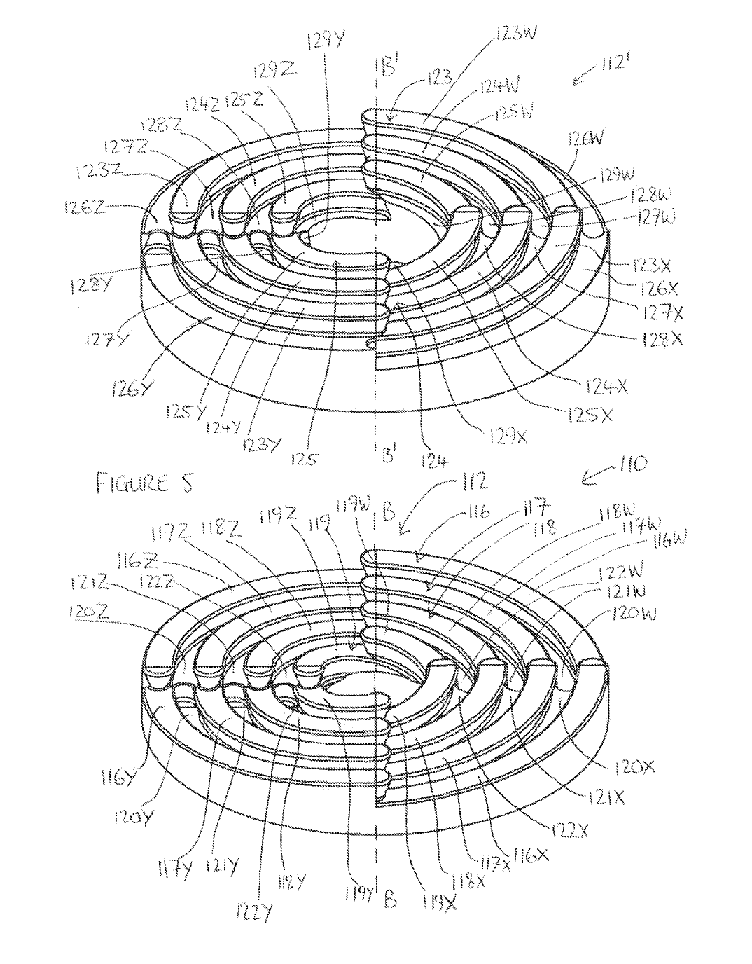

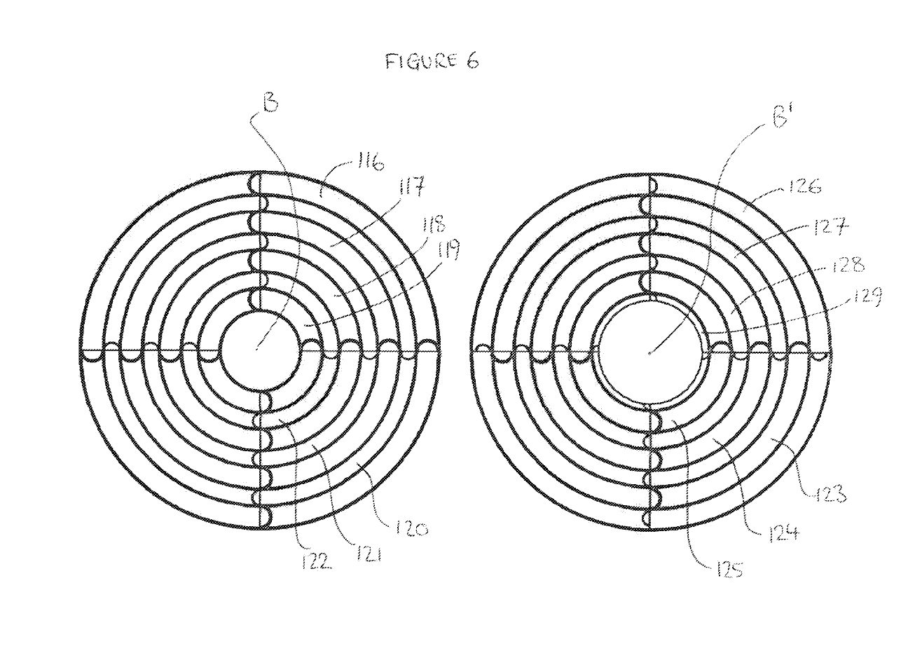

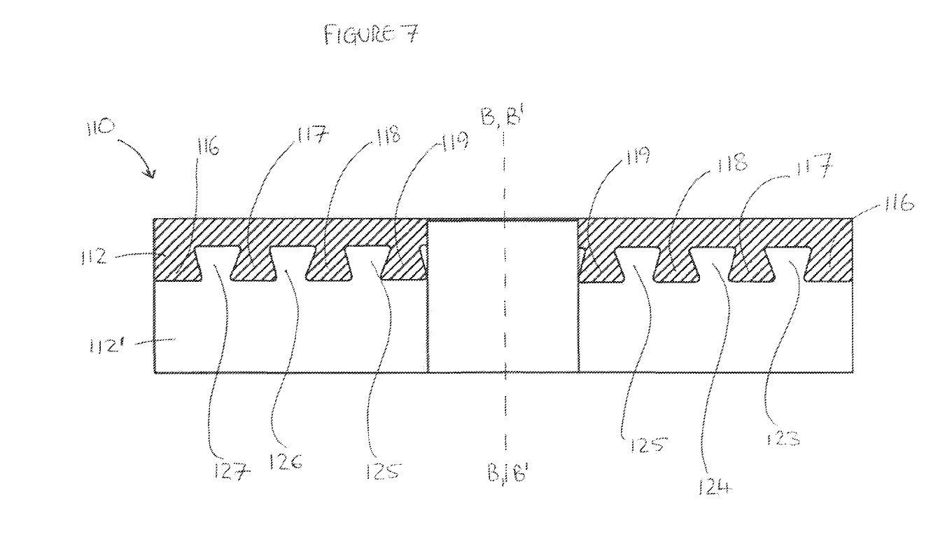

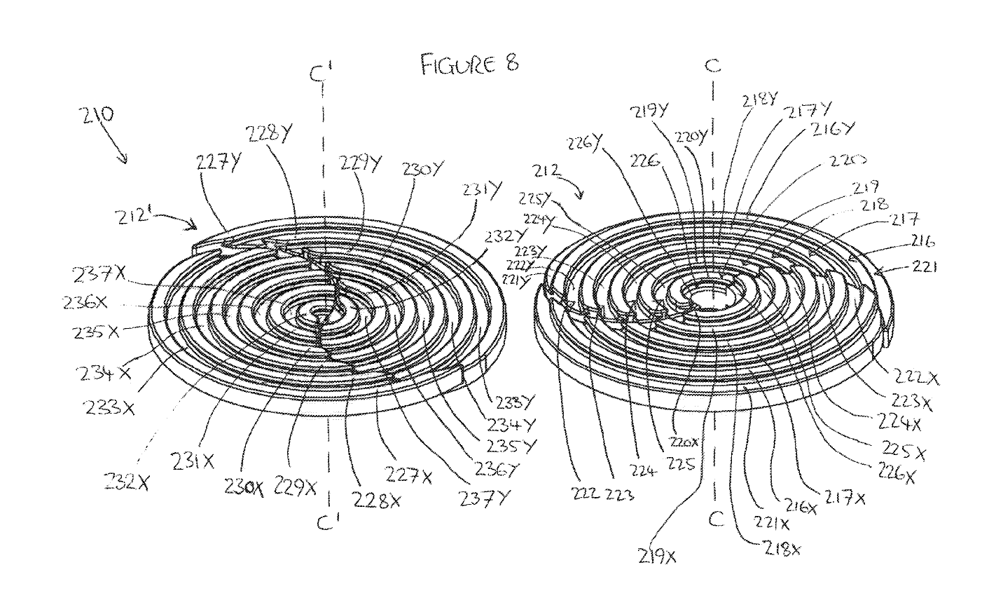

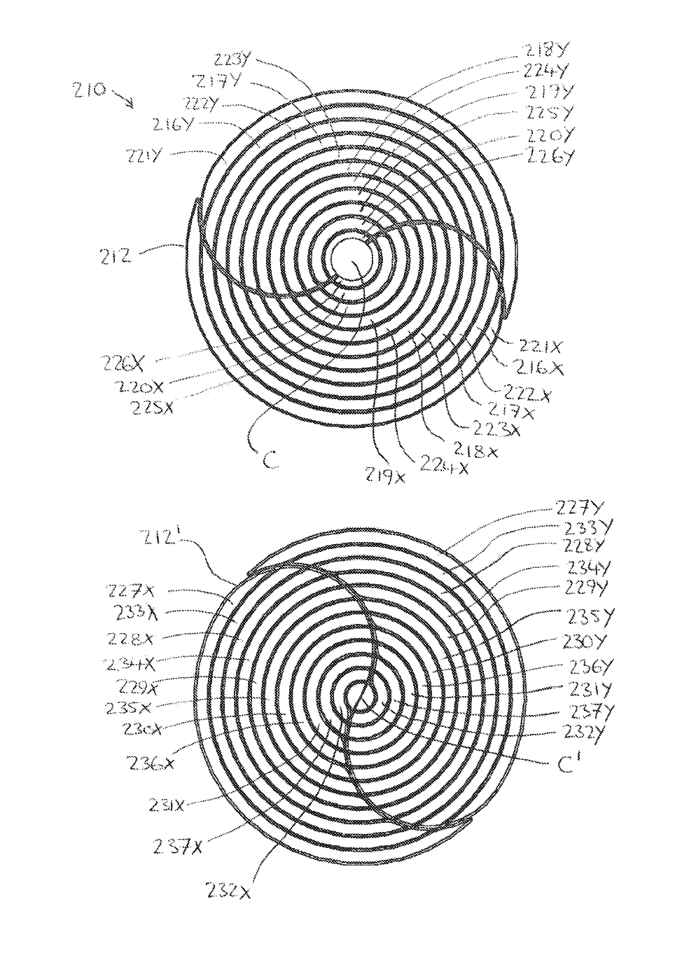

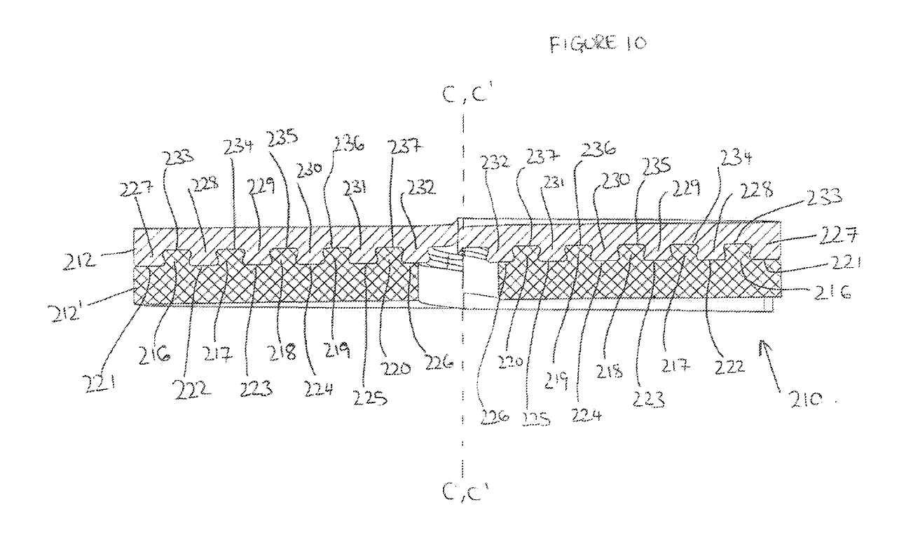

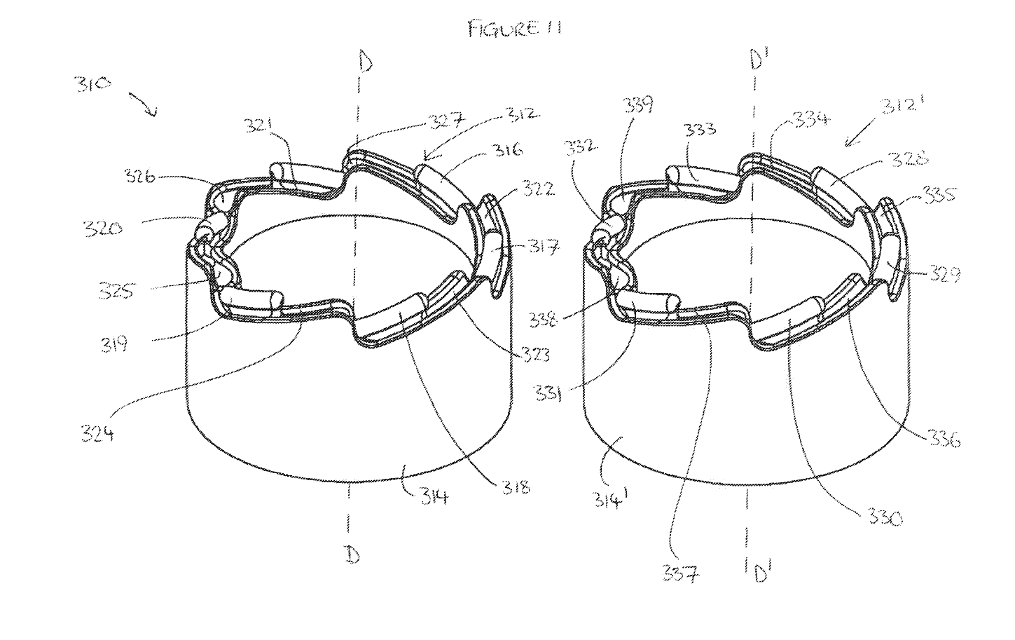

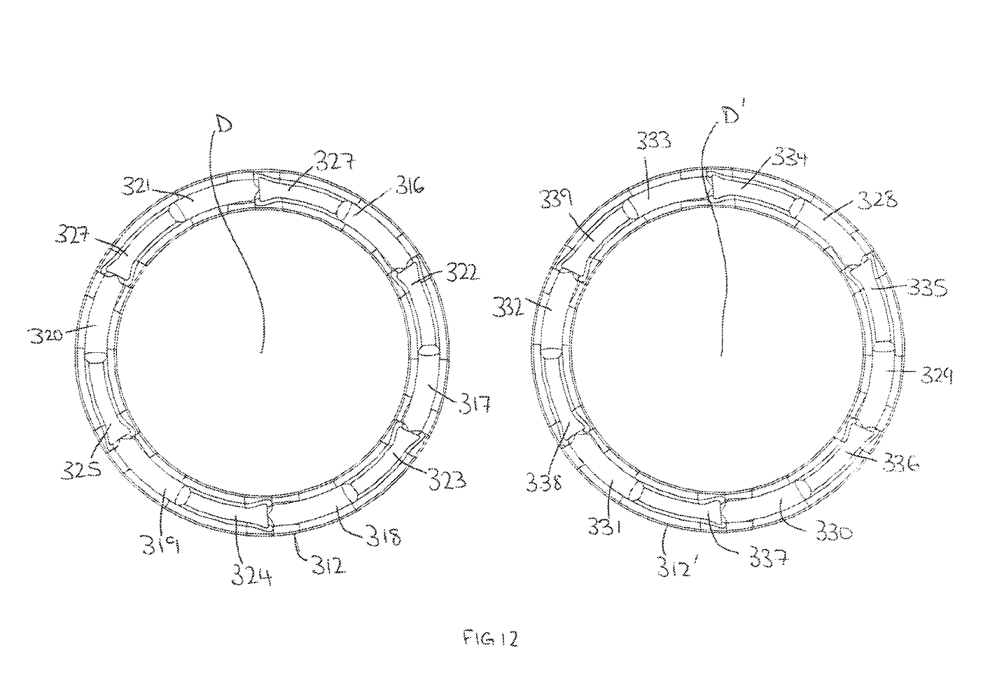

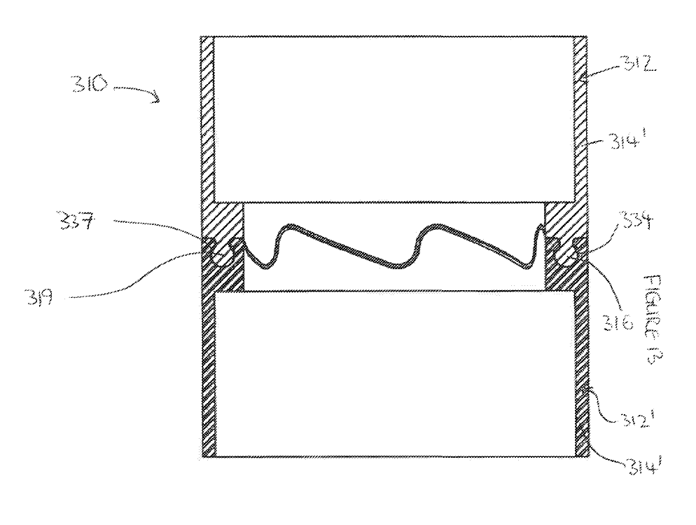

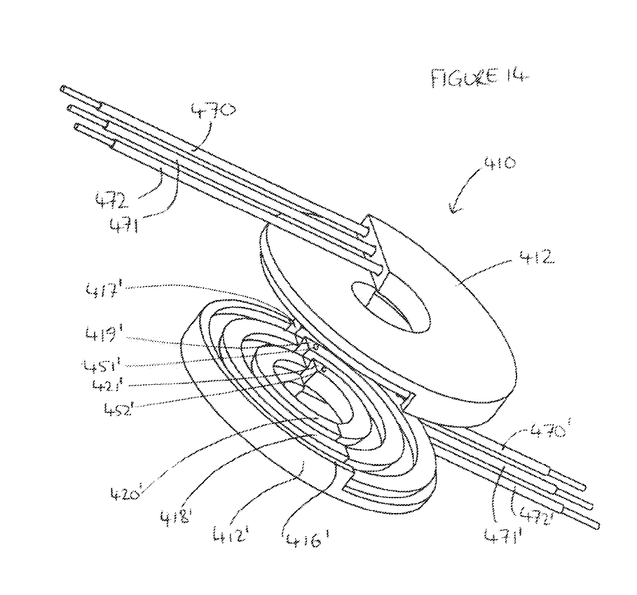

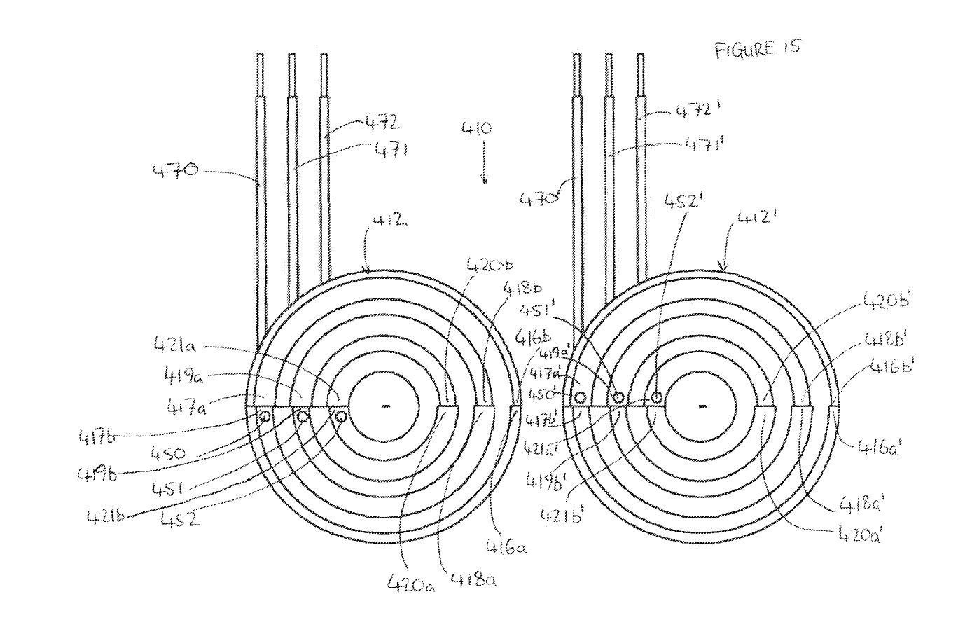

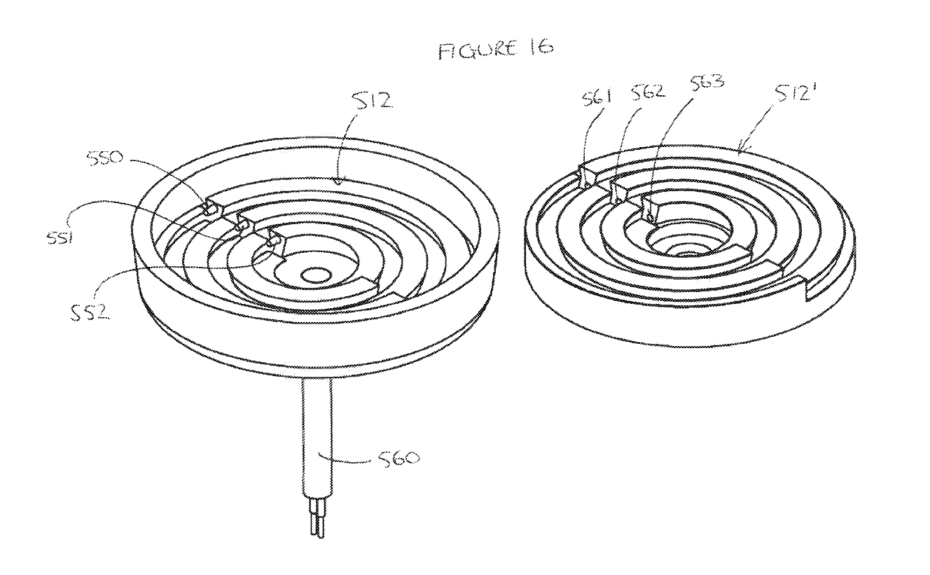

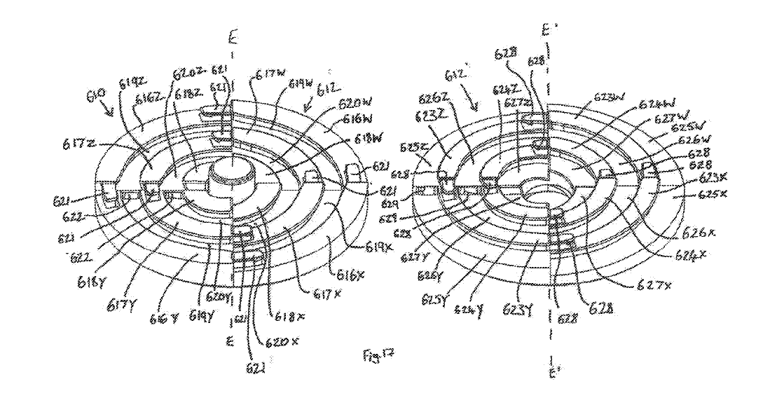

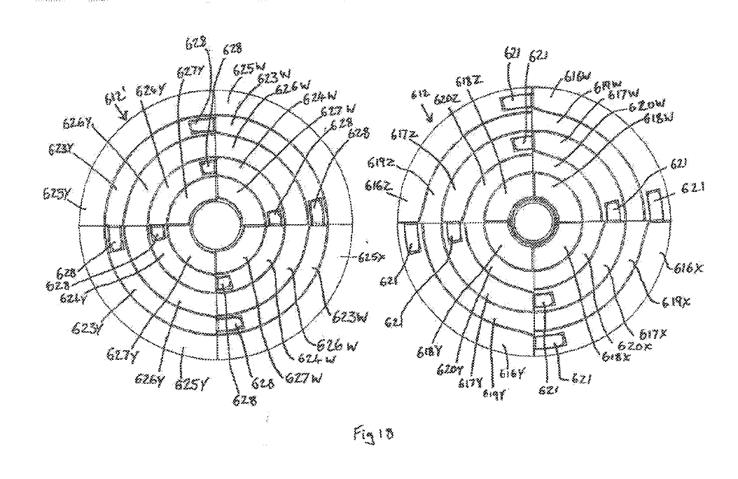

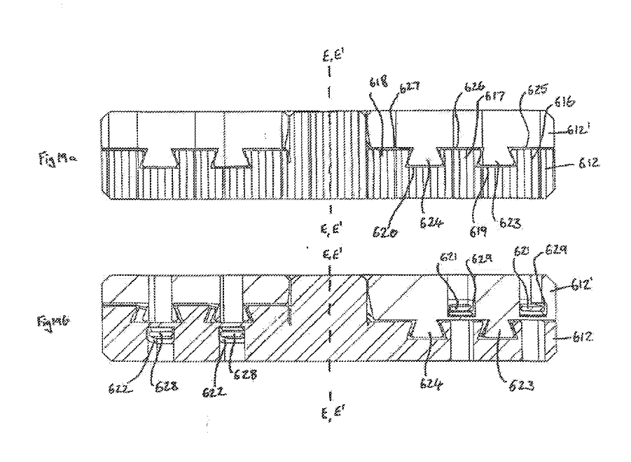

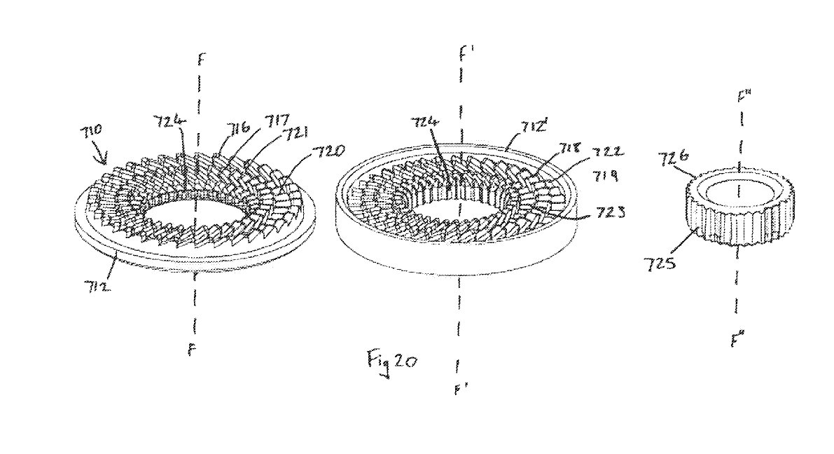

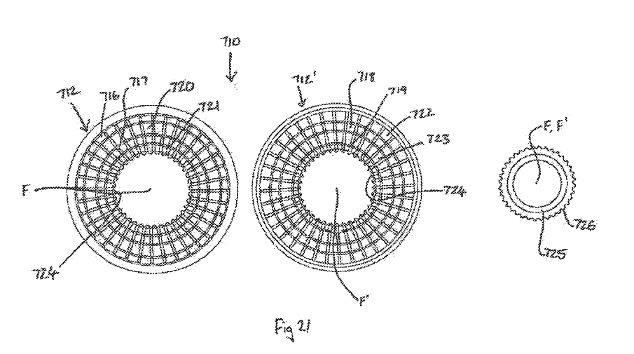

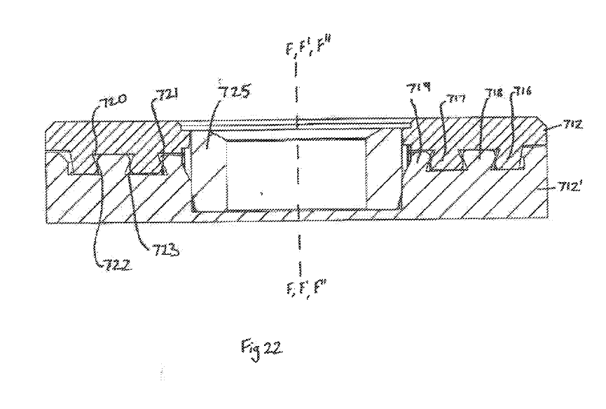

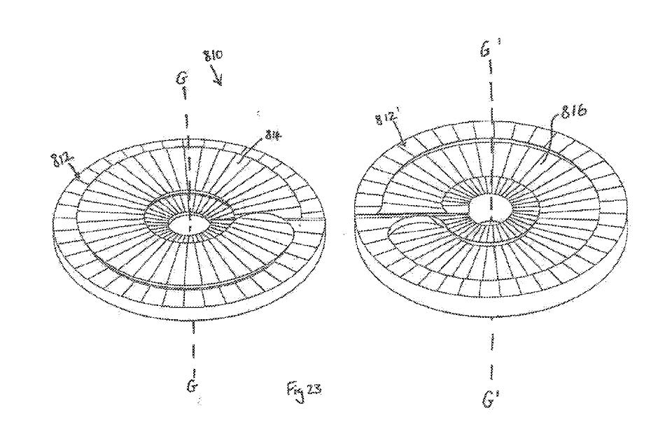

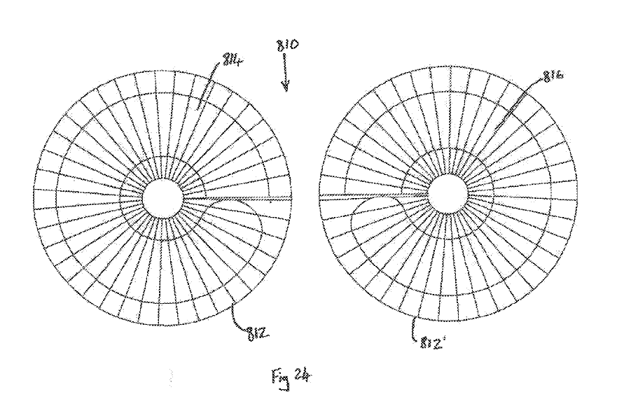

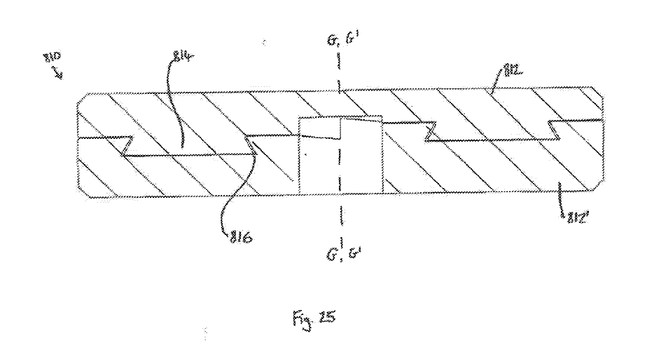

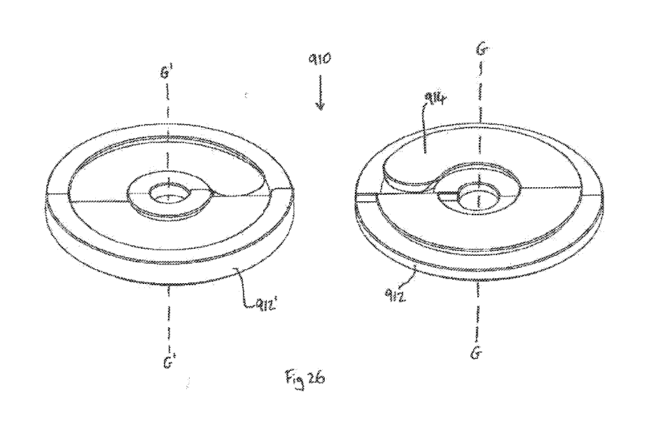

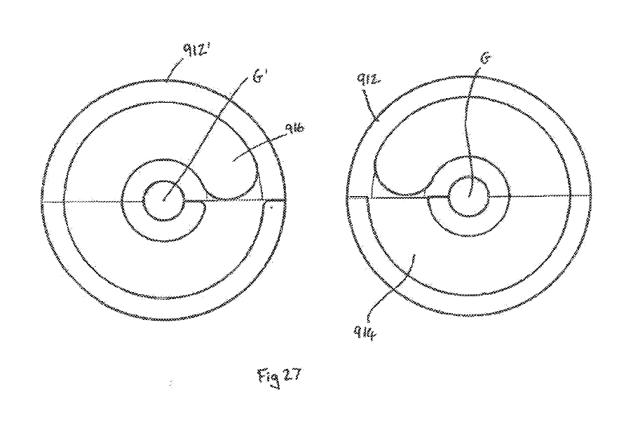

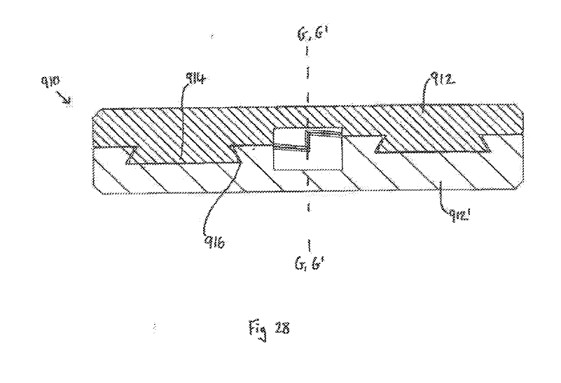

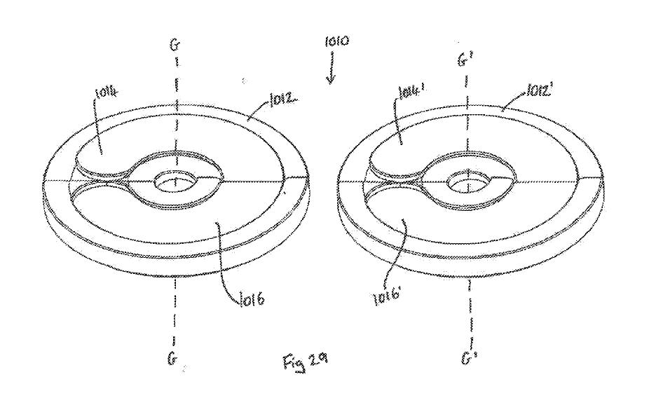

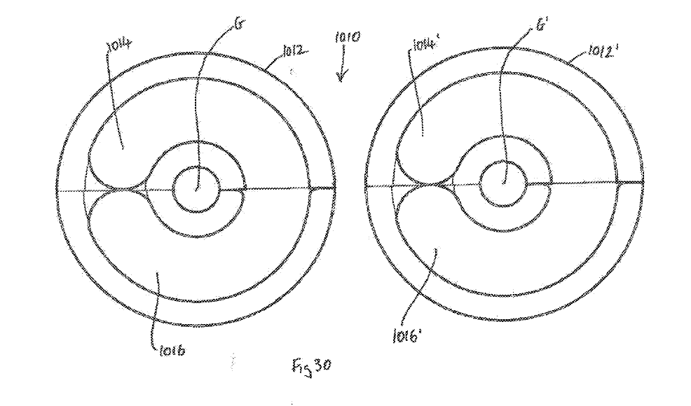

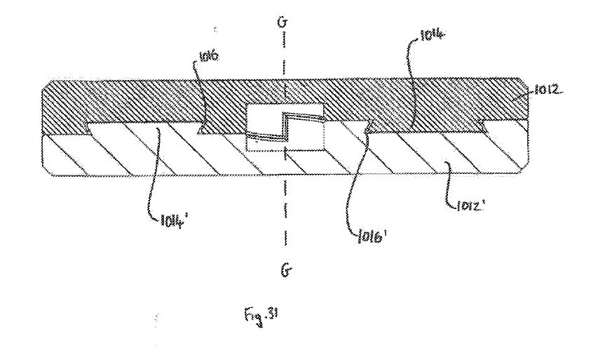

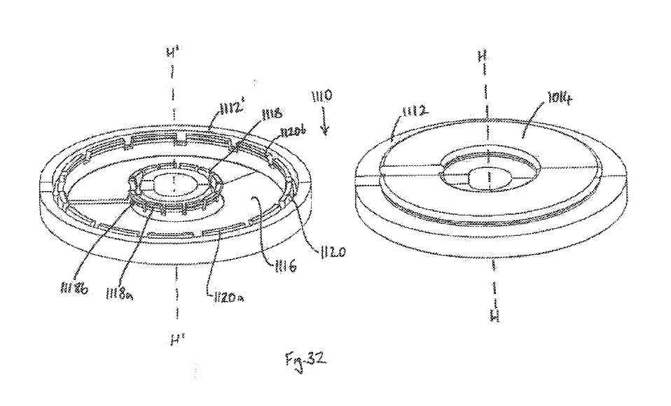

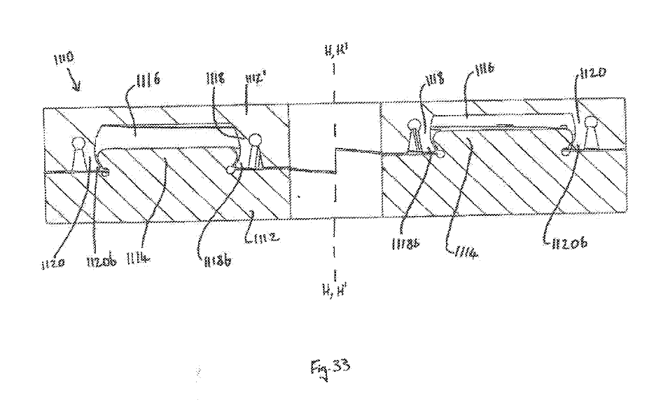

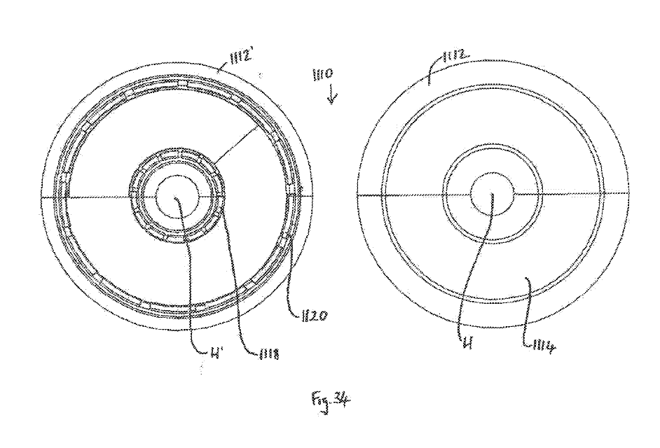

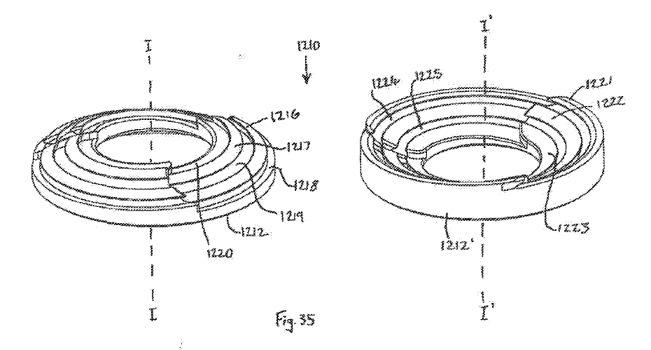

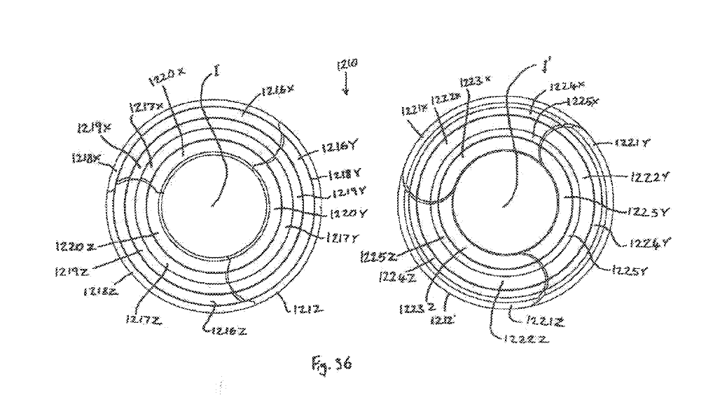

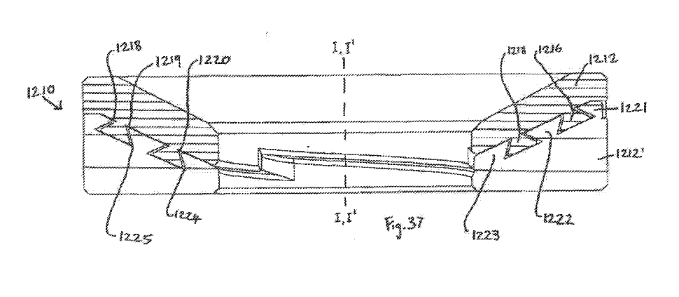

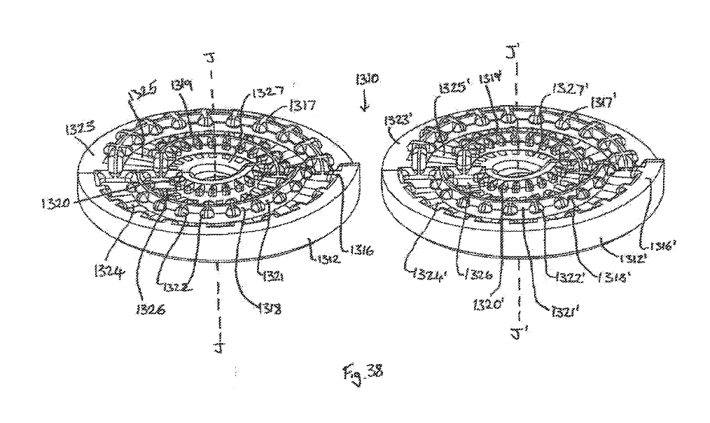

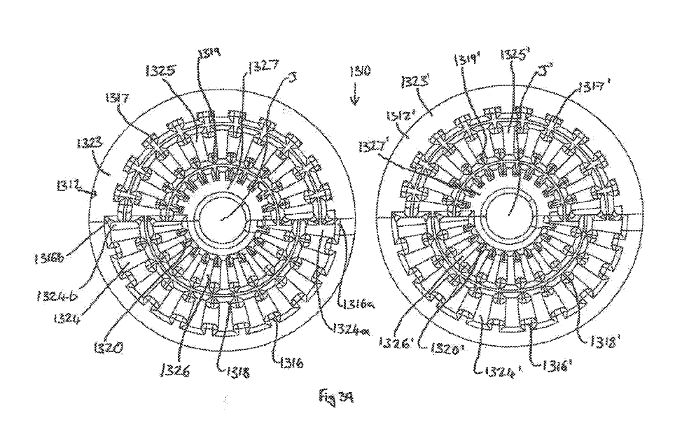

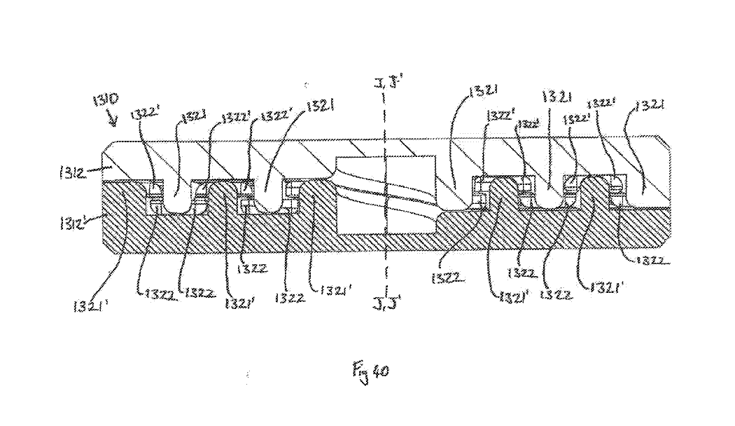

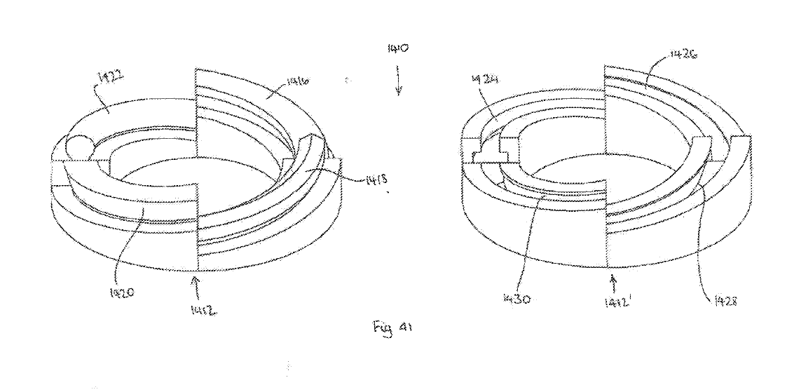

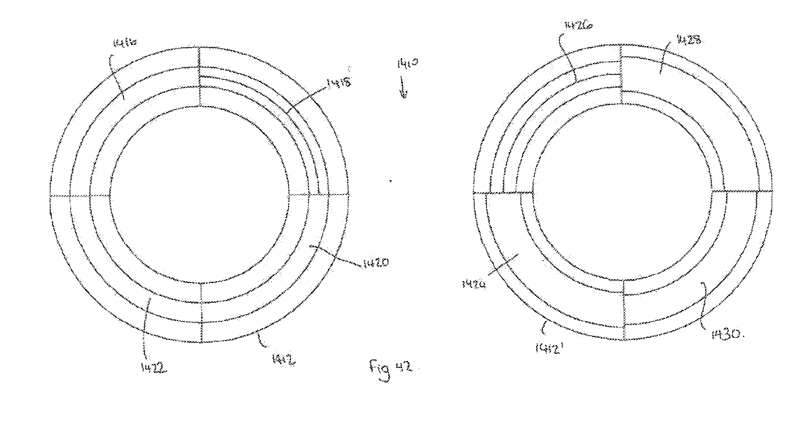

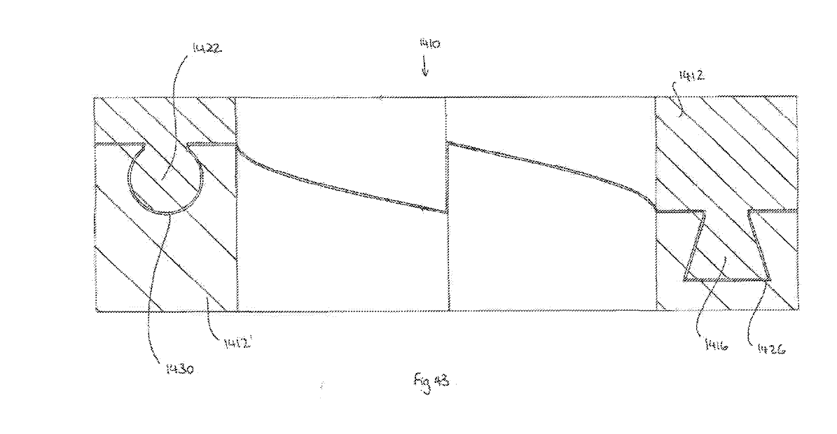

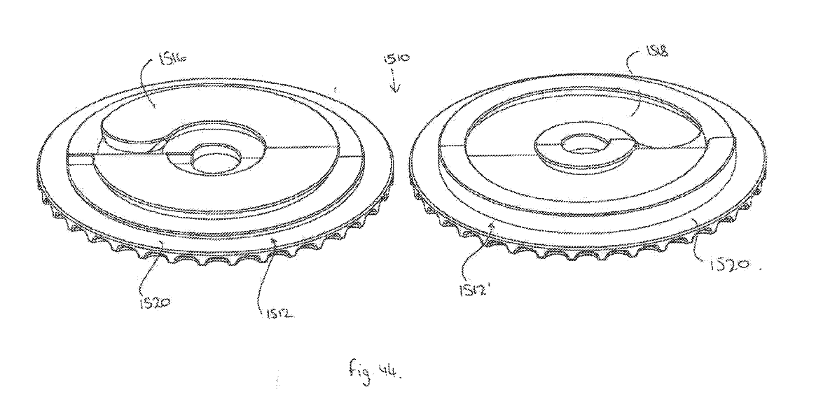

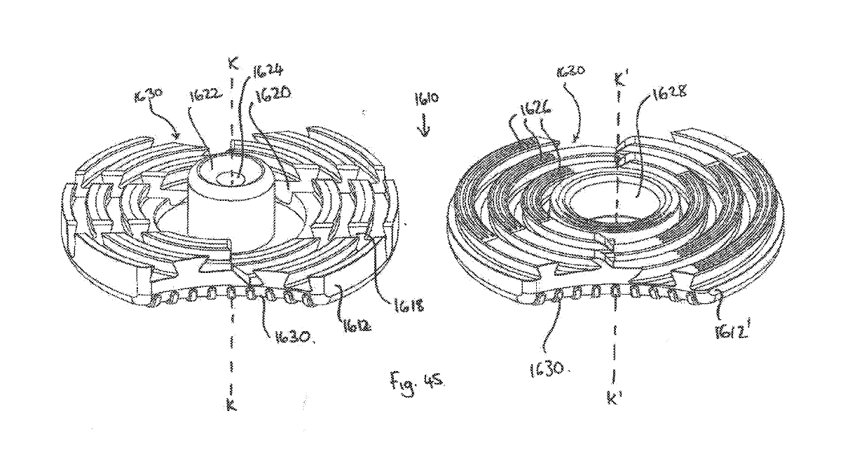

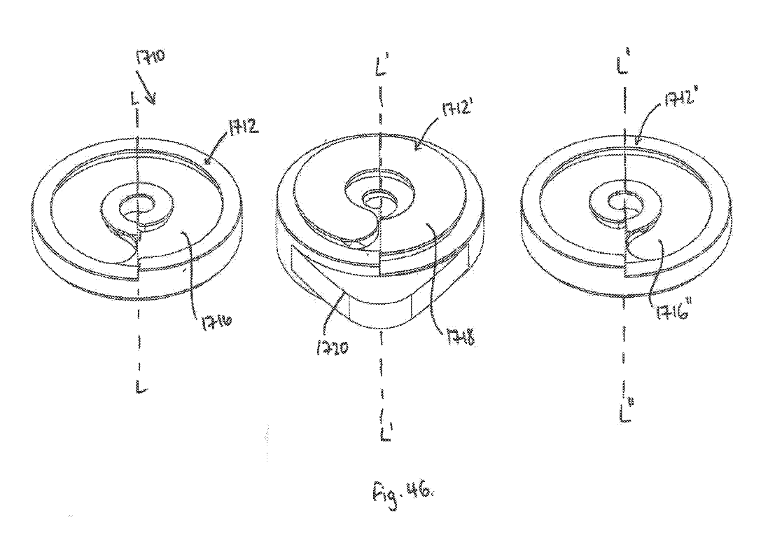

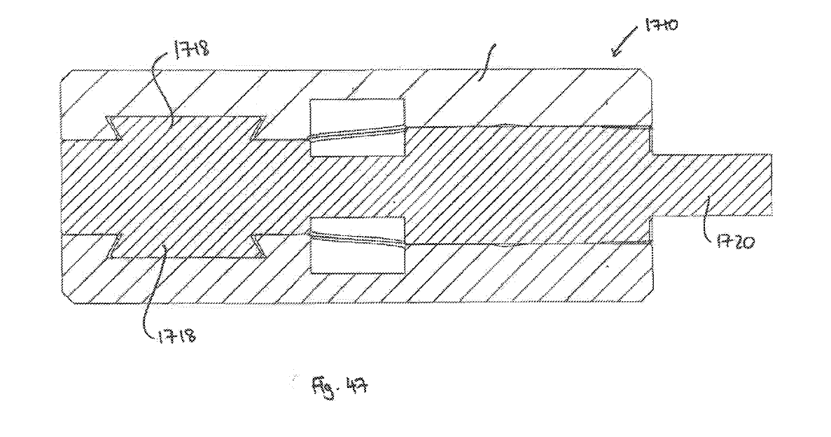

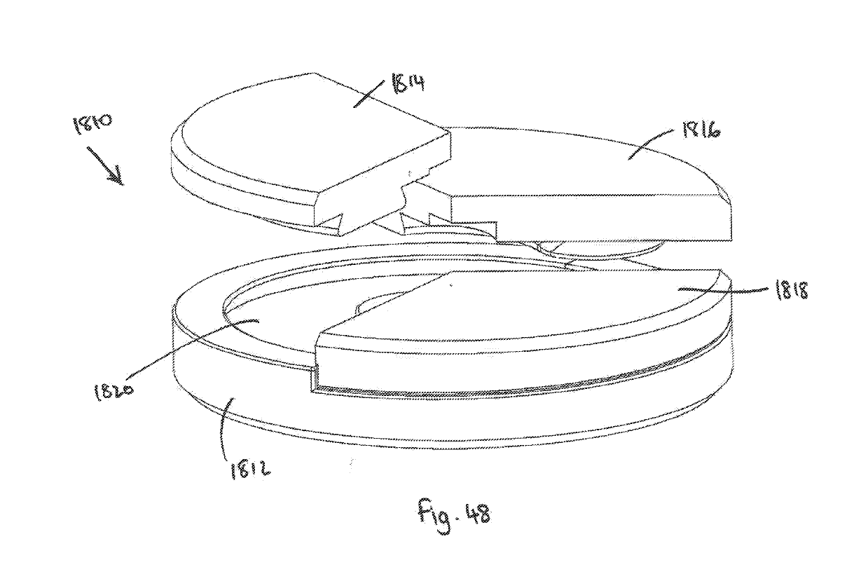

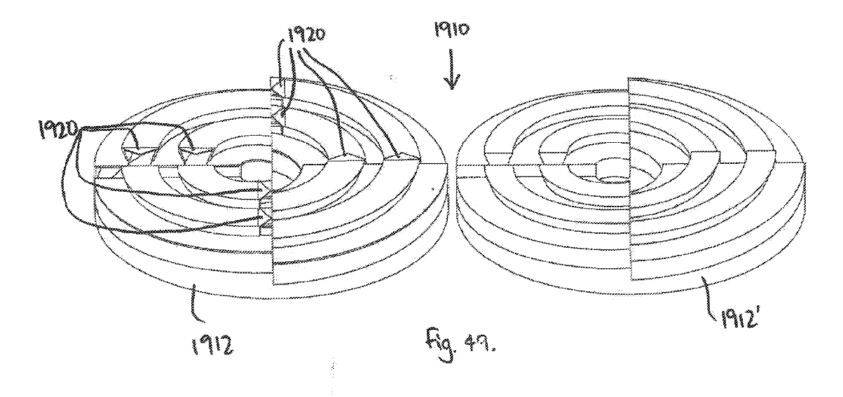

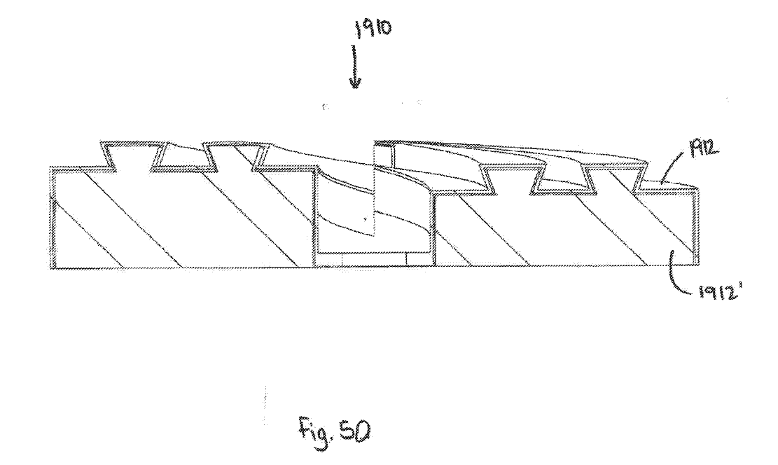

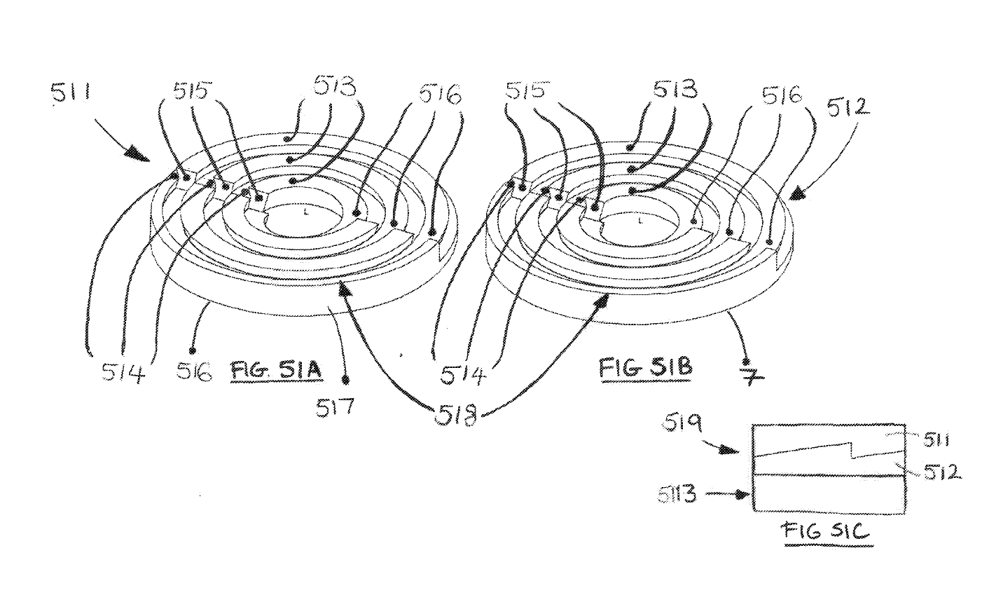

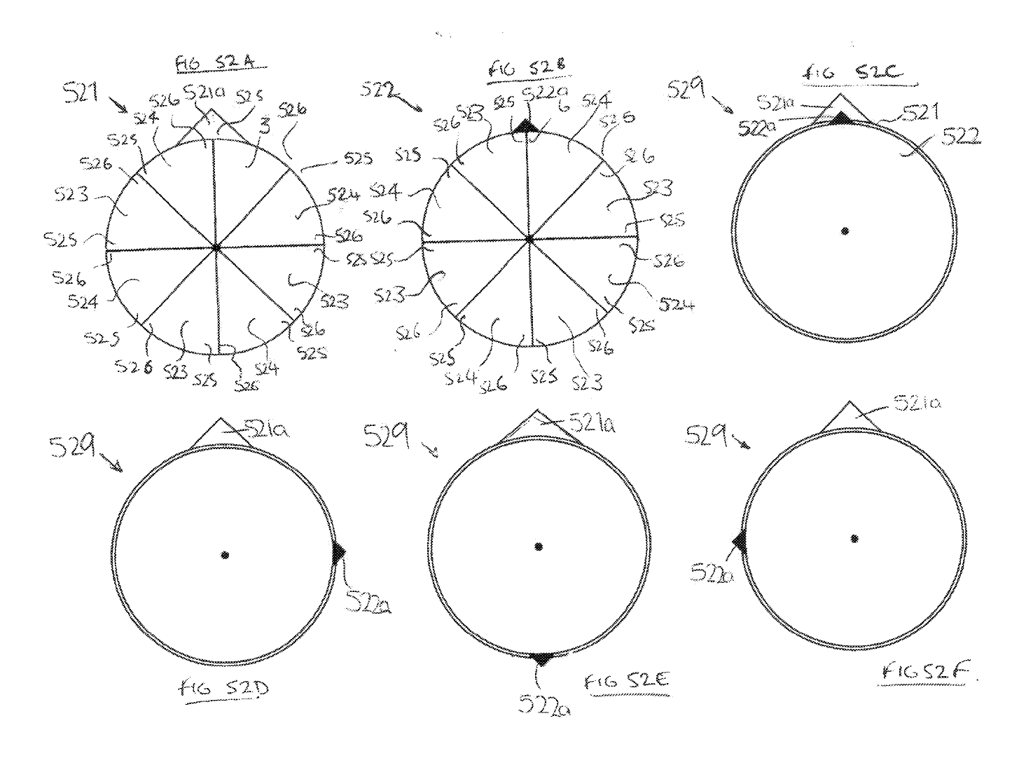

The upper surface 16c describes a single revolution of a helicoid, and the first end 16a of the formation 16 is adjacent the second end 16b of the formation. The upper surface 16c of the second end 16b of the engagement formation 16 meets the lower surface 16d of first end 16a of the formation 16, as shown in FIG. 2. Thus a junction between the first end 16a of the engagement formation 16 and the second end 16b of the engagement formation 16 forms an end face 16g which extends generally radially. The junction of the first end, 16a and the second end 16b forms a ‘step’ in the engagement formation 16. The end face 16g need not extend in the same general direction as the longitudinal axis A, and need not be planar. The end face 16g may be curved, ramped, chamfered or angled, for example.

The end faces 16g-21g, 16g′-21g′ of adjacent engagement formations 16-21, 16′-21′ are circumferentially offset from one another, by 180 degrees. Therefore the end faces 16g, 18g, 20g, of the first part 12 are aligned along a first radius which extends from the longitudinal axis A, and the end faces 17g, 19g, 21g of the first part 12 are aligned along a second radius which extends outwardly from the longitudinal axis A, in the opposite direction to the first radius. Similarly, the end faces 16g′, 18g′, 20g′ of the second part 12′ are aligned along a first radius which extends from the longitudinal axis A′, and the end faces 17g′, 19g′, and 21g′ of the second part 12′ are aligned along a second radius which extends outwardly from the longitudinal axis A′, in the opposite direction to the first radius.

Since, in this example, the two parts 12, 12′ of the connector are substantially the same as each other, and the second portion of each engagement formation 16-21, 16′-21′ forms a receiving formation for the corresponding engagement formation 16-21, 16′-21′ of the other part 12, 12′, this connector is described as being ‘hermaphroditic’.

The engagement formations 16-21, 16′-21′ are substantially circular and arranged generally concentrically, i.e. the average radius of the outermost engagement formation 16, 16′ of each part 12, 12′ is largest, and the average radius of the innermost engagement formation 21, 21′ of each part 12, 12′ is smallest. The outer circumferential wall of each engagement formation other than the outermost engagement formation 16, 16′ abuts the inner circumferential wall of the adjacent engagement formation.

In use, the two parts 12, 12′ of the connector 10 are placed adjacent one another, with the engagement formations 16-21 of the first part 12 facing the engagement formations 16′-21′ of the second part 12′ and the longitudinal axes A, A′ substantially aligned. The first end 17a, of the second formation 17 of the first part 12 is positioned adjacent and between the first ends 16a′, 18a′ of the first and third formations 16′, 18′ of the second part 12′, such that the first portion of each engagement formation 16-21 of the first part 12 overlies the second portion of the corresponding engagement formation 16′-21′ of the second part 12. The second portion of each engagement formation 16-21, 16′-21′ forms a receiving formation for the first portion of the corresponding engagement formation 16-21, 16′-21′ of the opposite part 12, 12.

Similarly, the first end 17a′ of the second formation 17′ of the second part 12′ is positioned adjacent and between the first ends 16a, 18a of the first and third formations 16, 18 of the first part 12 such that the first portion of each engagement formation 16′-21′ of the second part 12′ overlies the second portion of the corresponding engagement formation 16-21 of the first part 12.

The first end 19a of the fourth formation 19 of the first part 12 is positioned adjacent and between the first ends 18a′, 20a′ of the third and fifth engagement formations 18′, 20′ of the second part 12′ of the connector 10, and so on.

The upper face 16c-21c, of each of the engagement formations 16-21 of the first part 12 abuts the upper face 16c′-21c′ of the corresponding formation 16′-21′ of the second part 12′, and vice versa.

The engagement formations 16-21, 16′-21′ of the two parts 12, 12′ of the connector 10 face each other, in a generally axial direction.

Rotation of the two parts 12, 12′ relative to one another about the longitudinal axes A, A′, causes the engagement formations 16-21 of the first part 12 to inter-engage with the engagement formations 16′-21′ of the second part 12′. Relative rotation of the two parts 12, 12′ through 180° effects full inter-engagement of the two parts 12, 12′, wherein the end faces 16g-21g of the engagement formations 16-21 of the first part 12 abut the end faces 16g′-21g′ of the engagement formations 16′-21′ of the second part 12′. The distance moved by the two parts 12, 12′ in a direction generally parallel to the longitudinal axes A, A′ during rotation to bring the two parts 12, 12′ into full interengagement is approximately half of the height of the end face 16g.

Since the shape of the receiving portion of each engagement formation 16-21, 16′-21′ is the inverse of the shape of the engagement portion of the corresponding engagement formation of the opposite part of the connector 10, the engagement formations 16-21 and 16′-21′ “tessellate” or “dovetail” together as shown in FIG. 3. The outer circumferential wall of the second engagement formation 17′ of the second part 12′ abuts the inner circumferential wall of the first engagement formation 16 of the first part 12 and the inner circumferential wall of the second engagement formation 17′ of the second part 12′ abuts and is engaged with the outer circumferential wall of the third engagement formation 18 of the first part 12 and so on.

Such inter-engagement inhibits or prevents linear movement of the two parts 12, 12′ relative to one another in a direction parallel with the axes A, A′. Full inter-engagement of the two parts 12, 12′ prevents any such relative linear movement whatsoever. In other words, the connector 10 is difficult or impossible to pull apart.

Rotation of the two parts 12, 12′ relative to one another through less than 180° provides some inter-engagement of the two parts 12, 12′, and inhibits relative linear movement in a direction parallel to the axes A, A′, and may completely prevent such relative movement.

It will be appreciated that in order to engage the engagement formations 16-21, 16′-21′ of the two parts 12, 12′ of the connector 10, there is only one possible initial relative orientation of the two parts 12, 12′. This is embodiment of the invention is referred to as a “single pick-up” connector. All of the formations 16-21, 16′-21′ engage the adjacent formation(s) 16-21, 16′-21′ of the opposite part 12, 12′ simultaneously. However, the engagement formations of the first part 12 and the second part 12′ may be arranged such that orienting the two parts in more than one position relative to one another permits relative rotation of the two parts 12, 12′ about the axes A, A′, and interengagement of the two parts 12, 12′.

Rotation of the two parts 12, 12′ relative to one another in a direction opposite to that which effects engagement of the two parts 12, 12′, effects disengagement or partial disengagement of the two parts 12, 12′.

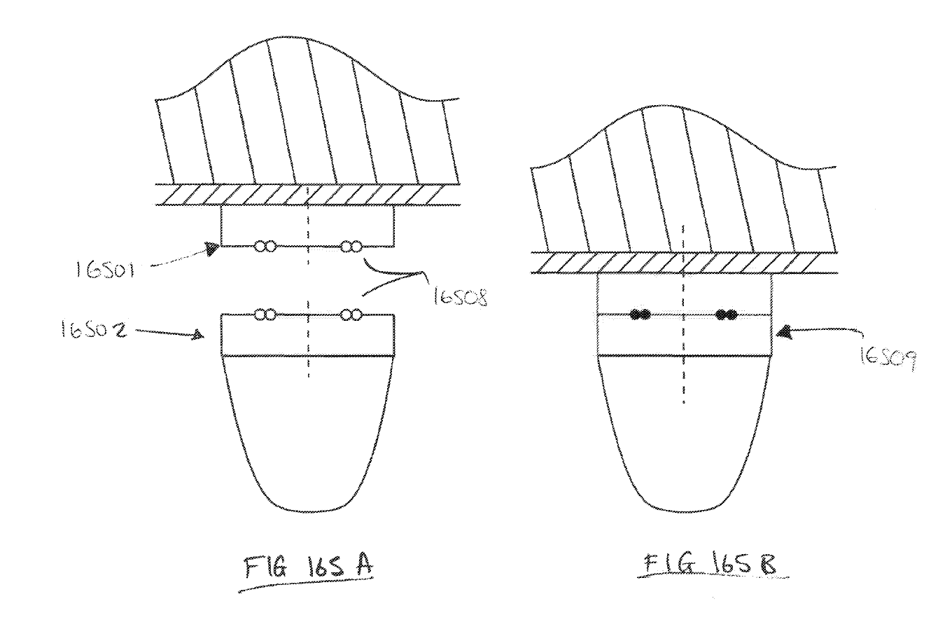

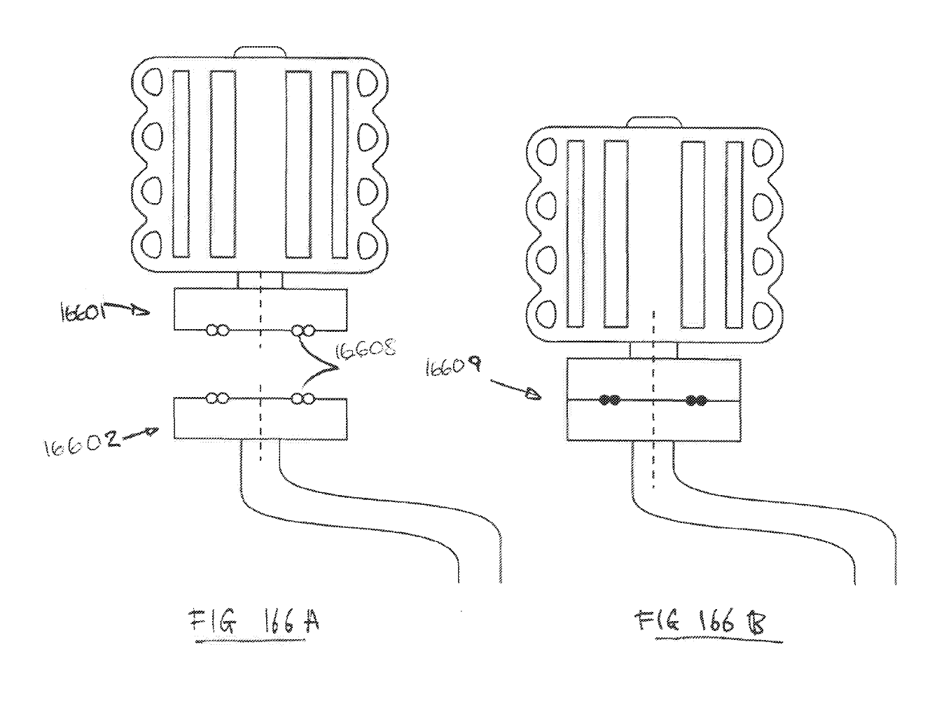

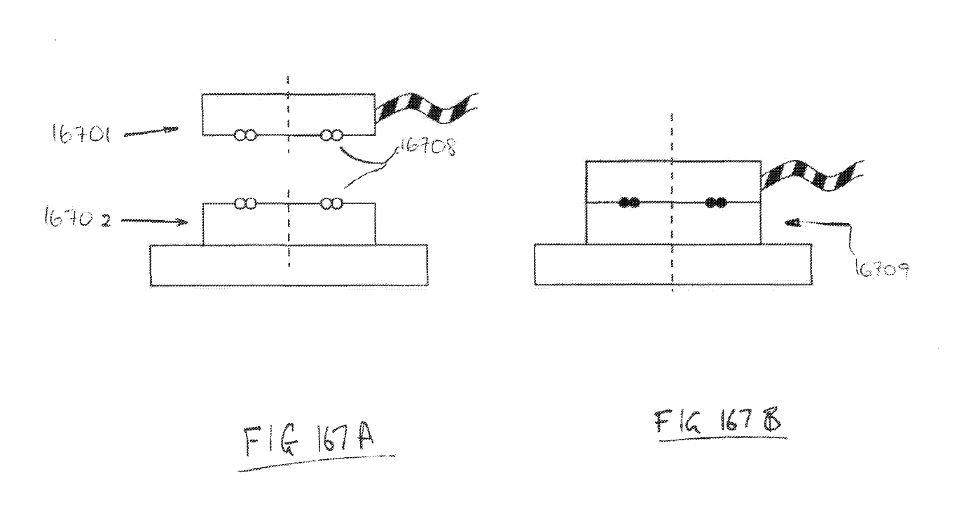

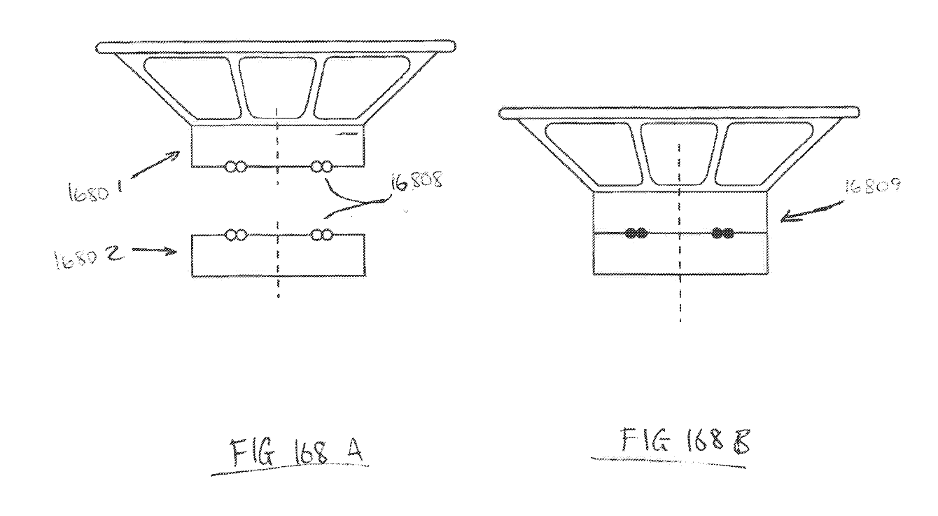

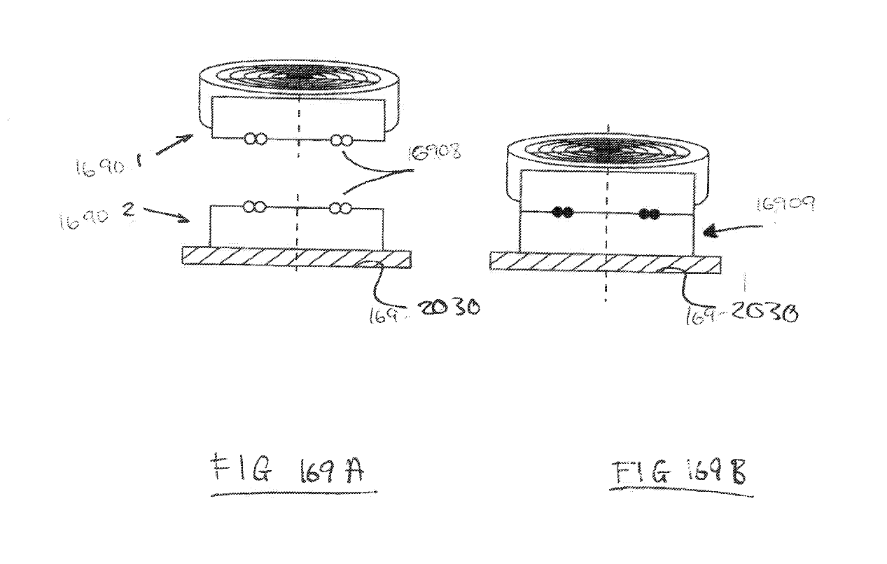

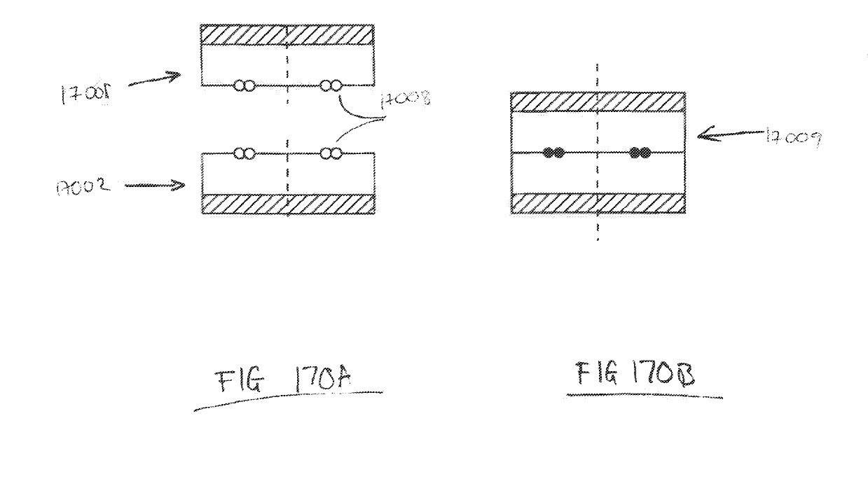

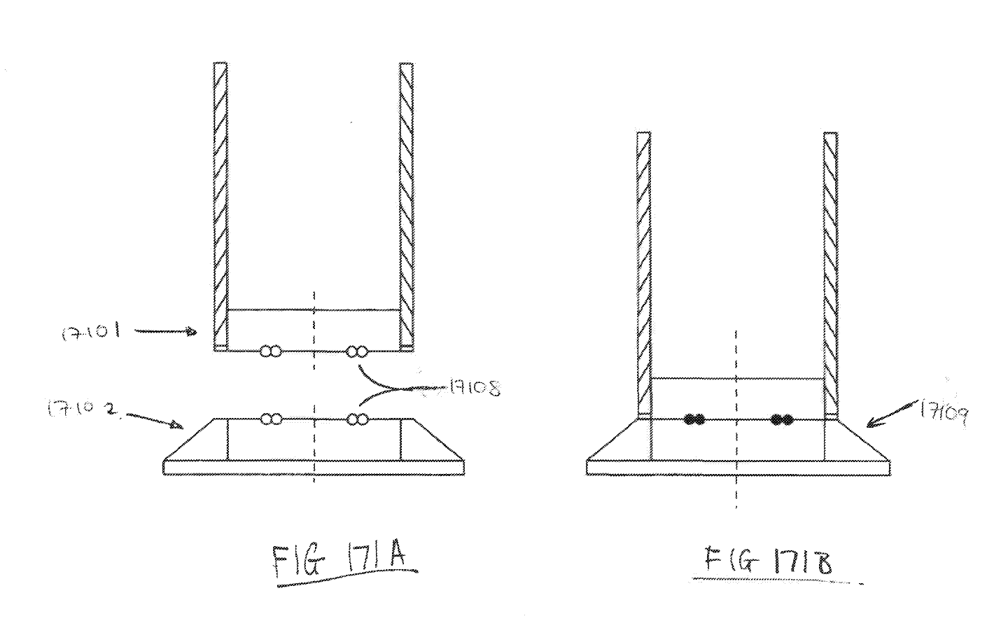

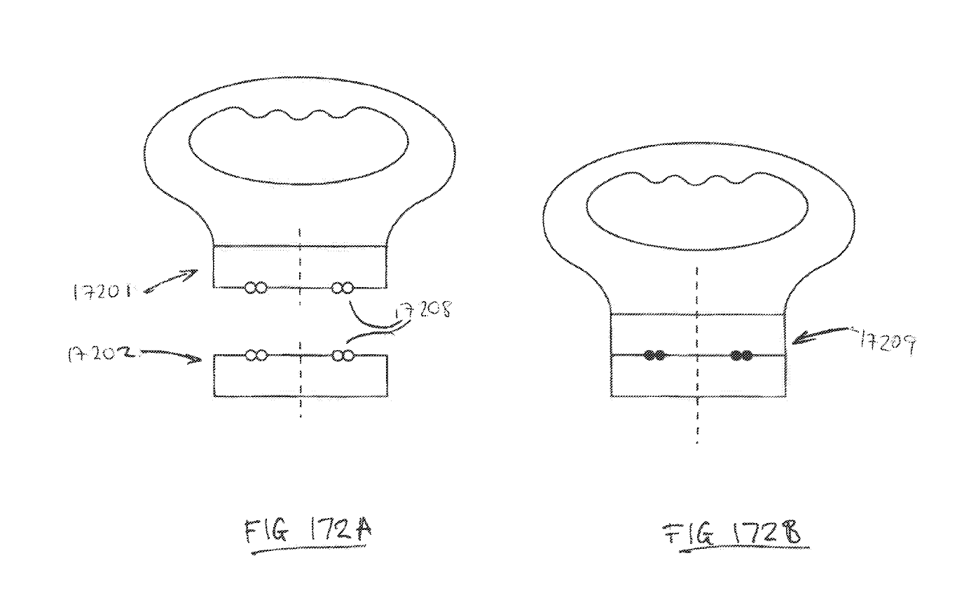

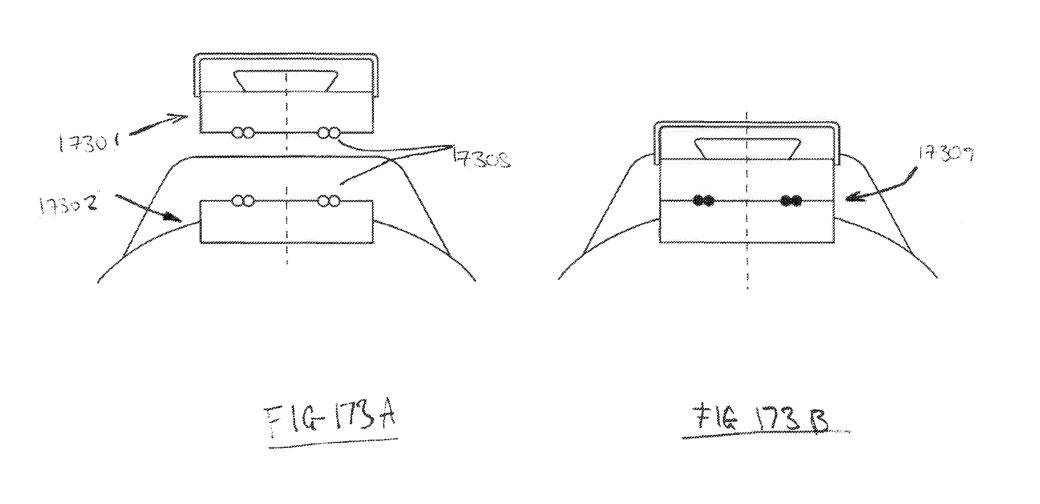

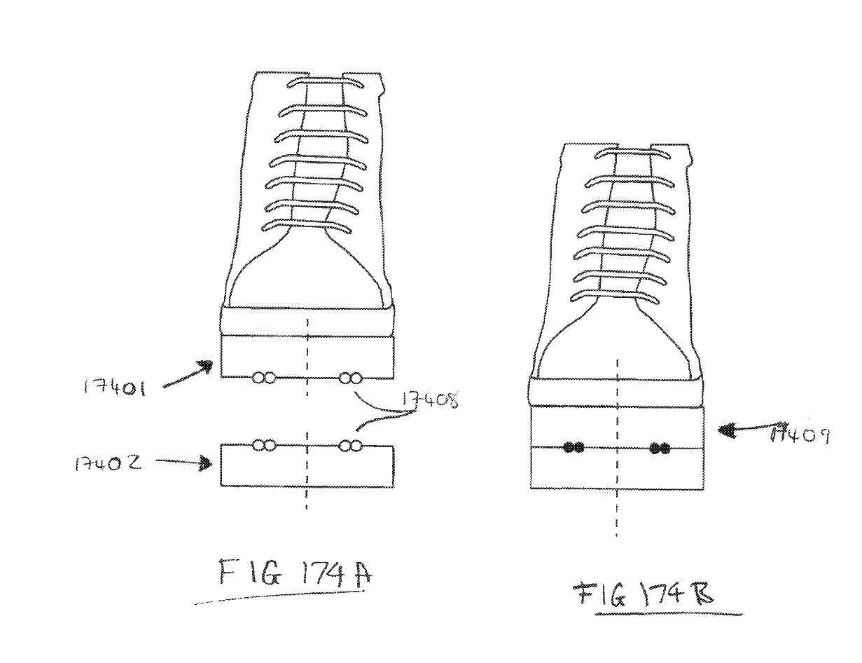

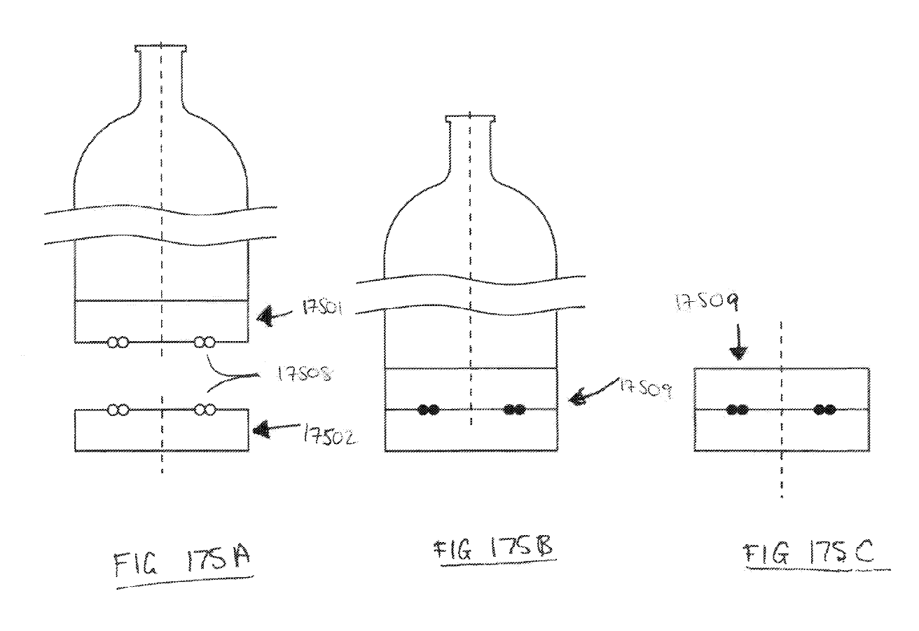

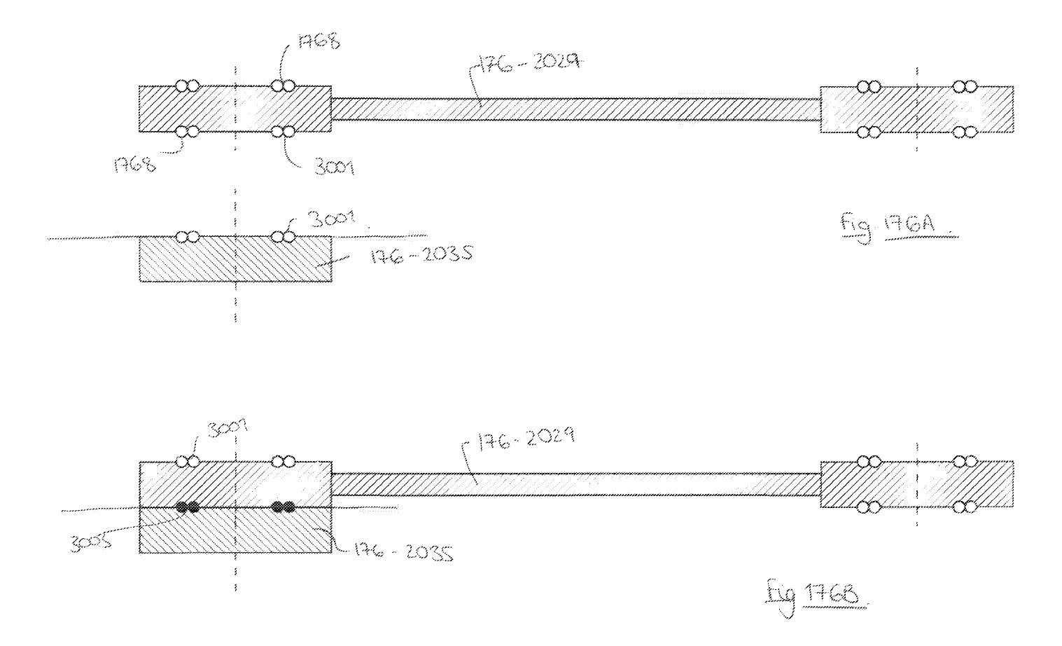

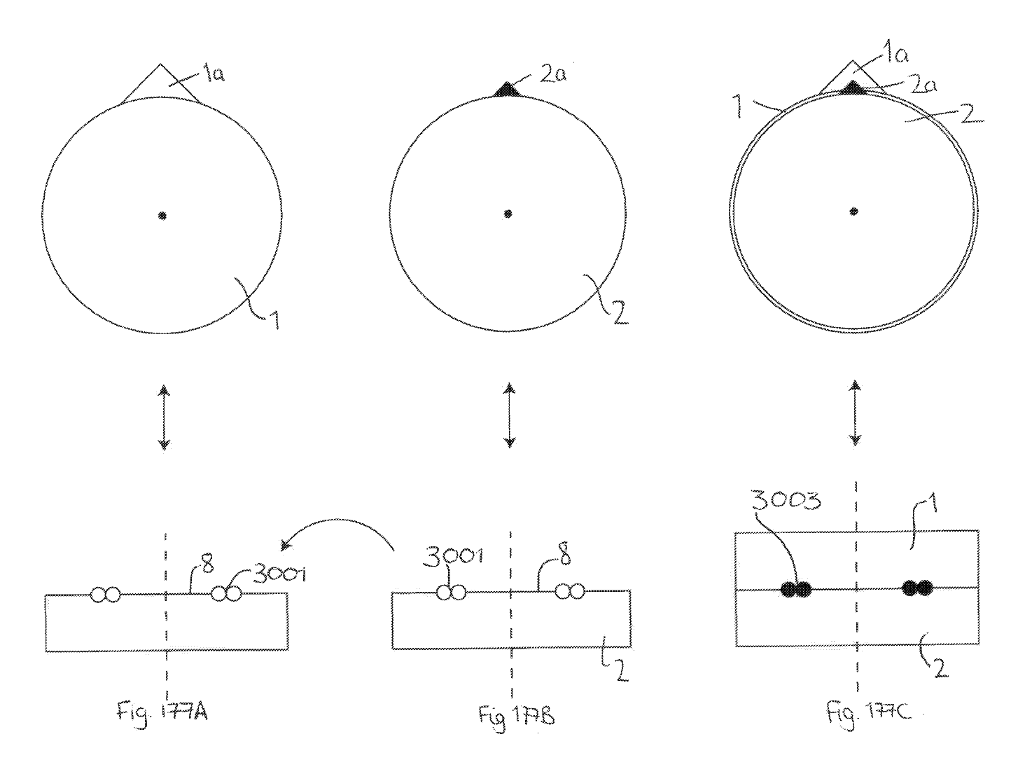

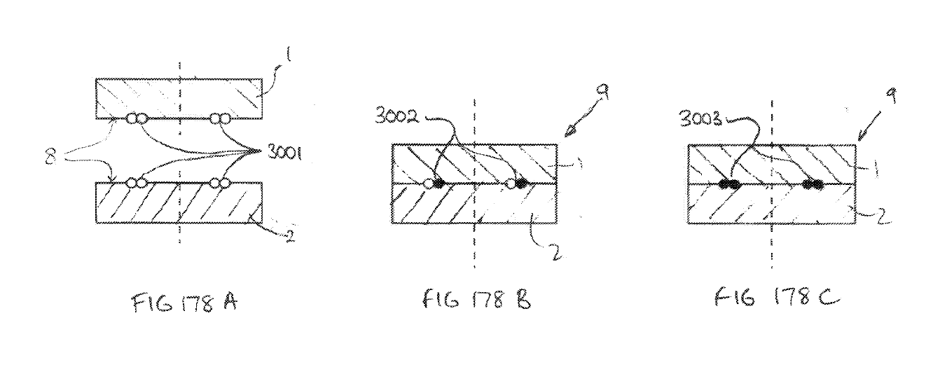

A second embodiment of the invention 110 is shown in FIGS. 5 to 7. The connector 110 is similar to the connector 10, and similar features are referenced with similar reference numerals, prefixed with “1”. The connector 110 is an example of a “quadruple pick-up”, 90° rotation connector.

The connector 110 includes two parts 112 and 112′. The two parts 112 and 112′ are not identical, but are engageable with one another. Each part 112, 112′ has a respective connecting face which is substantially transverse to a longitudinal axis B, B′ of the respective part 112, 112′.

The first part includes a plurality of engagement formations 116, 117, 118, 119. The engagement formations 116-119 are substantially annular, and are concentric about a longitudinal axis B. Each engagement formation 116-119 extends axially, in a direction which is substantially parallel to the longitudinal axis B. Each engagement formation 116-119 is separated from an adjacent engagement formation by a receiving formation 120, 121, 122.

Each engagement formation 116, 117, 118, 119 is substantially annular, and includes four sectors W, X, Y and Z. Each sector W, X, Y, Z of each engagement formation 116-119 has a first end and a second end. The sectors W, X, Y, Z of each formation 116-119 are arranged head-to-tail, such that the first end of each sector W, X, Y, Z is circumferentially adjacent the second end of an adjacent sector W, X, Y, Z. Each sector W, X, Y, Z of each engagement formation 116-119 is a partial helicoid. Each sector W, X, Y, Z extends through approximately 90°.

Each sector W, X, Y, Z of each engagement formation 116-119 includes an upper surface, which is substantially helicoidal. Each sector W, X, Y, Z also has a lower surface, an inner circumferential wall, and an outer circumferential wall. Each sector W, X, Y, Z also has an end face which is situated at the first end of the sector W, X, Y, Z, such that each engagement formation includes four ‘steps’. In the present example, the end face of sector W, X, Y, Z of each engagement formation 116, 117, 118, 119 is curved. However, each end face may be any shape as required. The heights of the end faces of the sectors W, X, Y, Z in each engagement formation are substantially the same as one another, as are the heights of the end faces of different engagement formations 116-119. However, the heights of the end faces of different engagement formation 116-119 need not be the same as one another. The inner and outer circumferential walls of each sector W, X, Y, Z slope inwardly towards the lower surface of the sector, such that the end face of each sector W, X, Y, Z is substantially trapezoidal in cross section. Other cross-sectional shapes are also possible and the cross-sectional shape may change over the extent of the engagement/receiving formations.

The circumferential walls of the engagement formations 116-119 define walls of receiving formations 120, 121, 122. The receiving formations are concentric about the longitudinal axis B. Each of the receiving formations 120-122 of the first part 112 also includes four sectors W, X, Y, Z, each having a first end, a second end and a substantially helicoidal upper surface extending between the first end and the second end. The sectors W, X, Y, Z of each receiving formation 120-122 are arranged head-to-tail, i.e. the first end of each sector W, X, Y, Z is adjacent the second end of an adjacent sector W, X, Y, Z.

The second part 112′ of the connector 110 includes a plurality of engagement formations 123, 124, 125, which are generally annular and concentric about a longitudinal axis B′, and a plurality of receiving formations 126, 127, 128, 129, which are concentric about the longitudinal axis B′. The engagement formations 123-125 of the second part 112′ are similar to the engagement formations 116-119 of the first part 112, in that each includes four sectors W, X, Y, Z. Each engagement formation 123-125 extends substantially axially, in a direction which is substantially parallel to the longitudinal axis A′. The two parts 112, 112′ of the connector 110 need not have the same number of sectors as one another. For example, alternating sectors of one of the parts 112, 112′ may be removed, or flattened, such that inter-engagement of the parts 112, 112′ occurs over half of the surface area of the abutting faces of the two parts of the connector 110. Additionally or alternatively one or more engagement formations may be omitted from one or both parts 112, 112′.

The receiving formations 126-129 are similar to the receiving formations 120-122 of the first part 112, in that each receiving formation 126-129 includes four sectors W, X, Y, Z, each having an upper surface which describes a partial helicoid.

Each sector W, X, Y, Z of each receiving formation 126-129 has a first end and a second end. The second end of each sector is positioned adjacent the first end of an adjacent sector. Each junction between adjacent sectors forms a step in the receiving formation, each receiving formation including four such steps. It will be appreciated that each “step” may be an incline, rather than a substantially vertical step.

The end faces of the engagement formations 116-119 of each sector W, X, Y, Z are aligned along a respective radii; i.e. the end faces of the first sectors W of each of the engagement formations are aligned along a first radius, and the end faces of the second, third and fourth sectors X, Y, Z of each of the engagement formations are aligned along three respective radii which extends outwardly from the longitudinal axis B. This need not be the case, and the end faces of the sectors W, X, Y, Z may be staggered or offset from one another.

Each of the engagement formations 116-119 of the first part 112 is receivable in a corresponding receiving formation 126-129 of the second part 112′. Similarly, each engagement formation 123-125 of the second part 112′ is receivable in a corresponding receiving formation 120-122 of the first part 112.

In use, the first part 112 and the second part 112′ are positioned adjacent one another and the axes B, B′ are substantially aligned, such that the engagement formations 116-119 extending from the connecting face of the first part 112 face the engagement formations 126-129 which extend from the connecting face of the second part 112′. The first end of each sector W, X, Y, Z of the first engagement formation 116 of the first part 112 is positioned adjacent the first end of a sector W, X, Y, Z of the first receiving formation 126 of the second part 112′. Similarly, the first end of each sector W, X, Y, Z of the first engagement formation 123 of the second part 112′ is positioned adjacent the first end of a sector W, X, Y, Z of the first receiving formation 120 of the first part 112, and so on.

Therefore each engagement formation 116-119, 123-125 of each part 112, 112′ is aligned with a corresponding receiving formation 120-122, 126-129 of the other part 112, 112′ of the connector 110.

The upper face of each of the engagement formations 116-119 of the first part 112 abuts the upper face of the corresponding receiving formation 126-129 of the second part 112′, and vice versa.

Rotation of the two parts 112, 112′ relative to one another, causes the engagement formations 116-119 of the first part 112 to engage with the receiving formations 126-129 of the second part 112′. In the present example, since the connector 110 includes four sectors of approximately equal angular size, relative rotation of the two parts 112, 112′ through 90° effects full inter-engagement of the two parts 112, 112′, wherein each end face of each sector W, X, Y, Z of each engagement formation 116-119 of the first part 112 abuts an end face of a sector W, X, Y, Z of a corresponding receiving formation 126-129 of the second part 112′, and vice versa.

Since the cross section of each engagement formation 116-119, 123-125 is substantially trapezoidal, the engagement formations 116-119 and 123-125 “dovetail” together. However, any “tessellating” arrangement of engagement formations and receiving formations is possible. Inter-engagement of the two parts 112, 112′ inhibits linear movement of the two parts 112, 112′ relative to one another in a direction parallel with the axes B, B′ and may completely prevent such movement. Full inter-engagement of the two parts 112, 112′ prevents any such relative linear movement whatsoever, without simultaneous relative rotational movement of the two parts 112, 112′. Rotation of the two parts 112, 112′ in a direction opposite to that which brings about engagement of the two parts 112, 112′, causes disengagement or partial disengagement of the two parts 112, 112′.

A third embodiment of the invention is shown in FIGS. 8 to 10. A connector 210 includes two parts 212, 212′. The first part 212 includes a plurality of engagement formations 216, 217, 218, 219, 220. The engagement formations 216-220 are substantially annular and concentric about a longitudinal axis C. Each engagement formation 216-220 includes two sectors X, Y. However, each part 212, 212′ may have any number of sectors. Each sector X, Y has a first end, a second end, an upper surface, and a lower surface. Each sector X, Y of each engagement formation 216-220 also includes an inner circumferential wall and an outer circumferential wall which, together, form two substantially circular side walls. The upper surface of each sector X, Y of each engagement formation 216-220 is substantially helicoidal. Each sector X, Y of each engagement formation 216-220 includes an end face which is positioned at the first end of the sector X, Y, and which is generally transverse to the side walls and the upper surface of the sector X, Y. Each end face of each sector X, Y of each engagement formation may be any shape, as desired. The side walls of each engagement formation 216-220 slope inwardly from the upper surface of the engagement surface to the lower surface thereof, such that each engagement formation is substantially trapezoidal in cross section. However, each engagement formation may have any suitable cross-sectional shape which enables interengagement of the two parts 212, 212′ of the connector 210.

Each sector X, Y of each engagement formation 216-220 extends around approximately 180° of the respective engagement formation 216-220. The two sectors X, Y of each engagement formation 216-220 are arranged head-to-tail, such that the first end of each sector X, Y is circumferentially adjacent the second end of the other sector X, Y of the same engagement formation 216-220. Since the upper surface of each segment X, Y of each engagement formation is substantially helicoidal, the upper surface of the second end of each sector X, Y meets the first end of the adjacent sector X, Y towards the lower surface of the adjacent sector, rather than being aligned with the upper surface of the adjacent sector. Thus there is a “step” between the upper surfaces of adjacent sectors X, Y of each engagement formation 216-220, with each engagement formation 216-220 including two steps which are positioned approximately 180° apart. Thus, this embodiment of the invention is a two pick-up, 180° connector. Each “step” may be an incline, rather than including a face which extends substantially axially parallel to the longitudinal axis C.

The first part 212 of the connector 210 also includes a plurality of receiving formations 221, 222, 223, 224, 225, 226. Each of the receiving formations 221-226 is substantially annular, and is defined by an outer wall of one engagement formation and an inner wall of the adjacent engagement formation. It will be appreciated that the innermost and/or outermost receiving formation may be defined by only a single wall.

Each receiving formation 221-226 has a substantially helicoidal upper surface. Each receiving formation includes two sectors X, Y, each of which extends approximately 180° around the receiving formation 221-226. The sectors of each receiving formation 221-226 are arranged “head-to-tail”, such that the second end of each sector is adjacent the first end of the other sector of the same receiving formation. Since the upper surface of each sector is substantially helicoidal, each junction between the second end of each sector X, Y with the first end of the other sector X, Y results in a step or incline in the upper surface of the receiving formation 221-226. In this example, since each receiving formation includes two sectors, each receiving formation 221-226 includes two such steps, which are positioned substantially diametrically opposite one another.

In the example shown, the junctions of the sectors X, Y of each of the engagement formations 216-220 and the junctions between the sectors X, Y of each of the receiving formations 221-226 are not radially aligned with one another. The junctions in the upper surfaces of the sectors X, Y of the engagement formations 216-220 and in the upper surfaces of the receiving formations 221-226 are staggered. Furthermore, each step of each engagement formation and receiving formation is not aligned with a radius of the connector 210. However, it will be appreciated that one or more of the steps may be aligned with a radius of the connector 210.

The second part 212′ of the connector 210 is similar, but not identical, to the first part 212. The second part 212′ includes a plurality of engagement formations, in this example six engagement formations 227, 228, 229, 230, 231, 232 which are arranged concentrically about a longitudinal axis C′ and extend substantially axially, in a direction which is substantially parallel to the longitudinal axis C′. The features of each engagement formation 227-232 of the second part 212′ are similar to those of the engagement formations of the first part 212. Each engagement formation 227-232 includes two sectors X, Y, each of which has a substantially helicoidal upper surface, with a step or incline being formed at each junction between the first end of each sector and the second end of the adjacent sector.

The second part 212′ also includes a plurality of receiving formations 233, 234, 235, 236, 237, arranged concentrically about the longitudinal axis C′. Each receiving formation 233-237 of the second part 212′ corresponds with an engagement formation 216-220 of the first part, and vice versa. The features of the receiving formations 233-237 of the second part 212′ are similar to those of the receiving formations 221-226 of the first part 212. Each receiving formation 233-237 includes two sectors, X, Y, each of which has a substantially helicoidal upper surface, with the junctions between adjacent sectors forming two steps in the upper surface of each receiving formation 233-237. Similarly to the first two embodiments of the invention, each part 212, 212′ of the connector 210 has a connecting face which is generally transverse to the longitudinal axis C, C′ of the respective part 212, 212′. The engagement formations 216-220, 227-232 extend generally axially from the respective connecting face, in a direction which is substantially parallel with the respective longitudinal axis C, C′.

Whilst the present example of the embodiment of the invention is described as having five engagement formations on the first part 212 and six engagement formations on the second part 212′, it will be understood that the third embodiment of the invention may have any number of engagement formations and a corresponding number of receiving formations. Not every engagement formation need be received in a receiving formation, and similarly, not every receiving formation need receive an engagement formation. Therefore, the two parts 212, 212′ of the connector 210 need not have corresponding numbers of engagement formations and receiving formations.

The first part 212 of the connector is engageable with the second part 212′ of the connector 210. In use, the two parts 212, 212′ of the connector 210 are positioned such that the connecting faces and hence the engagement formations of the two parts 212, 212′, 216-220, 227-232 are face to face. The axes C, C′ are aligned such that the first, outermost engagement formation 216 of the first part 212 is aligned with the first, outermost receiving formation 233 of the second part. Similarly, the first, outermost engagement formation 227 of the second part 212′ is aligned with the first, outermost receiving formation 221 of the first part 212, and so on.

The two parts 212, 212′ of the connector are rotated relative to one another about the longitudinal axes C, C′, and the upper surface of each engagement formation 216-220, 227-232 slides along the upper surface of the corresponding receiving formation of the other part. Such rotation of the two parts 212, 212′ relative to one another causes each engagement formation 216-220, 227-232 of each part to engage with a corresponding receiving formation 221-226, 233-237 of the other part of the connector. The sloping walls of the engagement formations 216-220, 227-232 mean that the two parts 212, 212′ “dovetail” or “tessellate” together. Rotation of the two parts 212, 212′ through approximately 180° causes the end face of each of the sectors of each of the engagement formations to abut the step of a sector X, Y of the receiving formation in which the engagement formation is received.

Rotation of the two parts 212, 212′ relative to one another in a direction opposite to that which effects interengagement of the two parts causes disengagement or partial disengagement of the two parts 212, 212′.

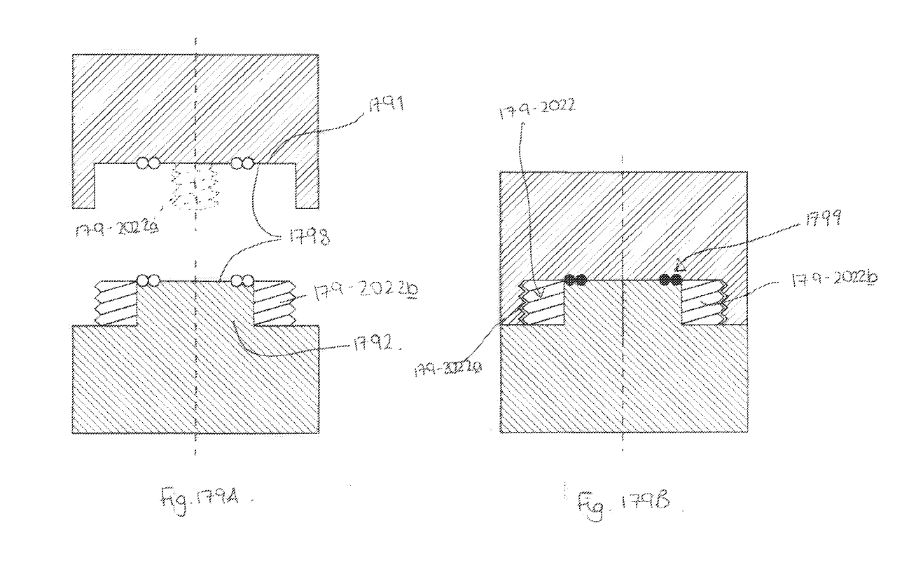

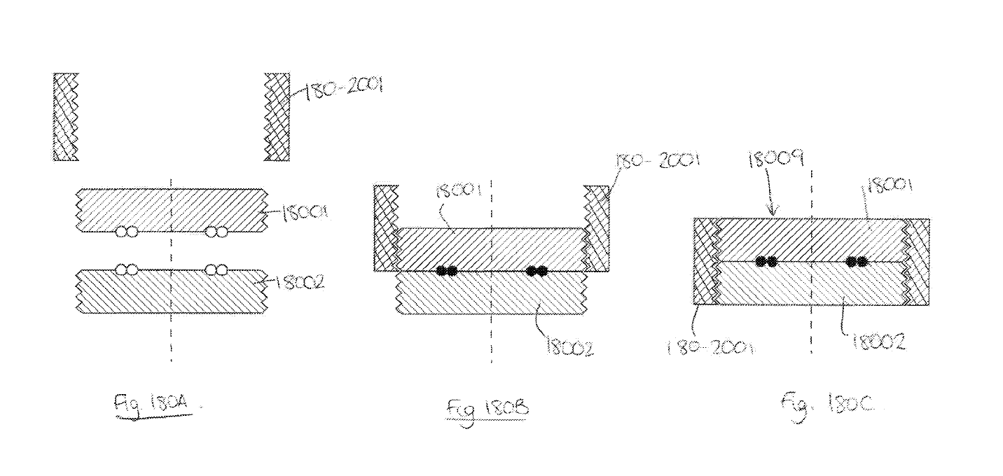

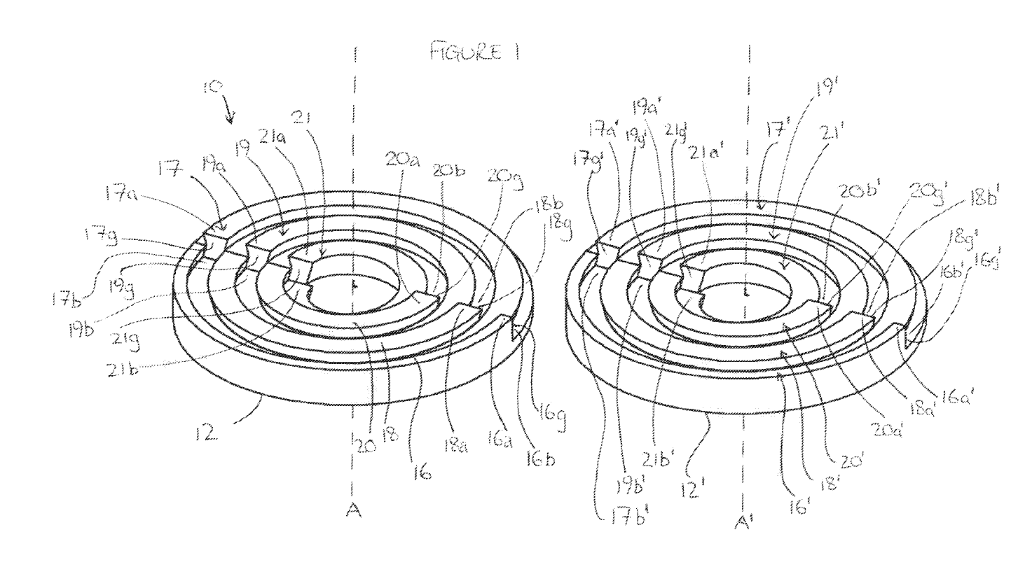

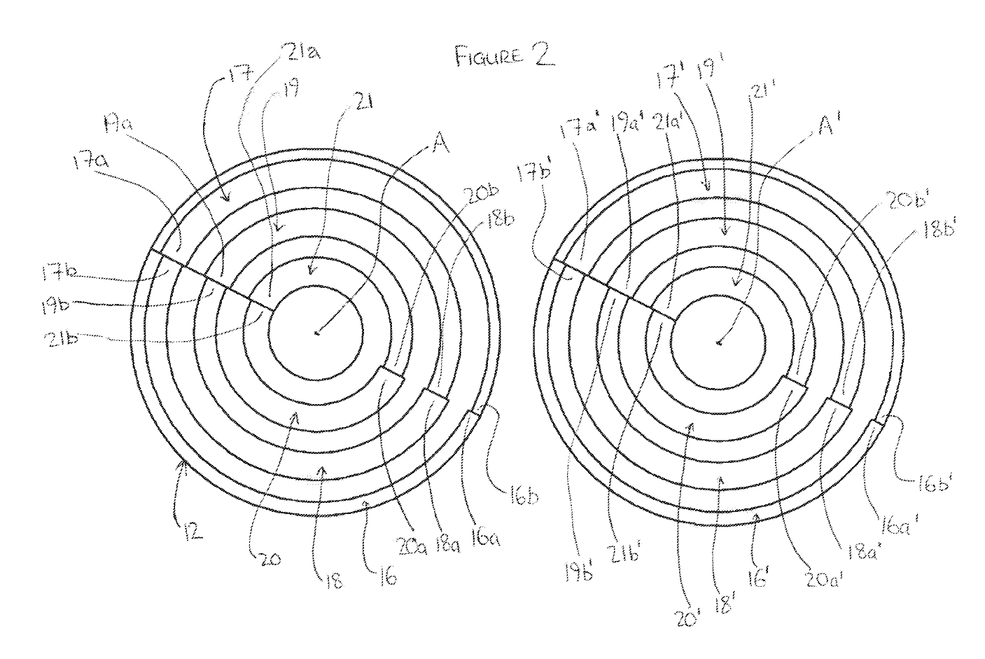

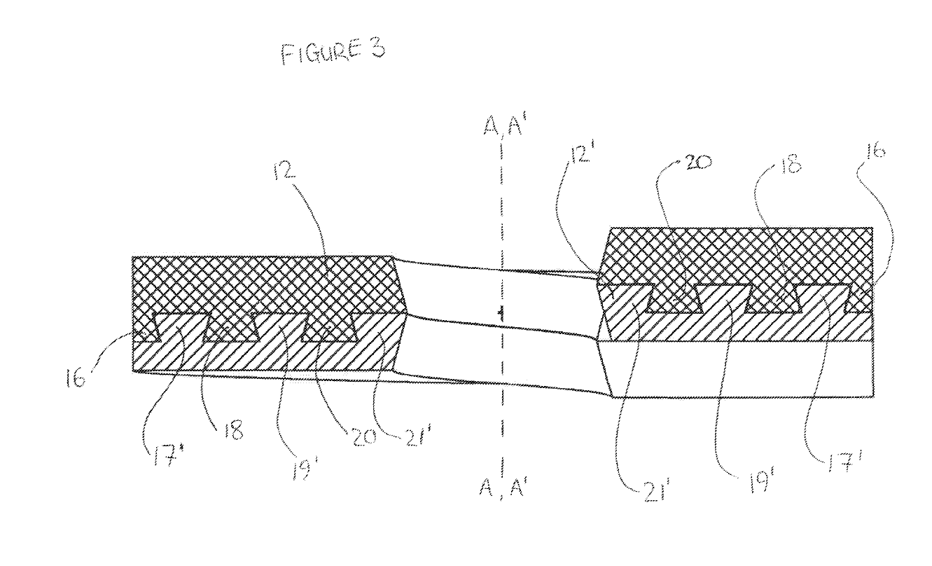

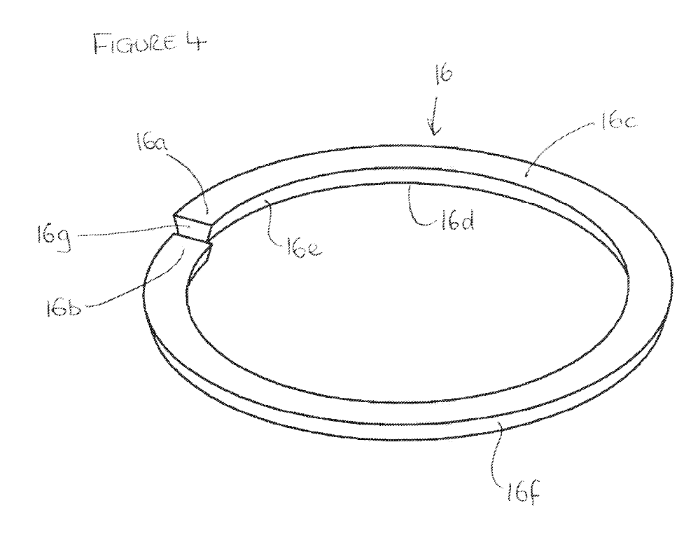

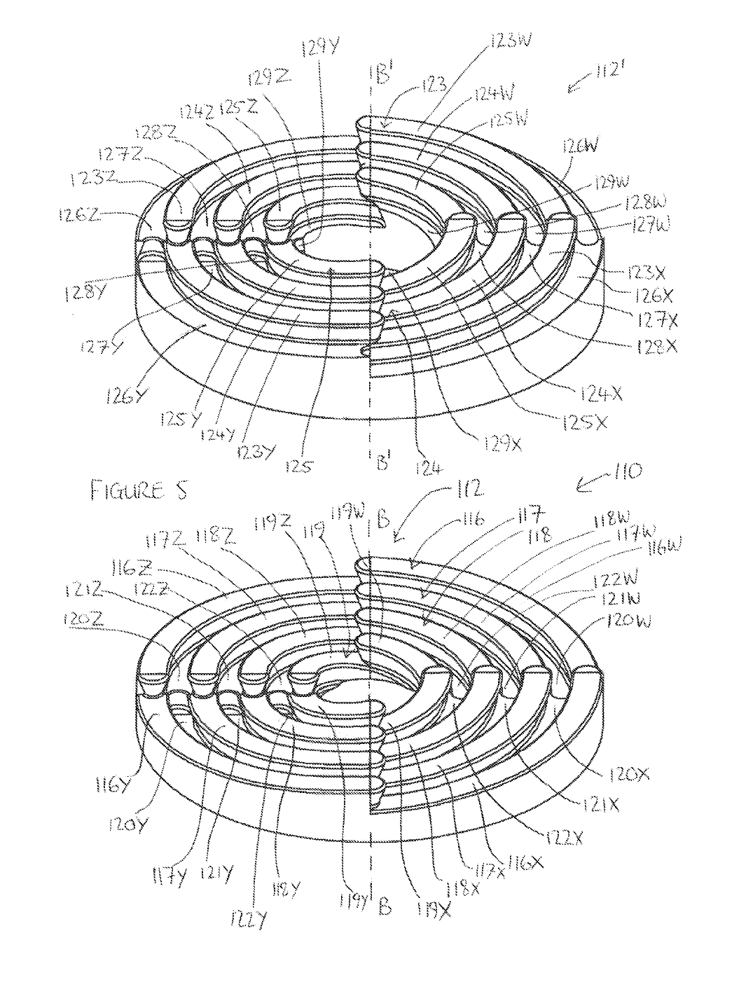

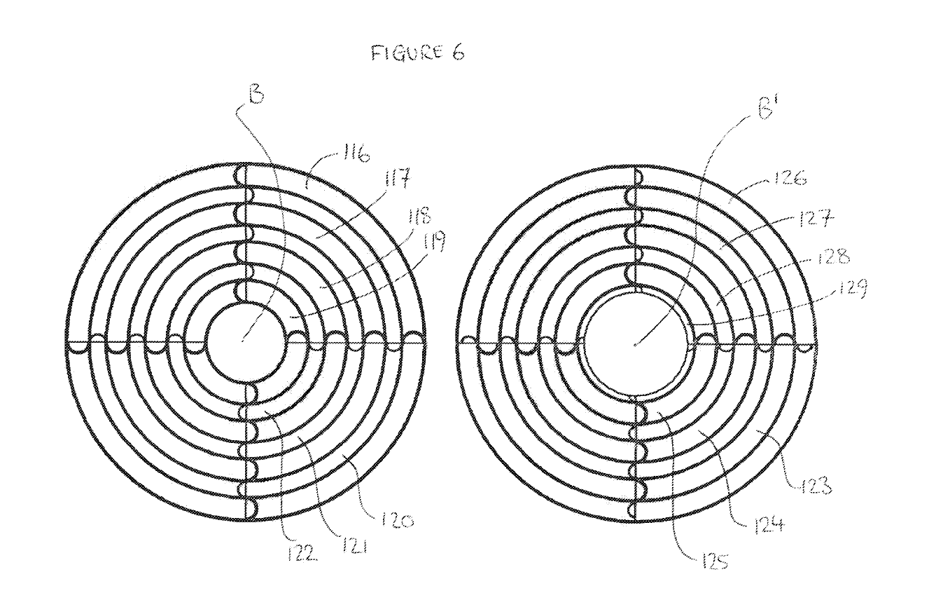

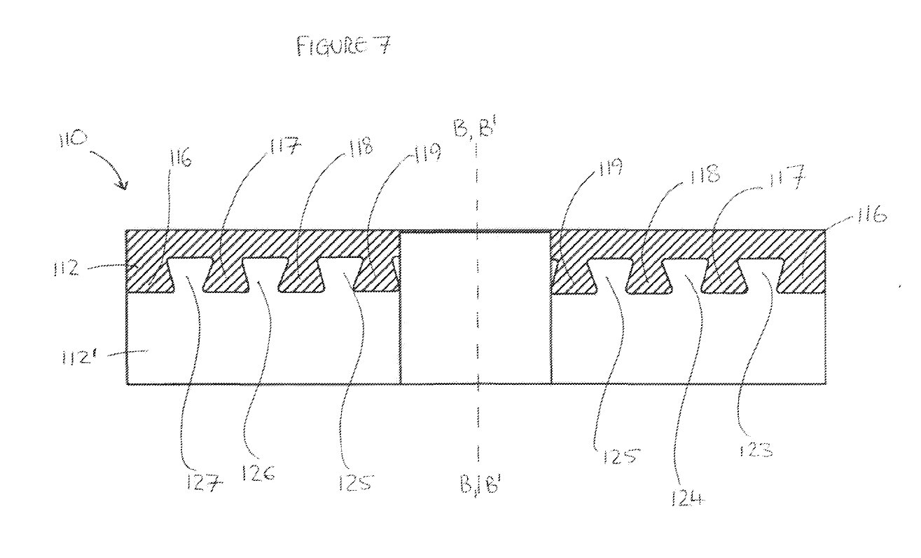

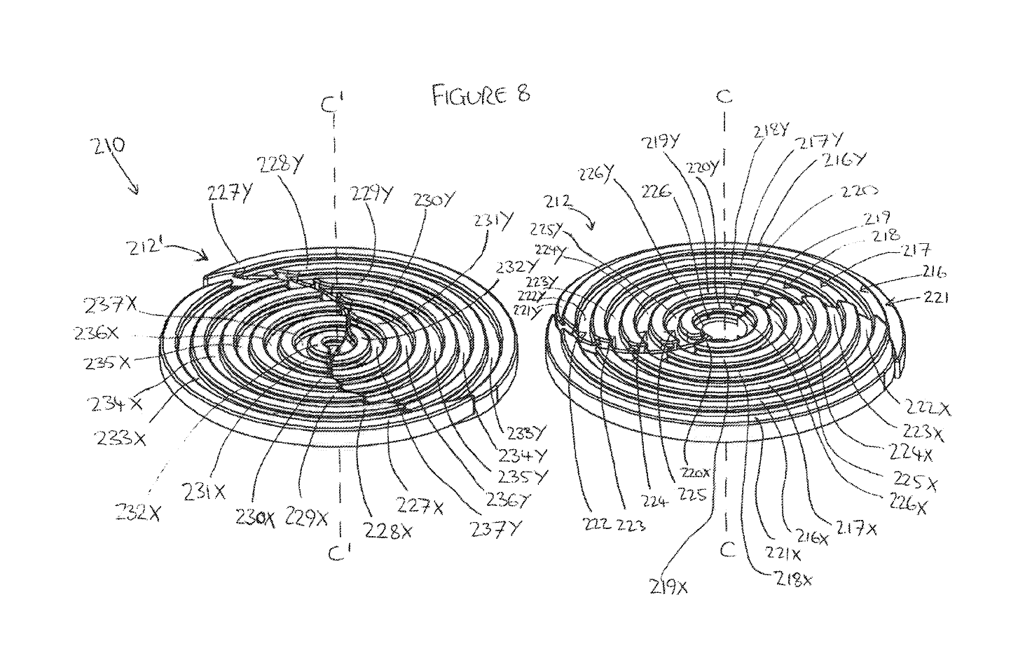

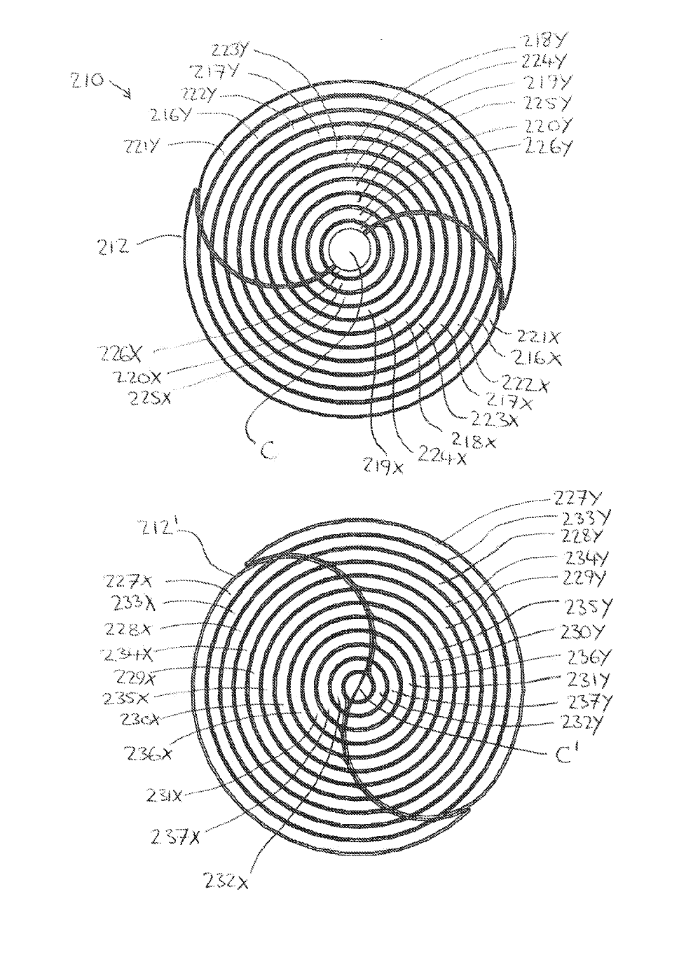

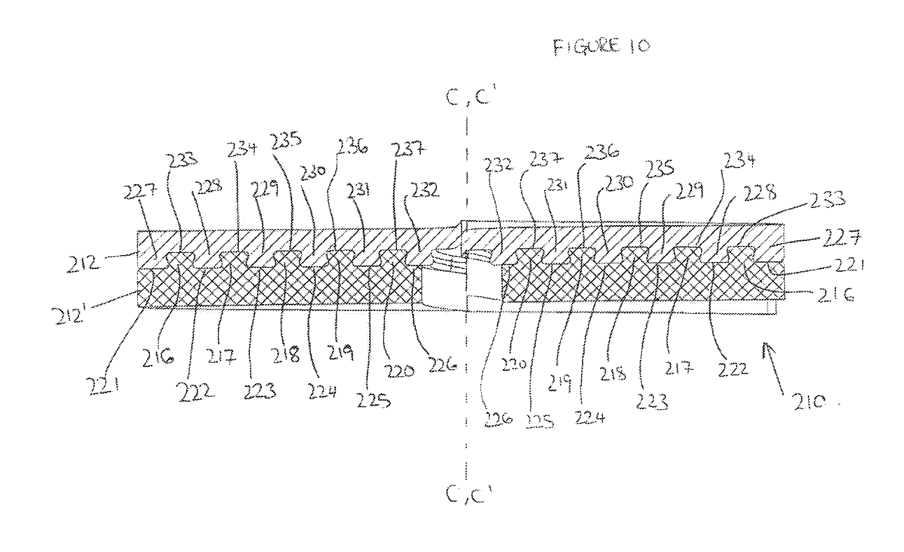

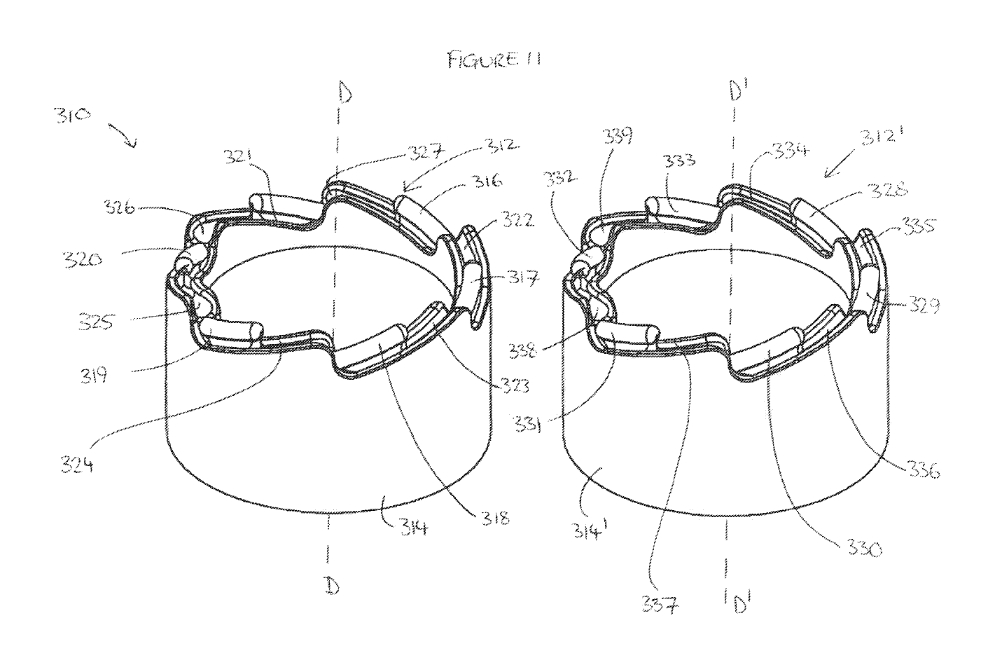

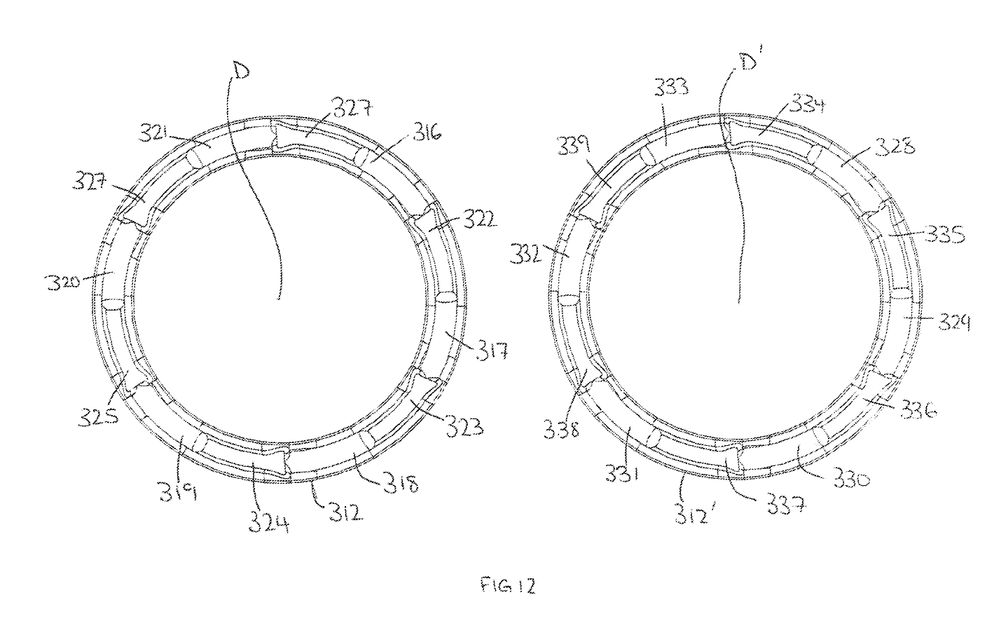

A fourth embodiment of the invention is shown at 310 in FIGS. 11-13. The connector 310 includes two parts 312, 312′. In the present example, the two parts 312, 312′ are identical, although this need not necessarily be the case.

The first part 312 includes a body 314, which is substantially cylindrical. The body 314 includes an opening 315, such that the body 314 is a substantially hollow cylinder. It will be appreciated that the body 314 need not be hollow. The first part 312 has a substantially central longitudinal axis D.

The first part 312 also includes a connecting face which is substantially annular and extends generally transversely to the longitudinal axis D. The connecting face of the first part 312 includes a plurality of engagement formations 316, 317, 318, 319, 320, 321 (in this example six) which are arranged in a substantially circular arrangement. Each engagement formation 316-321 extends through approximately 30°. Each engagement formation 316-321 is substantially circular in cross-section. However, each engagement formation 316-321 may have any appropriate cross-sectional shape.

Each engagement formation has a first end and a second end, an upper surface and two side walls. The upper surface of each engagement formation is inclined between the first end and the second end of the engagement formation.

Each engagement formation 316, 320 is adjacent a receiving formation 322, 323, 324, 325, 326, 327. Thus, the engagement formations 316-321 and receiving formations 322-327 alternate around the circumference of the first part 312.

Each receiving formation 322-327 is shaped so as to receive an engagement formation of the second part 312′. Each receiving formation 321-327 has a first end, a second end, an upper surface and a pair of side walls. In the present example each receiving formation has a substantially circular cross-section. Each receiving formation is a curved channel. The upper surface of each receiving formation is inclined between its first end and its second end.

The second part 312′ of the connector 310 is identical to the first part 312, having a plurality of engagement formations 328, 329, 330, 331, 333 and a plurality of receiving formations 334, 335, 336, 337, 338, 339 (in this example, six), in which the engagement formations 316, 317, 318, 319, 320, 321 of the first part 312 are receivable. Similarly, the engagement formations 334-339 of the second part 312′ are receivable in the receiving formations 322-327 of the first part 312.

The first part 312 may include only a single engagement formation, which is engageable with a single receiving formation of the second part 312′, such that relative rotation of the two parts through approximately 360° effects full interengagement.

The connector 310 may include a series of annular engagement formations which are arranged concentrically about the longitudinal axes D, D′, such that relative rotation of the two parts 312, 312′ of the connector 310 about the axes D, D′ causes simultaneous engagement of each of the engagement formations.

In use, the connecting faces of the two parts 312, 312′ of the connector 310 are brought together such that the engagement formations 316-321, 328-333 of the two parts 312, 312′ face the engagement formations 316-321, 328-333 of the other part 312, 312′ and the longitudinal axes D, D′ of the two parts 312, 312′ are substantially aligned.

The first end of each engagement formation 316-321, 328-333 of each part 312, 312′ is positioned adjacent the first end of a receiving formation 322-327, 334-339 of the opposing part 312, 312′. Rotation of the two parts 312, 312′ relative to one another causes each engagement formation to slide along the corresponding receiving formation of the opposing part until the first end of each engagement formation is positioned adjacent the second end of the receiving formation in which it is received. In this example relative rotation of the two parts 312, 312′ through approximately 30° causes full interengagement of the two parts.

Since each engagement formation is ‘undercut’ and each receiving formation is the inverse of the shape of the corresponding engagement formation of the opposite part, partial or full interengagement of the two parts 312, 312′ inhibits, and may completely prevent relative linear movement of the two parts 312, 312′ in a direction generally parallel to the longitudinal axes D, D′, without simultaneous relative rotation of the two parts 312, 312′.

Rotation of the two parts 312, 312′ relative to one another in a direction opposite to that which effects interengagement of the two parts 312, 312′ causes partial or complete disengagement of the two parts 312, 312′.

The connector 310 is suitable for use in connecting pipes or other tubular objects together. Each part 312, 312′ of the connector may be fitted to an end of a pipe, or may be integrally formed therewith.

Being able to control the degree of rotation required to effect full interengagement by providing an appropriate number of engagement formations, means that the ultimate relative position of the pipes on the end of which the parts of the connector 310 are provided, can be selected and controlled.

Plumbing connections can thus easily be made using the connector 310. Seals of rubber, for example, may be provided to inhibit leakage. Additionally or alternatively, an adhesive and/or a sealant may be applied to maintain and seal the connection between the two parts 312, 312′.

Each part of each connector 10, 110, 210, 310 may include a backing member, which carries each of the engagement formations and receiving formations of that part. The backing member may extend beyond the circumference of the outermost engagement formation or receiving formation, and may be used to attach the part of the connector to an object or a surface. Alternatively, the engagement formation(s) and/or receiving formation(s) of one or both parts of the connector may be integrally formed in an object or surface.

Attaching the first part 12, 112, 212, 312 of the connector 10, 110, 210, 310 to an object, and the second part 12′, 112′, 212′, 312′ to another object enables the two objects to be connected together. For example, a single connector 10, 110, 210, 310 can be used to attach a picture to a wall, one part of the connector being attached to the wall, and the other part of the connector being attached to the rear of the picture. There may be no need to drill the wall or puncture the wall with screws or nails. Furthermore, according to one or more embodiments, the picture is able to rest substantially flush with the wall, owing to the shallowness of the connector. Hanging a picture on a nail by a cord attached to the rear of the picture typically causes a gap between an upper part of the picture and the wall.

As a further example, a connector 10, 110, 210, 310 may be used to connect parts of flat-packed furniture together. For example, connecting a leg to a tabletop usually requires a threaded fastener to be provided, and for the leg to be turned through several revolutions relative to the tabletop, in order to engage the whole of the threaded fastener, and to provide a secure engagement between the leg and the table. According to various embodiments of the present invention, attaching one part of a connector in accordance with the present invention to an underside of the tabletop, and the other part to an in use upper end of the leg, enables the leg to be securely engaged with the tabletop by rotating the leg through less than 360° relative to the tabletop.

According to various embodiments, in order to fully engage the two objects, it is only necessary to rotate the two parts through up to 360° relative to one another, and preferably only through between 90° and 180°. It will be appreciated that the number of “pick-up points”, which is determined by the number of sectors into which each engagement formation and receiving formation is divided, affects the angle through which the parts have to be rotated relative to one another in order to achieve full engagement. The more pick-up points which are provided, the more convenient the connector 10, 110, 210, 310 may be to use, since the initial relative orientation of the two parts is less important. The more pick-up points are provided, the smaller the angle through which the parts have to be rotated through relative to one another to achieve full engagement. The optimum number of pick-up points and hence the degree of rotation required to achieve full engagement of the two parts may depend upon the application in which the connector is to be used.

The connection between the two parts of the connector 10, 110, 210, 310 is described above as being temporary, insofar as the two parts of the connector are disconnectable from one another by rotating the two parts relative to one another in a direction which is opposite to the direction in which the parts are rotated in order to achieve connection. The two parts of the connectors 10, 110, 210, 310 are frictionally engaged with one another. Where both parts of the connector 10, 110, 210, 310 are manufactured from an unpliable material, the engagement formations are unable to disengage one another by virtue of a force being applied in a longitudinal direction. Where one or both of the parts are manufactured from a pliable material, the two parts, when engaged or fully engaged, may be “peeled” apart, by deforming the or each pliable part.

However, the connection may be made permanent. For example, at least one part may include a locking formation such as a catch, tenon or barb, which inhibits or prevents rotation of the parts of the connector relative to one another in the direction opposite to the engagement direction.

Adding a projection to a part of the connector 10, 110, 210, 310 may increase the frictional engagement between the two parts. For example narrowing a receiving formation may tighten the receiving formation's grip on the corresponding engagement formation of the other part. This increased friction may cause “locking” of the two parts in an engaged configuration. It may be necessary to use a tool to overcome the increased friction.

A separate locking device, for example a pin or bolt, may be provided to hold the two parts of the connector together in an engaged configuration. Each engagement formation of each part of each connector may act as a pawl, which engages with a receiving formation, the upper surface of which includes a series of steps, in the form of a ratchet. Additionally or alternatively, one or both parts of the connector may be provided with an adhesive which permanently, or semi-permanently, bonds the two parts of the connector together in the fully engaged position, or in a partially engaged position relative to one another.

Each of the connectors described above may be an electrical connector. Such a connector is shown at 410 in FIG. 14. The connector 410 is similar to the first embodiment of the invention, but could alternatively have a similar configuration to the second, third or fourth embodiments. The connector 410 has a first part 412 and a second part 412′. The present example of the first part 412 includes six engagement formations 416, 417, 418, 419, 420, and 421. Each of the engagement formations has a first end 416a, 417a, 418a, 419a, 420a, 421a, and a second end 416b, 417b, 418b, 419b, 420b, 421b. The first part 412 includes three electrically conductive elements 450, 451, 452 each of which is positioned on an upper surface of the respective engagement formation towards the second end thereof. Each electrically conductive element 450, 451, 452 is connected to an electrical connector, for example a wire 470, 471, 472 each of which is embedded in the first part 412 of the connector 410. Three wires are shown in the present example. The first wire 470 may be a live wire, the second wire 471 may be a neutral wire and the third wire 472 may be an earth, for example.

The second part 412′ of the connector 410 is similar to the first part 412, insofar as it includes six engagement formations 316′ 317′, 318′, 319′, 320′, 321′, each having a substantially helicoidal upper surface. The second part 412′ include three electrically conductive elements 450′, 451′ and 452′, each of which is positioned towards the first end of an engagement formation, on the upper surface thereof. Each electrically conductive element 450′, 451′ 452′ is connected to an electrical conductor, for example, a wire 470′, 471′, 472′.

It will be understood that the number of engagement formations, receiving formations and electrically conductive elements shown provided on each part 412, 412′ is exemplary, and any number may be provided as required. In use, the two parts 412, 412′ are inter-engaged in a similar manner to the first connector 10, described above. The positions of the electrical elements 450-452, 450′-452′ on the two parts 412, 412′ are such that when the two parts 412, 412′ are fully engaged, each electrical element 450-452 of the first part 412 contacts the corresponding electrical element 450′-452′ of the second part 412′, permitting the flow of electrical current from one part 412, 412′ of the connector 410 to the other part 412, 412′. Therefore the connector 410 may be used as an electrical connector as part of an electric circuit.

Of course, different numbers of electrical elements may be provided, and the electrical elements may be positioned or configured differently. The only requirement is that at least a part of an electrical element which is positioned on the first part 412 contacts at least a part of an electrical element which is positioned on the second part when the two parts 412, 412′ of the connector 410 are fully or partially engaged.

The positions of the electrically conducting elements may be staggered, such that the connections are made sequentially, rather than simultaneously as the two parts 412, 412′ of the connector 410 are interengaged.

The electrically conducting elements may be positioned such that contact between the electrically conducting elements of the two parts is not effected until a further component or assembly is added, or until a further connecting step is carried out.

The connector 410 may be used as an alternative to terminal block, which is well known in the field of electric circuits. The wires 470-472, 470′-472′ need not be integral with the parts 412, 412′ of the connector 410, and in such a situation, a user is able to connect a cable or wire, for example to one part 412, 412′ of the connector 410, and another wire, cable or part of an electrical device to the other part of the connector 410, then rotate the two parts 412, 412′ of the connector 410 together so as to complete an electrical circuit. Apart from the electrical elements 450-452, 450′-452′, the connector 410 is manufactured from an electrically insulating material. Alternatively, the entire connector may be manufactured from an electrically conducting material. The electrical elements 450-452, 450′-452′ may have a safety covering, for example, which is removed during rotation of the two parts 412, 412′ relative to one another, such that the electrical elements 450-452, 450′-452′ are not accessible to a user, so as to reduce or avoid the risk of electrocution.

The connector 410 may be used as a means of holding an electrical device in or on a docking device, or in or on a charging device. Known docking/charging devices generally rely upon a connector on a base of the electrical device being held in contact with an electrical connector on the docking or charging device. Known docking/charging devices are generally reliant on the electrical device being held in or on the docking/charging device under gravity. An electrical item bearing one part of the electrical connector 410, is electrically connectable to a docking/charging device which carries the other part of the connector 410, by means of rotation. Such an electrical connection is secure, and is not gravity-dependent, and does not require repeated insertion and removal of a connector or a lead, for example, into a “port” of the device. The connector 410 is mounted on or embedded in the exterior of the electrical device.

The amount of wear on the connector is reduced, since the forces applied to effect connection and disconnection are rotational, and hence are not applied in a single direction. The connector has a low-profile, and does not protrude very far, if at all, from the exterior of the electrical device.

A seal, for example an o-ring, may be positioned externally of the connector 410, to increase the Ingress Protection (IP) rating of the connector 410. A seal or sealant may additionally or alternatively be provided between adjacent engagement formations of one or both parts 412, 412′ of the connector 410.

One or both parts 412, 412′ of the connector 410 may be manufactured from an elastomeric material, so as to provide snug inter-engagement of the two parts 412, 412′, which improves the water-tightness of the connection.

Such a connector can be provided as an electrical connection, for example in a ceiling rose for a light fitting, as shown in FIGS. 16 and 17. The connector 510 is similar to the connector 410 described above, except that the electrically conducting elements are positioned on end faces of the engagement formations. Each engagement formation of first part 512 includes an electrically conductive pin 550, 551, 552 and each engagement formation of a second part 512′ of the connector 512 includes an opening 560, 561, 562 which includes an electrically conductive element and in which a pin 550, 551, 552 of the first part 512 is receivable when the two parts 512, 512′ of the connector 510 are connected together.

Each pin 550, 551, 552 of the first part is connected an electrical cable which is connectable to an electrical device, for example a lighting device. Each pin 550, 551, 552 may be connected to a respective cable, for example live, neutral and earth.

The second part 512′ of the connector is connected to a lighting circuit, and is attachable to a surface, for example a ceiling. Each electrical element is electrically connected to the lighting circuit. Each electrical element is embedded in the second part 512′ of the connector 510, such that the electrical elements cannot be touched, inadvertently or intentionally. The pins 550-552 of the first part 512 are of a relatively small diameter and the openings 560-562 are of a corresponding diameter, such that a human finger, for example, is too large to fit inside the opening and contact the electrically conductive elements.

In use, a lighting device is attached to the cables 560 extending from the first part 512 of the connector. The second part 512′ is attached to a lighting circuit.

An electrical connection is made between the lighting device and the lighting circuit by offering the first part 512 of the connector up to the second part 512′ such that connecting faces of the two parts face one another, and rotating the first part 512 relative to the second part 512′ so as to inter-engage the engagement formations of the two parts 512, 512′, until the pins 550-552 are received in the openings 560-562 of the second part 512′, and the electrically conductive elements of both parts 512, 512′ are in contact with one another. The two parts 512, 512′ are fixable in the engaged configuration, for example by inserting fasteners through both parts of the connector 510.

An example of a connector 610 having a locking formation is shown in FIGS. 17 to 19. The connector 610 is similar to the connector 110, inasmuch as the connector is a “quadruple pick-up” 90° rotation connector. The connector includes two parts 612, 612′. The two parts are not identical, but are engageable with one another. Each part 612, 612′ has a respective connecting face which is substantially transverse to a longitudinal axis E, E′ of the respective part 612, 612′.

The first part 612 includes a plurality of engagement formations 616, 617, 618. Any number of engagement formations may be provided, as required. The engagement formations 616-619 are substantially annular, and are concentric about the longitudinal axis E. Each engagement formation 616-619 extends axially, in a direction which is substantially parallel to the longitudinal axis E.

Each engagement formation 616-618 includes four sectors W, X, Y Z. Each sector W, X, Y, Z of each engagement formation 616-618 has a first end and a second end. The sectors W, X, Y, Z of each formation are arranged head-to-tail, such that the first end of each sector W, X, Y, Z is circumferentially adjacent the second end of an adjacent sector W, X, Y, Z. Each sector W, X, Y, Z is a partial helicoid. However, it will be appreciated that each sector may have a substantially flat upper surface, provided that together the sectors W, X, Y, Z of each engagement formation 616-618 describe a substantially helicoidal connecting face. Each sector W, X, Y, Z extends through approximately 90°.

Each sector W, X, Y, Z of each receiving engagement formation has an end face which is situated at the first end of the sector W, X, Y, Z, such that the each engagement formation include four ‘steps’. Each end face of each sector W, X, Y, Z includes a locking formation 621. Each locking formation is a catch which extends circumferentially from the end face of the respective sector W, X, Y, Z. An underside of each catch 621 includes a tooth which extends downwardly from the underside of the catch 621. The underside of each catch 621 is spaced from an upper surface of the adjacent sector W, X, Y, Z, such that there is a clearance between the catch 621 and the upper surface of the adjacent sector W, X, Y, Z. Each catch 621 is thus capable of flexing slightly.

It will be appreciated that as many locking formations 621 may be provided as is deemed necessary, and not every sector of every engagement formation need include a locking formation 621.

Each engagement formation 616-618 is separated from an adjacent engagement formation by a receiving formation 619, 620. The receiving formations 619, 620 are concentric about the longitudinal axis E. Each receiving formation 619, 620 also includes four sectors W, X, Y, Z, each having a first end and a second end. An upper surface of each sector W, X, Y, Z of each receiving formation is preferably substantially helicoidal, but may also be substantially flat, provided that together, the four sectors W, X, Y, Z of each receiving formation describes a substantially helicoidal surface. The sectors W, X, Y, Z of each receiving formation are arranged head-to-tail, such that the first end of each sector W, X, Y, Z is adjacent the second end of an adjacent sector W, X, Y, Z. Each sector W, X, Y, Z includes a recess 622 which is positioned beneath the first end of the sector W, X, Y, Z, and which is communicable with the second end of an adjacent sector W, X, Y, Z.

The second part 612′ includes a plurality of engagement formations 623, 624 which are generally annular and concentric about the longitudinal axis E′. The second part 612′ also includes a plurality of receiving formations 625, 626, 627. The engagement formations 623, 624 of the second part 612′ are similar to the engagement formations of the first part 612, and each includes four sectors W, X, Y, Z. Each sector W, X, Y, Z of each engagement formation 623, 624 includes a locking formation 628, which is similar to the locking formations 621 of the first part 612.

It will be appreciated that as many locking formations 628 may be provided as is deemed necessary and not every sector of every engagement formation need include a locking formation 628.

The receiving formations 625-627 of the second part 612′ are similar to the receiving formations of the first part 612, and each also includes four sectors W, X, Y, Z. The receiving formations 619, 620 of the first part 612 are engageable with the engagement formations 623, 624 of the second part 612′ and the receiving formations 625, 626, 627 of the second part 612′ are engageable with the engagement formations 616, 617, 618 of the first part 612. Each sector W, X, Y, Z of each receiving formation 625-627 of the second part 612′ includes a recess 629, which is similar to the recesses 622 of the first part 612. The number of recesses 629 provided in the second part 612′ preferably corresponds to the number of locking formations 621 provided on the first part 612, and vice versa.

When the two parts 612, 612′ are engaged with one another, as described in relation to other embodiments, i.e. by rotation of the two parts 612, 612′ relative to one another, and by engagement of each engagement formation 616, 617, 618, 623, 624 with a receiving formation of the other part 612, 612′, the locking formations 621, 628 of each part 612, 612′ are receivable in and engageable with a corresponding recess 622, 629 of the other part 612, 612′. Once the two parts have been rotated such that the two parts are ‘home’, each locking formation 621, 628 enters the corresponding recess 622, 629 beneath the first end of the adjacent sector W, X, Y, Z of the corresponding receiving formation of the other part 612, 612′. The tooth of each catch 621, 628 impinges on a substantially longitudinally extending face of an adjacent receiving formation 619, 620, 625, 626, 627 with which the engagement formation 616, 617, 618, 623, 624 is engaged. This inhibits or prevents the catch 621, 628 from being disengaged from the recess 622, 629, thus permanently or semi-permanently engaging the two parts 612, 612′ in the connected configuration. The flexibility of each of the catches 621, 628 means that, if desired, the two parts 612, 612′ may be disengaged from one another, if a sufficient force is applied to rotate the two parts 612, 612′ relative to one another in a direction which causes the engagement formations 616, 617, 618, 623, 624 to disengage from the corresponding receiving formation 619, 620, 625, 626, 627 of the other part 612, 612′.

Such a connector may, for example, be used in assembling parts of products which are intended to remain connected to one another, as the locking formation inhibits or prevents inadvertent disconnection of the parts.

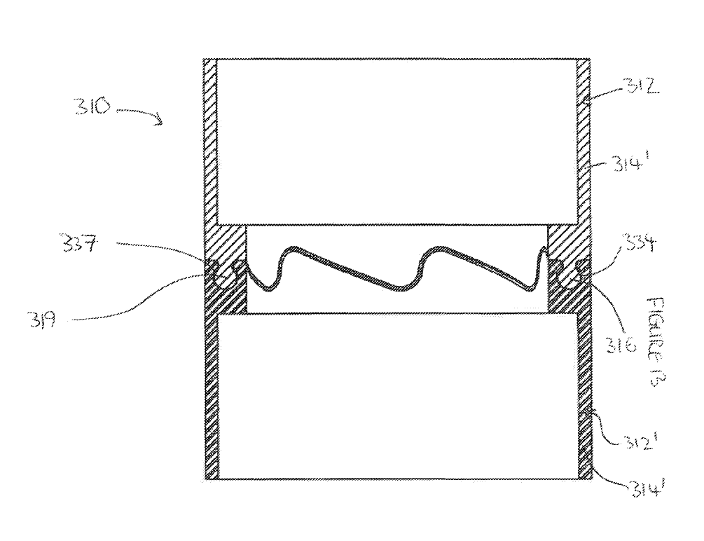

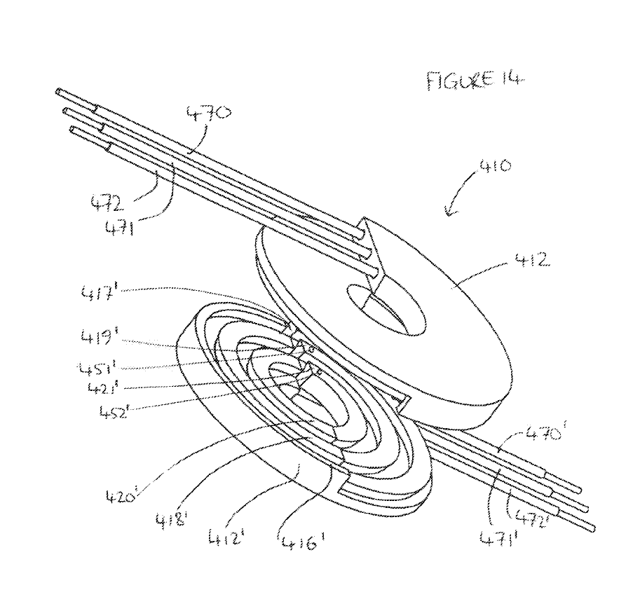

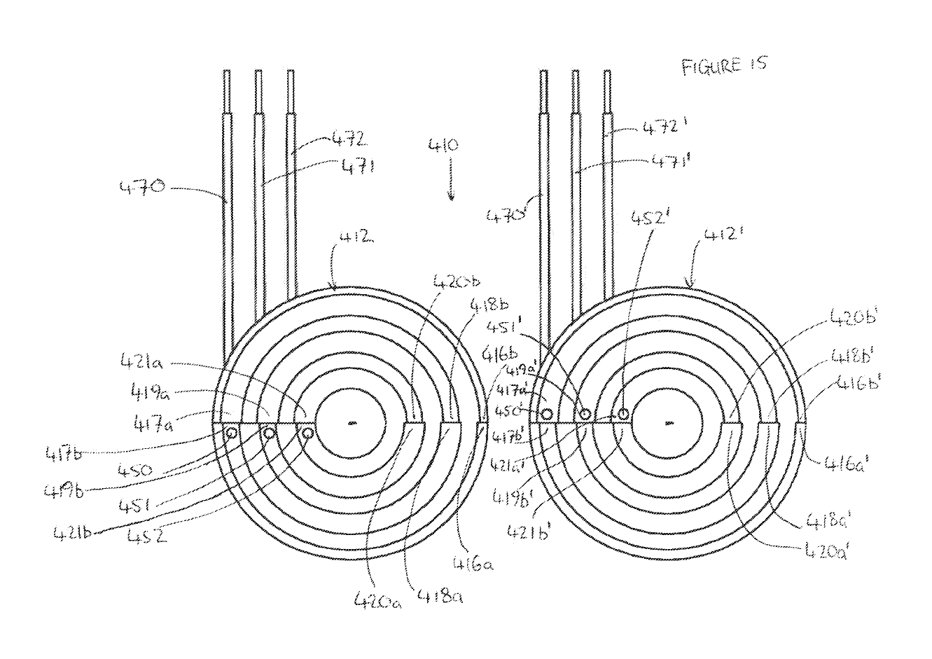

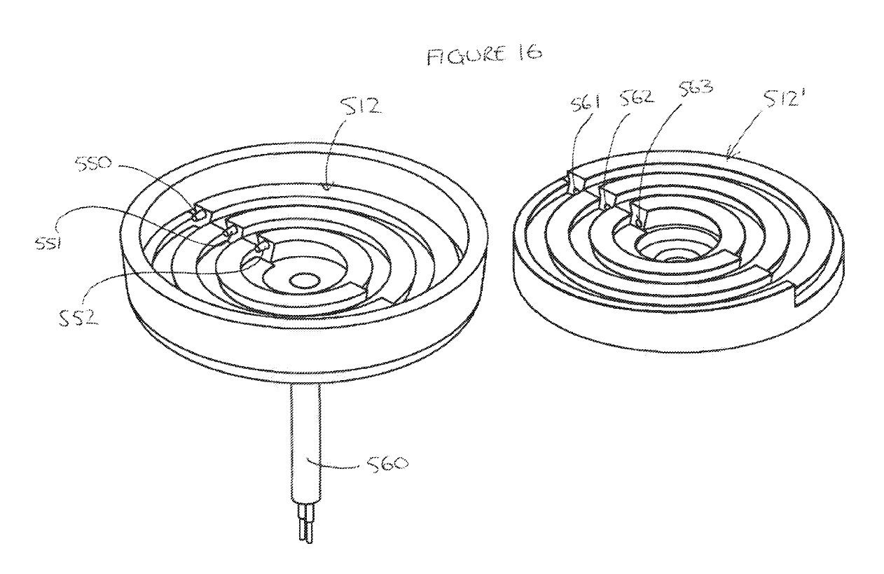

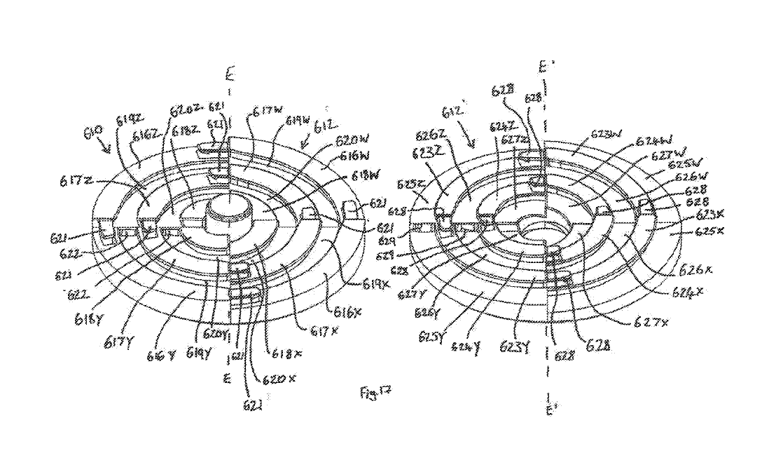

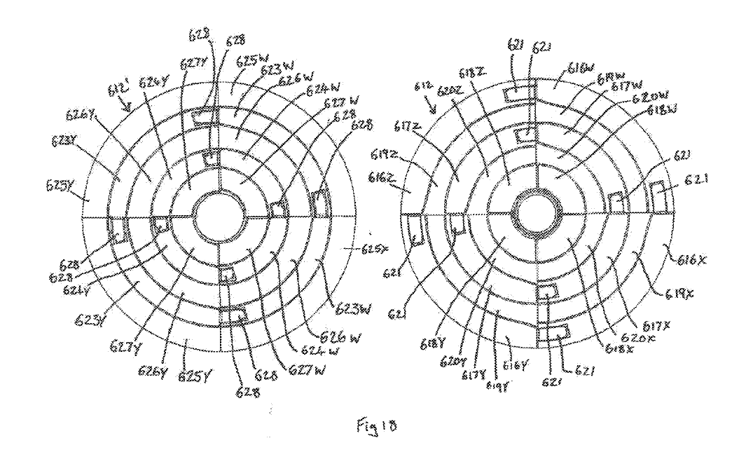

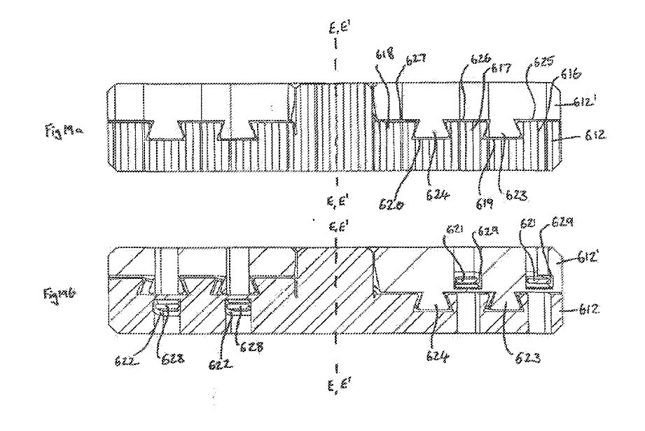

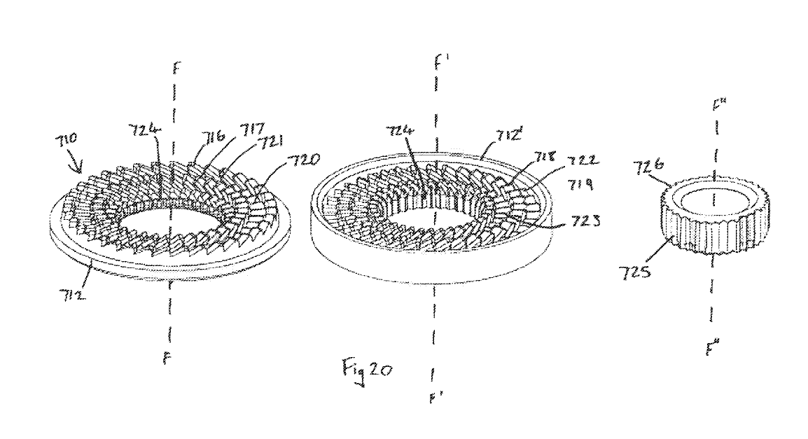

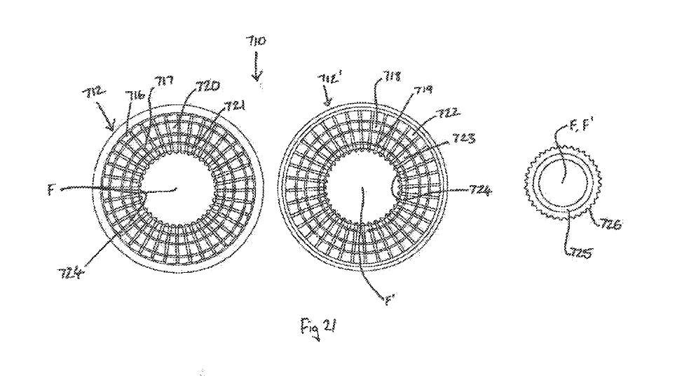

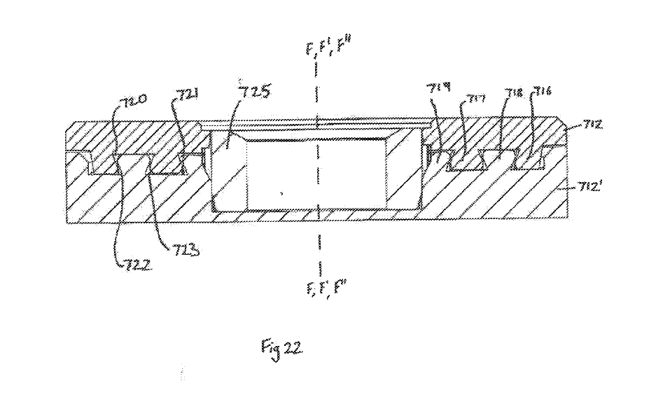

An example of a connector 710 having a separate locking device is shown in FIGS. 20 to 22.

The connector 710 has two connecting parts, 712, 712′, each having a connecting face which is substantially transverse to a longitudinal axis F, F′ of the respective part 712, 712′. The connecting face of each part 712, 712′ has a plurality of engagement formations 716, 717, 718, 719. The engagement formations 616-620 are annular and concentric about the respective longitudinal axis F, F′. Each engagement formation 716-719 has a plurality of segments, each of which has a substantially helicoidal upper surface. In the example shown, each engagement formation 716-719 includes thirty-six segments, such that the connector 710 is a thirty-six pick up point, 10° rotation connector.

Each engagement formation 716-719 of each part 710 is radially spaced from an adjacent engagement formation 716-719 by a receiving formation 720, 721, 722, 723. Each engagement formation 716-719 of each part 712, 712′ is engageable with a respective receiving formation 720-723 of the other part 712, 712′.

The pitch of the engagement formations 716-719 and the receiving formations is relatively large, for example the pitch may be 180 mm. As a result of this and the fact that the degree of rotation required to achieve full engagement is relatively small, it is possible for the two parts 712, 712′ to engage one another under gravity, without any external rotational force having to be applied to the two parts 712, 712′.

Each part 712, 712′ is substantially annular and has an inner circumference which includes a locking formation 724. In the example shown, the locking formation 724 includes a plurality of splines or teeth, which are provided in a zig-zag configuration. The splines extend radially inwardly from the inner circumferences of the two parts 712, 712′. The locking formations 724 of the two parts 712, 712′ lie adjacent one another, one above the other, when the two parts 712, 712′ are fully engaged with one another.

The connector 710 also includes a locking device 725 which is substantially circular, and this case is annular. The locking device has a substantially longitudinal axis F″. A nominal outer circumference of the locking device 725 is substantially the same as a nominal inner circumference of each of the parts 712, 712′, such that a push fit engagement between the locking device 725 and the two parts 712, 712′ is permitted. The outer circumference of the locking device 725 includes a second locking formation 726, which is engageable with the locking formations 724 of the two parts of the connector 712, 712′.

The second locking formation also includes a plurality of splines or teeth in a zig-zag configuration, which are engageable with the splines of the locking formations 724 of the first part 712 and the second part 712′. The splines of the locking device 725 extend generally outwardly from the outer circumference of the locking device 725.

Once the two parts 712, 712′ of the connector 710 are engaged with one another, by rotation of the two parts 712, 712′ relative to one another, the locking device 725 is receivable through the centres of the two annular parts 712, 712′. The locking device is slidable in a generally longitudinal direction, through the connected parts 712, 712′, by off-setting the teeth of the locking formations 724 from the teeth of the locking formation 726 of the locking device 725. The height of the locking device 725 is such that it is simultaneously engageable with the first part 712 and the second part 712′ of the connector 710.

The teeth of the interlocked locking formations 724, 726 prevent or inhibit rotation of the two parts 712, 712′ with respect to one another, thus preventing or inhibiting disconnection of the two parts 712, 712′. If it is subsequently desired to disconnect the two parts 712, 712′, then the locking device 725 is slidable out of engagement with one or both of the parts 712, 712′ to enable the two parts to rotate in a direction opposite to that which causes engagement of the two parts 712, 712′. If it is desired to permanently connect the two parts together, the locking device 725 may be adhered to the two parts 712, 712′ of the connector 710.

Minimal rotation is required to engage and disengage the parts of the connector, and therefore is quick to use. Therefore, such a connector may be used in a fire extinguisher or gas cylinder bracket, where a strong connection is required, but a quick release mechanism is also required.

This embodiment of the invention may be particularly useful in hanging pictures or other wall mounted objects, as it is possible to achieve engagement by the application of an axial load.

Whilst each of the embodiments is described above as having an engagement formation and a receiving formation including a plurality of sectors, wherein each of the sectors has a substantially helicoidal surface, each sector may have a substantially flat surface, wherein together, the sectors of each engagement formation or receiving formation describe a substantially helicoidal connecting face. Such a connector is shown in FIGS. 23 to 25.

A connector 810 has a first part 812 and a second part 812′, each of which has a respective longitudinal axis G, G′. The first part 812 includes a connecting face which extends substantially transversely relative to the longitudinal axis G. The connecting face includes an engagement formation 814 which has a substantially helicodial surface. It will be appreciated that the connecting face may include a plurality of engagement formations which may be arranged substantially concentrically. The engagement formation 814 includes a plurality of segments. Each segment has a substantially flat surface which is substantially transverse to the longitudinal axis G. However, the segments are stepped, such that each successive segment is at a slightly different height. Together the segments form a substantially helicoidal upper surface of the engagement formation 814.

The second part 812′ includes a receiving formation 816, with which the engagement formation 814 of the first part 812 is engageable, by rotation of the first and second parts 812, 812′ relative to one another. The receiving formation includes a connecting face which extends substantially transversely relative to the longitudinal axis G′. Similarly to the engagement formation 814 of the first part 812, the receiving formation 816 includes a plurality of segments, each of which has a substantially flat lower surface which extends generally transversely to the longitudinal axis G′, and each of which is a different height from adjacent segments such that a lower surface of the receiving formation 816 is substantially helicoidal. The lower surface of the receiving formation and the upper surface of the engagement formation 14 are ‘stepped’.

Advantages of this embodiment of the invention are that the interaction of the ‘steps’ at the junctions of adjacent sectors of the engagement formation 814 and the receiving formation 816 inhibits or prevents disengagement of the two parts particularly under a load applied in a substantially axial direction. Removal of the load reduces the amount by which the steps of the engagement formation 814 and the receiving formation 816 impinge on one another, and rotation of the two parts 812, 812′ relative to one another to enable disengagement is possible.

This embodiment of the invention may be particularly useful in the fixing of heavy loads for transportation. The downward force applied to the connector during use inhibits disengagement of the two parts of the connector, thus holding the load in position relative to a surface of a transportation vehicle.

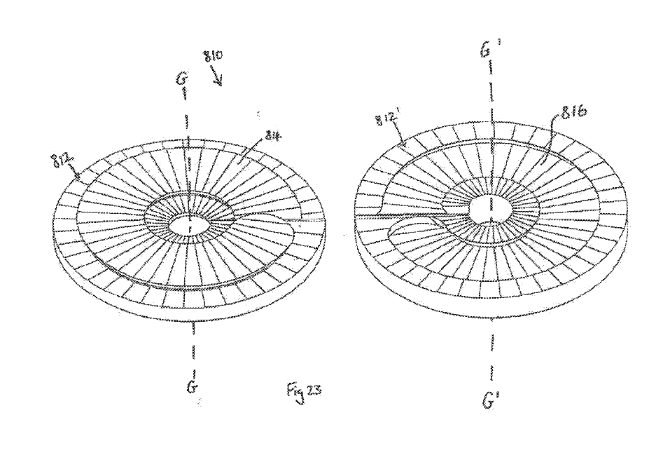

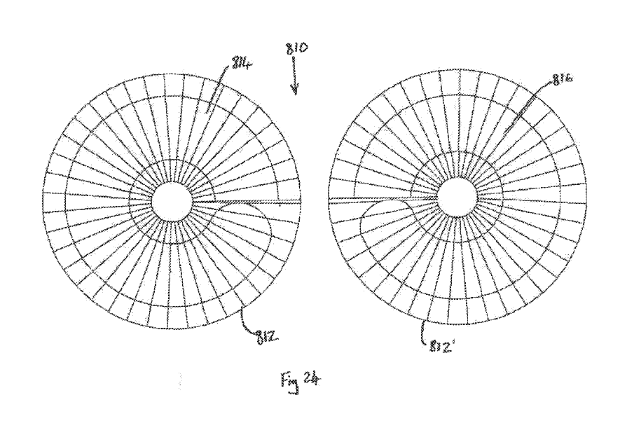

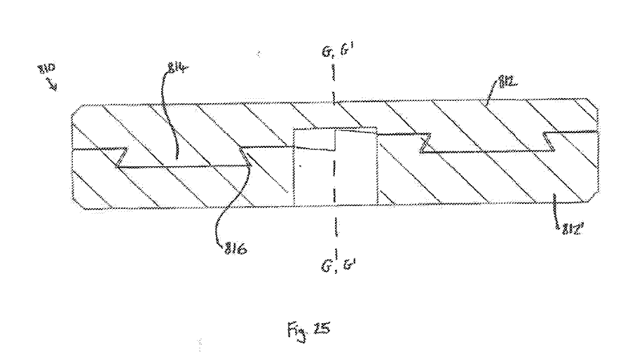

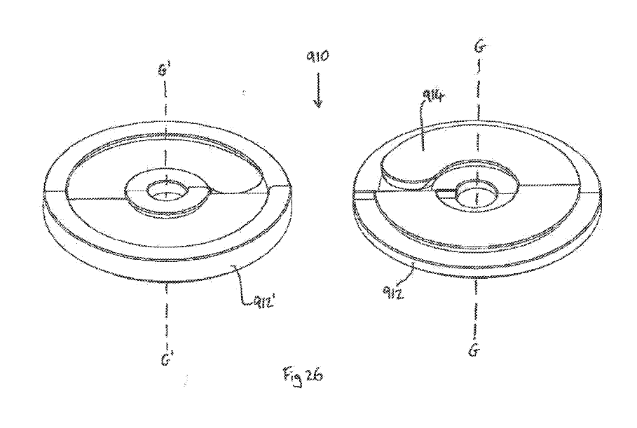

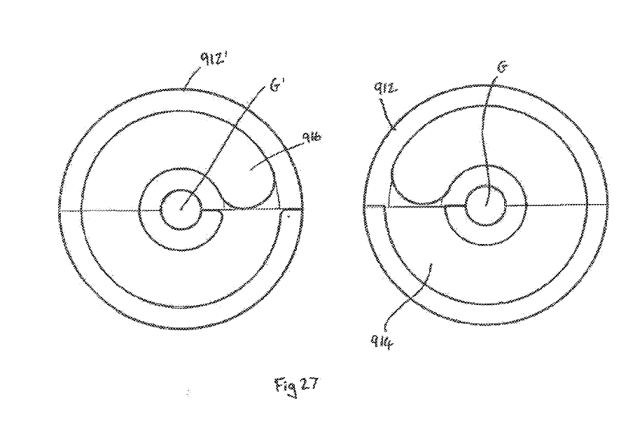

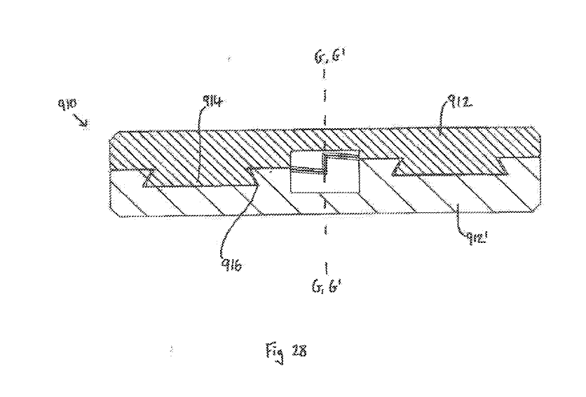

A simpler embodiment of the connector 810 is shown generally at 910 in FIGS. 26 to 28. The connector 910 is similar in the majority of aspects to the connector 810, and similar parts are given similar numbers, but prefixed with a ‘9’, instead of an ‘8’ The engagement formation 914 of the first part does not include a plurality of sectors and has a smooth, substantially helicoidal surface. Similarly, the receiving formation 916 does not include segments and has a smooth, substantially helicoidal lower surface, with which the engagement formation 914 of the first part 912 is engageable.

The connectors 810 and 910 described and shown in FIGS. 23 to 28 are single pick-up, 360° rotation connectors, but it will be appreciated that the engagement formations and the receiving formations may include segments which are stepped in such a way as to provide an alternative number of pick-up points and to alter the angle through which the two parts 812, 812′ have to be rotated relative to one another to achieve full engagement. The number of segments provided may be selected as appropriate.

The connectors 810, 910 provide relatively strong connections, owing to the need to rotate the parts through 360° to achieve full engagement and, subsequently, disengagement. Therefore, it is difficult to inadvertently disengage the two parts. These connectors may be particularly useful in attaching ceiling roses or other fittings to ceilings or walls.

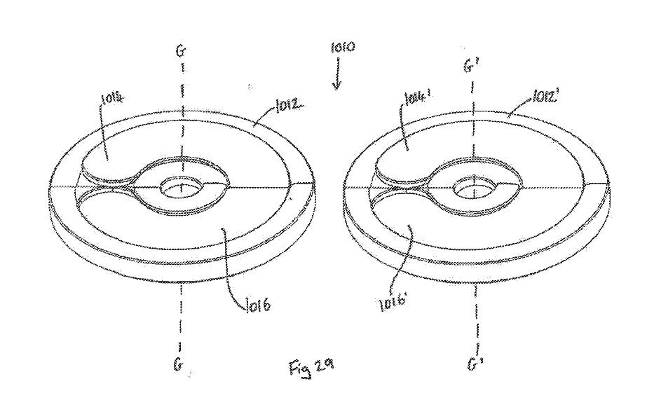

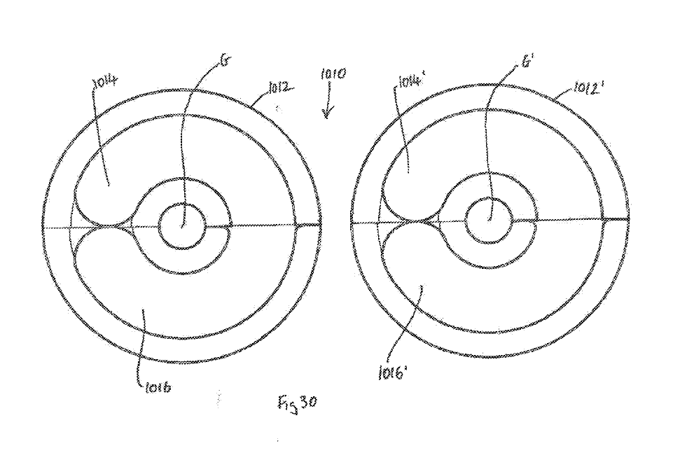

An alternative embodiment to the connectors 810, 910 is shown at 1010 in FIGS. 29 to 31. The connector 1010 is similar to connectors 810, 910 and features which are similar have similar reference numerals, preceded with ‘10’ rather than ‘8’ or ‘9’. The connector 1010 differs from the connectors 810 and 910 in that the two parts 1012, 1012′ of the connector 1010 are identical to one another.

Each part 1012, 1012′ has a connecting face which extends substantially transversely to a respective longitudinal axis G, G′. Each connecting face includes a respective engagement formation 1014, 1014′ and a respective receiving formation 1016, 1016′. The engagement formation 1014 of the first part 1012 is receivable in the receiving formation 1016′ of the second part 1012′ and vice versa.

The connector 1010 is ‘hermaphroditic’, and hence is also similar to the first connector 10 described above, but each part has only a single engagement formation 1014, 1014′ and a single receiving formation 1016, 1016′, rather than having a plurality of concentric engagement formations and receiving formations.

An advantage of ‘hermaphroditic’ connectors is that only a single moulding tool is required for manufacture. The single formation embodiment 1010 is relatively simple, and can be used where a particularly strong connection is not required, for example to connect fabric together, for example in lieu of a button or other fastener in clothing.

A further embodiment of the invention is shown in FIGS. 32 to 34. A connector is shown generally at 1110. The connector 1110 has two parts 1112, 1112′, each of which has a respective longitudinal axis H, H′. The two parts 1112, 1112′ are substantially annular.

The first part 1112 includes a connecting face which extends generally transversely to the longitudinal axis H and includes an engagement formation 1114. The engagement formation 1114 is similar to that of the connector 910, in that it is substantially annular, and has a substantially helicoidal upper surface. The engagement formation has a first end and a second end. The engagement formation 1114 has generally circular side walls which are curved.

The second part 1112′ also has a connecting face which extends generally transversely to the longitudinal axis H′. The connecting face of the second part 1112′ includes a receiving formation 1116, in which the engagement formation 1114 of the first part 1112 is receivable.

The receiving formation 1116 has a substantially helicoidal lower surface, to abut the upper substantially helicoidal surface of the engagement formation 1114 of the first part 1112. The receiving formation 1116 of the second part 112′ is defined by an inner wall 1118 and an outer wall 1120, each of which is substantially annular. Each wall 1118, 1120 has an upper surface which is substantially helicoidal. Each of the inner wall 1118 and the outer wall 1120 includes a plurality of circumferentially spaced portions 1118a, 1120a, the upper surface of each of which is substantially helicoidal. However, it will be appreciated that the upper surface of each portion 1118a, 1120a may be substantially flat, and generally transverse to the respective longitudinal axis H, H′, but a different height to adjacent portions 1118a, 1120a, such that together the upper surfaces of the portions define a substantially helicoidal upper surface.

Each portion 118, 1120 of each wall 1118, 1120 includes a lip 1118b, 1120b, which is positioned at an upper end of the respective wall 1118, 1120. The lip 1118b of each portion 1118a of the wall 1118 extends generally radially outwardly, and the lip 1120b of each portion 1120a of the wall 1120 extends generally radially inwardly.

In use, the first part 1112 of the connector 1110 is engageable with the second part 1112′ by virtue of a ‘push-fit’, when the axes H, H′ are aligned. Since the walls 1118, 1120 of the second part 1112′ include a plurality of portions, the walls 1118, 1120 are able to flex, and the engagement formation 1114 can be pushed in a generally longitudinal direction into the receiving formation. Full engagement is achieved when the first end of the engagement formation 1114 abuts a first end of the receiving formation 1116, such that the upper surface of the engagement formation 1114 contacts the lower surface of the receiving formation 1116 around the entire circumference of the connector 1110. The lips 1118b, 1120b of the walls 1118, 1120 engage the curved walls of the engagement formation to inhibit the two parts of the connector 1110 being inadvertently pulled apart, or falling apart.

One or both of the parts 1112, 1112′ may be made of an elastomeric material to aid the connection of the two parts 1112, 1112′, by making the engagement formation 1114 and/or the walls 1118, 1120 flexible.

In order to disengage the two parts 1112, 1112′, the parts 1112, 1112′ are rotated relative to one another, through almost 360° such that the first end of the engagement formation 1114 is adjacent the second end of the receiving formation 1116. This lifts the engagement formation 1114 out of the receiving formation 1116 slightly (by an amount which is equivalent to the pitch of the helix), so that the two parts 1112, 1112′ can more easily be pulled apart. An advantage of the push-fit arrangement is that an audible indication that engagement has been achieved is provided.

A further embodiment of the invention is shown in FIGS. 35 to 37 at 1210. The connector 1210 has a first part 1212 and a second part 1212′ which are engageable with one another. The two parts 1212, 1212′ have respective longitudinal axes I, I′.

The first part 1212 has a connecting face which extends generally transversely relative to the longitudinal axis I. However, the connecting face of the first part 1212 is substantially frusto-conical. The first part 1212 is the male part of the connector 1210.

The connecting face of the first part 1212 includes a plurality of engagement formations. In the example shown, the first part includes two engagement formations 1216, 1217; however, it will be appreciated that any number of engagement formations may be provided. Each engagement formation 1216, 1217 is substantially annular and includes a plurality of sectors, in this example, three sectors X, Y, Z. The engagement formations 1216, 1217 are concentric about the longitudinal axis I. An upper surface of each sector of each engagement formation 1216, 1217 is a partial helicoid. Each engagement formation is substantially trapezoidal in cross-section.

The first part 1212 includes a plurality of receiving formations 1218, 1219, 1220 which are positioned adjacent the engagement formations 1216, 1217. Each receiving formation 1218, 1219, 1220 is substantially annular and includes a plurality of sectors X, Y, Z. A lower surface of each sector X, Y, Z of each receiving formation is a partial helicoid. Each receiving formation 1218, 1219, 1220 is substantially trapezoidal in cross section, so as to enable engagement with an engagement formation of the second part 1212′.

The second 1212′ part is not identical to the first part 1212. The second part 1212′ has an inverted substantially frusto-conical connecting face which extends generally transversely to the longitudinal axis I′. The second part 1212′ is the female part of the connector 1210. The second part 1212′ includes three engagement formations 1221, 1222, 1223, each of which is substantially annular and includes three sectors X, Y, Z. The engagement formations 1221-1223 of the second part 1212′ are engageable with the receiving formations 1218-1220 of the first part 1212, and are substantially trapezoidal in cross-section. The second part 1212′ also includes two receiving formations 1224, 1225 which are engageable with the engagement formations 1216, 1217 of the first part 1212. Each of the receiving formations is substantially annular and includes three sectors X, Y, Z. Each sector X, Y, Z of each receiving formation 1224, 1225 has a lower surface which is a partial helicoid.

Since the engagement formations 1216, 1217, 1221, 1222, 1223 and the receiving formations 1218, 1219, 1220, 1224, 1225 of the connector 1210 include three sectors, the connector 1210 is a three pick up point, 120° rotation connector 1210. The frusto-conical arrangement of the two parts 1212, 1212′ aids initial alignment of the longitudinal axes I, I′, and aids engagement of the two parts 1212, 1212′. This type of connector may be particularly useful in hose connectors or fixings for fence posts, for example, where positioning of the two objects to be connected together is important.

It will be appreciated that the two connecting faces of the respective parts 1212, 1212′ may have shapes other than a frusto-conical shape (e.g., conical, convex, curved), and that any number of engagement formations and receiving formations may be provided.

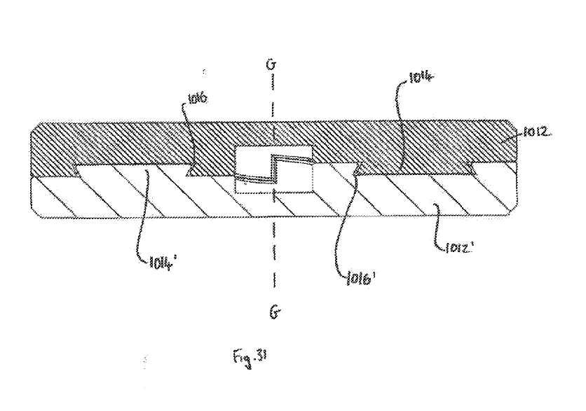

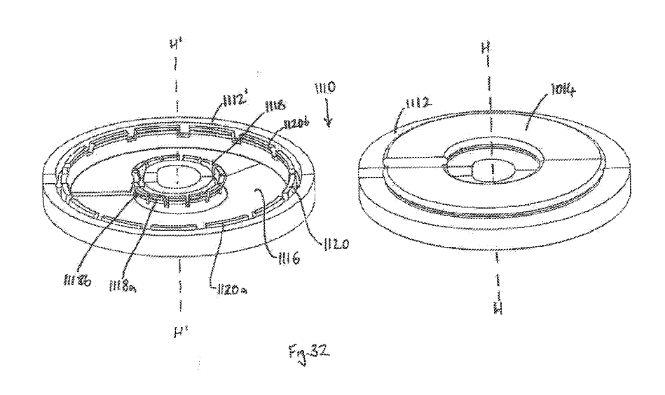

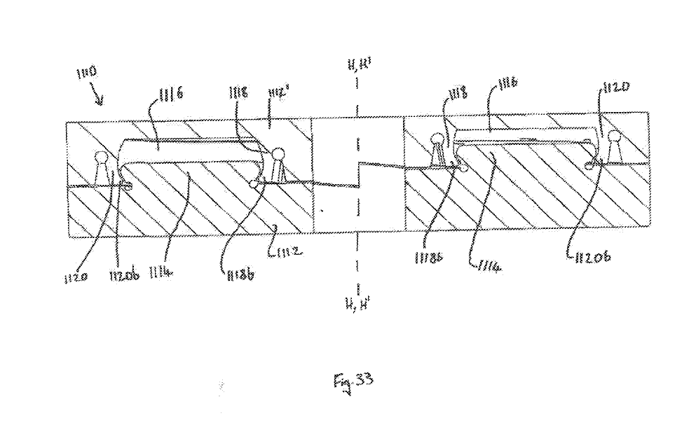

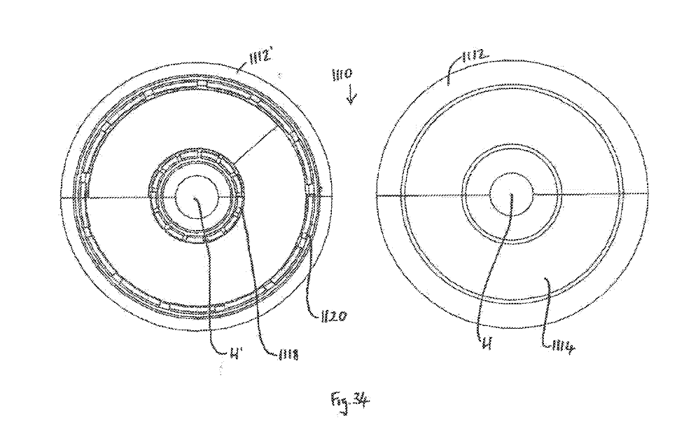

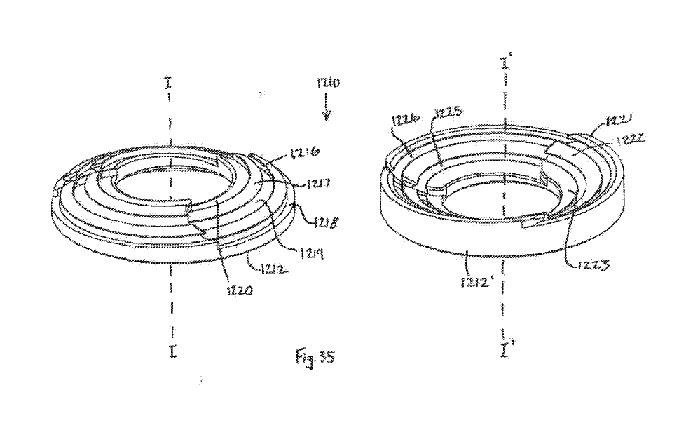

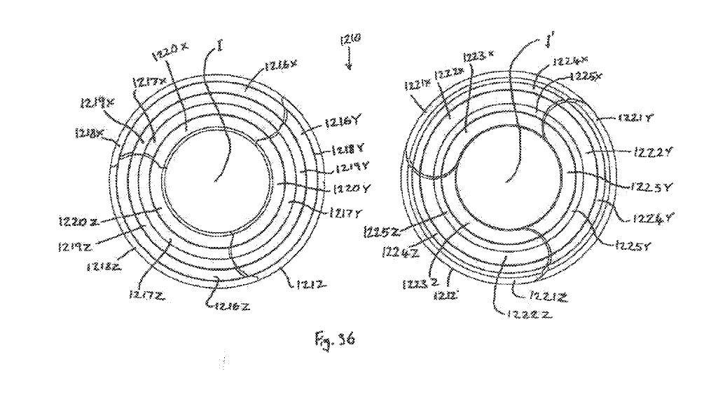

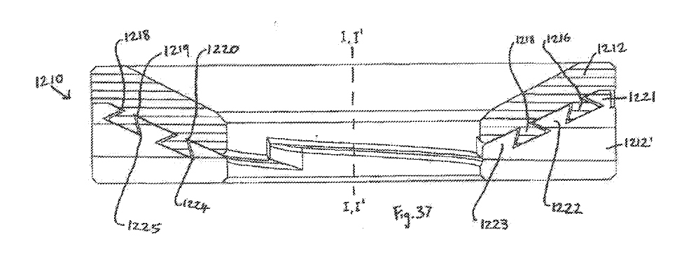

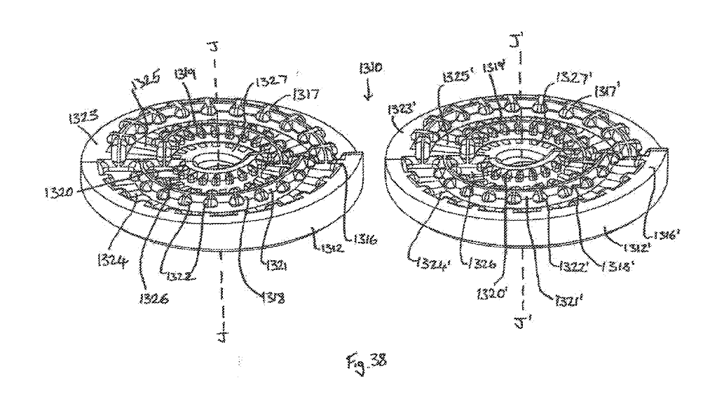

A further embodiment of the invention is shown at 1310 in FIGS. 38 to 40.

The connector 1310 has two parts 1312, 1312′ which are identical to one another. Each part 1312, 1312′ has a respective longitudinal axis J, J′ and a connecting face which extends generally transversely relative to the respective longitudinal axis J, J′. The connector 1310 is similar to that shown in FIGS. 1 to 3 in that the connector is a 180° rotation, single pick up point connector.

Each part includes a plurality of engagement formations 1316, 1317, 1318, 1319, 1320, 1316′, 1317′, 1318′, 1319′, 1320′. Whilst in the present example, each part 1312, 1312′ includes five engagement formations, it will be appreciated that any number of engagement formations may be provided as required. Each engagement formation 1316-1320, 1316′-1320′ is substantially semi-annular and has a first end and a second end. The first end 1316a and the second end 1316b of engagement formation 1316 are illustrated in FIG. 38. The first end of each successive engagement formation 1316-1320, 1316′-1320′ is positioned adjacent the second end of the adjacent engagement formation 1316-1320, 1316′-1320′, and is spaced radially therefrom. Thus, the positions of the engagement formations 1316-1320, 1316′-1320′ alternate between sides of the connecting face of the respective part 1312, 1312′.

Each engagement formation has a substantially helicoidal upper surface such that the first end of each engagement formation 1316-1320, 1316′-1320′ extends axially outwardly from a base of the connecting face of the respective part 1312, 1312′ more than the second end of the engagement formation 1316-1320, 1316′-1320′. Alternatively, it will be appreciated that the base of the connecting face, may he substantially helicoidal, and each engagement formation 1316-1320, 1316′-1320′ may be the same height along its entire length between the first end and the second end, such that the upper surface of the engagement formation is substantially helicoidal. Each engagement formation describes a partial helicoid.

Each engagement formation 1316-1320, 1316′-1320′ includes a body 1321, 1321′ which extends substantially axially upwardly from the connecting face of the respective part 1312, 1312′. Each body is generally semi-circular in cross-section. Each engagement formation 1316-1320, 1316′-1320 also includes a plurality of projections 1322, 1322′ which extend radially from an upper part of each body 1321, 1321′. The projections 1322, 1322′ are circumferentially spaced along the respective engagement formation 1316-1320, 1316′-1320′. The outermost engagement formation 1316, 1316′ has projections 1322, 1322′ which extend only radially outwardly from the body 1321, 1321′ of the engagement formation 1316, 1316′ and the innermost engagement formation 1320, 1320′ has projections 1322, 1322′ which extend only radially inwardly from the body of the engagement formation 1320, 1320′. The remaining engagement formations 1317-1319, 1317′-1319′ have projections which extend radially outwardly and projections which extend radially inwardly, such that each of the engagement formations 1317-1319, 1317′-1319 has a T-shaped cross section at each point where the projections 1322, 1322′ extend from the respective body 1321, 1321′.

In the example shown, the bodies 1321, 1321′ and the projections 1322, 1322′ are curved, but it will be appreciated that any shape may be selected as appropriate.

Each part 1312, 1312′ includes a plurality of receiving formations 1323, 1324, 1325, 1326, 1327, 1323′, 1324′, 1325′, 1326′, 1327′. Each receiving formation 1323-1327, 1323′-1327 has a first end and a second end, as illustrated with respect to the receiving formation 1324 of the first part 1312 in FIG. 38. Each receiving formation 1323-1327, 1323′-1327 is substantially semi-annular and has a substantially helicoidal lower surface, for receiving a corresponding receiving formation of the other part 1312, 1312′ of the connector 1310. The first end of each receiving formation 1323-1327, 1323′-1327′ is positioned adjacent the second end of an engagement formation 1316-1320, 1316′-1320′ which is radially aligned with the receiving formation 1323-1327, 1323′-1327′. Thus considering an annulus of the connecting face, half of the annulus is an engagement formation 1316-1320, 1316′-1320′ and the other half of the annulus is a corresponding receiving formation 1323-1327, 1323′-1327′.

In use, the two parts 1312, 1312′ of the connector 1310 are positioned such that their axes J, J′ are aligned. The first end of each engagement formation 1316-1320, 1316′-1320 is positioned adjacent the first end of the corresponding receiving formation 1323-1327, 1323′-1327′ of the opposite part 1312, 1312′, and the two parts 1312, 1312′ are rotated relative to one another through 180°, until the first end of each engagement formation 1316-1320, 1316′-1320′ is positioned circumferentially adjacent the corresponding engagement formation 1316-1320, 1316′-1320′ of the opposite part 1312, 1312′ of the connector 1310. In this configuration, the two parts 1312, 1312′ are fully inter-engaged. Since the projections 1322, 1322′ of the engagement formations 1316-1320, 1316′-1320′ are positioned towards an upper end of the respective body 1321, 1321′, there is a clearance between an underside of each projection 1322, 1322′ and the respective connecting face. The radially extending projections 1322, 1322′ of each engagement formation 1316-1320, 1316′-1320′ are able to slide beneath the projections 1322, 1322′ of the radially adjacent engagement formations 1316-1320, 1316′-1320′ of the opposite part 1312, 1312′.

The provision of surfaces which are discontinuous, by virtue of the radially extending projections, enables the material used in the manufacture of such a connector to be reduced, therefore the cost of production and the weight of the connector are both reduced. The production tool required to manufacture such a connector is simpler than that required for the other embodiments of the invention, since the tool itself need not be helicoidal. The connecting faces of the connector may be aesthetically pleasing owing to the configuration of the bodies 1321, 1321′ and the projections 1322, 1322′. It is also possible to control friction and torque acting between the two parts 1312, 1312′ of the connector 1310 by virtue of the use of an underside of each engagement formation 1316-1320, 1316′-1320′ as well as the upper surface which engages the lower surface of the corresponding receiving formation 1323-1327, 1323′-1327′.

Such a connector may be particularly useful in hanging pictures, decorations or electrical fittings to upright surfaces, such as walls.

A further embodiment of the invention is shown in FIGS. 41 to 43. The connector 1410 is a 90° rotation connector, but has only a single pick-up point. A first part 1412 of the connector 1410 has four engagement formations 1416, 1418, 1420, 1422, which extend upwardly from a connecting face of the first part 1412. Each engagement formation has a different cross-sectional shape. Engagement formation 1416 is substantially T-shaped in cross section, engagement formation 1418 is substantially hexagonal and has an apex on its upper surface, engagement formation 1420 is substantially trapezoidal in cross-section, and engagement formation 1422 is substantially circular in cross section.

A second part 1412′ of the connector 1410 has four corresponding receiving formations 1424, 1426, 1428, 1430, each of which corresponds with one of the engagement formations 1416, 1418, 1420, 1422 of the first part 1412. Since the engagement formations 1416-1422 and the receiving formations 1424-1430 have corresponding cross sections, it is not possible to engage the first part 1412 with the second part 1412′ unless each engagement formation 1416-1422 is positioned adjacent the corresponding receiving formation 1424-1430 of the second part 1412′.

It will be appreciated that additional or alternative engagement formations and receiving formations may be provided, and any suitable cross-sectional shape may be provided. Concentric engagement formations and receiving formations may be provided as required to strengthen the connection between the parts 1412, 1412′.

This embodiment of the invention may be used as a lock, or as an educational toy, for example.

The connector may be used as a clamp, wherein an object may be clamped between two parts of the connector. For example a relatively thin material may be inserted between the two parts of the connector, such that interengagement of the two parts of the connector is still possible.

An example of a clamp is shown in FIG. 44. A clamp 1510 has two parts 1512, 1512′. The first part 1512 has an engagement formation 1516 including a substantially helicoidal upper surface. The second part 1512′ has a receiving formation 1518 for engaging with the engagement formation 1516 of the first part 1512. Each part 1512, 1512′ includes a substantially annular flange 1520 between which objects may be clamped. For example, the clamp may be used as a paper fastener, with the engagement formation engaging with the receiving formation, through apertures in the papers to be fastened together, such that the flanges 1420 abut the outermost sheets of paper, and hold the papers together.

A further embodiment of the invention is shown in FIG. 45. A connector 1610 has two parts 1612, 1612′. The first part 1612 has a plurality of engagement formations and receiving formations, similar to other embodiments of the invention described above. In addition the first part includes a pair of channels 1618, 1620 each of which extends across a connecting face of the first part 1612. Items to be clamped or held in position, for example electrical cables, are receivable in the channels 1618, 1618. The first part 1612 also includes a central spigot 1622 which extends along a longitudinal axis K. An aperture 1624 is provided in the spigot 1622, for receiving an item such as an electrical cable.

The second part 1612′ of the connector 1610 has a plurality of engagement formations and receiving formations which are engageable with the engagement formations and receiving formations of the first part 1612. The second part 1612′ is engageable with the first part 1612 so as to hold items received in the channels 1618, 1620 of the first part in position. The engagement formations of the second part 1612′ includes grip portions 1626 on upper surfaces of the engagement formations, to grip the items received in the channels 1618, 1620.

The second part 1612′ includes a central aperture 1628 which extends along a substantially longitudinal axis 1628 of the second part 1612′, in which the spigot 1622 of the first part 1612 is receivable.

Each of the first part 1612 and the second part 1612′ includes a pair of diametrically opposed gripping formations 1630, which assist manual manipulation of the two parts 1612, 1612′, particularly for engagement and disengagement of the two parts 1612, 1612′. The gripping formations 1630 include indents, and a plurality of ridges which increase friction between each part 1612, 1612′ and a user's hand or a tool which is used to engage and disengage the two parts 1612, 1612′.

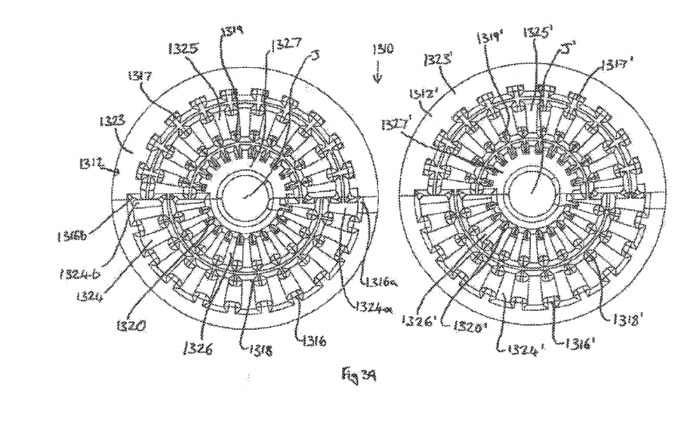

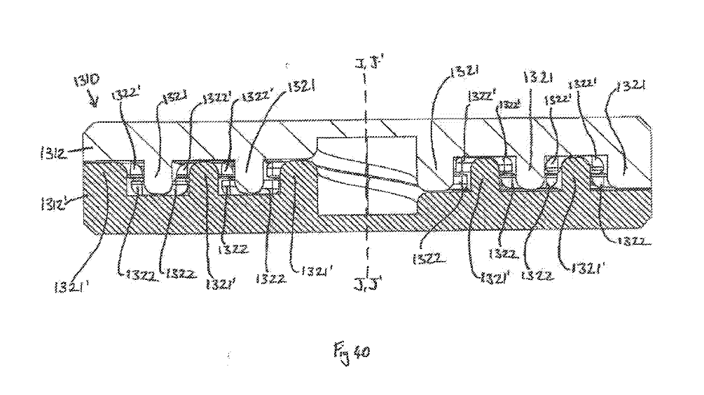

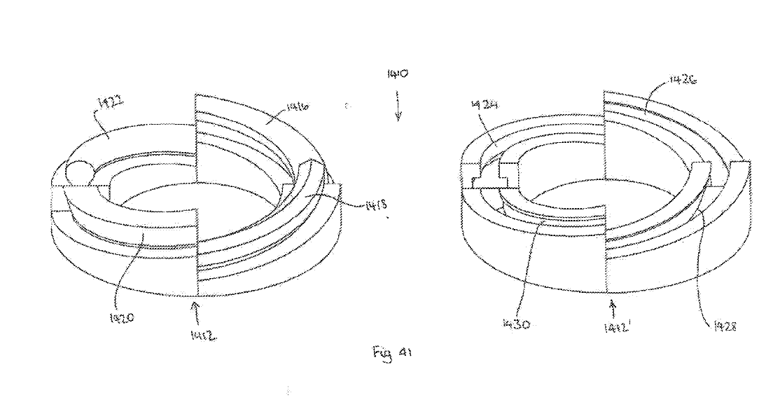

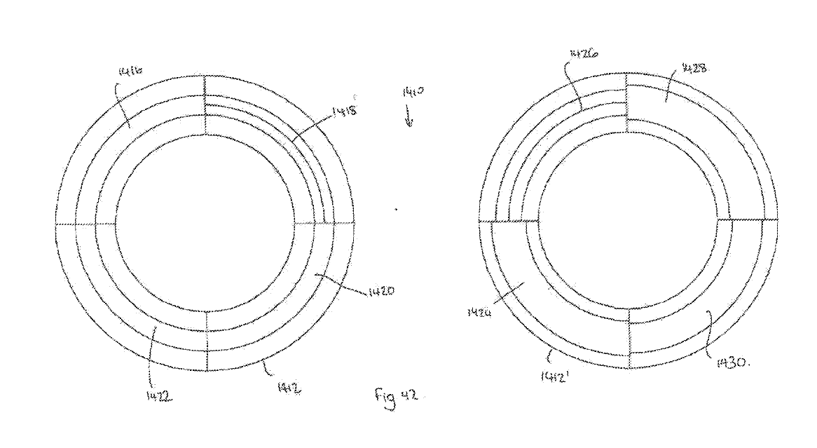

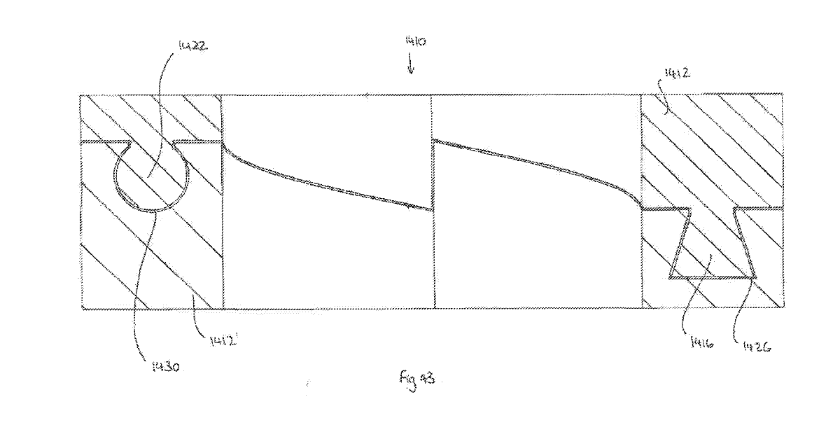

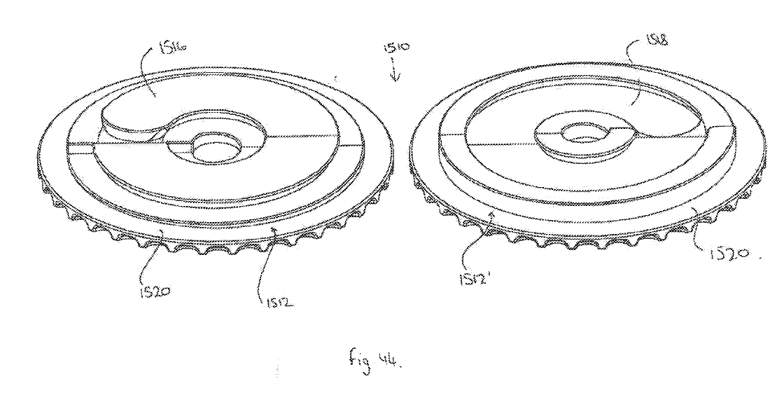

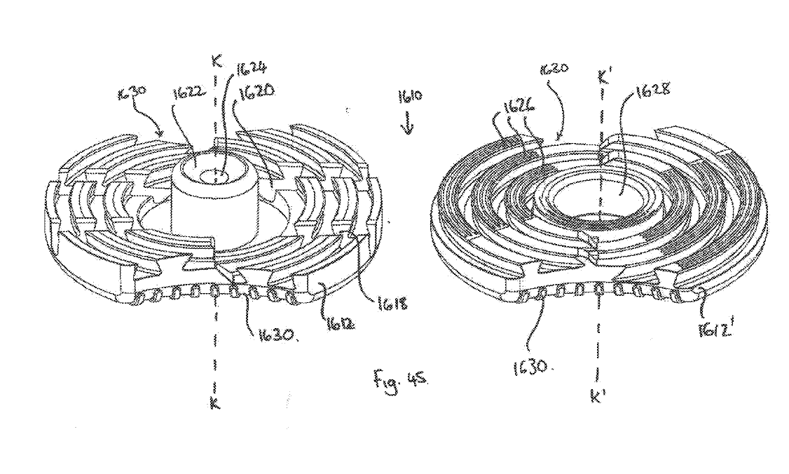

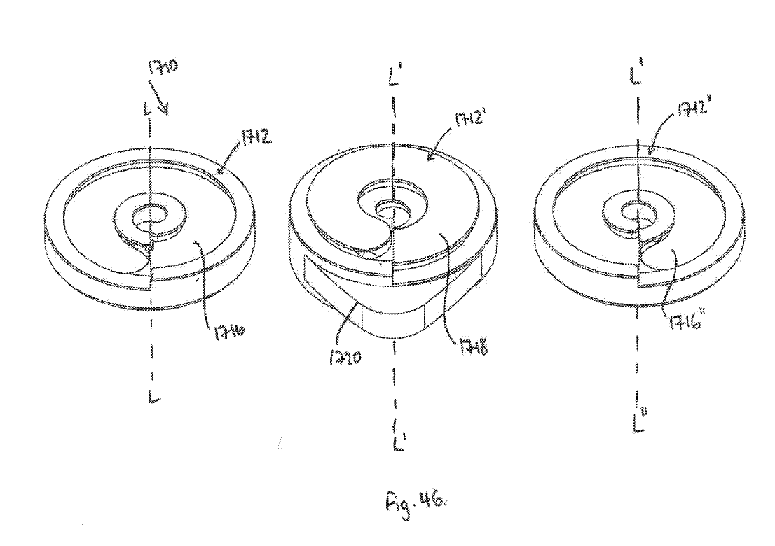

A further embodiment of the invention is shown in FIGS. 46 and 47. A connector 1710 has three parts 1712, 1712′, 1712″. The first part 1712 and the third part 1712″ are similar, and both inter-engage with an intermediate part 1712′.

Each of the first part 1712 and third part 1712″ includes a receiving formation 1716, 1716″ which has a substantially helicoidal lower surface, and is engageable with an engagement formation 1718 of the intermediate part 1712′. The receiving formations 1716, 1716′ extend in opposite directions.

The intermediate part 1712′ has two connecting faces, each of which extends substantially transversely to a longitudinal axis L′ of the intermediate part 1712′. Each connecting face includes an engagement formation 1718. The intermediate part 1712′ also includes a projection 1720 which extends generally radially outwardly from the intermediate part 1712′.

The first part 1712 and the third part 1712″ are attachable to items to be connected together. The intermediate part 1712′ is then engageable with both the first part 1712 and the third part 1712″, by virtue of the engagement formations 1718 engaging with the receiving formations of the first part 1712 and the third part 1712″. A user may grasp the projection 1720 and rotate the intermediate part 1712′ relative to the first part 1712 and the third part 1712″, such that the items to which the first part 1712 and the third part 1712″ are attached do not have to rotate relative to one another to achieve connection of the two items. The fact that the engagement formations 1718 extend in opposite senses and the receiving formations of the first part 1712 and the third part 1712″ extend in opposite senses enables such a connection to occur.

It will be appreciated that the engagement formations 1718 may be provided on the first part 1712 and the third part 1712″ and the receiving formations 1716, 1716″ may be provided on the intermediate part 1712′. Any number of engagement formations and receiving formations may be provided, as required.

Each part of each connector may be engageable with a plurality of other parts. Such a connector is shown in FIG. 48. The connector includes a first part 1812 which has a receiving formation 1820, as described above, and a plurality of secondary parts, 1814, 1816, 1818, each including at least one engagement formation which is engageable with the receiving part 1820 first part 1812. Each secondary part 1814, 1816, 1818 may be substantially arcuate, such that the secondary parts 1814, 1816, 1818 are engageable individually with the first part 1812 of the connector 1810 to complete a full circle. Additionally or alternatively, each secondary part may be substantially annular, such that a plurality of secondary parts may be individually engaged with the first part 1812, such that the secondary parts 1814, 1816, 1818 are radially spaced relative to one another.

Alternatively, the connector may include a first part of the connector which has a plurality of engagement formations and receiving formations, as described above, and a plurality of secondary parts, each including at least one receiving part which is suitable for receiving an engagement formation of the first part. It will be appreciated that any number of engagement formations and receiving formations and any number of secondary parts may be provided.

The engagement formations of a connector may be hollow, such that the end face of the or each engagement formation is an opening, such that one part of the connector can “self-tap” into a relatively soft material, for example plasterboard. Such a connector is shown in FIGS. 49 and 50. The connector 1910 includes two parts 1912, 1912′, and is similar in most respects to the connector 610, except that each engagement formation of the first part 1912 is substantially hollow. Each engagement formation of the first part 1912 includes a tapping formation 1920 at a first end of the respective engagement formation. Each tapping formation 1920 is preferably a point which is able to dig into a relatively soft material. The engagement formations of the first part 1912 are then able to dig into the material, by following the groove made by the respective tapping formation 1920.

The second part 1912′ is then engageable with the first part 1912, as shown in FIG. 51, by virtue of the engagement formations of each part 1912, 1912′ engaging with the corresponding engagement formations and receiving formations of the other part 1912, 1912′ as described above.

This connector provides a strong connection, as a large surface area of the connector is frictionally engaged with the relatively soft material, yet the connector does not penetrate deeply into the material. Furthermore, the connector 1910 does not extend very far, or at all, outwardly from the surface into which it has been inserted.

The connectors 10, 110, 210, 310, 410, 610, 710, 810, 910, 1010, 1110, 1210, 1310, 1410, 1510, 1610, 1710, 1810, 1910, may be any size appropriate to the objects being connected together. The sizes of connectors of the kind described herein may range between nanoscale and of the order of metres. Large scale connectors of the kind described herein may be used in construction of buildings and the like. Where certain embodiments of the invention have been described as being useful for particular applications, this is not intended to be limiting, since any of the embodiments may be used in any application, as is deemed appropriate.

It will be appreciated that full engagement may not be required in all applications, and that full engagement may be inhibited, as a safety feature, or to enable checking of the connection, with full engagement being accomplishable by certain trained or qualified personnel, for example. Use of a specific tool to effect engagement may be necessary.

Each part of each connector 10, 110, 210, 310, 410, 610, 710, 810, 910, 1010, 1110, 1210, 1310, 1410, 1510, 1610, 1710, 1810, 1910 may be attachable to an object to be attached to another object. However, one or both parts of each connector 10, 110, 210, 310, 410, 610, 710, 810, 910, 1010, 1110, 1210, 1310, 1410, 1510, 1610, 1710, 1810 1910, may be integrally formed with an object which is to be connected to another object.

It will be understood that more than one connector may be used, in order to connect more than two items together, for example to connect together a plurality of items which overlie one another, so as to “stack” a plurality of items together. The longitudinal axes of the connectors are substantially aligned in such an arrangement. The connector 1710 is an example of a connector which may enable such stacking of items.

The connectors described above have engagement formations and receiving formations having substantially uniform cross-sections. Alternatively one or more engagement formations and/or receiving formations may include “cut away” portions, such that the cross-section of the engagement formations/receiving formations varies along its length. Additionally or alternatively one or more engagement formations and/or one or more receiving formations may include a projection or enlarged portion to increase frictional engagement between two parts of the connector.

In the examples shown and described above, both circumferential walls of each engagement formations are engaged by circumferential walls of adjacent receiving formations of the other part of the connector (although this may not be the case for an innermost or outermost engagement formations). Providing one or more cut away portions in an engagement formation enables the engagement formation to engage only one circumferential wall of a receiving formation of the other part of the connector. A cut away portion may extend along part of or the entire length of an engagement formation.

The geometry of each embodiment of the device may be generated by the application of a formula:

H×S=P

wherein:

H=the height of the engagement formation (from a base of the connecting face);

S=the number of segments (i.e. a division of 360 degrees); and

P=the pitch of the helicoid.

The selection of a particular geometry may be driven by H, S or P.

A base part of each part of each device may be any shape as is appropriate to the application in which the device is to be used. For example the base from which the connecting face of each part extends may be flat, frusto-conical, or substantially helicoidal.

It will be appreciated that there are alternative methods for generating connector geometries.

### SUPPLEMENTAL LIST OF REFERENCE NUMBERS

The following numbers apply particularly to FIG. 51 onwards, and are generally prefixed with the figure number in which the part is shown.
1. FIRST PART OF CONNECTOR, APPARATUS OR DEVICE
2. SECOND PART OF CONNECTOR, APPARATUS OR DEVICE
3. ENGAGEMENT FORMATION
4. RECEIVING FORMATION
5. FORMATION START POINT
6. FORMATION END POINT
7. BASAL SURFACE OR FORM
8a. INTERLOCKING FACE OF APPARATUS
8b. INTERLOCKING FACE OF APPARATUS
9. COMBINED FIRST AND SECOND PARTS FORMING APPARATUS
10. PROACTIVE MODIFICATION (RANGE)
11. REACTIVE MODIFICATION (RANGE)
12. RANGE OF OPERATIONAL SUBFUNCTIONALITY
2001. COMPONENT OF ACTUATION
2002. COMPRESSION SPRING OR SIMILAR BIAS SYSTEM
2003. INTERENGAGEMENT FORMATION WITH CAMMING SURFACE
2004. ROTATIONAL RANGE REQUIRED FOR INTERENGAGEMENT OR DISENGAGEMENT
2005. HEAD OF A FIXING
2006. POSITION OF EQUILIBRIUM
2007. MATING FORMATION FOR REGISTRATION “A”
2008. MATING FORMATION FOR REGISTRATION “B”
2009. STAKES FOR SWAGING
2010. SWAGED STAKES POST ASSEMBLY
2011. RESULTANT POSITION OF FORMATION START “5”
2012. POTENTIAL RANGE OF INTERENGAGEMENT
2013. CONICAL SURFACE INDEPENDENT OF INTERENGAGEMENT FORMATIONS
2014. MAGNET OR ELECTROMAGNET WITH POLARITY INDICATION
2015. CUT AWAY SECTION FROM PART
2016. CENTRAL REGISTRATION APERTURE
2017. CYLINDRICAL OR CONICAL CENTRAL REGISTRATION FORM
2018. AXIS ABOUT WHICH INTERENGAGEMENT FORMATIONS EXTEND
2019. INTERENGAGEMENT FORMATIONS WITH DIFFERING CROSS SECTIONS
2020. SNAP HOOK
2021. LOCKING OR LATCHING RECEIVING FORMATION OR APERTURE
2022. LATCH OR CATCH WITH INTEGRAL BUTTON FOR OPERATION
2023. APERTURE FOR SUBFUNCTIONAL MECHANICS
2024. ECCENTRIC ROTARY CAM
2025. AXIS OF ROTARY CAM
2026. ROTARY BEZEL
2027. EXTERNALLY THREADED COMPONENT SUCH AS A SCREW
2028. PIEZO RESTRICTIVE MATERIAL
2029. ROTARY TOOL BODY
2030. BASE MATERIAL
2031. FUSED CONNECTION TO BASAL MATERIAL
2032. BASE MATERIALS TO BE FASTENED TOGETHER
2033. CAP OR COVER FOR INTERENGAGEMENT FACES
2034. SUBSTANTIALLY HELICOIDAL THREAD
2035. FIXING DEVICE
2036. UNIFORM OR TAPERED SHAFT
2037. ROTATIONALLY ENGAGING BUT NON INTERLOCKING FORMATION
2038. SLEEVE OR SUBSTANTIALLY ANNULAR WALL FIXING
2039. EXPANDING WEDGES
2040. UNIVERSAL JOINT OR FLEXIBLE SHAFT
2041. ROD SHAFT OR AXEL
2042. METHOD OF AXIAL RESTRAINT ALLOW FREE ROTATION
2043. RADIAL, NEEDLE ROLLER, THRUST OR TAPER BEARING
2044. SURFACE TO ATTACH TO
2045. EXTERNAL MEANS OF ACTUATION ROTARY OR LINEAR
2046. BELT FOR ACTUATION/DRIVE
2047. TOOTHED SURFACE OR COG
2048. SPRING BIAS RESTRAINT OR CAPTION
2049. ROLLER
2050. “O”RING AND RETAINING ANNULUS
2051. FLANGED PIPE FITTING
2052. DEVICE FOR INHIBITING ROTATION OF APPARATUS
2053. CONTAINER, HOUSING OR ENCLOSURE
2054. FLANGE FOR CONNECTION OR BONDING TO BASAL MATERIAL
2055. SUBSTANTIALLY HOLLOW TUBULAR FORM
2056. ADAPTER, TOOL OR NOZZLE
2057. CONFORMABLE, COMPOUNDABLE OR MOULDABLE MATERIAL
2058. CURED, DRIED OR HARDENED MATERIAL
2059. RIGID TOOL BODY
2060. MOULD TOOL CAVITY
2061. RESIN COMPONENT “A”
2062. RESIN COMPONENT “B”
2063. SUCTION CUP DEVICE OR SIMILAR DIAPHRAGM
2064. INLET OR OUTLET FOR FLUID, GAS OR AIR
2065. CHECK VALVE OR SIMILAR
2066. FLOW OF FLUID, GAS OR AIR
2067. SHEATH OR SHROUD OR TUBULAR FORM
2068. FIBRE OPTIC OR CONDUCTIVE MATERIAL
2069. CALIBRATION MARKINGS
2070. FABRIC, WEBBING, SRAPPING, FLEXIBLE MATERIAL OR FIBROUS NETWORK
2071. STRING, TWINE, WIRE, MONOFILAMENT OR STRAP MATERIAL
2072. SPRING BIASED RETRACTIVE SPOOL
2073. TOOL (ROTARY OR OTHERWISE)
2074. TOOL BODY OR MANUFACTURING JIG
2075. INDUCTION CHARGING COIL PRE INTERFACE
2076. INDUCTION CHARGING COIL POST INTERFACE
2077. COMPONENT PART OF CONNECTOR MODIFIED TO EXTRACT AIR FROM A CAVITY
2078. DESHEATHING DEVICE.
3001 PRE INTERENGAGEMENT SYMBOL
3002 PARTIAL INTERENGAGEMENT SYMBOL
3003 FULL INTERENGAGEMENT SYMBOL

FIGS. 51A and 51B are perspective views of the two parts of a connector of the first embodiment, but in which simplified reference numerals are used. An interlocking connector 519 is shown which includes a first part 511, which is shown in FIG. 51A and a second part 512, which is shown in FIG. 51B. Each of the first part 511 and the second part 512 has a connecting face 518 which includes engagement formations 513 and receiving formations 514. Each engagement formation 513 has a start 515 and an end 516. The engagement formations 513 project from a backing 517. The backing 517 of the or each of the first part 511 or the second part 512 may be integral with or bonded to another part 5113 (see FIG. 51C) of an assembly comprising a connector 519. The part 5113 may be another type of connector, for example a threaded bolt. Various assemblies including one or more connectors 519 are described in more detail below.

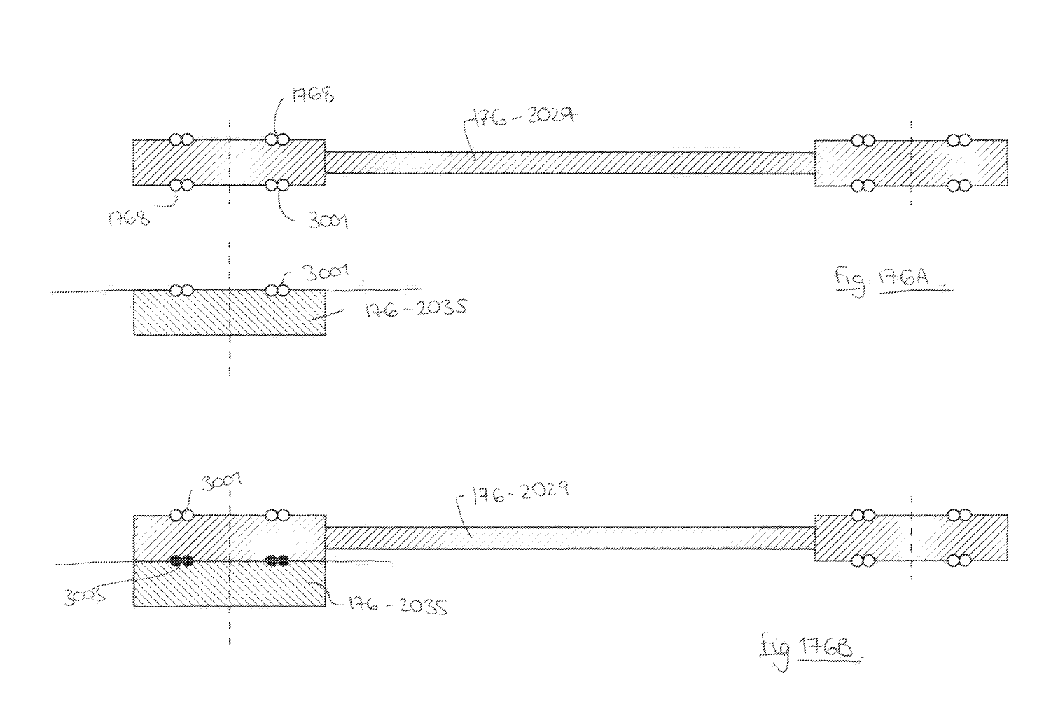

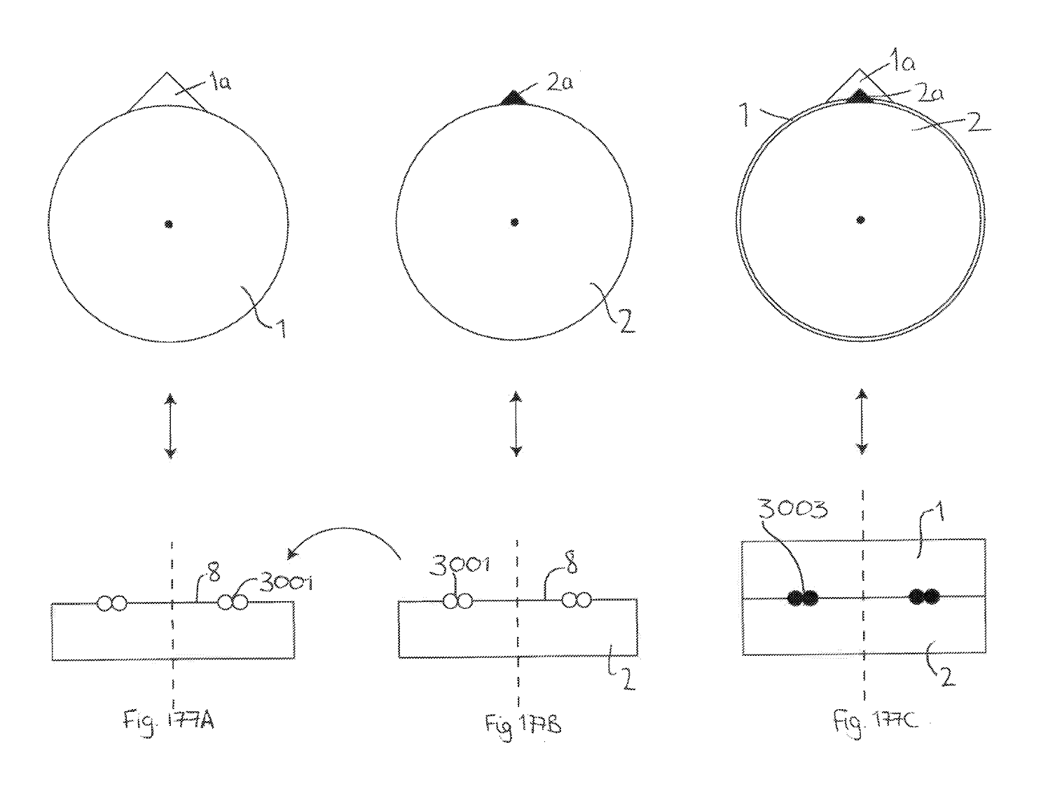

The connection between the connecting faces 8 or “interlocking sides” of a first part 1 and a second part 2 of a connector 9 is visually represented by a series of graphic symbols or representations 3001, 3002, 3003, as shown in FIGS. 178A-C. Each graphic symbol 3001, 3002, 3003 includes a pair of conjoined circles.

The graphic symbol 3001 represents no inter-engagement of the parts 1 and 2 of the connector 9, as shown in FIG. 178A. Both of the conjoined circles in graphic symbol 3001 are uncoloured.

The symbol 3002 denotes partial engagement of the connecting faces of the parts 1 and 2 of the connector 9. One circle of the pair is coloured, whilst the other is uncoloured.

The symbol 3003 denotes full inter-engagement of the connecting faces, wherein both circles of the pair are coloured.

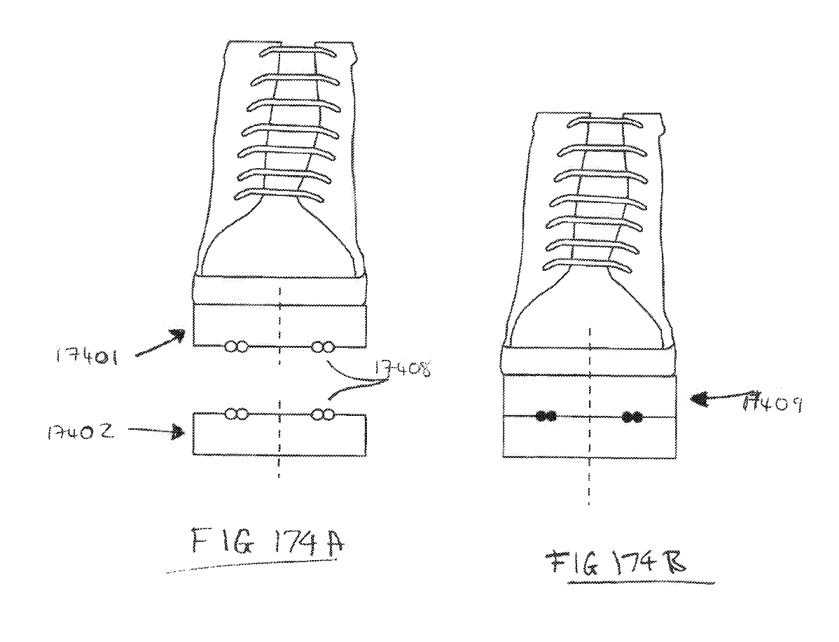

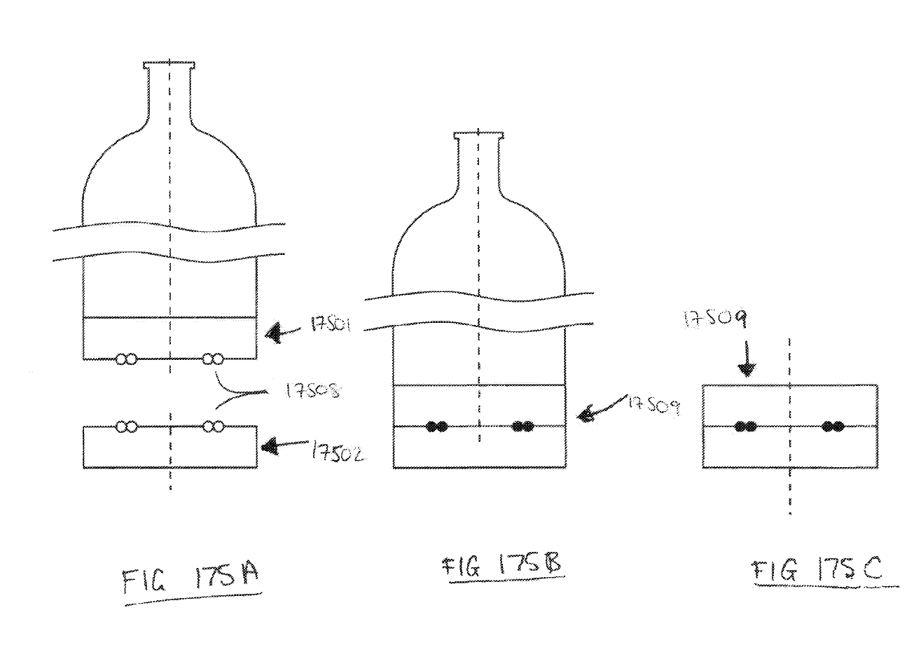

A system of schematic representation will also be used and the legend for this schematic representation or symbolism may be seen in FIGS. 177A-C. FIG. 177A is a representation of the first part 1 of the connector 9 and FIG. 177B is a representation of a second part 2 of the connector 9. The representation of each of the parts 1 and 2 includes a respective marker 1a, 2a which shows the orientation of the parts 1 and 2. It will be understood that the parts 1 and 2 need not have physical parts which indicate their orientations, and that the purpose of these markers is to aid understanding of the connection and orientation of the two parts 1, 2. The perimeters of both parts 1, 2 are both visible in FIG. 177C, however, it will be understood that part 1 is beneath part 2, and that the diameters of the physical parts of the connector 9 may be identical.

It should be understood that this simplified numbering can be applied to the respective parts of all the previously described embodiments and that the graphic representation of 3001, 3002, 3003 applies to the connecting face 8 of each part of all the previous embodiments and further embodiments described herein, in order to most efficiently illustrate practical applications of the invention. The markers 1a, 2a, may be shown in conjunction with any of the embodiments of the invention disclosed herein, in order to symbolise the relative orientations of two or more parts which are inter-engaged.

It should be understood that various embodiments of the invention rely on mechanical interlocking parts to achieve their respective compression, tension, shear and torsion characteristics, not depending upon friction between surfaces except for specifically described features, for example to achieve a frictional tightness caused by the narrowing of the receiving formation gap towards the end of the desired rotation and/or a ramp section towards the end of the receiving formation, both options typically closing the tolerance gap between surfaces required to enable free rotation. Before describing further embodiments by reference to figures, it should be understood that compared to various prior art rotational fixings, for example of a screwed bolt or a bayonet fixing, various embodiments of the present invention typically achieve a higher level of axial, shear and torsional restraint for a relatively small angle of rotation and axial displacement compared to such prior art fixing systems.

FIGS. 52A and 52B schematically represent an example of a connector 529, wherein both component parts 521 and 522 of the connector 529 are substantially similar to each other to the extent that upon rotation they inter-engage with each other. The connector 529 is hermaphroditic in that the connecting face 528 of each part 521, 522 includes engagement formations 523 and receiving formations 524. The engagement formations 523 and receiving formations 524 alternate circumferentially and each extends through approximately 45°. The circumferential alternation between an engagement formation 523 and an adjacent receiving formation 524 is 45°.

A start point 525 of any inter-engagement formation 523, 524 on the part 521 may initially be aligned with the start point 525 of any of the alternate respective inter-engagement formations 523, 524 upon the other part 522. FIG. 52C shows the parts 521 and 522 positioned one above the other such that they are coaxially aligned in a first orientation to form the connector 529, wherein the markers 521a, 522a are adjacent one another.

FIGS. 52D-F show alternative possible alignments of the parts 521 and 522. The parts 521, 522 of the connector 529 shown in FIGS. 52A and 52B may be positioned relative to one another in four different orientations in order to achieve a connection. The connector 529 can be used as a re-positionable fastener for modular domestic use where a selection of final engagement positions may be desirable as seen in FIGS. 52C-F. The connector 529 may be used while hanging pictures on walls where it is desirable to be able to select either landscape or portrait orientation, for example.

Flat Tight Connection.

FIGS. 53A-C schematically represent connector 539 seen in FIG. 53C comprising part 531 seen in FIG. 53A and part 532 seen in FIG. 53B which inter-engage as seen in FIG. 53C to form connector 539. Part 531 is a device wherein at least two protrusions 533 project substantially perpendicularly from the basal surface of the part 531, said protrusions extending circumferentially less than or equal to 89 degrees. Part 532 seen in FIG. 53B is a device where at least two protrusions 533 project substantially perpendicularly from the basal surface circumferentially about the axis to an extent which is less than or equal to 89 degrees. The area or sector 5315a seen in FIG. 53A represents an area of diminished mechanical clearance. The part 532 is a complimentary device wherein each engagement formation 533 includes a similar area or sector of reduced mechanical clearance 5315b. Upon rotation of either part 531, 532 about the other, the inter engaging formations 533, 534 rotationally engage as a free mechanism until the area 5315a of part 531 interacts with the area 5315b of part 532, to have a combined effect 5315c as seen in schematic in FIG. 53C. Said combined effect of said reduced mechanical clearance 5315a, 5315b therein acts as resistance to the rotation of the connector 539, or acts as an end stop to limit rotation of connector 539.

Sequencing.

FIGS. 54C, 54D, and 54E schematically represent a connector 549 comprising two parts 541 and 542 wherein part 542, as shown in FIG. 54B, has a geometric modification 5410 upon the connecting face 548, that performs a mechanical task such as actuation, when inter-engaged with its complimentary part 541 as seen in FIG. 54A. Part 541 represents a range of inter-engagement 540-2004 subdivided into distinct ranges with sub functions of any number, wherein the modification 5410 seen in FIG. 54B affects a mechanism or series of mechanisms within or about the range of sector subdivisions or engagement formations 543, 544 of part 541, each of which has a start point 545 and an end point 546. FIGS. 54C, 54D and 54E show connector 549 in three potential sequential stages (it should be noted that said device may have any number of sequential subdivisions), each with the capability of performing more than one sub-functional task actuated by a geometric modification 5410. The geometric modification 5410 may be disposed at any point that is advantageous along the range 54-2004 to be used.

Camming Action.

FIGS. 55A-C represent a cross section of a connector 559 seen in FIG. 55C comprising parts 551 and 552, wherein at least one surface 55-2003 of one inter-engagement formation of the first part 551 has a varying height from the helicoidal basal surface. The second part 552 includes an actuator 55-2001 which extends through a radially outer part of the second part 552. In the example shown, the actuator is spring-biased to a non-actuated state. FIG. 55B shows the two parts, 551, 552 of the connector 559 in a state of engagement wherein actuator 55-2001 is in a non-actuated state. FIG. 55C represents said connector 559 after a specified degree of rotation wherein the engagement formation with modification 55-2003 (varying height helicoidal surface) seen in FIG. 55C has pushed said actuator 55-2001 linearly along its axial restraint. In the example shown, the helicoidal surface of the engagement formation provides a camming action, wherein the highest part of the helicoidal surface is capable of overcoming the spring bias of the actuator 55-2001. It should be noted that modifications to the form of part 551 FIG. 55A may be carried out upon any surface of the first part 551. This is advantageous for the mechanical actuation or switching of any actuation device whatever the purpose, regardless of its orientation to the primary axis of engagement. It should also be noted that said connector 559 may have any number of actuators 55-2001 that may be deemed as advantageous for performing other mechanical tasks.

Yin Yang.

FIGS. 56A-C schematically represent an apparatus 569 (shown in FIG. 56C), which comprises a first part 561 (shown in FIG. 56A) and a second part 562 (shown in FIG. 56B), wherein the first part 561 has at least two recesses 564 projecting substantially perpendicularly into a basal surface 567. Said basal surface need not be planar. From the basal surface 567 of the second part 562 projects at least one protrusion 563 extending substantially perpendicularly from the basal surface 567, the form of the protrusions 563 has a substantially trapezoidal cross section or any other inter-engageable profile. The example shown in FIG. 56B includes two protrusions 563, but it will be appreciated that any number of protrusions 563 may be provided, including one. The first part 561 and the second part 562 have somewhat complimentary inter engaging profiles wherein the protrusions 563 are defined by an arcuate curvature wherein the subtended surfaces taper such that the an interference fit is provided between each protrusion and the corresponding recess in the other part. Each protrusion and recess need not have a helicoidal engagement surface. The tapering of each protrusion and recess may be a logarithmic curvature. In this embodiment seen FIG. 56C only a minimal degree of rotation (as represented by the segment 56-2004) is required to engage the subtended surfaces of the first part 561 FIG. 56A with said inter-engaging formations of the second part 562. It should be noted that similarly only a small degree of rotation is required before all subtended surfaces of the second part 562 disengage from their mating counterparts of the first part 561, prior to separation about the primary axis of inter engagement.

Ranges.

FIG. 57C schematically represents a device 579 comprising a first part 571 (shown in FIG. 57A) and a second part 572 (shown in FIG. 57B), wherein the inter engagement formations are structured about a planar, conical, domed or helicoidal basal surface. The height of the engagement formation on part 571 or the corresponding receiving formation of the second part 572 remains ordinarily within a range less than the height of the pitch of the helicoidal basal surface or, if formed about a flat basal surface, the height of the engagement formation would ordinarily be uniform from the basal surface, throughout its entire circumferential extent. However, it is advantageous to introduce a small ramp nodule or nipple 5710 upon any surface of the first part 571 or the second part 572 to affect the friction between the two parts 571, 572 or the position of the inter-engaging formation 578 in relation to the inter engaging device 579. Said ramps or other geometric modifications 5710 may serve to reduce the mechanical clearance between the first part 571 and the second part 572, to add localised increased surface friction about the interfering regions 5712 of the inter engagement formations 578 FIG. 57C. The ramped surface 5710 may increase friction suddenly or progressively over a rotational range, said resistance between 5710 of the second part 572 and 57-2004 may provide audible vibratory outputs or localised deformation of either the first part 571 or the second part 572 or either of their respective subcomponents. It should be noted that said modification 5710 may be positioned at any point along the range of extent 57-2004, on either the first part 1 or the second part 2. The position of the modification 57-10 may provide an adjustable output, dependent upon its position relative to the range 57-2004. For example, positioning the modification 5710 at a start point 575 provide a minimum output, whereas positioning the modification at an end point 576 of the range 57-2004 may provide a maximum output. Such an embodiment may be used as a volume control, for example, with the relative positions of the device enabling gradual or stepped volume adjustment between a minimum and a maximum level.

External Pawl Action.

FIG. 58 schematically represents an interlocking connector 589 seen in FIG. 58C comprising a first part 581 seen in FIG. 58A, and a second part 582 seen in FIG. 58B. FIG. 58C represents the first part 581 and the second part 582 in inter-engagement with each other. The first part 581 includes a modification to its form, which, in this example is the provision of a ratchet formation 5811 on or near an edge of the first part 581, facing inwardly towards the axis of rotation of the first part 581. The second part 582 includes a pawl or tooth formation 5810 on an outer edge of the second part 582, facing outwardly of the second part 582. The ratchet and pawl formations 5810, 5811 may be manufactured integral to the form of the respective parts 581 and 582, or may be subsequently attached. The ratchet 5811 upon the second part 581 shall be flexible but biased to return to a closed position. Upon rotational inter-engagement of the first part 581 with the second part 582 about a specified degree of rotation, about the primary axis of inter-engagement, the modification to the first part 581, i.e. the ratchet formation 5811, interact with the complimentary modification of the second part, i.e. the pawl or tooth 5810. This ratchet and pawl mechanism is brought about by the interaction of modification 5811 to the first part 581 and modification 5810 to the second part 582 and serves to resist or inhibit counter rotation of the first and second parts 581, 582 about each other as seen in FIG. 58C. The ratchet and pawl formations need not be positioned on an outer edge of the respective part 581, 582, but may be provided internally of the part 581, 582, for example in an aperture, or could be positioned on an upper or lower face of the part 581, 582, provided the two parts are able to interact with one another when the two parts 581, 582 are brought together.

3 Stage Function.

FIG. 59A shows a schematic representation of a first part 591 of a connector 599, which includes three regions or sectors, each of which includes one of an engagement formation 593 and a receiving formation 594. Each sector has a different purpose or effect. FIG. 59B shows a schematic diagram of a second part 592 of the connector 599. The second part 592 is similar to the first part 591 in that it includes three sectors, each of which includes one of an engagement formation 593 and a receiving formation 594 for receiving a corresponding engagement formation 593 of the first part. The second part 592 includes a modification 5910 adjacent to a start point 595 of an engagement formation 593 or a receiving formation 4. The modification 5910 actuates different stages of connectivity when inter engaged with the first part 591. The modification 5910 provides or operates differing sub functions when the two parts 591, 592 are rotated by 120 degrees from the initial start point, relative to one another. Since there are three possible starting orientations of the two parts 591, 592, there are also three final orientations of the two parts 591, 592 relative to one another, as shown in FIGS. 59C-E. The range 5912 in each of FIGS. 59C-E represents an inter-engagement, or co-operation of the modification 5910 with one of three regions 5911, which are provided on the first part 591. When the two parts 591, 592 are inter-engaged they provide one of three operational ranges 5912. Each range 5912 represents a different function or sub function, for example one may enable resistance free rotation, whilst another may provide resisted rotation whilst another may provide locking of said device.

Picture Hanging.

A connector of the present invention can be engaged to its full rotation position, typically when opposing engagement formation start points 605 interact or may be deliberately partially rotated to enable relative rotation in either direction in use. For example, in FIG. 60, the second part 2 is engaged with the first part (not shown) as far as point 60-2006, which enables rotation up to point 606 as well as in the opposite direction, for example to enable an object supported by second part 602, for example a hook or a picture, to find its own gravitational equilibrium, for example facilitating “straight” (vertical) hanging of a picture frame. The two parts may be rotated through a range 60-2012 whilst still remaining at least partially engaged.

Annular Programmability.

FIGS. 61A and 61B represent half a set of apparatus (the complimentary part is not shown). A first part 611 of the apparatus has sub-component parts 611A and 611B which are manufactured as separate components and subsequently assembled to create a form that is “annularly compounded”. More than two subcomponents may be provided, as required. Assembly of the two or more components 611A and 611B forms the compounded inter engagement formations. The parts 611A, 611B are rotationally registered about each other by aligning part 611A with the other part 611B by selecting one of a series of registration points 61-2007. The part 611B has external to its form a protrusion or recess 61-2008 or a repetitive pattern of protrusions or recesses to inter engage with the internal surfaces of the larger part 611A which has complimentary protrusions or recesses or a similar radially repetitive pattern. The parts 611A and 611B of the first part 611 of this embodiment may have integral to their forms further geometric modifications 61-2009 to aid assembly with or attachment to any other basal surface. Said modifications of this embodiment may be used to connect this compounded form to another item or part 61-2030 by means of swaging stakes 61-2009 into the part 61-2030 as shown in FIG. 61B.

Micro Arc.

FIGS. 62A-F are schematic diagrams of an apparatus 629, wherein rotational inter engagement of the two parts 621 and 622 is limited to a specified range. The extent of the inter-engagement of engagement formations 623 or receiving formations 624 on the parts 621, 622 is limited to just a few degrees between start points 625 and end points 626, which in turn allows minimal rotation of the first part 621 about the second part 622, but also allows a series of final positions or orientations such as 90°, 180° and 270° as shown in FIGS. 62D-F). There may be any number of start points 625 and end points 626, and any number of formations on either part 621, 622 as is advantageous for operation of the connector.

Dual Direction.

FIGS. 63A-C show schematic representations of an apparatus 639 which allows both clockwise and anticlockwise inter-engagement between two parts 631, 632. Inter-engagement of the two parts 631, 632 is permitted or enabled when inter-engagement formation 633 seen in FIG. 63B is inserted between two inter-engagement formations 633, 634 seen in FIG. 63A and rotated through an extent 63-2012. Relative rotation of the two parts 631, 632 in either direction enables the two parts 631, 632 to become inter-engaged. The cross sections of the inter-engagement formation 633 of the second part 632 seen in FIG. 63 B are of a suitable profile to inter-engage either clockwise and anticlockwise from the point of insertion, It may be seen from the schematic diagram 63C that more than one choice of initial inter-engagement position is available.

Conicality.

FIGS. 64A-H represent other cross sections of apparatuses 649 wherein the basal surface 647 or underlying form is either conical (see FIGS. 64A and 64B), domed (see FIG. 64C and FIG. 64D), or frusto-conical (see FIGS. 64E and 64F). The frusto-conical faces may be provided in an annular or a tubular structure (see FIG. 64E and FIG. 64F). It is also possible to provide a stepped conical basal structure as seen in FIGS. 64G and 64H. Each example has a first part 641 and a second part 642, each having a connecting face to enable inter-engagement of the two parts 641, 642.

Additional Location Aids.

FIG. 65A and FIG. 65B illustrate another structure 65-2013 that may be used in conjunction with a connector. The second part 652 of the connector 659 includes a boss having a substantially frusto-conical surface 65-2013 which is coaxial with and positioned radially internally relative to the inter-engagement formations (indicated generally at 658) upon the second part 652. The frusto-conical surface 65-2013 is receivable in a suitable aperture in the opposing first part 651 of the connector 659. The formation 65-2013 aids axial alignment of the two parts 651, 652 prior to inter-engagement. FIGS. 65C and 65D represent an additional or alternative formation 65-2013 which is coaxial with but positioned radially outwardly relative to the inter-engagement formations (indicated generally at 658) of the connector. The formation 65-2013 shown in FIGS. 65E and 65F also assists axial alignment of the primary axes of rotation of the two parts 651, 652 of the connector. Additional formations 65-2013, represented in FIGS. 65E and 65F, may be independent of the parts 651, 652 of the connector. Such substantially frusto-conical formations 65-2013 may be tapered inwards to the inter-engagement formations as shown in FIG. 65F or may be tapered away from the inter-engagement formations as shown in FIG. 65E. The frusto-conical formations shown in FIGS. 65A-F may or may not extend through 360° around the primary axis of rotation. Such frusto-conical formations may be removable or interchangeable, and may also be engageable via a connecting interface which includes a pair of connecting faces similar to any of those described above. The connecting faces of the parts may be identical to one another, but the two parts 651, 652 may differ from one another through the inclusion of a frusto-conical formation 65-2013 on one part 651, 652 and a recess being provided in the other part 651, 652. The frusto-conical formation 65-2013 may be attached to either of the parts 651, 652 of the connector 659 by means of a helicoidal connection. External parts, such as parts 65-2013 seen in FIGS. 65E and 65F may be disconnected from the connector 659, and may be provided on another item, or part of an apparatus.

Magnetic Axial.

FIG. 66C represents a schematic diagram of apparatus 669 comprising two parts 661 (see FIG. 66A) and 662 (see FIG. 66B), each having a connecting face 668 and a magnetic device 66-2014, such as magnet or electromagnetic device positioned adjacent or co-axially aligned with its primary axis of rotation. FIG. 66A shows a magnet 66-2014 with its polarity indicated by the letter N and FIG. 66B shows a magnet 66-2014 with its polarity indicated by the letter S. When the axes of rotation of the two parts 661, 662 of the apparatus 669 are approximately aligned with one another, the magnetic attraction of the two magnets 66-2014 disposed about the two separate parts 661 and 662 assist in axial alignment prior to inter-engagement, this in turn assists inter-engagement of the two parts 661, 662.

Magnetic Pokayoke.

FIG. 67C represents a schematic diagram of apparatus wherein each part 671 and 672 seen in FIGS. 67A and 67B, respectively, includes a pair of magnets 67-2014 or electromagnetic devices. The purpose of magnetic devices 67-2014 is to repel or attract the start points of the inter-engagement formations of the connecting faces 678 to their respective positions needed for correct alignment of the parts 671, 672, prior to inter-engagement of the two parts 671 and 672. FIGS. 67a, 67B, and 67C are representative of one such arrangement of magnetic devices. It should be noted that such devices 67-2014 may be arranged in any configuration that is advantageous for axial alignment. It should also be noted that such devices 67-2014 may be electromagnetic in their functionality and therefore may be switchable to reverse the polarity of the devices 67-2014. Such functionality may serve to change the initial position and resultant position of inter-engagement of the two parts 671, 672.

Groove Alignment.

FIG. 68C shows an apparatus 689 comprising a first part 681 with a cut away section 68-2015, which in conjunction with a central registration aperture 68-2016, aids axial alignment of the first 681 with a second part 682 of the apparatus 689, prior to inter-engagement of the two parts, 681, 682. The geometric modifications 68-2015 and 68-2016 in the first part 681 locate with a central location post 68-2017 which is provided on the second part 682 to aid inter-engagement of the two parts 681, 682.

Cross Sections

FIGS. 69A, 69B, 69C, 69D, 69E, 69F, 69G, and 69H represent additional cross sections that may be used for apparatus such as those described above or below. Each figure shows a section of a first part 691 and a second part 692 of a connector and represents the interlocking profiles of the apparatus. The dotted line 69-2018 denotes the axis about which the two parts of each connector are rotatable to enable inter-engagement.

Opposing EFX.

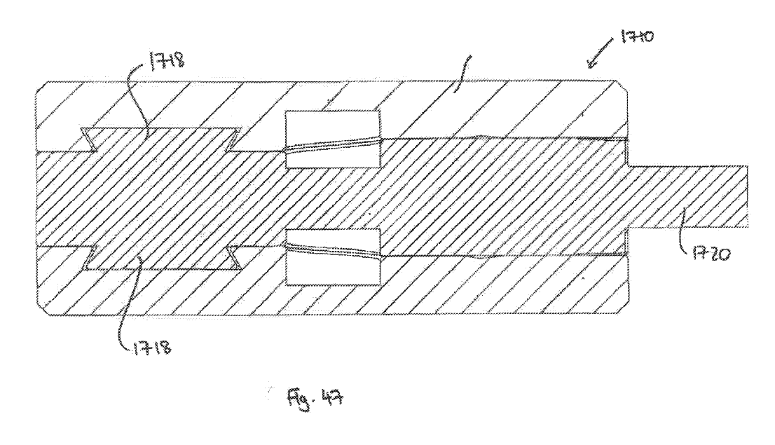

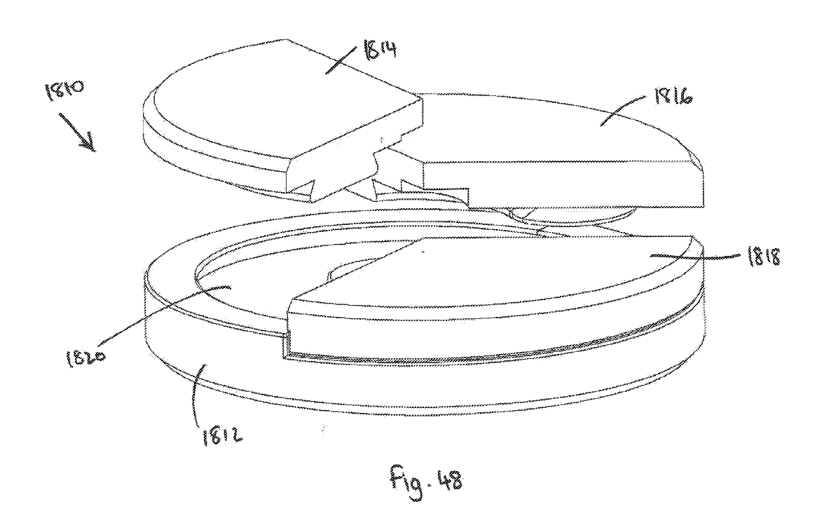

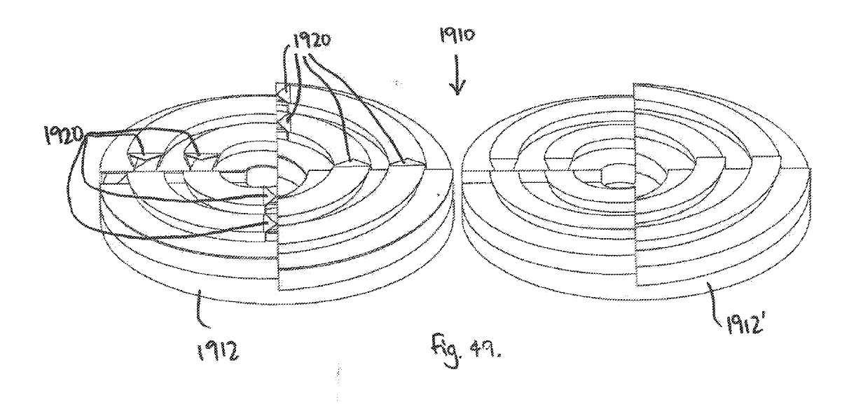

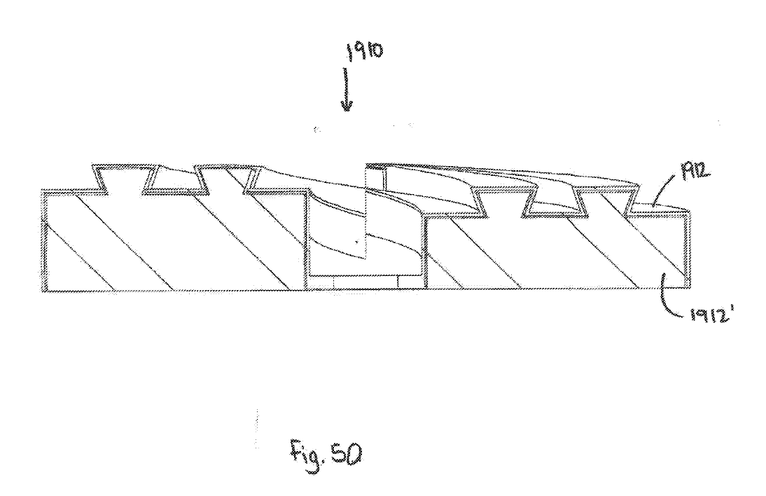

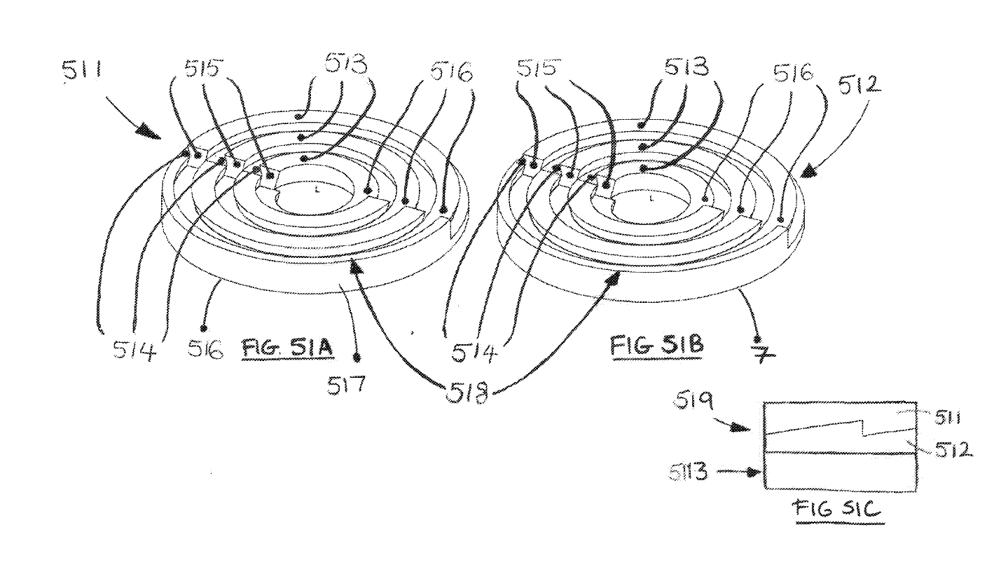

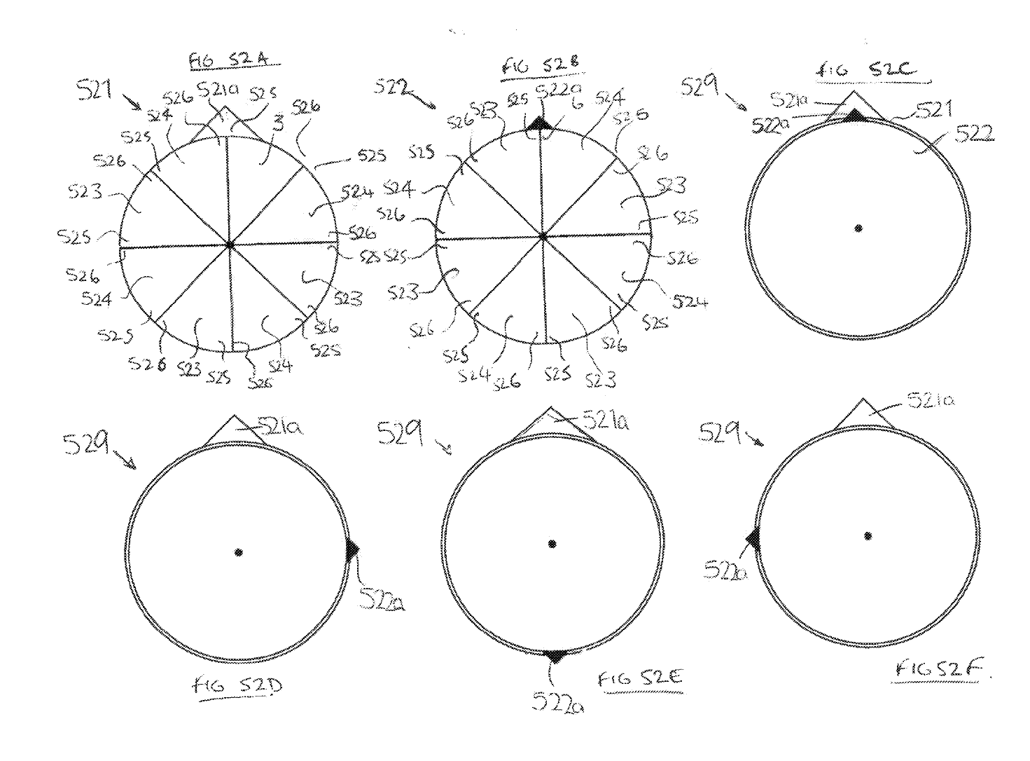

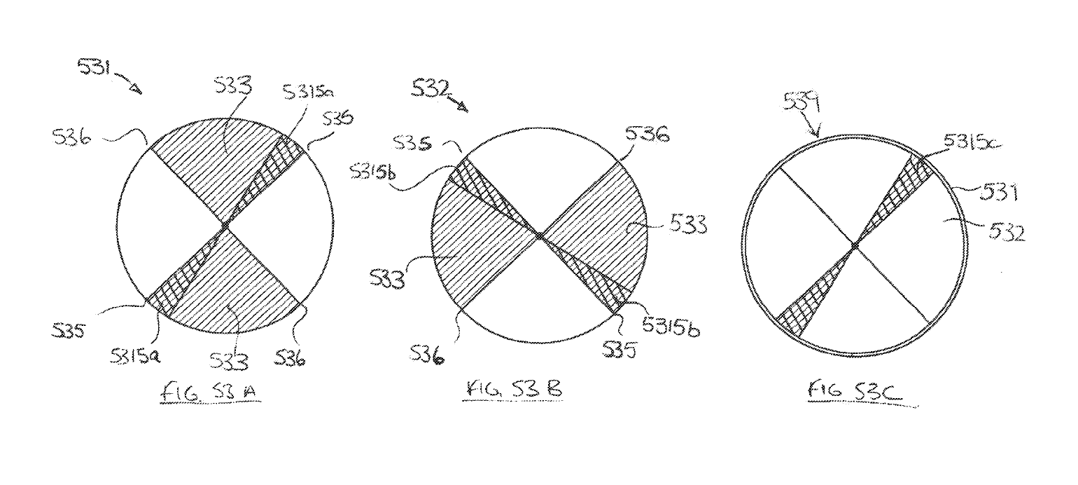

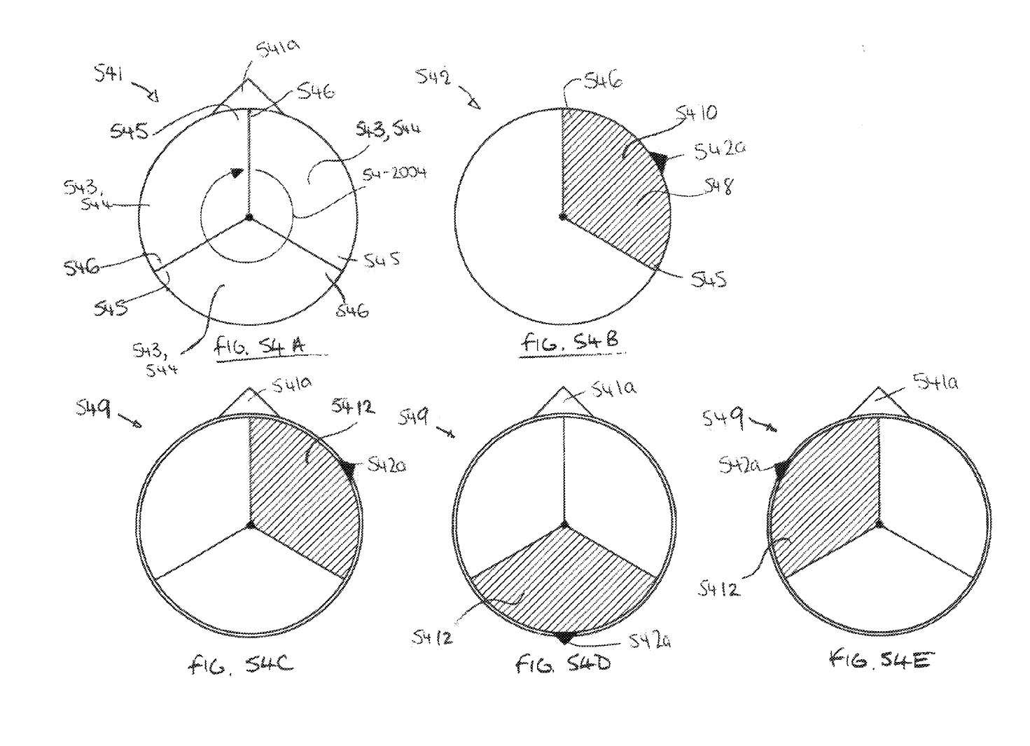

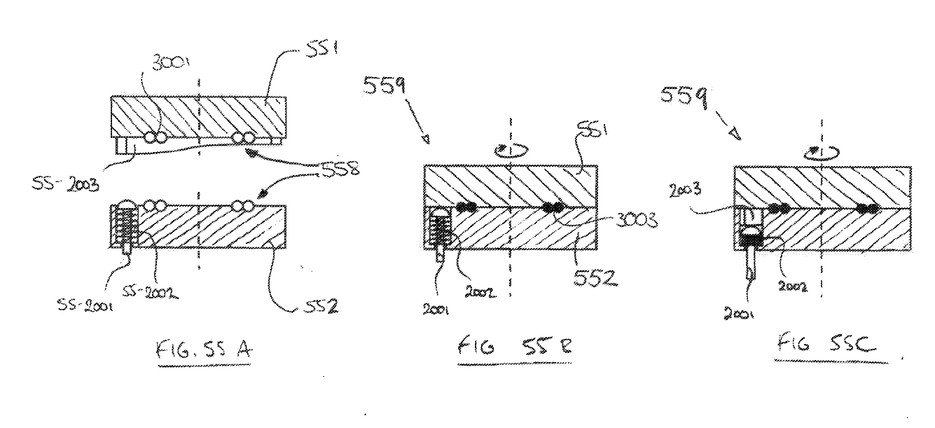

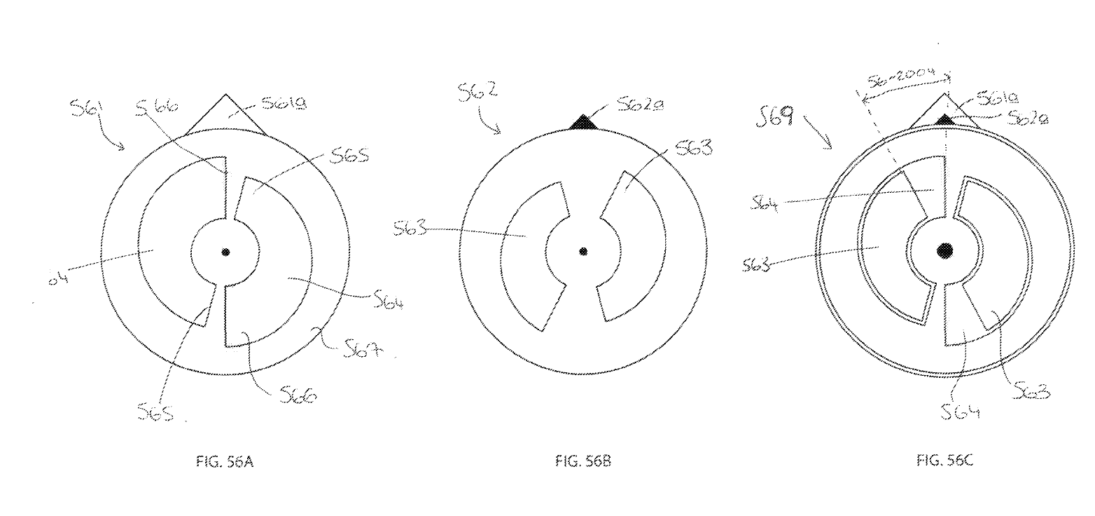

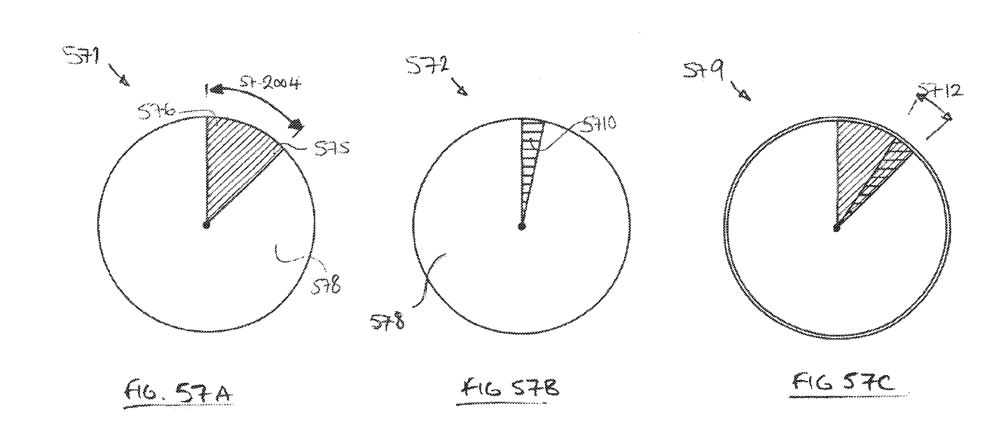

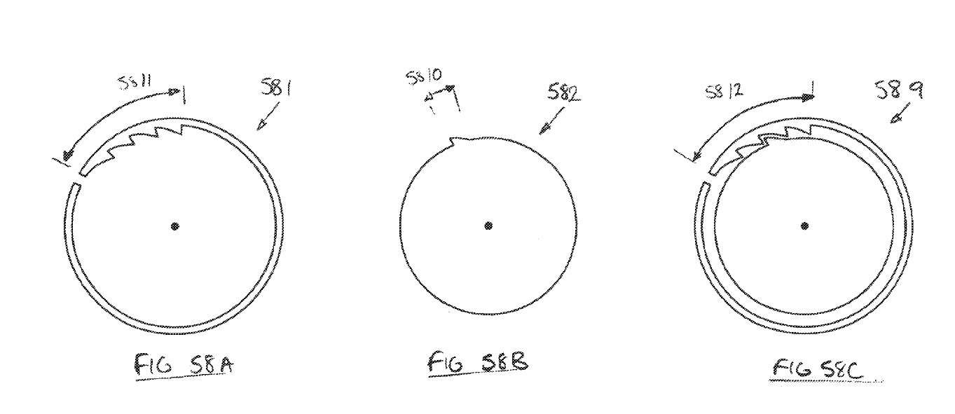

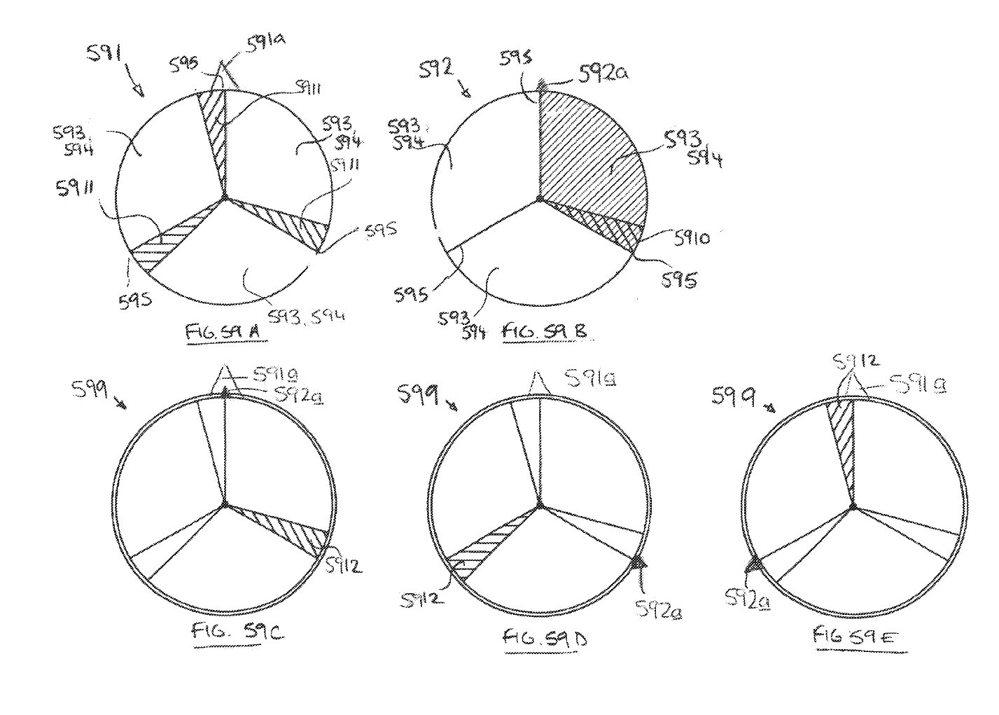

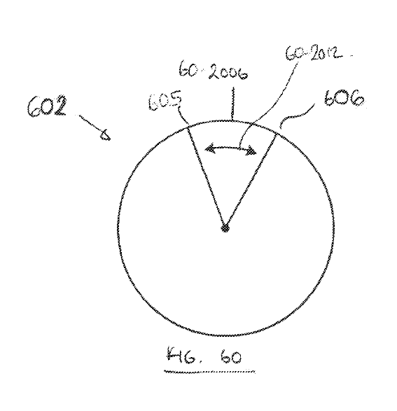

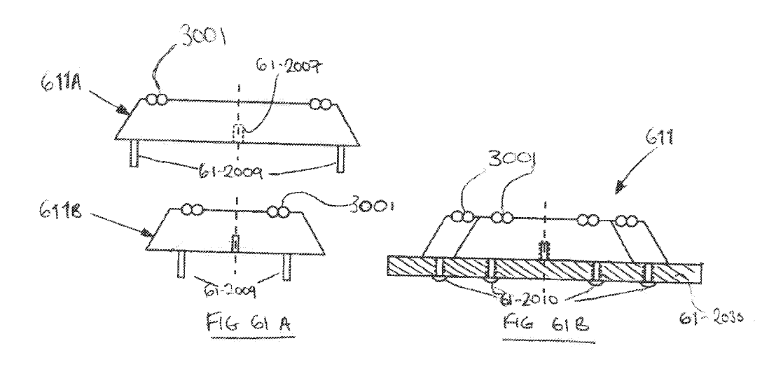

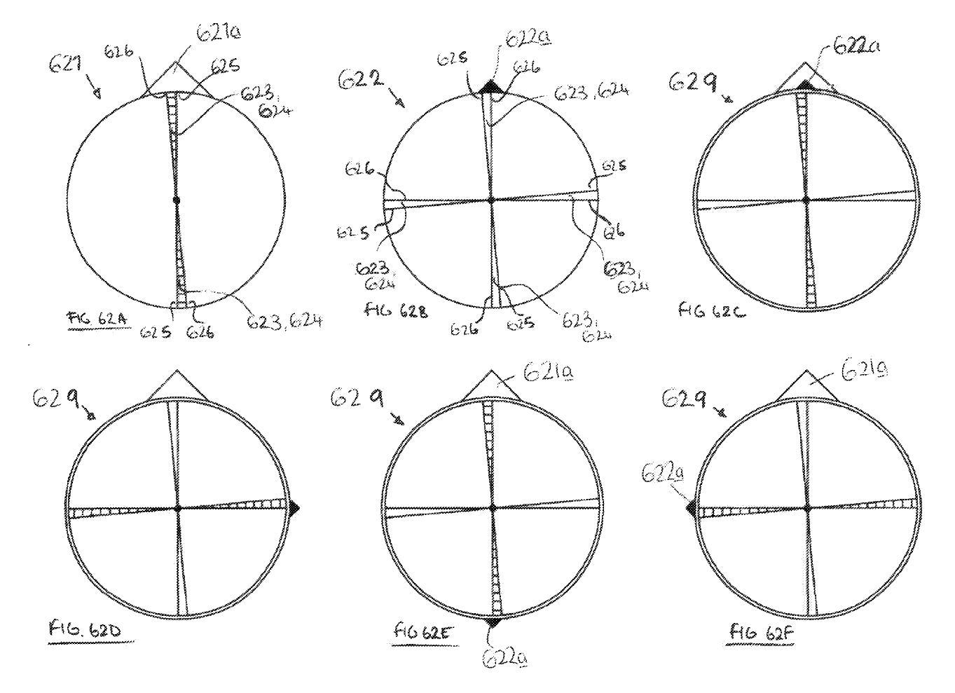

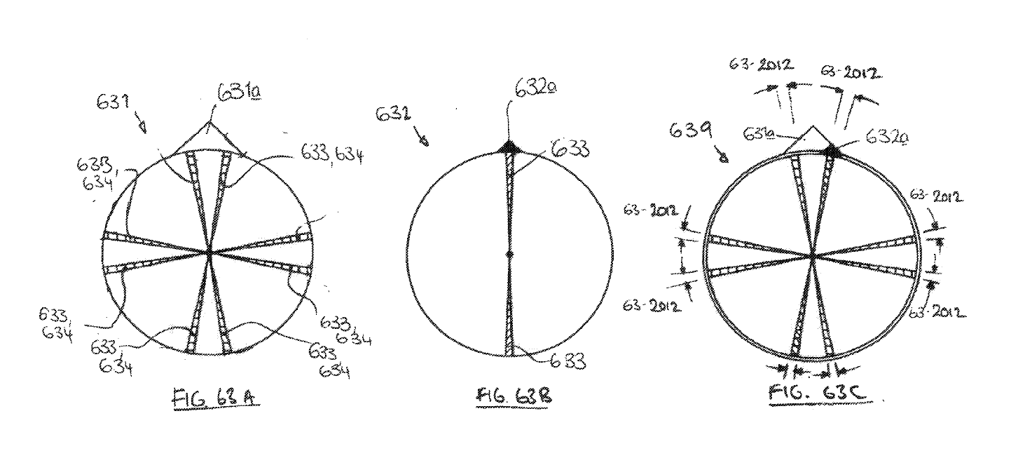

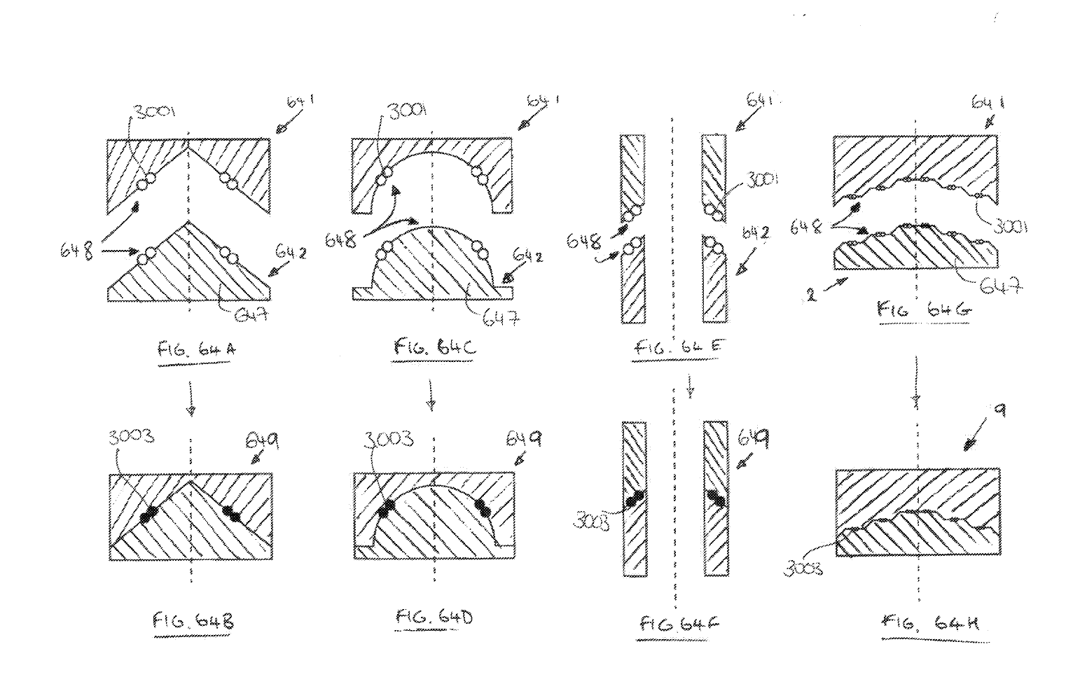

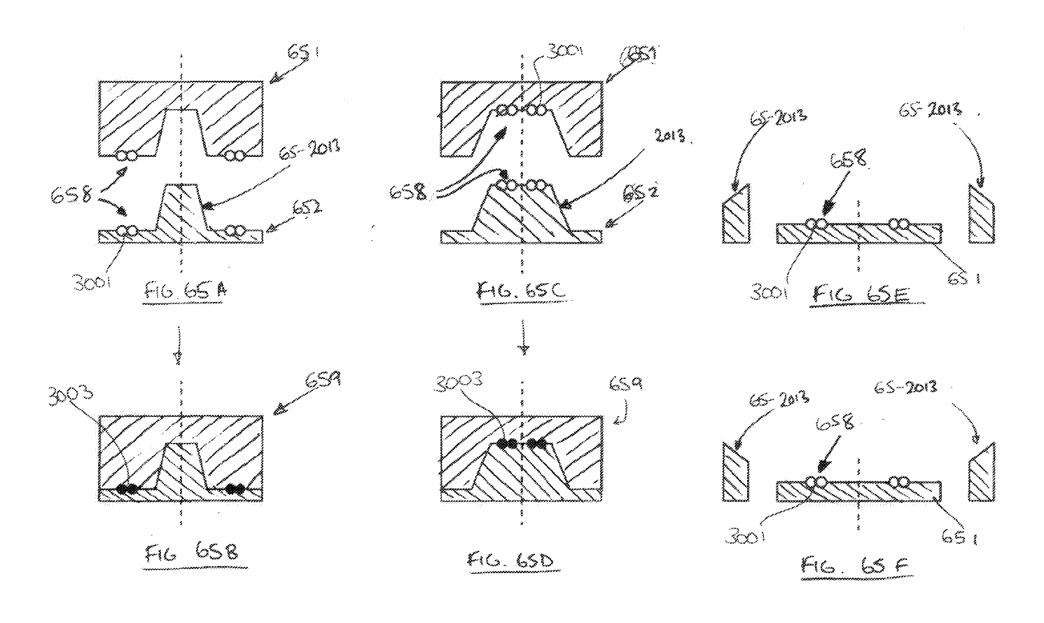

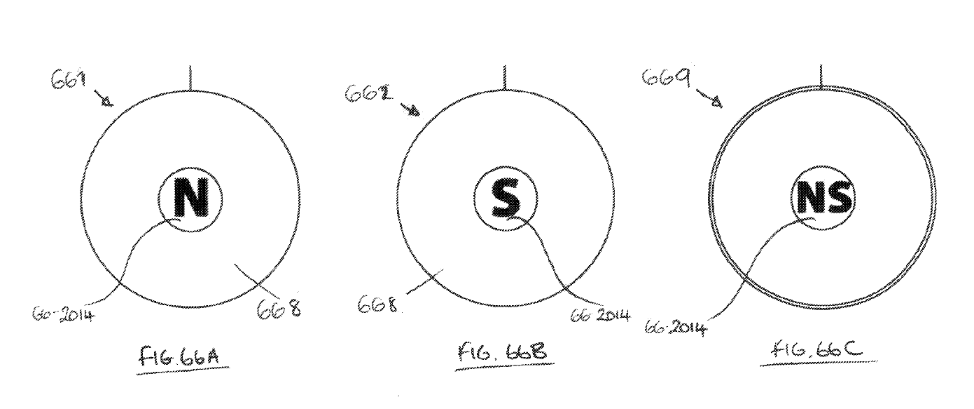

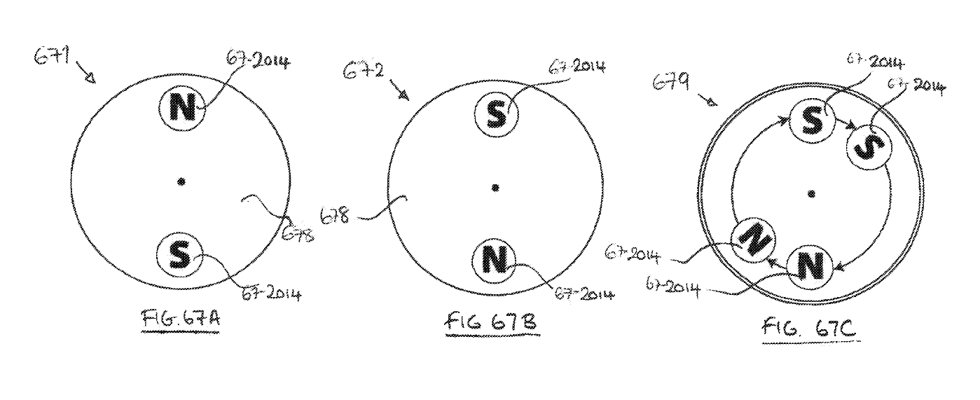

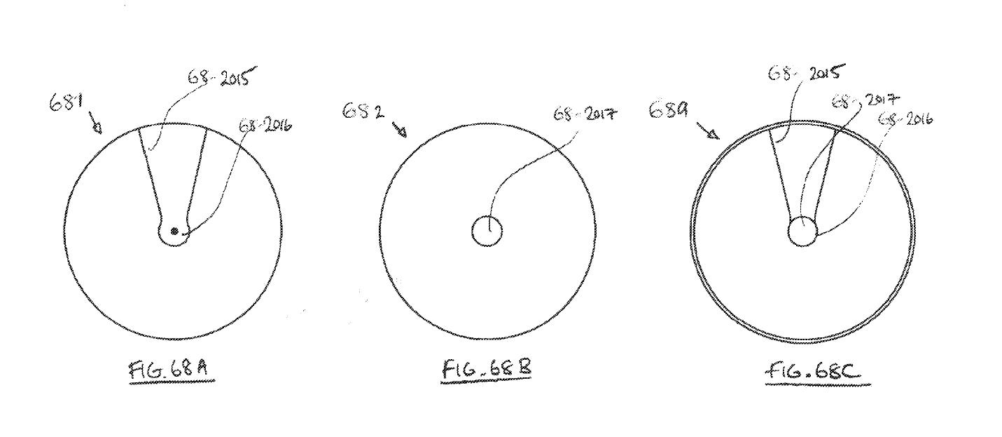

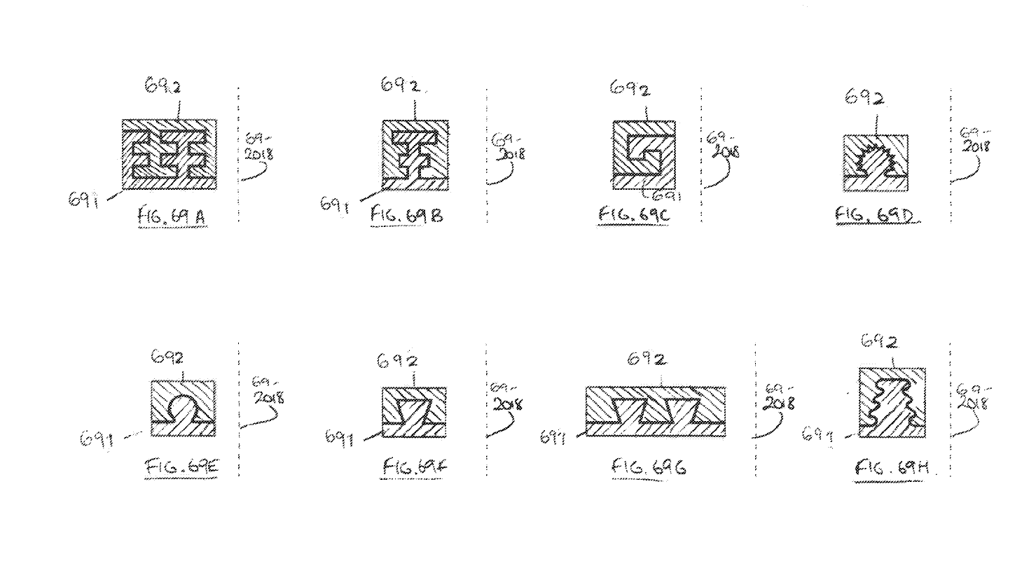

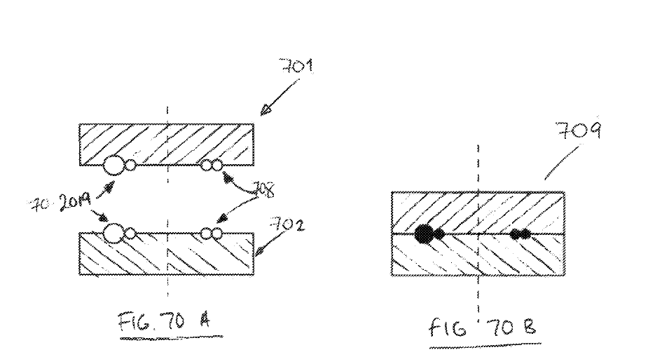

FIGS. 70A and 70B represent an apparatus 709 comprising a first part 701 and a second part 702, each including a connecting face 708 and a longitudinal axis of rotation. Each connecting face 708 includes inter-engagement formations which enable the inter-engagement of the two parts 701, 702. The inter-engagement formations on each part 701, 702 differ on either side of the respective longitudinal axis, with an engagement formation 70-2019 on one side of the longitudinal axis having a different cross-section from the engagement formation on the opposite side of the connecting face 708. Such an arrangement may be beneficial to assist in the correct use of device 709 in circumstances where there is more than one potential primary position available prior to inter-engagement, but only one correct position. Such an arrangement may be seen as a Poka Yoke to avoid inadvertent application of said apparatus 709.

Locking Mechanisms: External Snap Fit.

FIGS. 71A and 71B represent an apparatus 719 comprising a first part 711 and a second part 712. The first part 711 includes a snap hook 71-2020 which is positioned on the perimeter of the first part 711 and extends in a direction which is parallel to an axis of rotation of the first part 711. The second part 712 includes a receiving formation 71-2021 which may be a locking or latching formation or an aperture with which the snap hook 71-2020 is engageable. The combination of the parts 71-2020, 71-2021 serves to act as a lock to hold the two parts 711, 712 together following inter-engagement. The interaction of the hook 71-2020 and receiving formation 71-2021 inhibits parting of the two parts 711 and 712. Such an operation may be irreversible, or may be deactivated manually or by means of a tool.

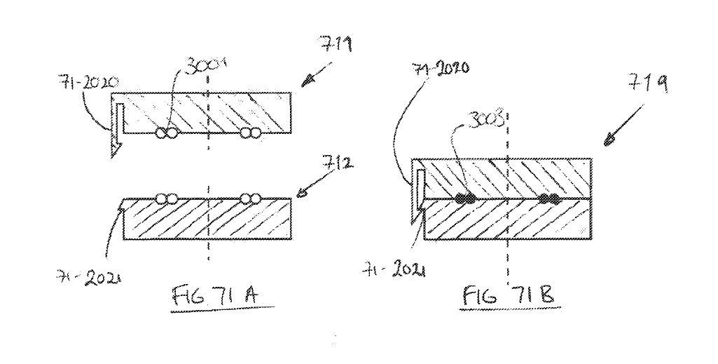

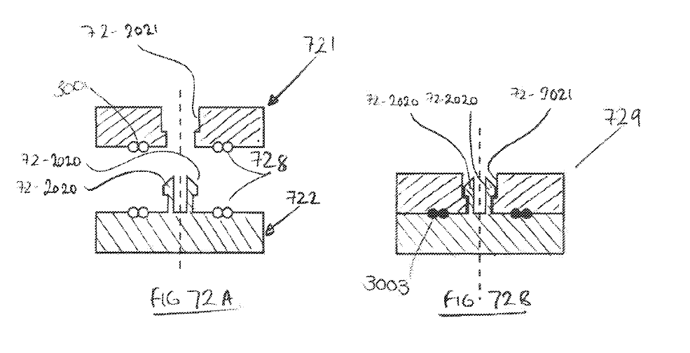

Alternatively, as shown in FIGS. 72A-B, such snap fit formations 72-2020 and 72-2021 may be disposed closer to the axes of rotation of the two parts and may be positioned radially inwardly of the inter-engagement formations which are provided on the respective connecting face 728 of the two parts 721, 722 of a connector 729. After inter-engagement, the formations 2020 and 2021 are positioned to be advantageous when said apparatus 729 is used in confined spaces, such as internally within another product. The interaction or engagement of the formations may occur during product assembly.

Squeeze Release.

FIGS. 73A-C illustrate a releasable catch 73-2022 for an apparatus 739 having a first part 731 and a second part 732. The catch includes a pair of clips mounted on opposite sides of the second part 732, and moveable radially relative thereto between a locking position and a releasing position. The clips are sping biased towards the locking position. Each of the clips includes a projection positioned on the circumference of the second part 732, which extends in a direction substantially parallel to an axis of rotation of the apparatus 739 towards the first part 731, when the first and second parts 731, 732 are inter-engaged. Each clip also includes a projection which is positioned at a radially inward position on the second part 732, and extends in a direction which is generally parallel to the circumferential projection into an aperture 73-2021 of the first part 731. Each of inner projections has a lug which is engageable with a corresponding ledge on the first part 731 when the catch is in the locking position. In order to release the catch, the outer projections are squeezed inwardly, such that the lugs are clear of the ledges, and the first part 731 can be rotated relative to the second part 731 to disengage the connecting faces 738 thereof, with a continuous (hand on) motion. It should be noted that there are other such mechanisms available to achieve the same effect of rotational inhibition.

Push Pull.

It may be required to fix a first part 741 of a connector 749 in relation to a second part 742 in a non-frictional manner, preferably by taking hold of the first part 741, optionally attached to another object such as a handle 74-2001, undertaking a single rotation of the first part 741 relative to the second part 742 to a stop position, typically at the abutment of two opposing inter-engagement formation ends, and then by means of a single pull or push on the first part 741, activating a locking device, for example any prior art push or pull locking devices, sprung or otherwise. Such embodiments of the invention can be summarised as “locate, rotate, push/pull lock” with a continuous (hand on) motion, as shown in FIG. 74. FIG. 74 illustrates one example of such a mechanism wherein the handle 74-2001 includes a pin which extends through the first part 741 and is receivable in a recess 74-2021 in the second part 742, in order to inhibit counter rotation of the two parts of the connector relative to one another, and thus to inhibit disconnection of the two parts 741, 742.

Rotary Cam Parting Force.

FIG. 75C represents an apparatus 759 comprising a first part 751 and a second part 752. The second part 751 includes an aperture or recess 75-2023 for receiving ancillary mechanics 75-2024. In the example shown, an eccentric rotary cam 75-2024 is provided. At any point during rotational inter-engagement of the parts 751 and 752 about each other, the eccentric rotary cam 75-2024 may be rotated to impart a parting force between the two interengaged parts 751 and 752. Such functionality could serve to resist rotation of the two parts 751, 752 relative to one another, by reducing the mechanical clearances in the apparatus 9. Such internal mechanics 75-2024 may also serve to lock the two parts 751, 752 together at any chosen point about the rotational extent of inter-engagement of the two parts 751, 752 of the apparatus 759.

FIGS. 76A-76C depict an apparatus 769 comprising a first part 761 and a second part 762. Each part 761, 762 has a respective connecting face 768, each face 768 including inter-engagement formations which enable inter-engagement of the two parts 761, 762. In this embodiment, the second part 762 includes an eccentric rotary cam 76-2025 which is positioned radially outwardly of inter-engagement formations of the second part 762. The cam 76-2025 is rotatable about an axis 76-2024. The first part 761 includes a recess or aperture 76-2023, in which the cam 76-2025 is receivable, in its perimeter. The cam 76-2025 may be used as a method of locking the parts 761, 762 of the apparatus 769 together when the aperture 76-2023 becomes aligned with the cam 76-2025. Such an operation may be ergonomically advantageous as the action of rotating the cam 76-2025 about its axis 76-2024, such substantially all of the cam is located in the recess or aperture 76-2023, or at least substantially within the perimeter of both the first part 761 and the second part 762, may be successive to the action of rotational engagement in a continuous hands on operation.

Annular Compound.

FIGS. 77A-77C represent an apparatus 779 including a first part 771, a second part 772 and an ancillary rotary bezel 77-2026. Each of the first and second parts 771, 772 has a respective connecting face 778, each of which includes inter-engagement formations. The rotary bezel includes a pair of annuli 77-2026a, 77-2026b, each of which is associated with and connectable to one of the first and the second parts 771, 772. The rotary bezel 2026 is positioned radially outwardly of the first and second parts 771, 772. Each part 77-2026a, 77-2026b of the rotary bezel 77-2026 has a respective connecting face 778 which has inter-engagement formations which enable inter-engagement of the two parts 77-2026a, 77-2026b of the bezel 77-2026. In use, the two parts 771, 772 of the apparatus 779 are rotated to effect inter-engagement of the two parts 771, 772 and a subsequent action of rotating the two parts 77-2026 inter-engages the inter-engagement formations of the two adjacent parts 77-2026a, 77-2026b of the bezel 77-2026. FIG. 77B depicts apparatus 779 after inter-engagement of the inner formations but prior to inter-engagement of the external formations 77-2026. It should be noted that such a mechanism of external rotary inter-engagement of the two parts 77-2026a, 77-2026b may happen in a direction contrary to the initial rotational direction of inter-engagement of the two parts 771, 772. The bezel 77-2026 may serve as a lock to the overall combined apparatus 779, and such a mechanism may be advantageous when connecting systems where risk is involved if apparatus 779 were to become disengaged, such as the transfer of toxic waste from one vessel to another.

Internal Spring Latch.

FIGS. 78A-C illustrates an apparatus 789 comprising a first part 781 and a second part 782 wherein the first part includes an aperture 78-2021 having a substantially axial part, and a substantially radial part, which has a limited circumferential extent. The second part 782 includes a latching device 78-2022 which has a central boss, which is receivable in the substantially axial part of the aperture 78-2021, and a detent which is receivable in the substantially radial part of the aperture 78-2021 when the two parts 781 782 are appropriately aligned. The latching device 78-2022 may be spring biased to an engaging position, so that the latching mechanism automatically engages with the aperture 78-2021 when a specified degree of rotational inter-engagement of the two parts 781, 782 has been achieved. Control of the latching device 78-2022 may be located on the exterior of the form or may in turn be operated remotely from any given distance. The latching device 78-2022 includes an accessible portion which, when the detent of latching mechanism 78-2022 is in an engaged position, extends beyond the perimeter of the second part 782. In order to disengage the detent of the latching mechanism 78-2022, a user exerts a radially inward force on the accessible portion of the latching device. The two parts 781, 782 may then be rotated, as the boss and the detent of the latching mechanism are both received within the substantially axial portion of the aperture 78-2021. The latching mechanism 78-2022 may be spring biased into the disengaged position and may only activate when external means are applied, such as remotely via a cable. Conversely a spring bias may be applied so as to only engage when required. It is necessary to overcome the spring bias to enable either inter-engagement or disengagement of the two parts 781, 782 of the connector 789.

Cam Operated Spigot.

FIGS. 79A-79C represent an apparatus 799 comprising a first part 791 and a second part 792. Each part 791, 792 includes a central aperture 79-2021 for receiving a locking or latching apparatus. The locking or latching apparatus includes components 79-2001 which are forced outwards axially by the rotation of an eccentric cam 79-2024 acting on the inner surfaces of the components 79-2001, serving to lock two parts 7901, 7902 together when the aperture 79-2021 aligns with the components 79-2001.

Screw in Parting Force.

FIG. 80 represents an apparatus 809 comprising a first part 801 and a second part 802. The first part 801 has a substantially central longitudinal aperture 80-2021. The aperture 80-2021 has an internally threaded portion with which an externally threaded component such as a grub screw 80-2027 is engageable. The second part 802 also has receiving aperture 80-2021. Following either complete or partial inter-engagement of the two parts 801, 802, the screw 80-2027 may be wound through the aperture 80-2021 of the first part 801, so as to extend into the aperture 80-2021 of the second part, to increase friction between inter-engagement formations 808 of the first and second parts 801, 802, and act as a locking device. It should be noted that the screw 80-2027 need not be co-axial with the connector 809.

Gravity Actuated.

FIG. 81 represents an apparatus 819 comprising two inter-engageable parts 811, 812. A third component 81-2001 is a slide action bolt which is mounted on the second part 812 and is receivable in a recess 81-2021 positioned in a perimeter of the first part 811. The slide action bolt 81-2001 may be manually operated or may be gravity actuated as and when correct alignment of the bolt 81-2001 and the aperture 81-2021 takes place. It should be noted that the slide action bolt, could act in any direction in relation to the apparatus 819 seen in FIG. 81C.

Central Release Button.

FIGS. 82A-C represent an apparatus 829 including two inter-engageable parts 821, 822. The apparatus 829 also includes a central release button 82-2001 in an aperture 82-2023 which extends substantially along the axis of rotation of the second part 822. The button 82-2001 is biased into an ‘engaged’ position by a spring 82-2002. In the engaged position, the button extends into an aperture 82-2023 of the first part 821. When the correct amount of rotational inter-engagement between the first and second parts 821, 822, takes place, the button 82-2001 self activates to lock the two parts 821, 822 together. FIG. 82C shows the depression of the button 82-2001 required to release the two parts 821, 822 of the apparatus 829 from rotational engagement. A longitudinal axis of the button need not be co-axial with the rotational axis of the connector apparatus 829.

Centrifugal Activation.

FIGS. 83A-C represent an apparatus 839 comprising two parts 831, 832. The apparatus 839 has at least one device 83-2001 which is received in co-operating apertures 83-2023 in connecting faces 838 of the first part 831, and the second part 832. The device 83-2001 may be a locking device or an actuator, including parts which, upon rotation of the whole apparatus 839 are forced outwards by centrifugal force. Said parts of the or each device 83-2001 may be biased into an ‘engaged’ position by a spring 83-2002. One such application of this apparatus 839 may be in the connection of a wheel to a drive mechanism such as a vehicle axle, where the centrifugal force of rotation serves to add additional safety to the device by inhibiting counter-rotation of the two parts 831, 832 of the apparatus 839 relative to one another.

EPAM Parting Force.

FIGS. 84A-C show an apparatus 849 comprising two inter-engageable parts 841 and 842. The apparatus 849 also includes an actuator 84-2001 made from electro active polymer artificial muscle. The actuator 84-2001 is positioned in a central aperture 84-2021 which extends along the rotational axis of the first part 841, and is extendible into a recess 84-2021 in the centre of a connecting face 848 second part 842. Upon the application of the correct voltage and current said E.P.A.M. actuator expands to impart a parting force between the two parts 841 and 842. This expansion of the E.P.A.M. actuator 84-2001 serves as a lock to the apparatus.

Piezo-Restrictive Clamping Force.

Another embodiment of the invention is shown in FIGS. 85A-C, wherein component parts 851 and 852 of the apparatus 859 are made entirely or partially of a piezo restrictive material, shown generally at 85-2028. Each part 851, 852 has a connecting face 858 which includes inter-engagement formations. Upon the application of a correct voltage and current to said piezo restrictive components 851, 852, contraction of one or more of the inter-engagement formations takes place, which results in a locking of the apparatus 859.

Drive Systems:

Friction Stir. FIGS. 86A, 86B, and 86C show a process where rotary tool body 86-2029 has inter-engagement formations provided on an end face 868, which forms the operative surface of the tool 86-2029. Upon rotation to the correct speed and duration for a given base material 86-2030 fusion of a localised area of the material 86-2030 with the end face 868 takes place. The tool body 86-2029 is then plunged into the base material 86-2030 and then stopped at the desired rotational orientation seen in FIG. 86B. FIG. 86C shows the tool 86-2029 after rotational extraction from the base material 86-2030 which in turn leaves inter-engagement formations upon a face 868 of the base material 86-2030. Such a technique would offer an integral fastener without the need to penetrate the base material 86-3030.

Alternatively, as can be seen in FIGS. 87A, 87B, and 87C, a different method of forming fasteners may be seen wherein the tool body 87-2029 has connected to its lower surface one part 872 of an apparatus 879. In this embodiment, the tool 87-2029 acts as a drive face for the second part 872, which is driven by 87-2029 or linearly oscillated until the desired amount of friction fuses the part 872 to a base material 87-2030. The tool 87-2029 is then retracted as seen in FIG. 87C, leaving the second part 872 of the apparatus 879 fused to the base material 87-2030 ready to accept a first part of another device. An application for this method may be in aerospace assembly.

FIGS. 88A-C illustrate a similar technique as used in FIGS. 87A-C. Inter-engagement formations 888 are on distinct annuli of a second part 882 of an apparatus 889, and are applied independently of each other. The annuli are fused (shown generally at 88-2031) to a base material 88-2030. The independent application of these distinct rings allows variable positioning of start points of the inter-engagement formation. This gives an element of programmability about the fasteners, which in turn could be used as a “poka yoke” failsafe method of fastening other devices to the base material 88-2030, which is similarly applicable to aerospace assembly.

FIG. 89C shows an apparatus 899 that may be used as a through fix method of fastening sheet materials 89-2032 together. The apparatus 889 includes a first part 891 and a second part 892. The second part 892 is first fastened to a lower base material 89-2032, as shown in FIG. 89B and the first part 891 is subsequently applied during the fastening of two base materials 89-2032 together.

Screwdriver and Cap.

FIG. 90A illustrates embodiments of the invention in which a first part 901 of the apparatus 909 forms a head 90-2005 of a bolt, coach bolt, screw or similar fixing device 90-2035 with a substantially helical external thread 90-2034 disposed along at least a part of a uniform or tapered shaft 90-2036. The first part 901 may be fixed to a wall or other structural member, for example, and acts as a receiving part for a second part 902, for example to provide a smooth flat or domed cover to such a fixing device 90-2035. Alternatively, the second part 902 can form part of another device to be connected to first part 901, for example a hook, a structural member, an appliance, for example a tool, or any other object. The fixing device 90-2035, for example a bolt, typically undergoes many rotations in order to be firmly embedded within a receiving screw thread, for example in a wall fixing device, or in the case of a screw fixing device, into a relatively soft material, for example timber.

In order to rotate the head 90-2005, another second part 902 is attached to or integral with the end of a screwdriver or spanner or other levering device or general tool 90-2029 to apply the necessary torque to the first part 901, as illustrated in FIG. 90B. In this use, the second part 902 has the advantage of being interlocked before respective ends of inter-engagement formations provide the torsional reaction to enable rotation. This interlocking of second part 902 which is attached to the driving element or tool, has a distinct advantage over various prior art bolt head spanners or screwdriver heads that can easily become disengaged. According to one or more embodiments, the second part 902 can be completely released and still stay in place, making the insertion of such screwed fixing devices easier and without damaging interacting surfaces between the head and the driving device, for example a screwdriver.

Screwdriver [Non-Engaging] and Cap.

Alternatively, as illustrated in FIG. 91A, a non-interlocking driver tool 91-2029 has a rotationally engaging but non interlocking formation 91-2037 on an end face can be pushed into position with reacting ends immediately ready to apply the rotational, torsional force required to insert a fixing device 91-2035 into a surface, for example as shown in FIG. 91B. FIG. 91C shows a further device 91-2033 such as a hook, a cap an eyelet inter-engaged with said device the device 91-2035.

Spanner.

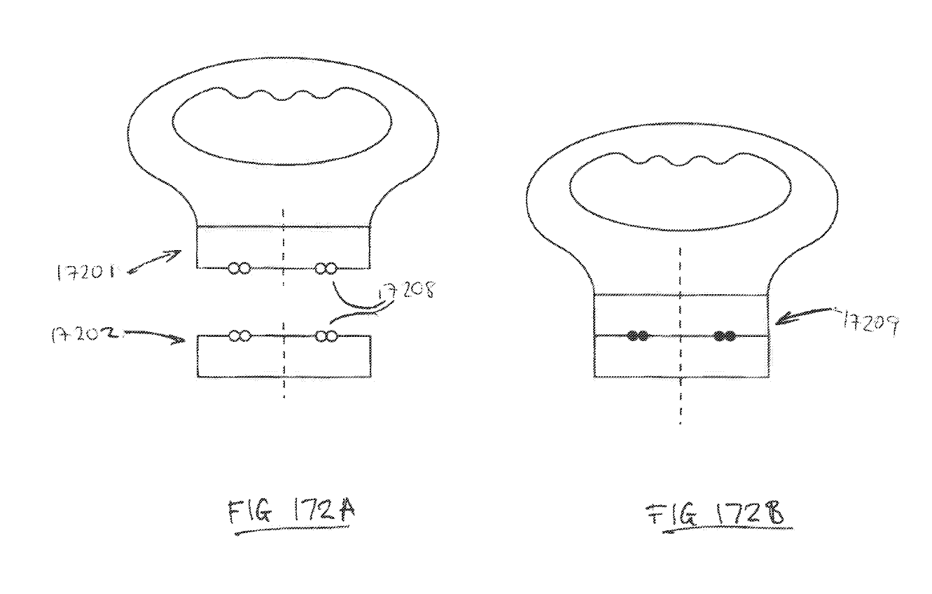

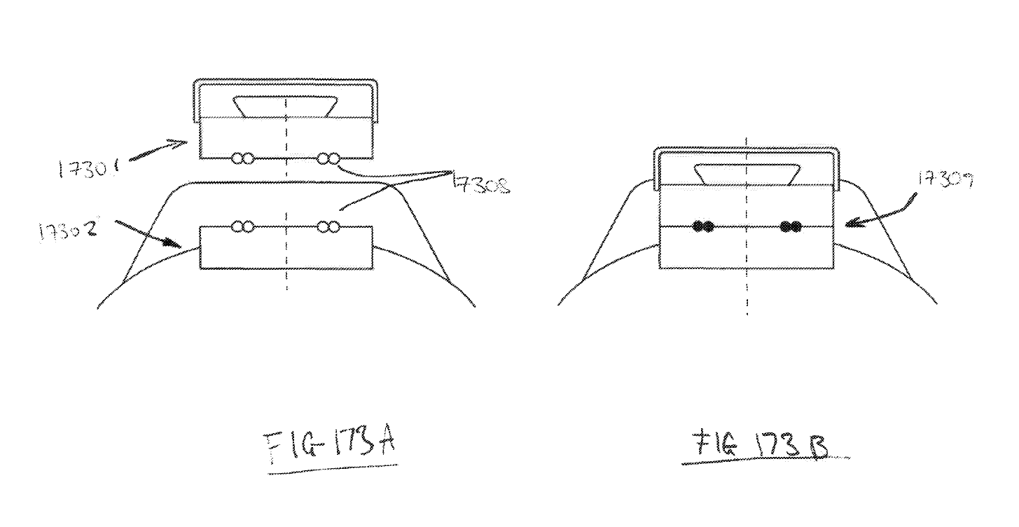

(See FIG. 176) If the required torque to tighten a first element is greater than can easily be provided with an axial “screwdriver”, a spanner embodiment 76-2027 can be provided comprising an apparatus 1769 including inter-engaging connecting faces 1768 and a lever, as illustrated in FIG. 176A. The lever may have a second connecting face or pair of connecting faces at its opposite end to enable tightening of a part of a fixing as illustrated in FIGS. 176A and 176B. An advantage is that the fixing may be completely sunk into a surface, and engagement with the spanner 176-2027 is still possible. Optionally, the lever element is offset but approximately parallel to the connecting face of the element to be tightened. Optionally, a “wrench set” of different tightening inter-engageable formations are connectible to a single lever.

Anchor.

FIGS. 92A and 92B illustrate a particular application of the use of a first part 921 of a device to provide a connecting face 928 as or comprising part of a head 92-2005 of another fixing device 92-2035, for example a bolt to expand a sleeved or predominantly annular wall fixing 92-2038 with expandable wedges 92-2039 or other components at its end, which are expanded by the end of the bolt shaft 92-2036 when inserted to the position of the expanding wedges 92-2039 to retain the wall fixing and the fixing device 92-2035 in a wall. This is similar to an expanding wall fixing device manufactured by Hilti, Switzerland, for example.

Universal Joint or Goose Neck.

FIG. 93 illustrates a universal joint 93-2040 attached to a second part 932 of an interlocking connector 939. The universal joint 93-2040 may be a mechanical universal joint or comprise a highly flexible material, for example a natural or synthetic rubber. The universal joint 93-2040 is typically attached to another object 93-2041, for example a rod. The object or rod 93-2041 may assist the remote engagement of the second part 932 to a first part 931 or, may form part of another device, for example, a tiller extension. Alternatively, a ball joint can be connected to the second part 932, providing a rotational capability that can be fixed, for example by means of a clamping screw thread. A practical use for this embodiment is as a means of connecting an object to another item 93-2035, for example a camera or other optical device to a tripod.

Bearing or Other Means of Rotation.

FIG. 94A illustrates a second part 942 with connecting face 948 on one side and a freely rotating part 94-2042 on the other side. The freely rotating part 94-2042 typically is rotatable coaxially with the second part 942, for example by means of a race of ball bearings as seen in FIGS. 95, 96, 97, 98 and 99, wherein thereference numerals are similar to those used in FIG. 94, but incorporate the relevant figure number as a prefix. The freely rotating part 94-2042 enables rotation without transmitting torsional loading onto the second part 942 and any connected first part 941 of a connector. The freely rotating part 94-2042 is used, for example, to support a hook or picture or other device which is thereby enabled to hang vertically or otherwise with its centre of gravity directly beneath the axis of rotation. Rotating part 94-2042 may form part of a pulley arrangement or form the support for an object to be rotated.

Actuated by Actuator.

FIG. 100 illustrates an apparatus 10009 including two inter-engageable parts 10001, 10002, wherein external means of rotary actuation is applied to the apparatus by means of linear actuator 100-2045.

FIG. 101 illustrates an apparatus 10109 including two inter-engageable parts 10101, 10102, wherein an external means of rotary actuation is applied to the second part 10102 of the apparatus 10109 by means of a belt drive 101-2046.

FIG. 102 illustrates an apparatus 10209 including two inter-engageable parts 10201, 10202 wherein an external means of rotary actuation is applied to the apparatus by means of a cog drive 102-2045.

FIG. 103 illustrates an apparatus 10309 which may be operated as a spring bias clutch. The apparatus includes two inter-engageable parts 10301, 10302. In this apparatus, inter-engagement of the two parts 10301, 10302 is influenced by the bias of a spring 103-2002 or other means. The apparatus 10309 offers transmission in one direction and disengagement in the other, and thus acts as a clutch mechanism.

FIG. 104 illustrates a roller end 104-2041. The roller end 104-2041 includes a connecting face 10408 and is thus equivalent to a first part 10401 of a connector 10409. The connecting face 10408 of the roller end 104-2041 is engageable with a corresponding connecting face 10408 of a second part 10402 of the connector 10409. The second part 10402 of the connector may be driven, and when the second part 10402 is inter-engaged with the roller-end 104-2041, drive may be transmitted to the roller end 104-2041. The roller may be used in the manufacture of other goods.

FIG. 105 illustrates a part of an apparatus 10509 which includes a Kline fitting. It is known to clamp two flanged components 105-2051 together, for example in the field of industrial chemistry or additive manufacture. The apparatus 10509 includes two parts 10501, 10502 which are connectable together as discussed above. Reference numeral 105-2050 represents a seal, such as an o-ring or gasket, which is positioned between the components 105-2051.

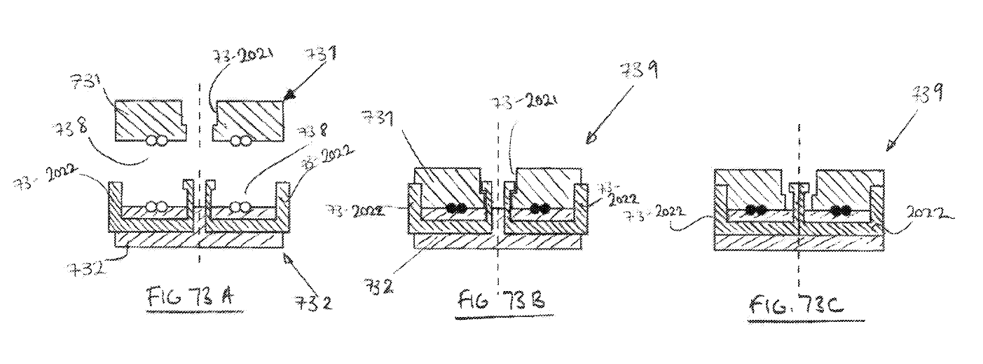

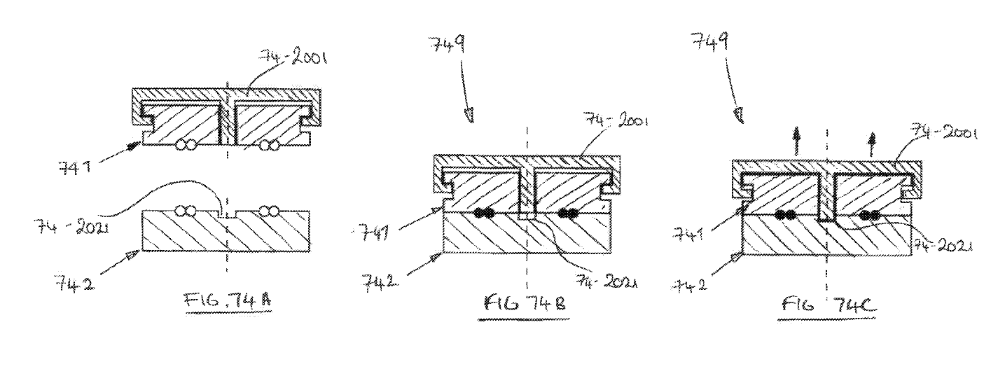

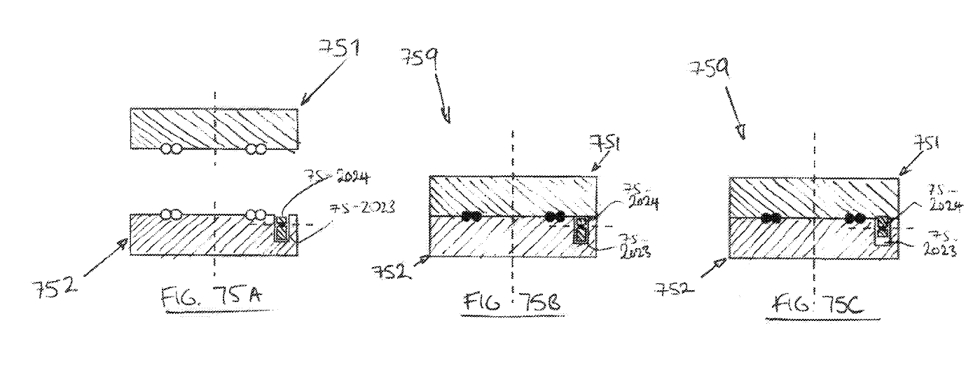

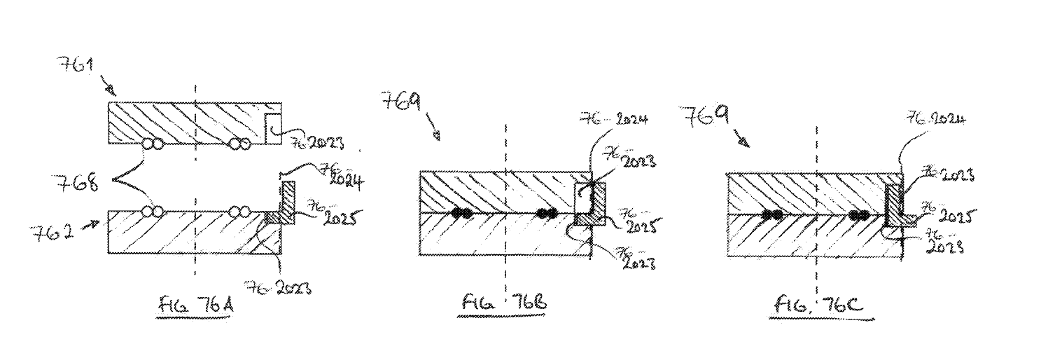

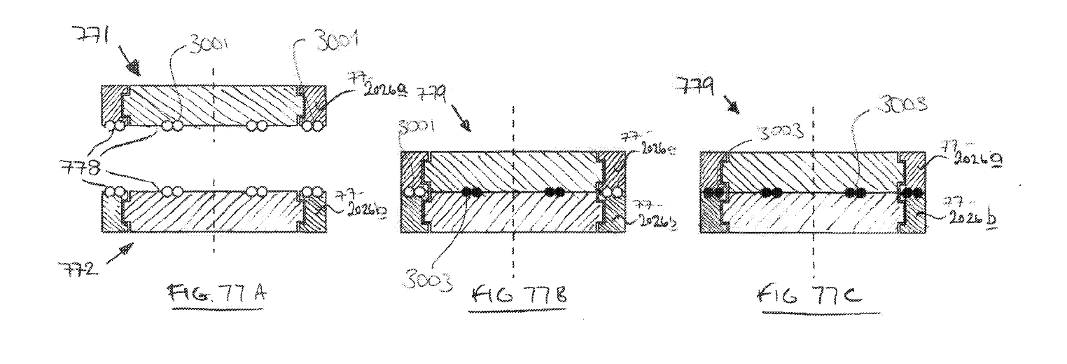

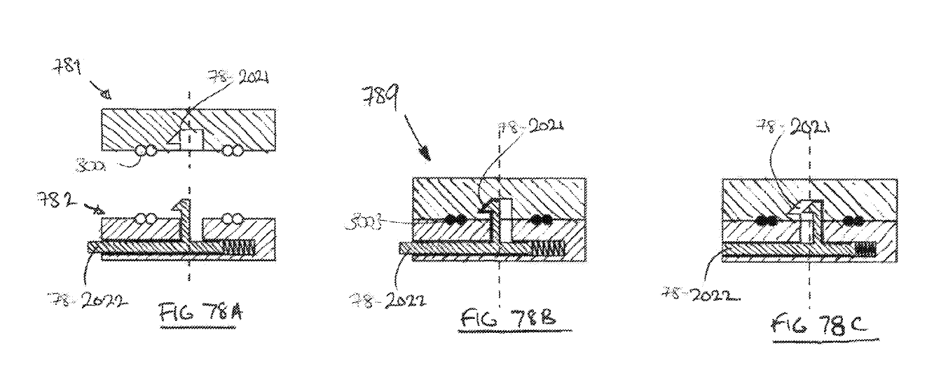

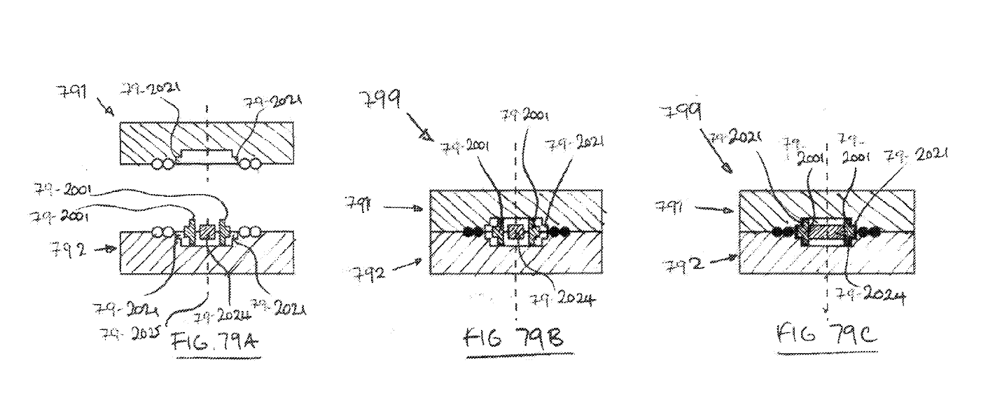

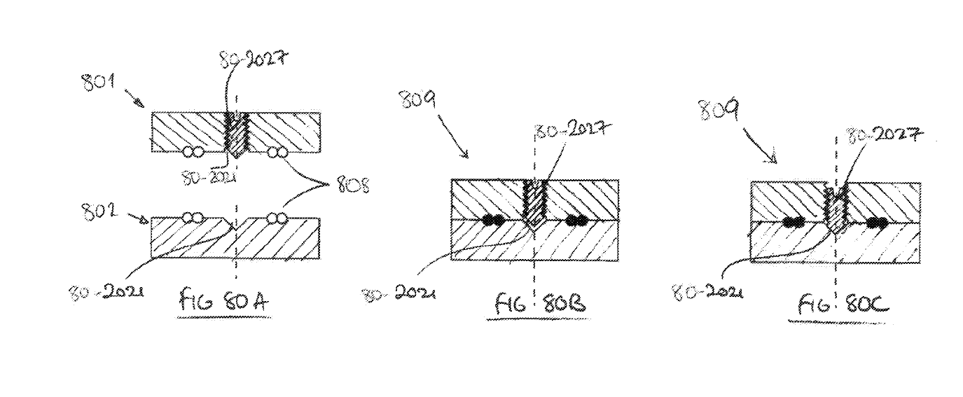

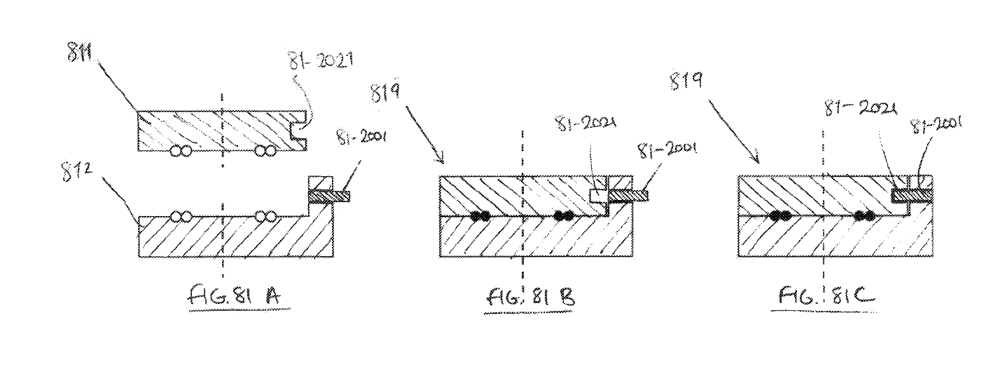

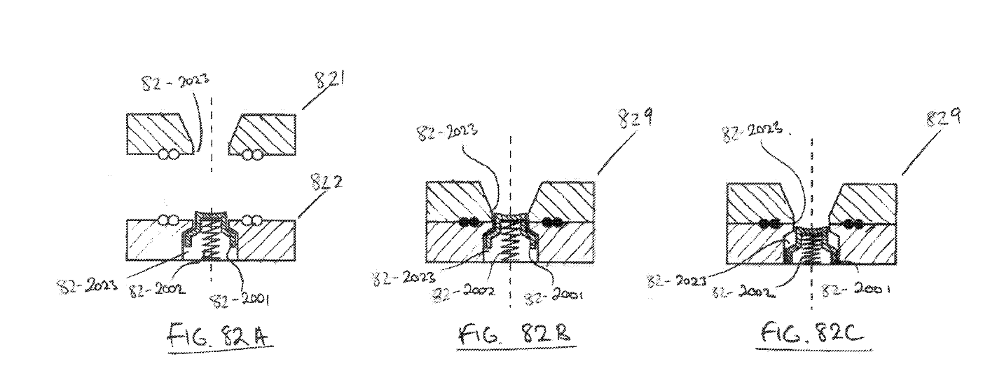

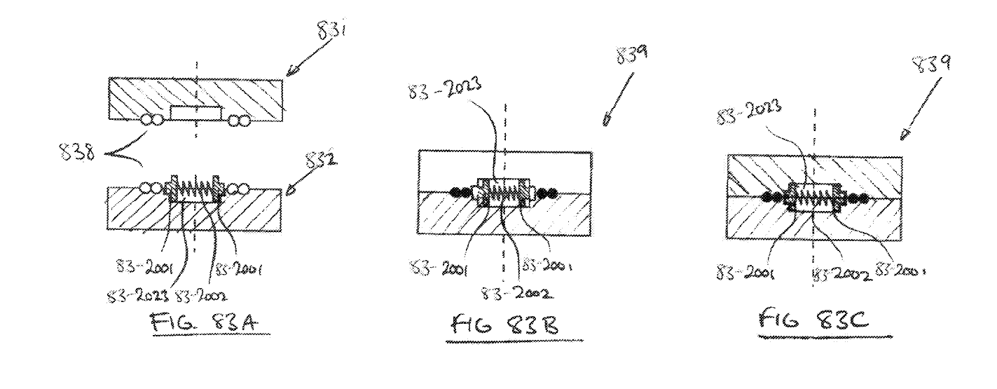

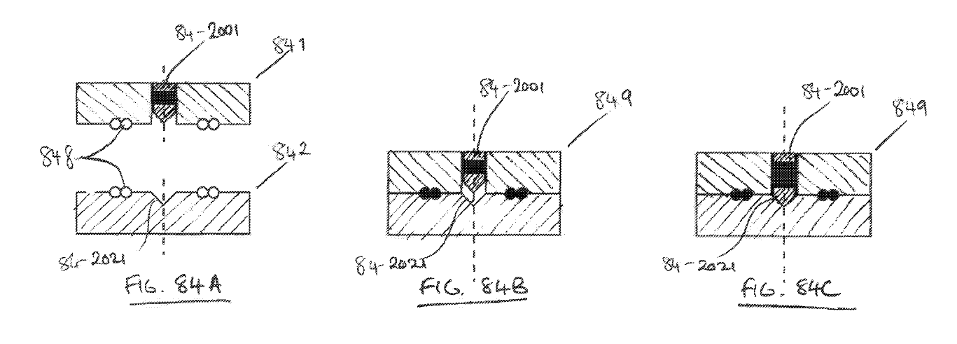

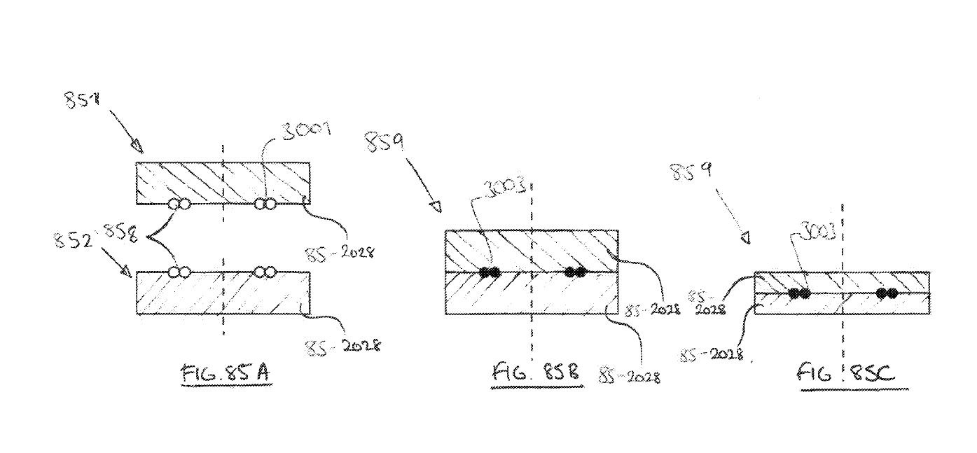

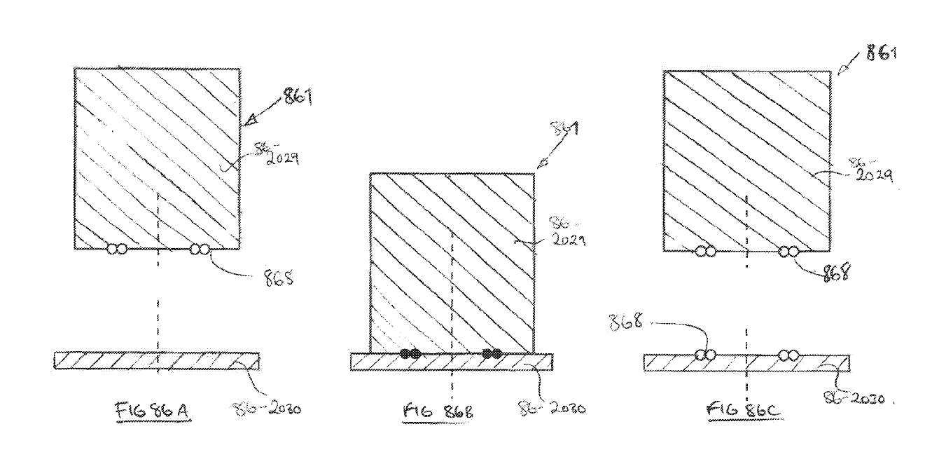

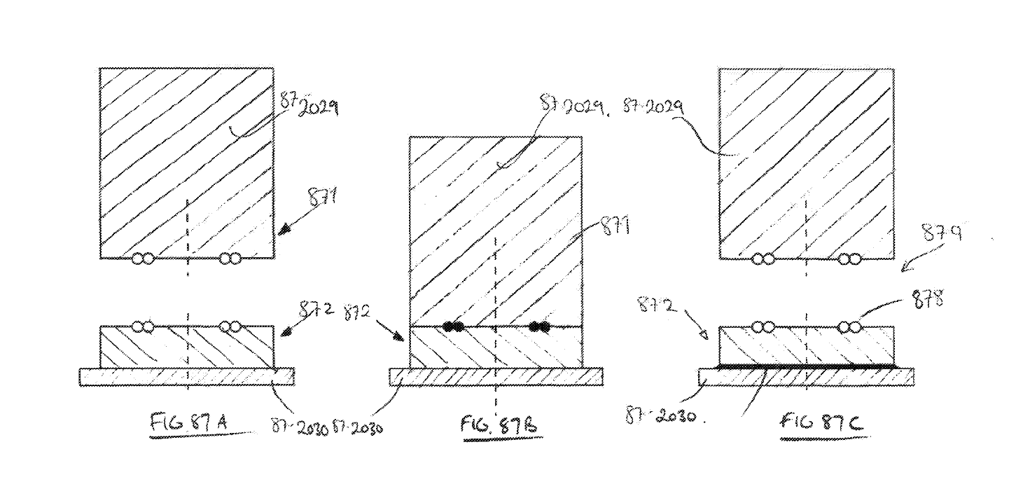

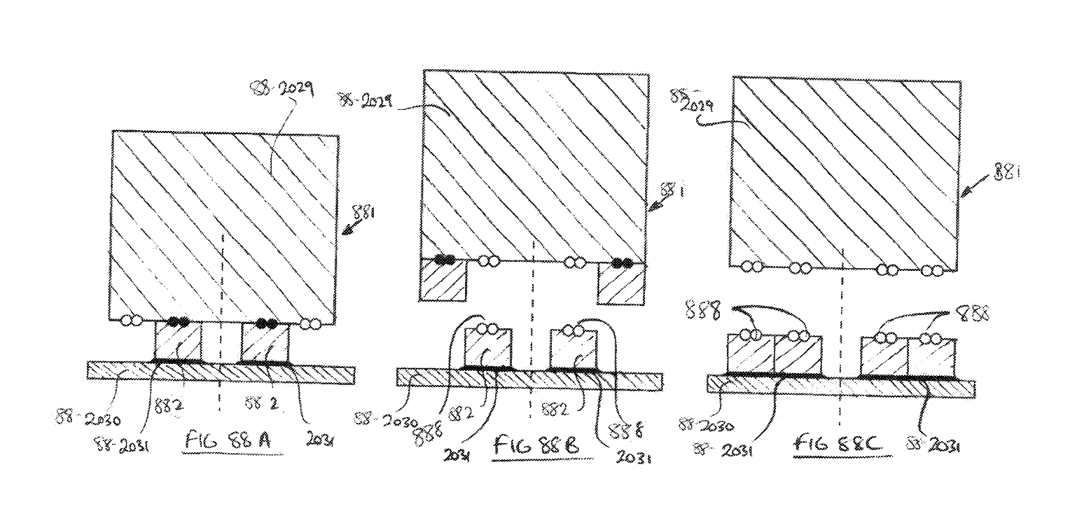

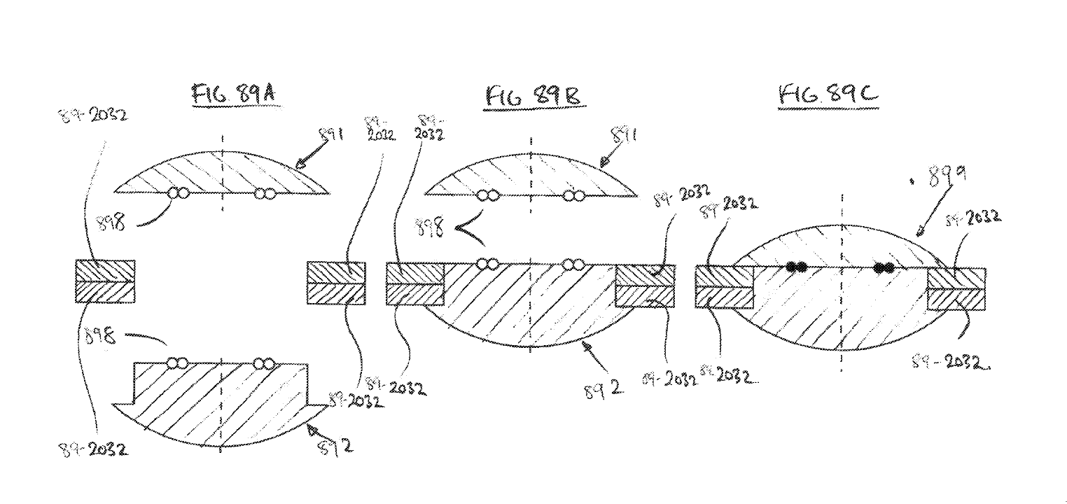

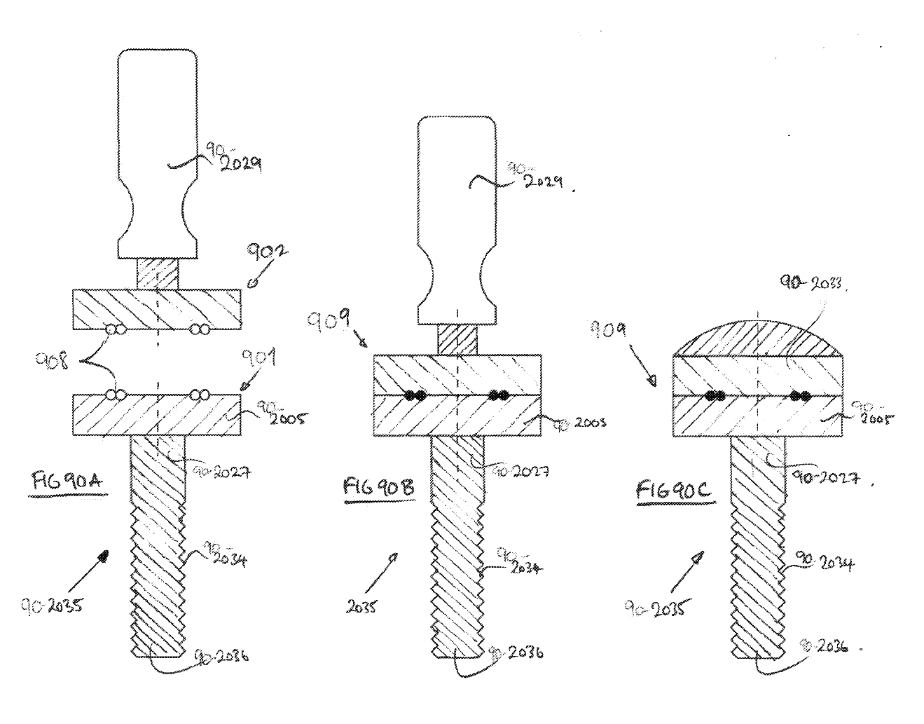

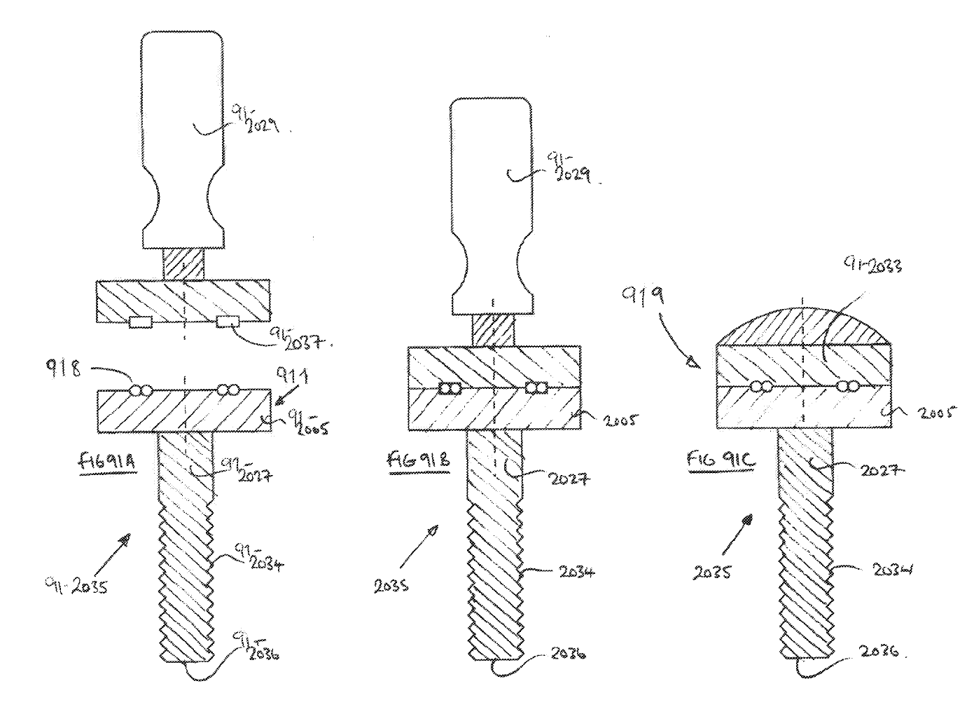

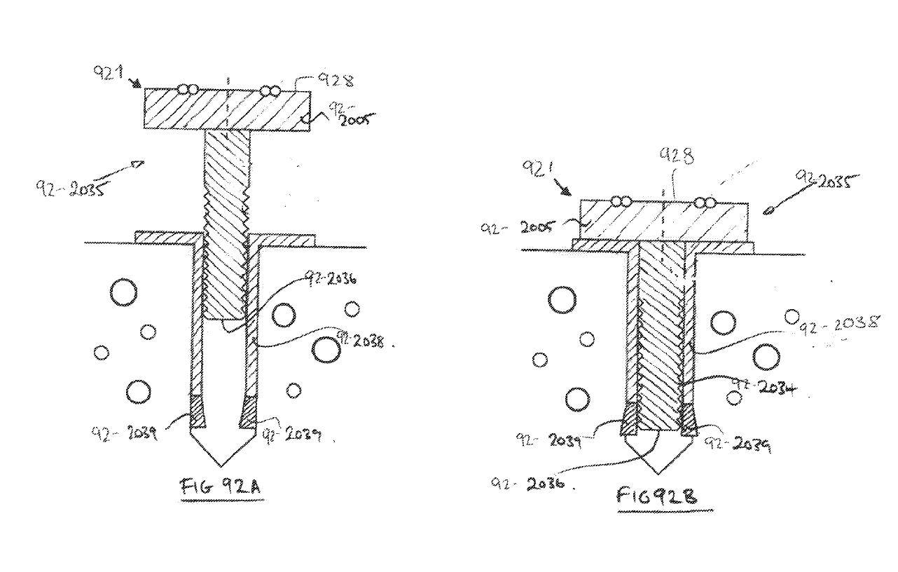

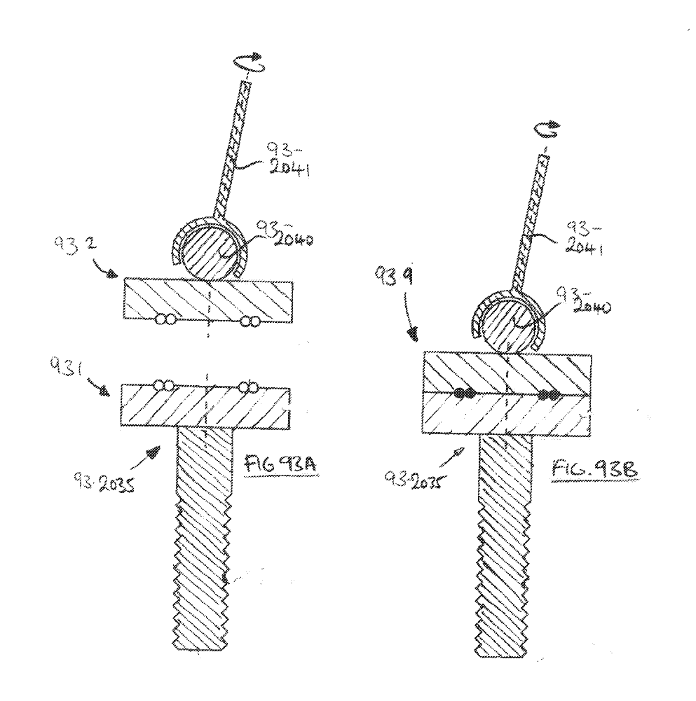

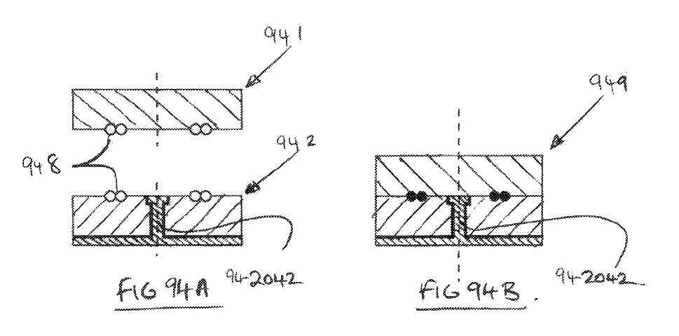

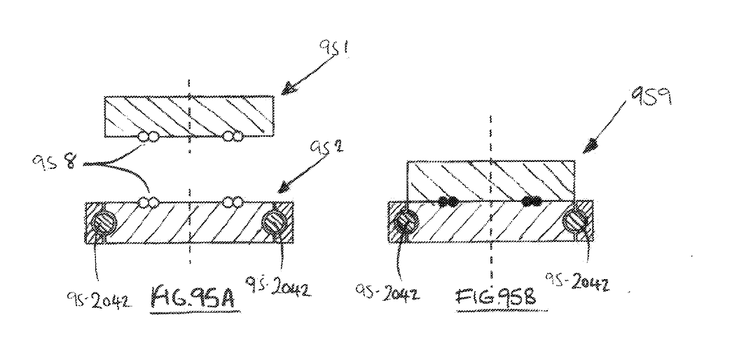

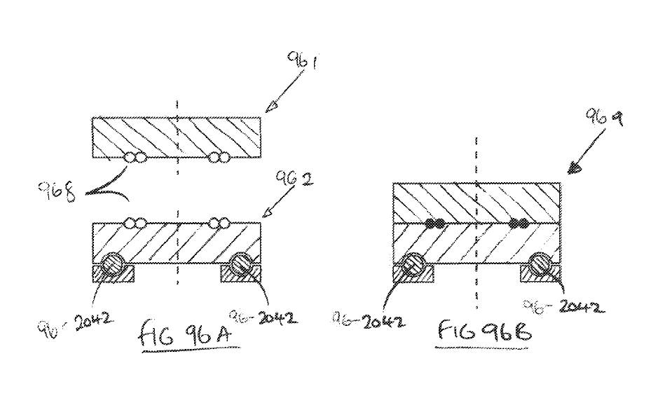

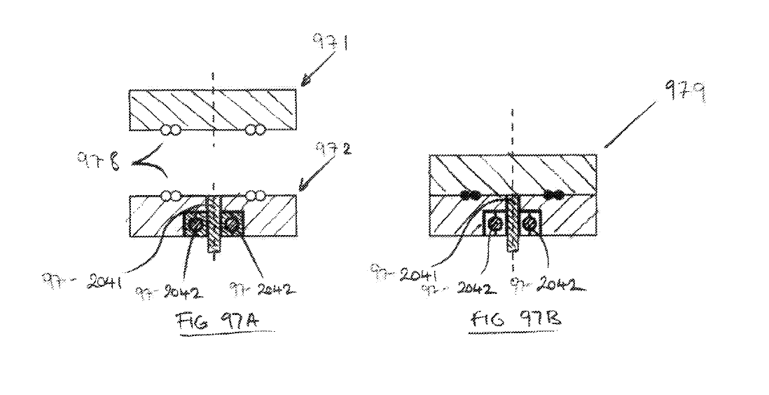

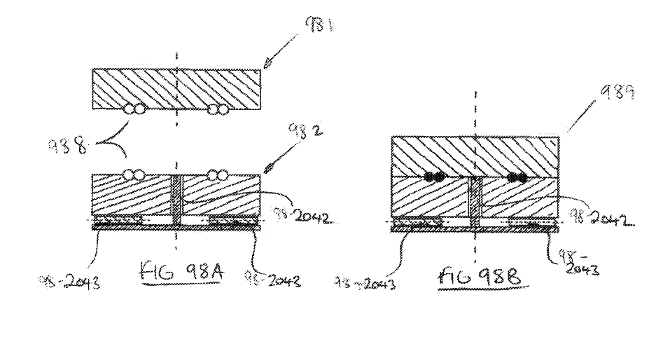

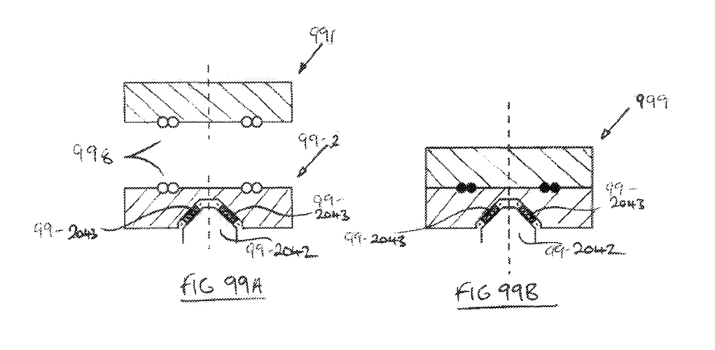

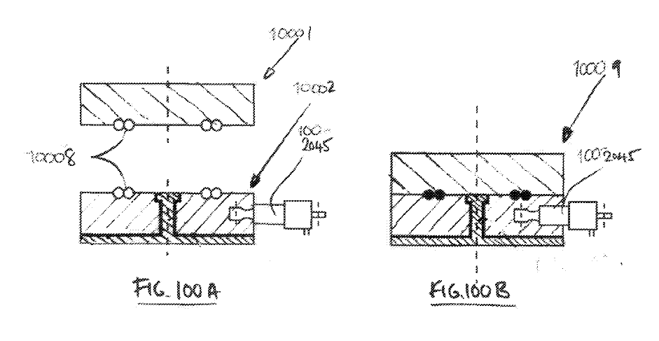

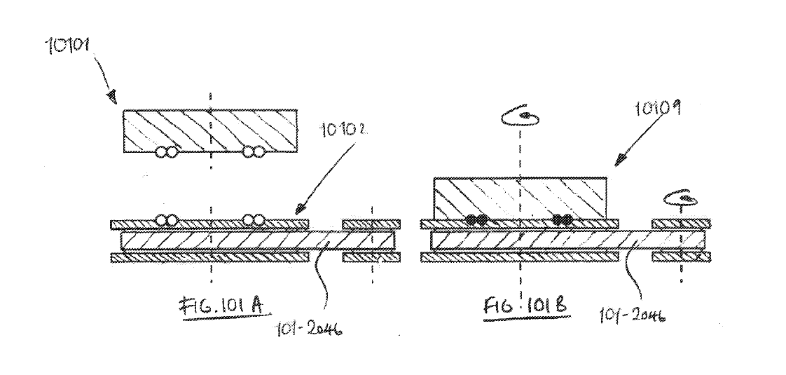

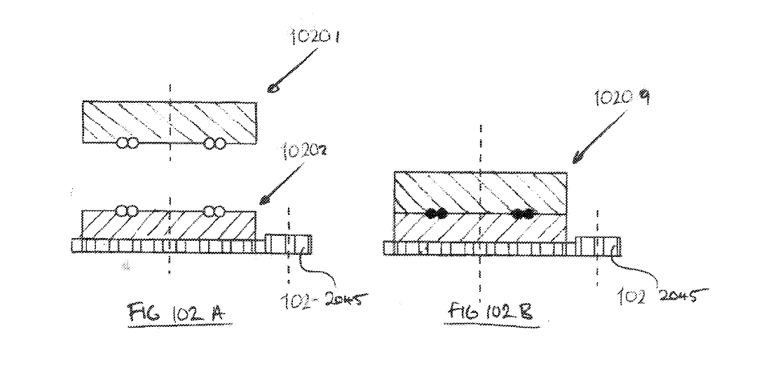

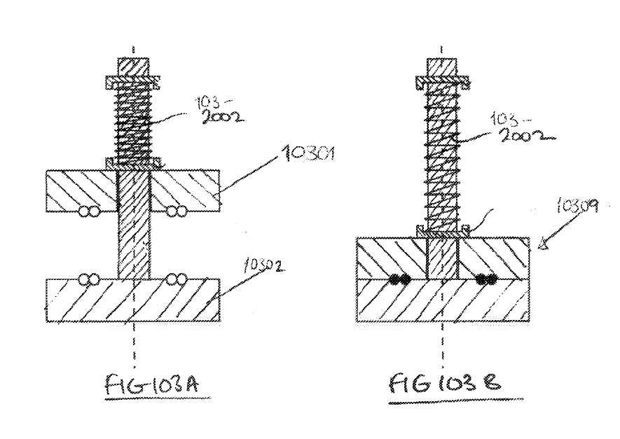

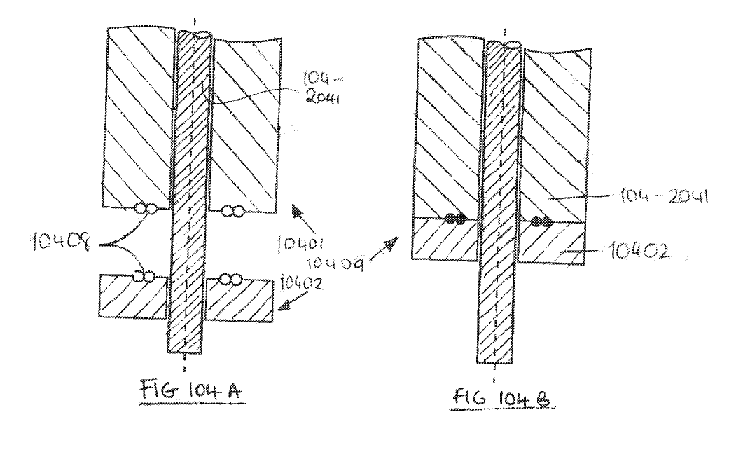

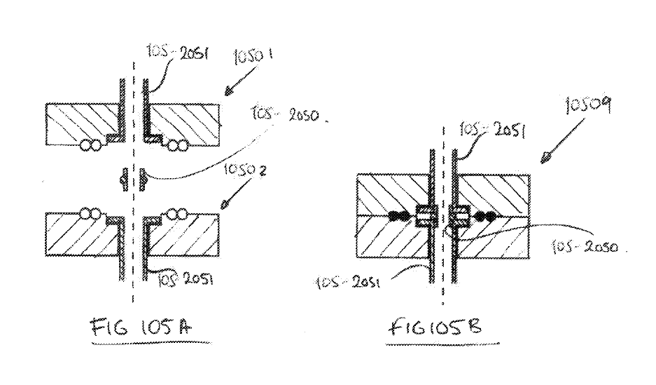

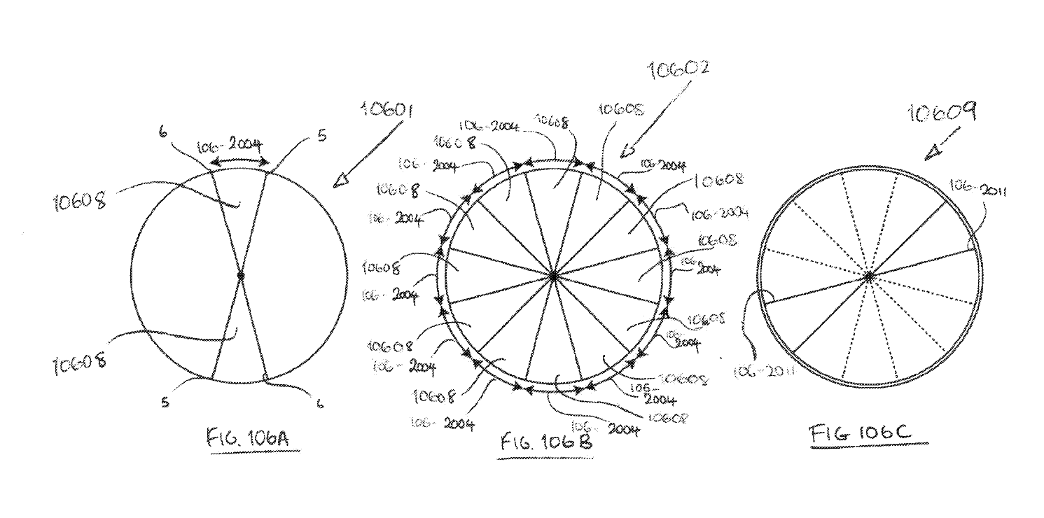

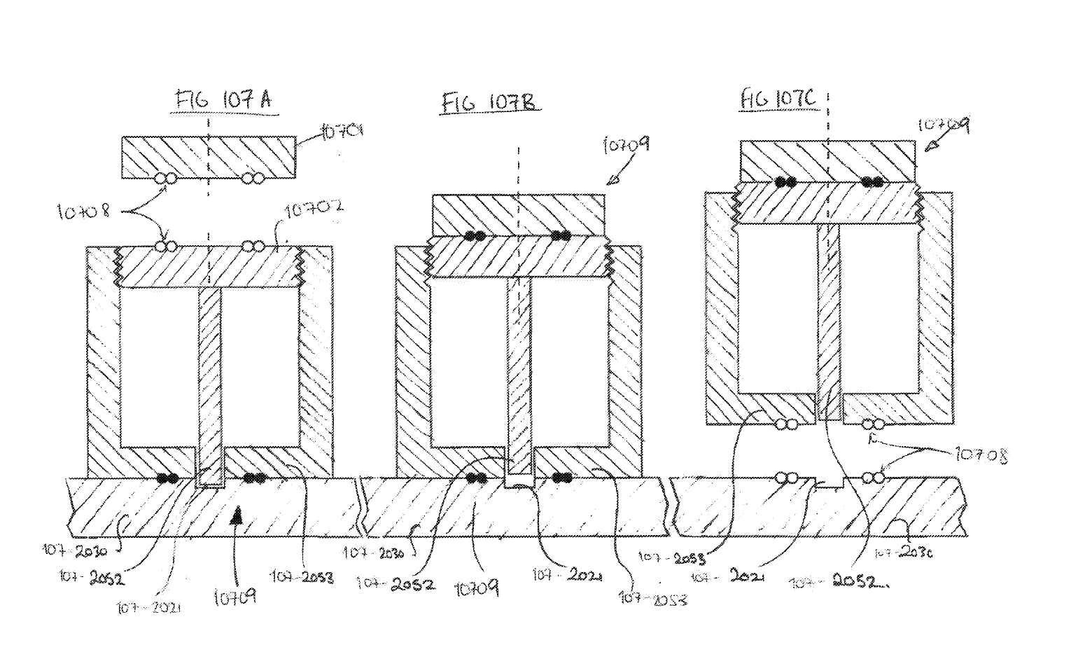

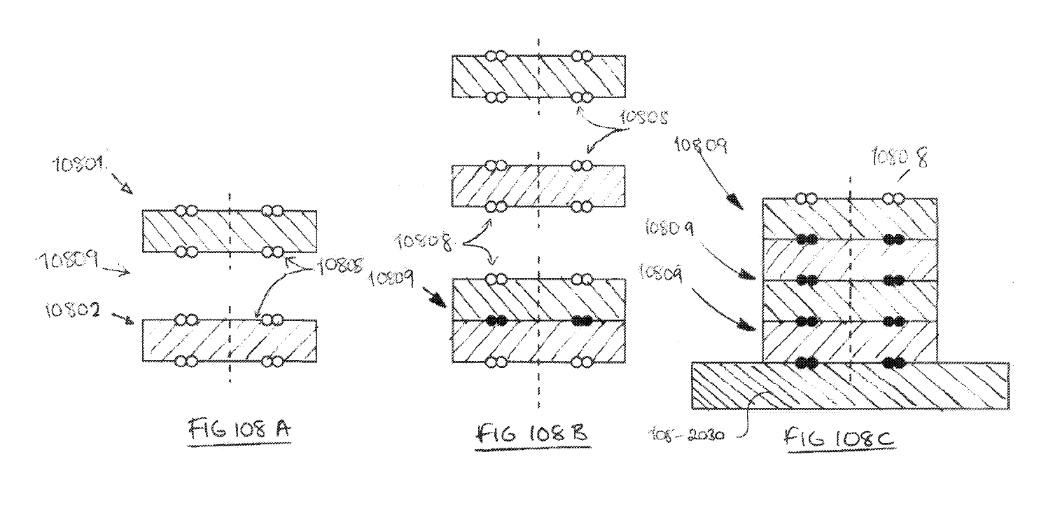

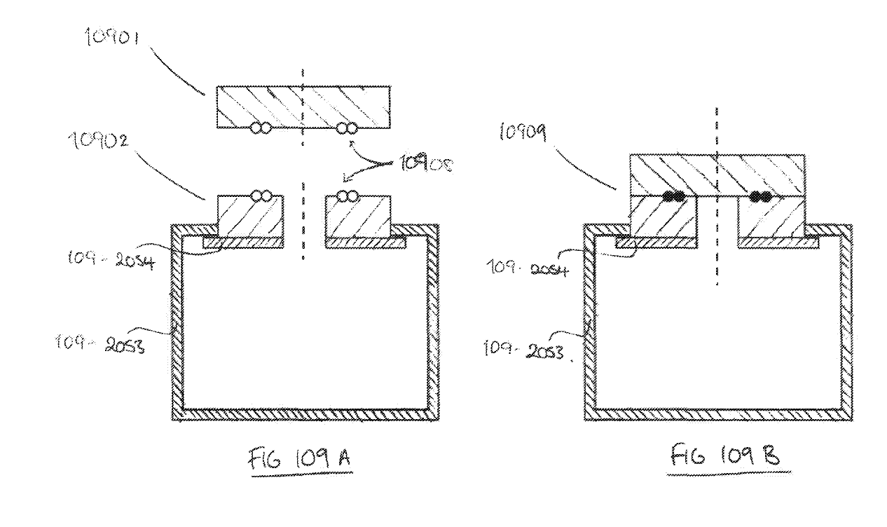

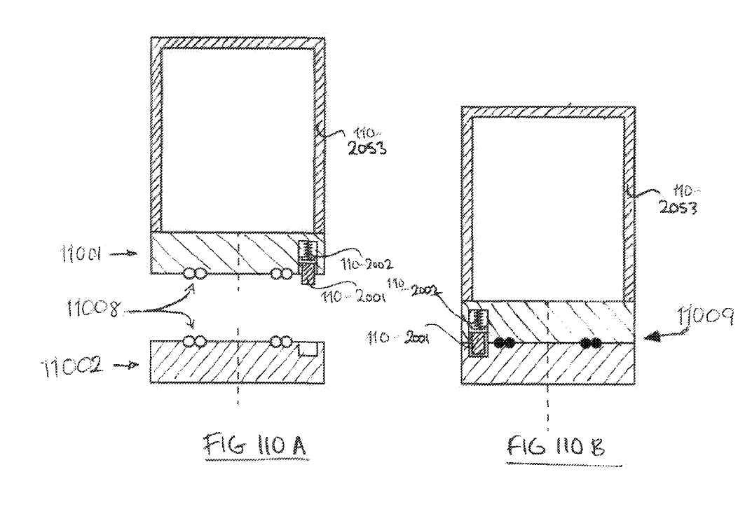

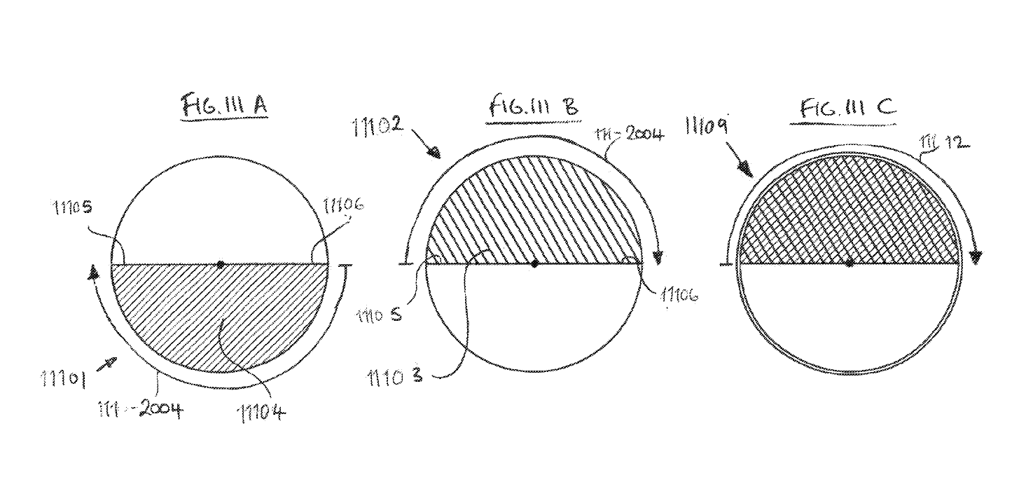

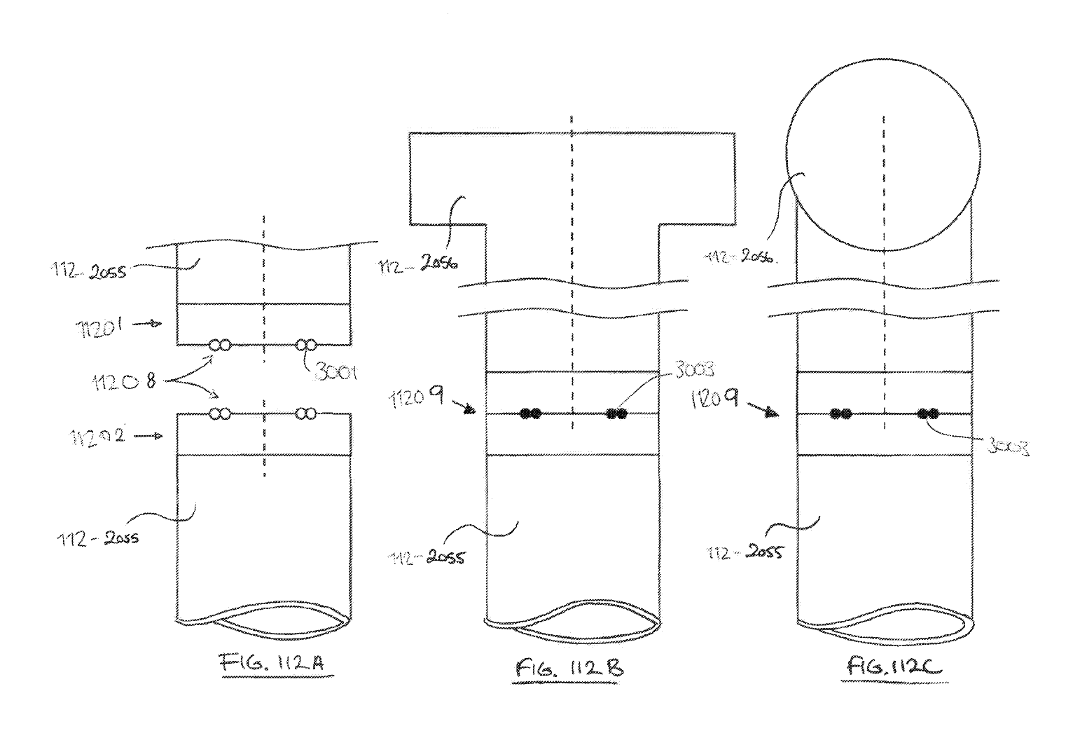

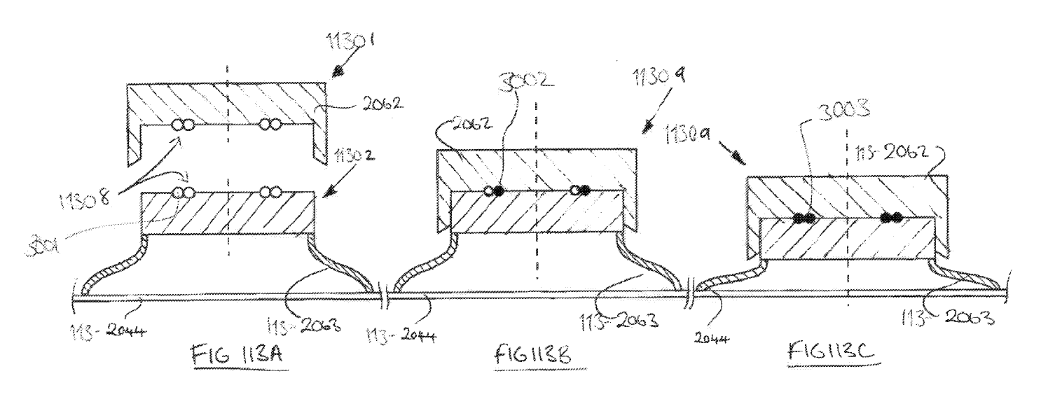

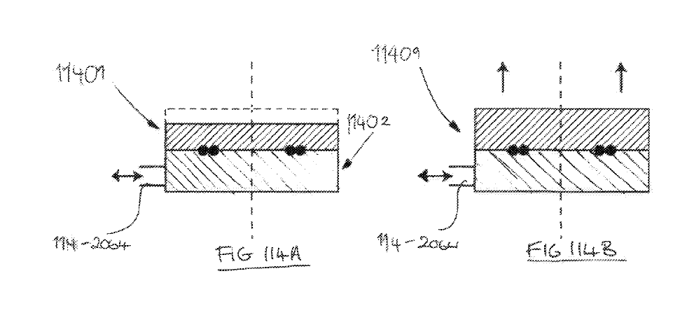

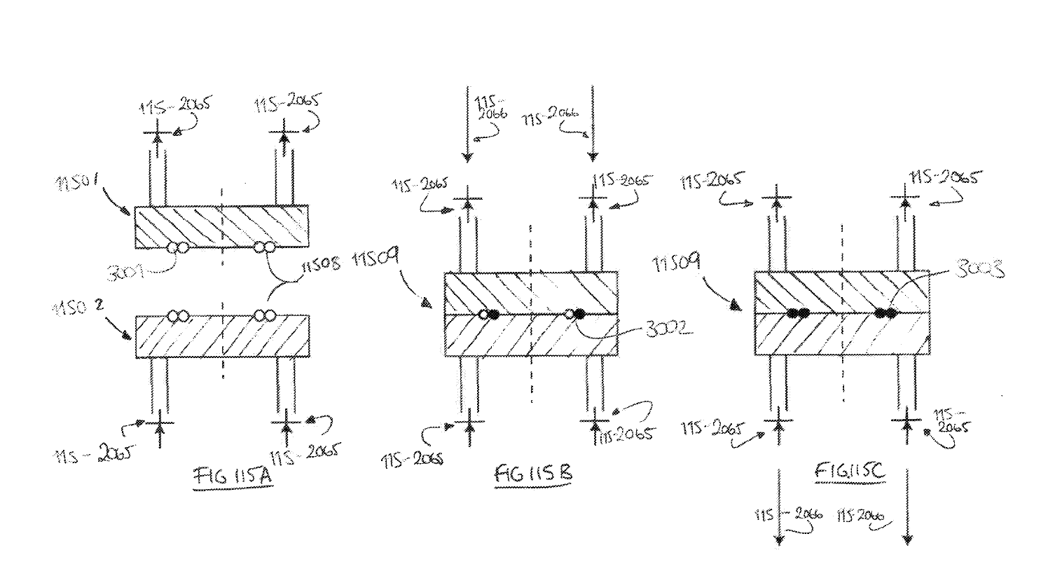

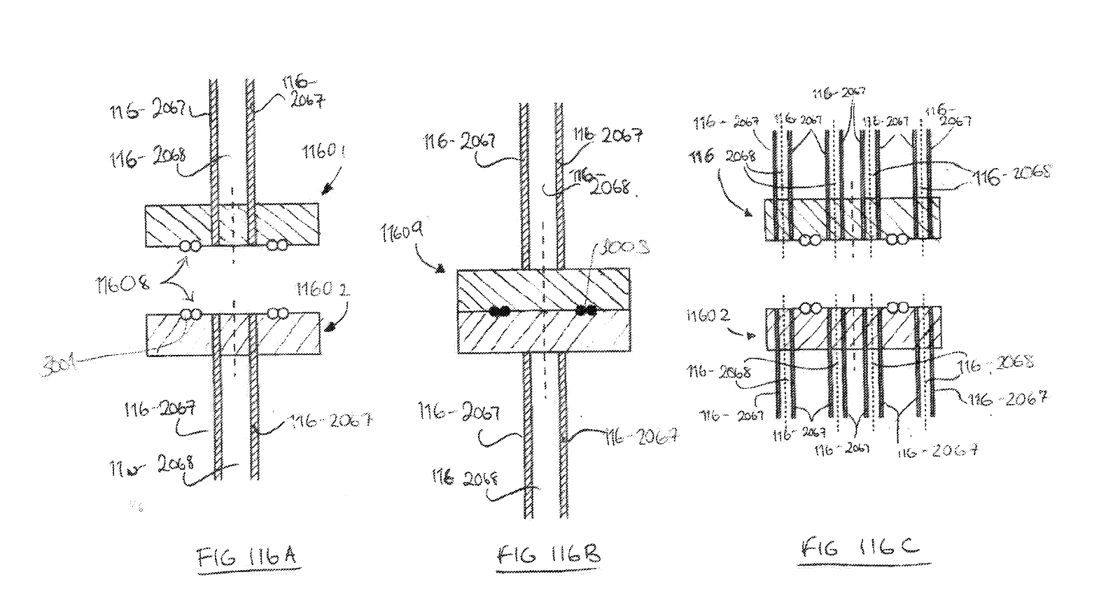

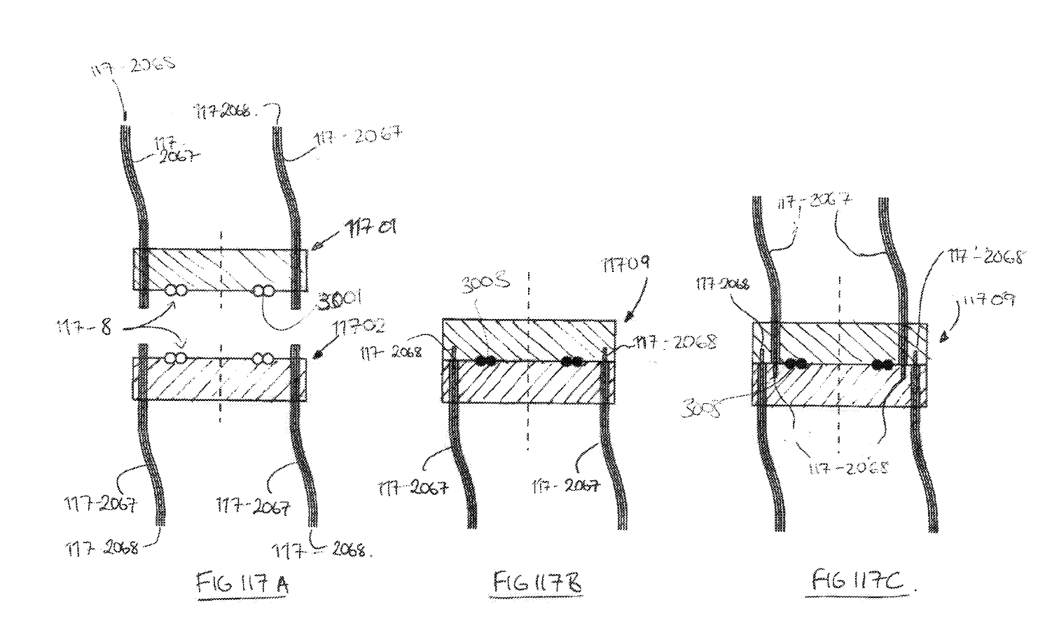

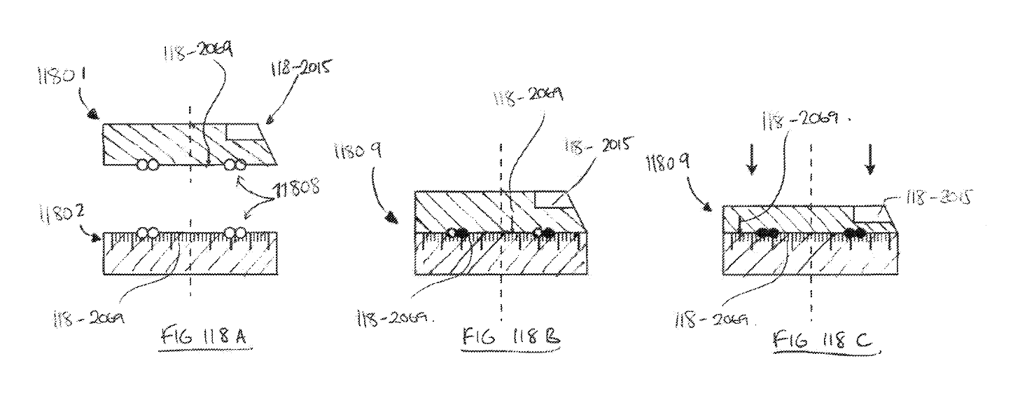

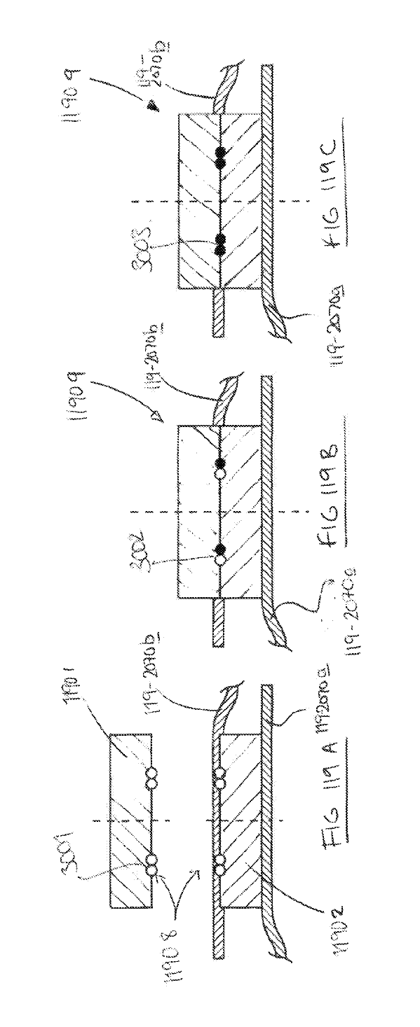

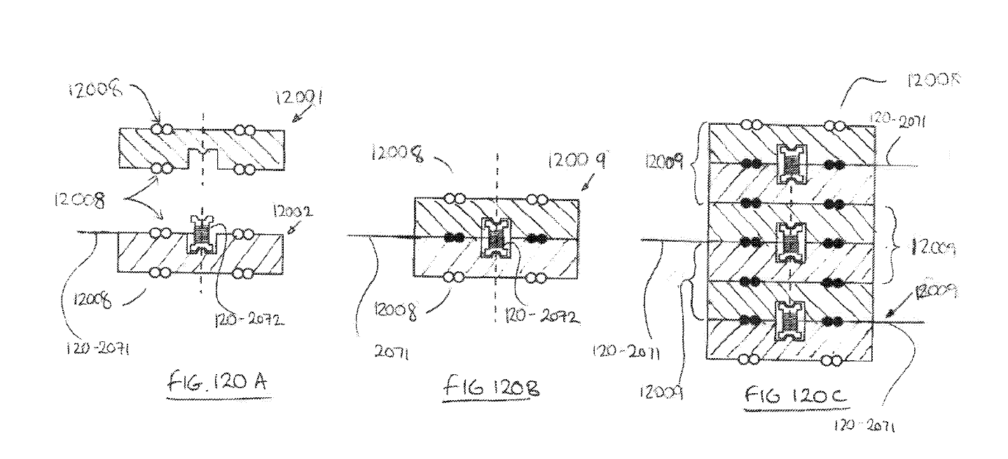

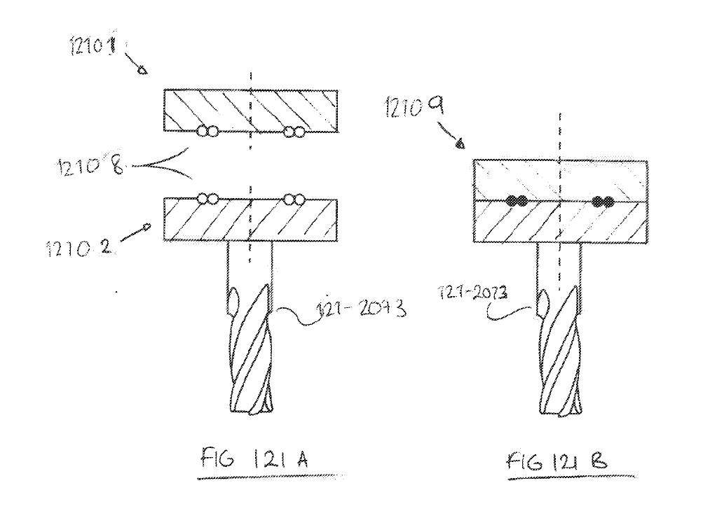

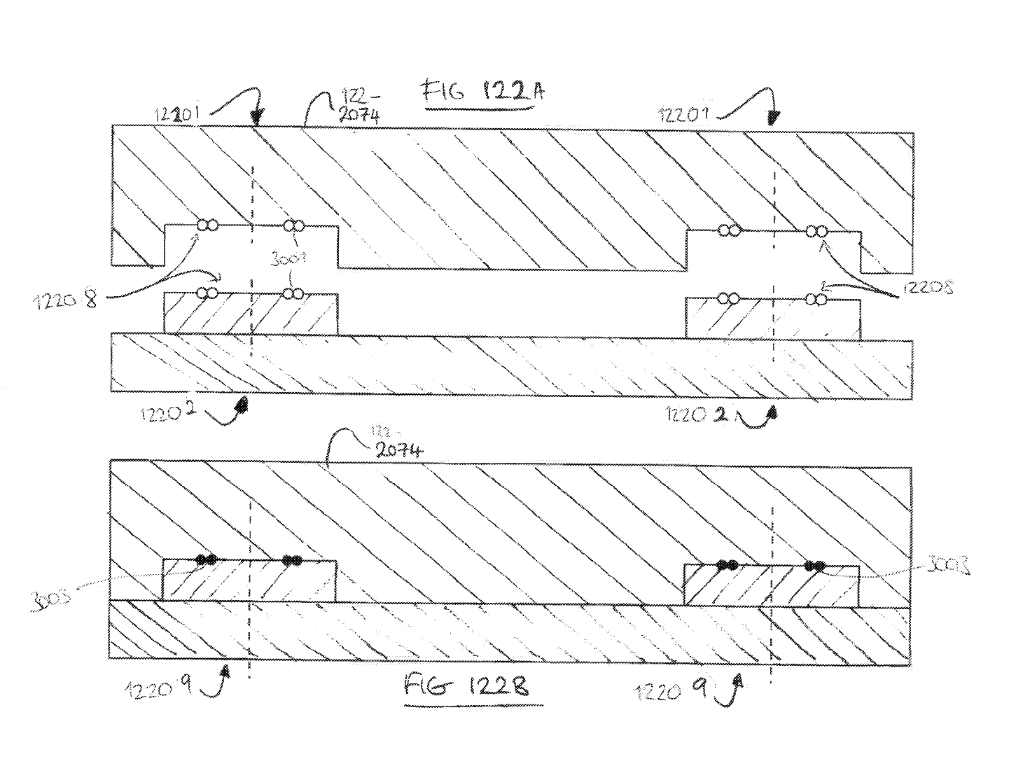

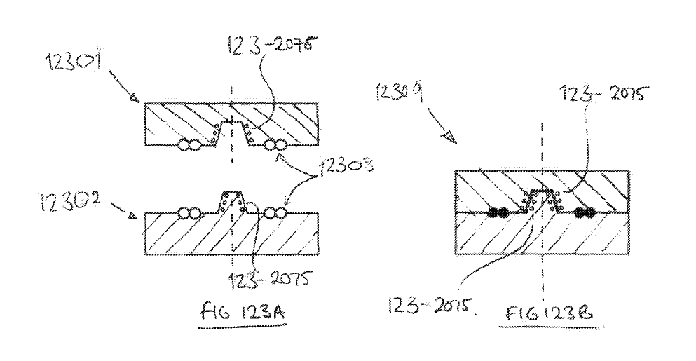

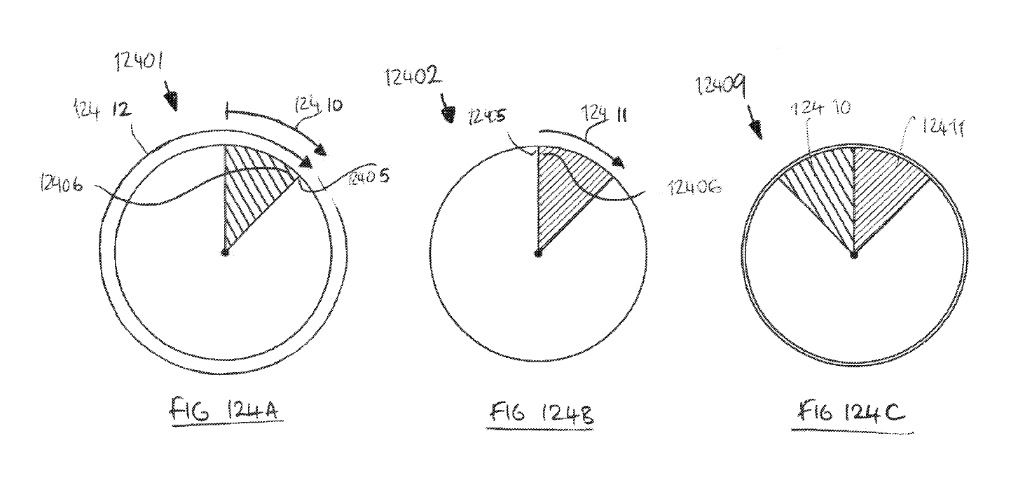

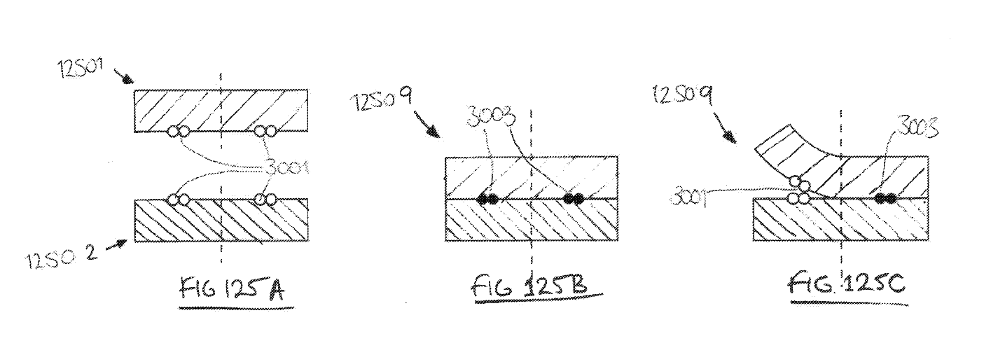

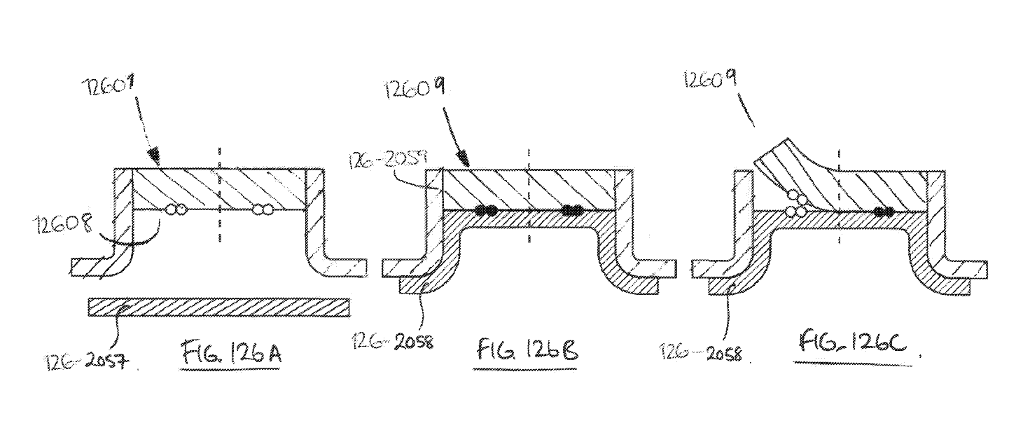

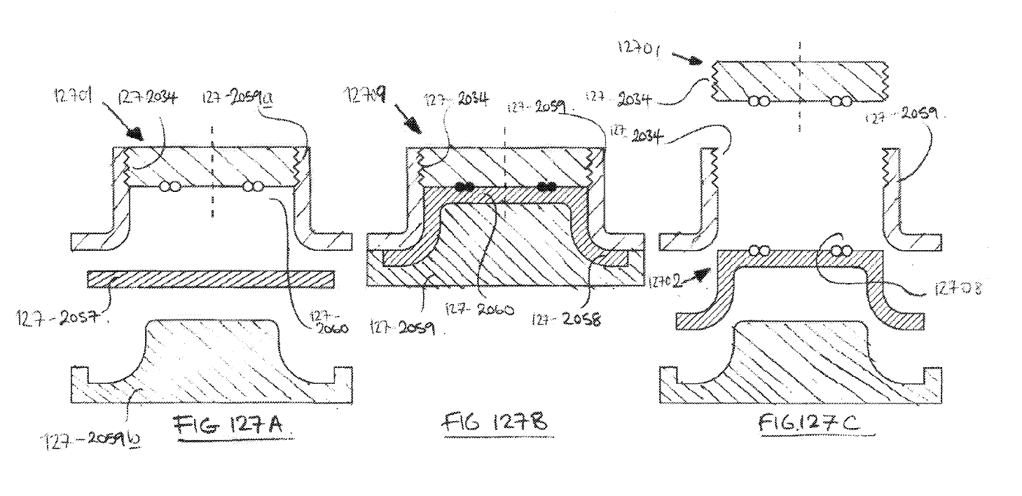

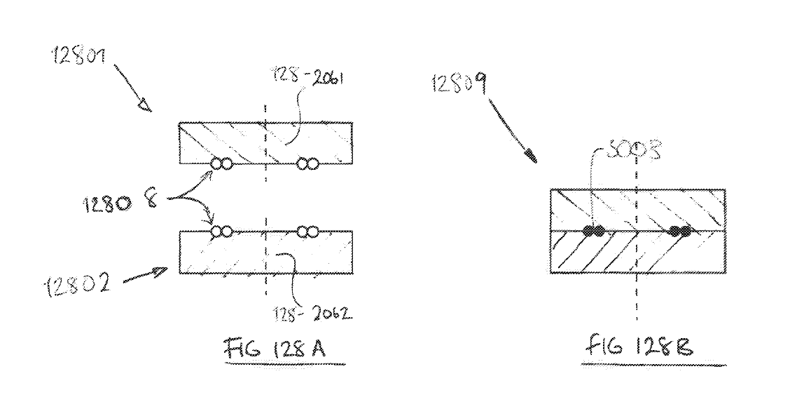

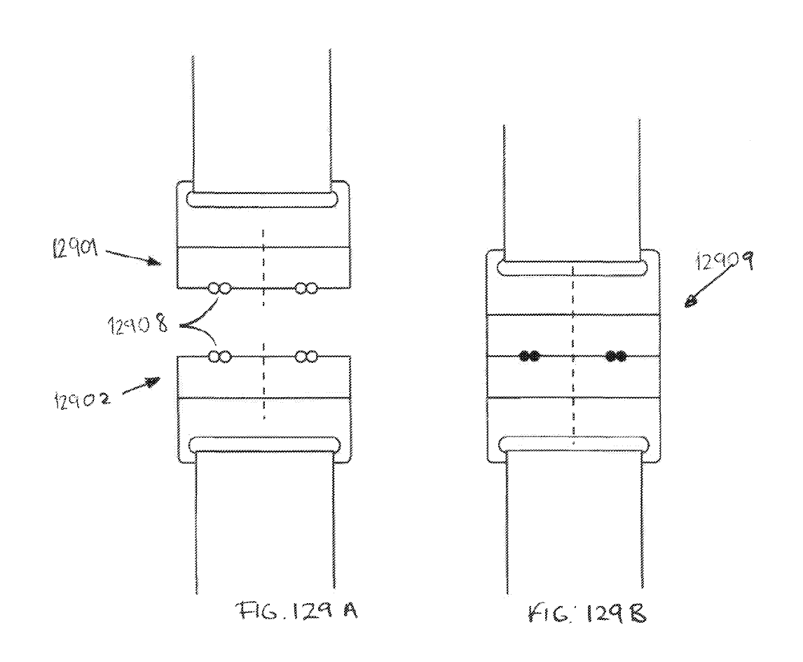

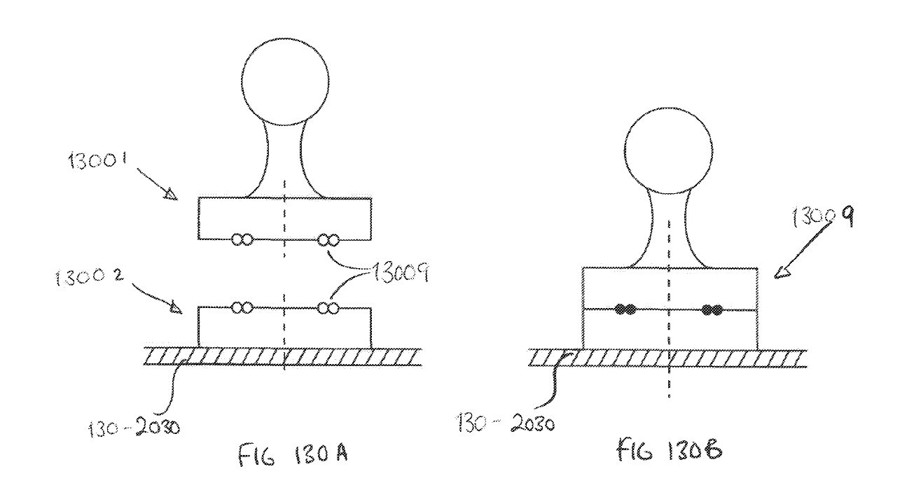

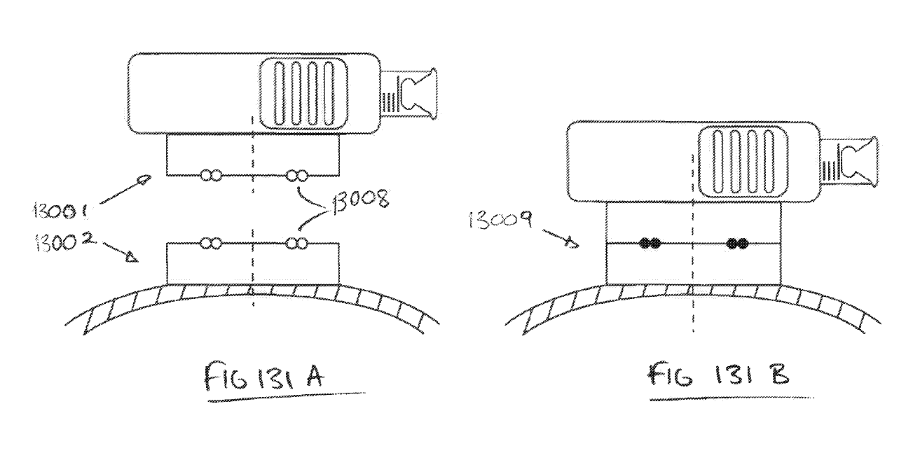

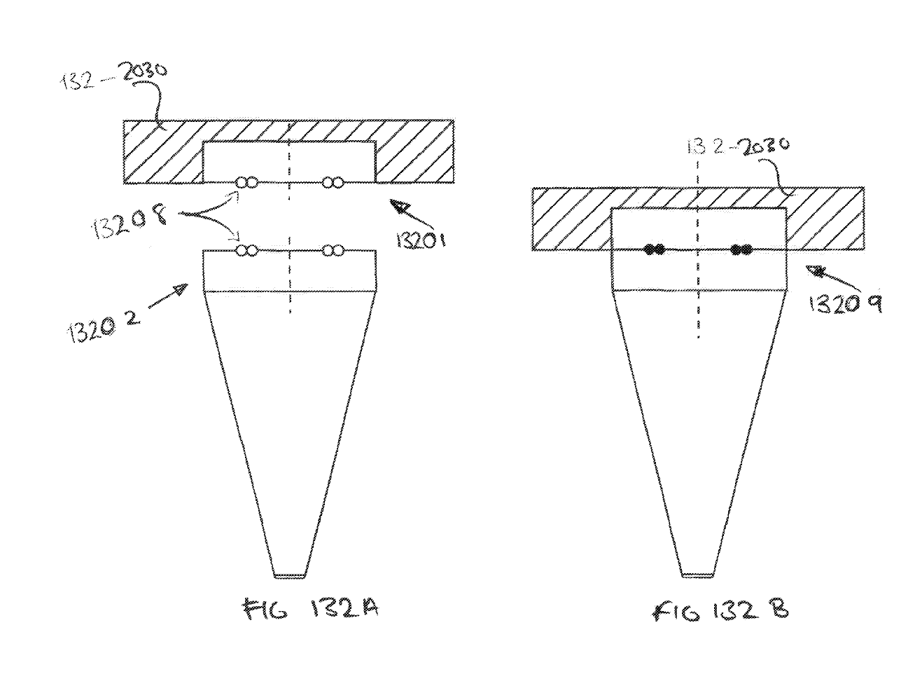

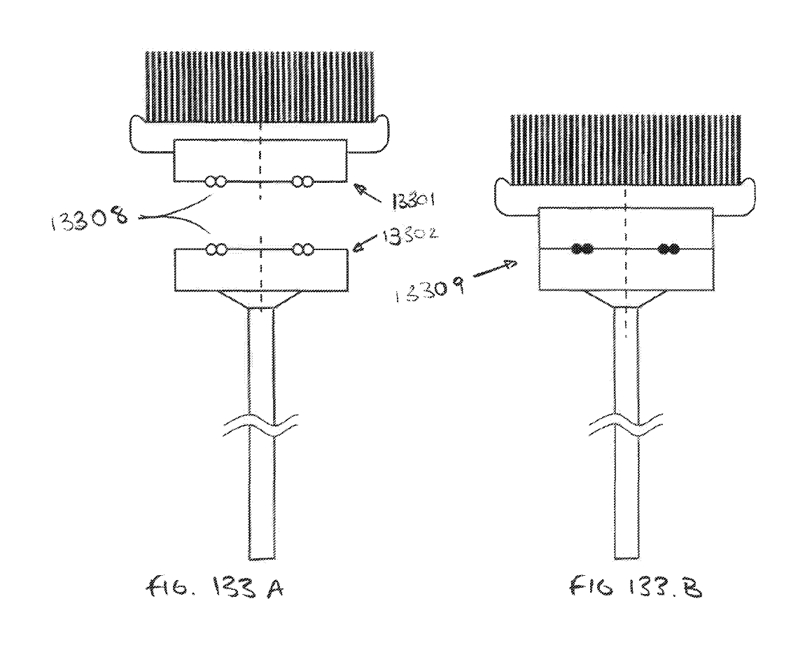

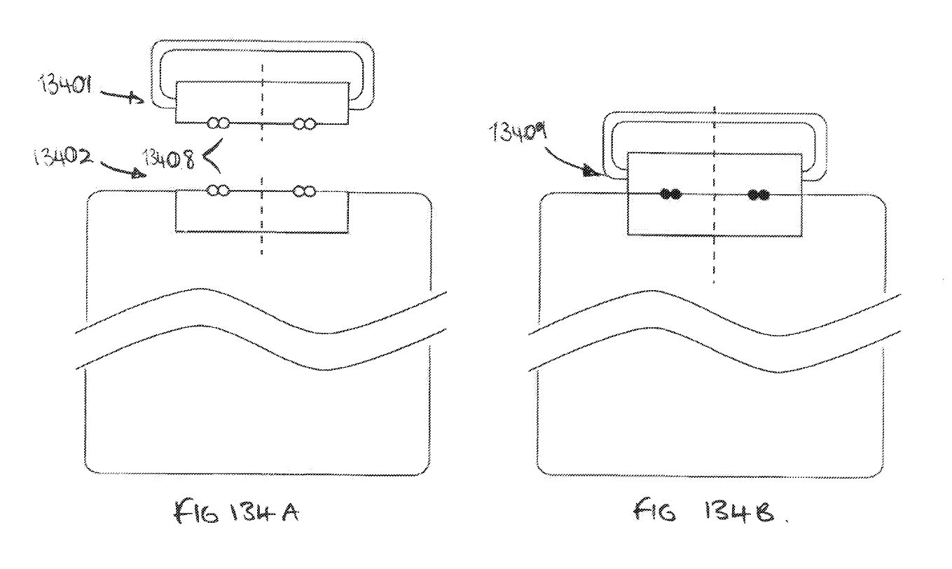

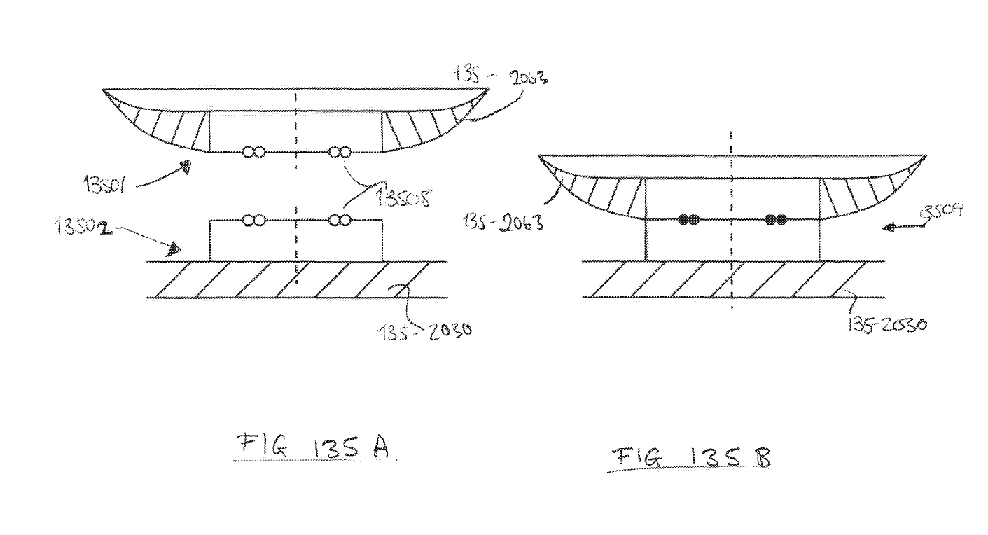

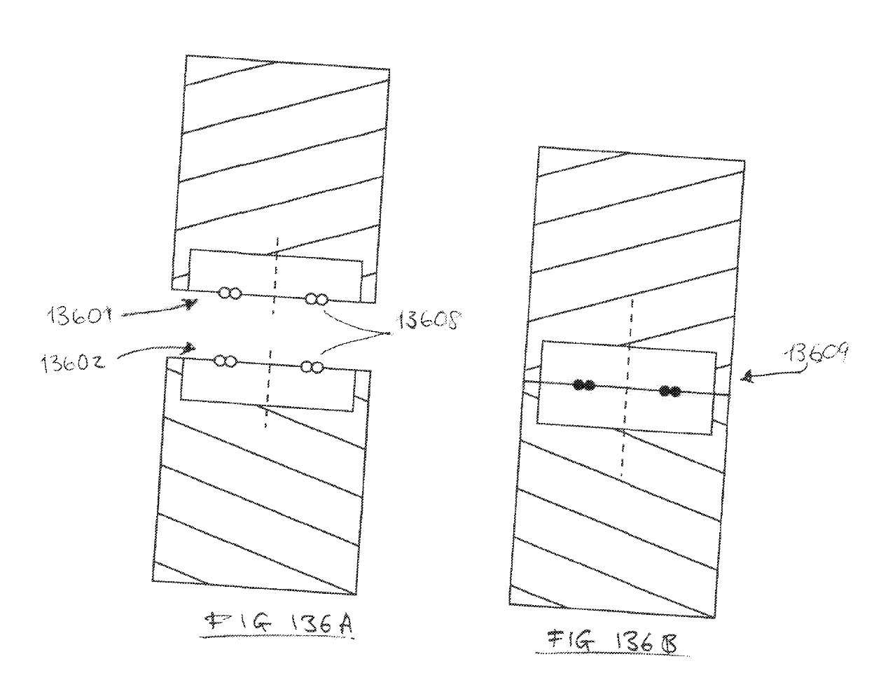

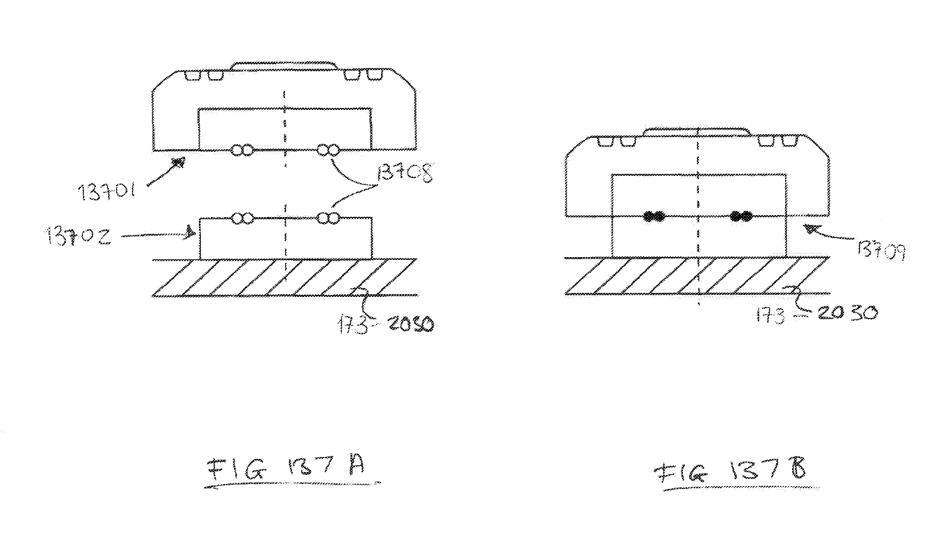

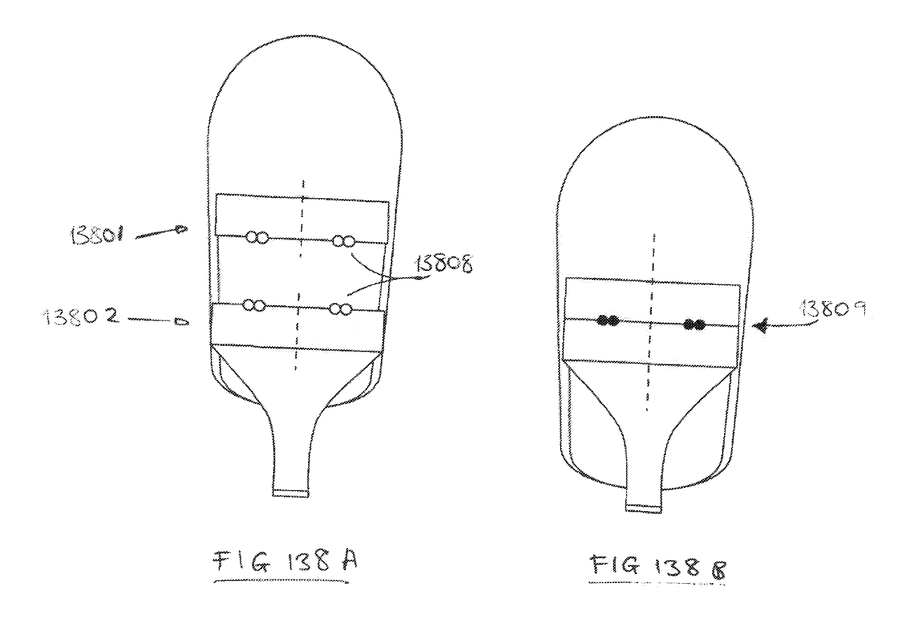

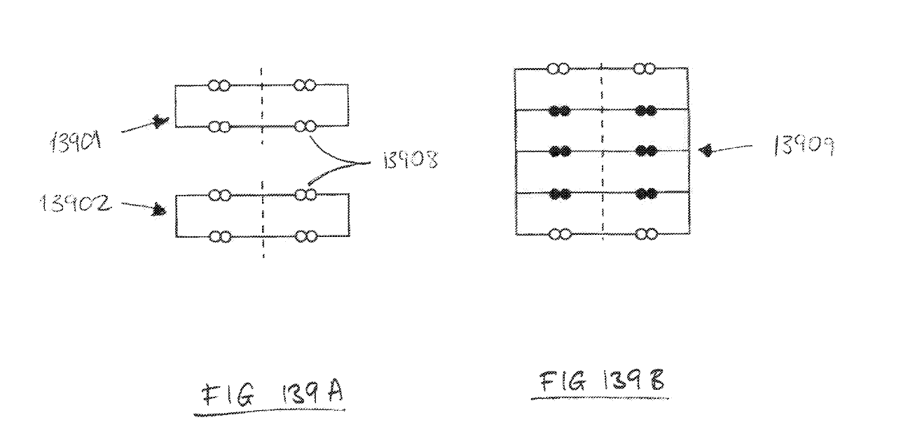

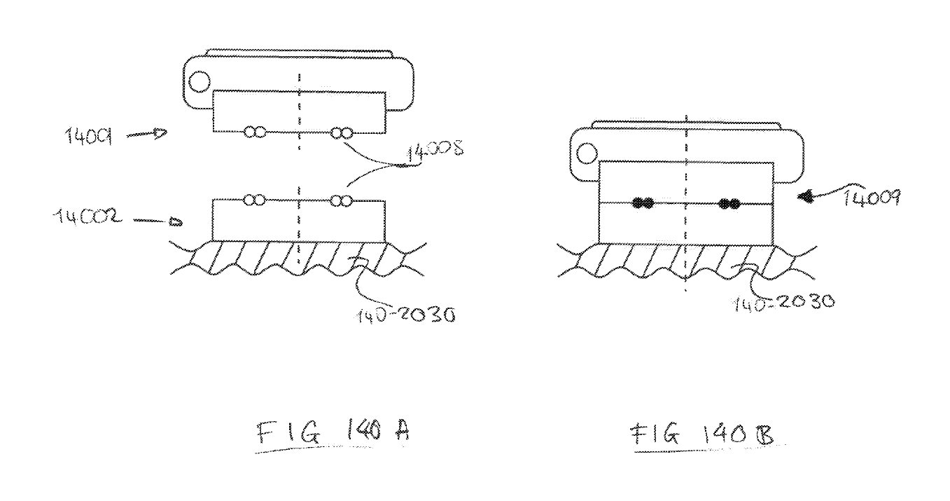

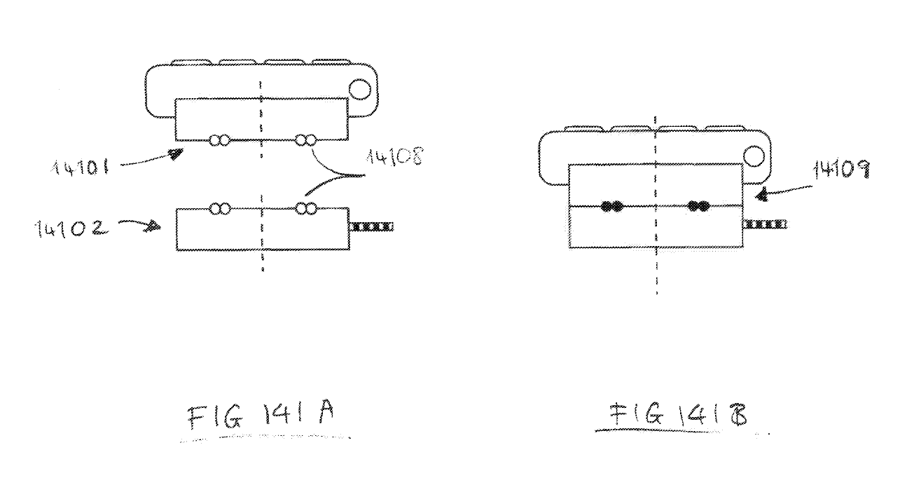

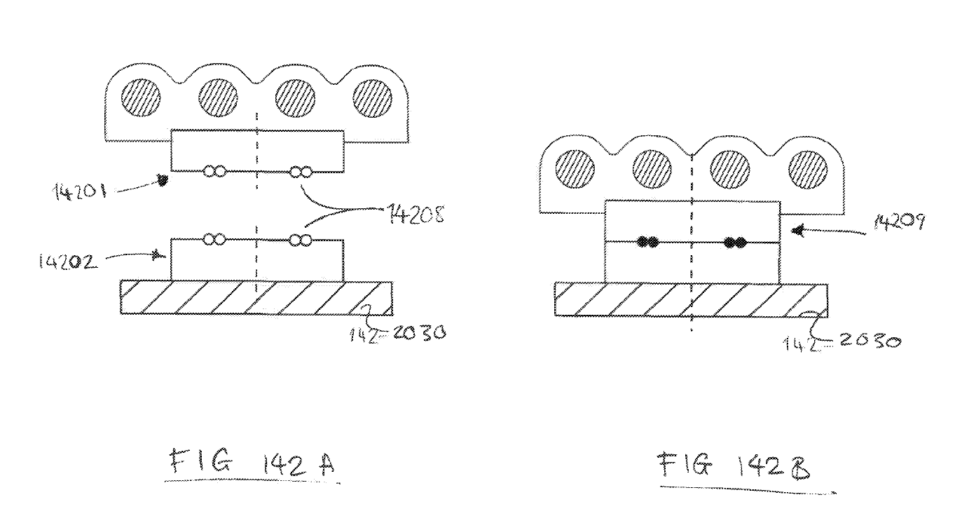

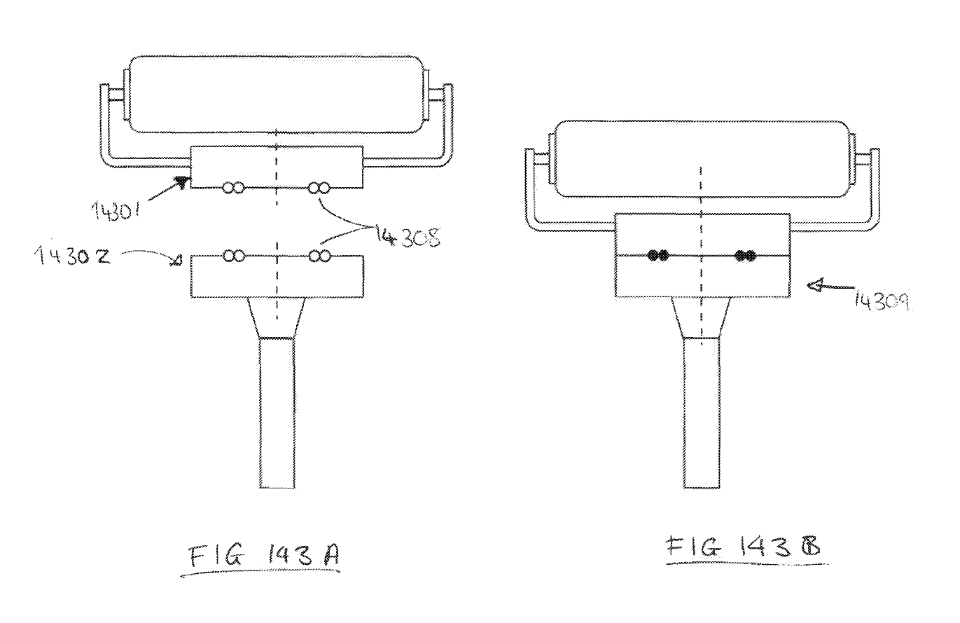

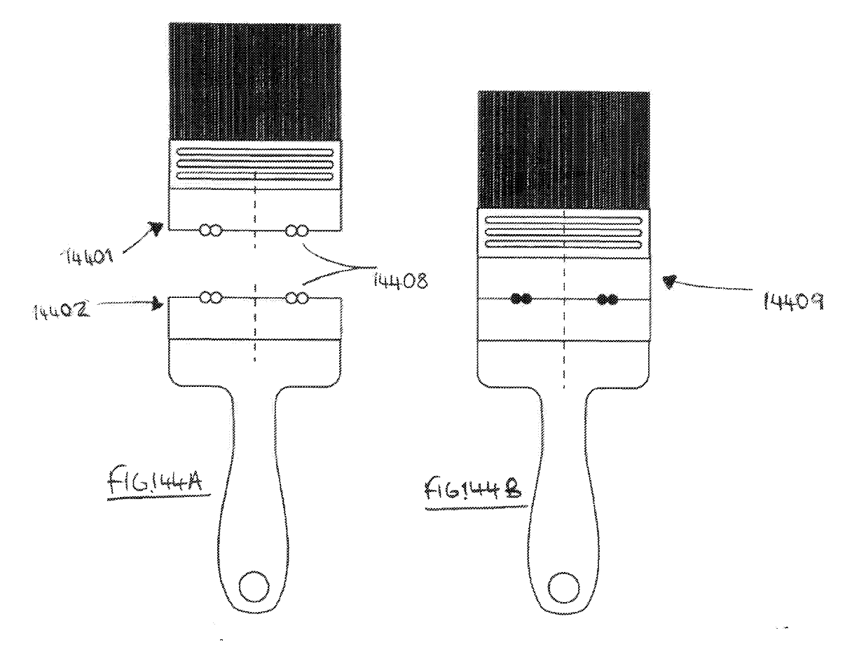

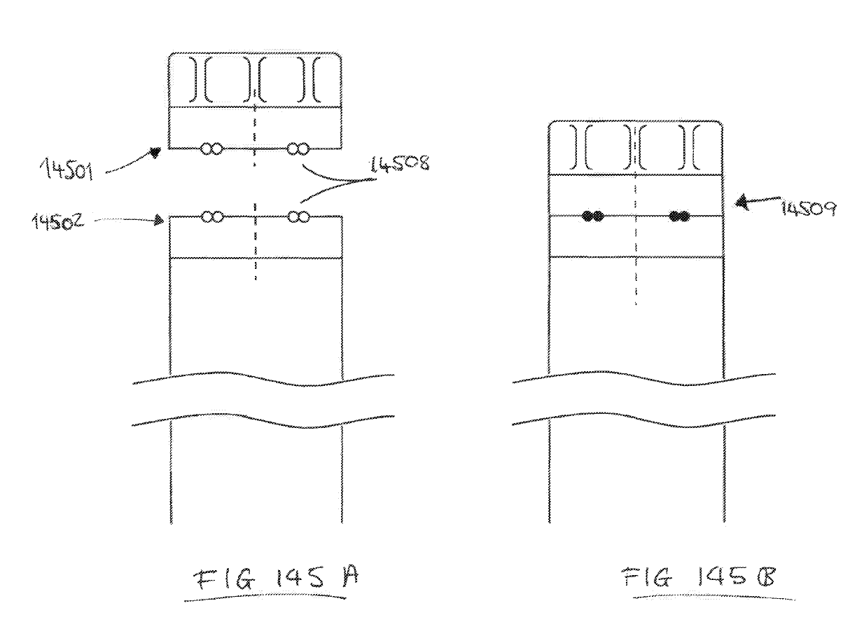

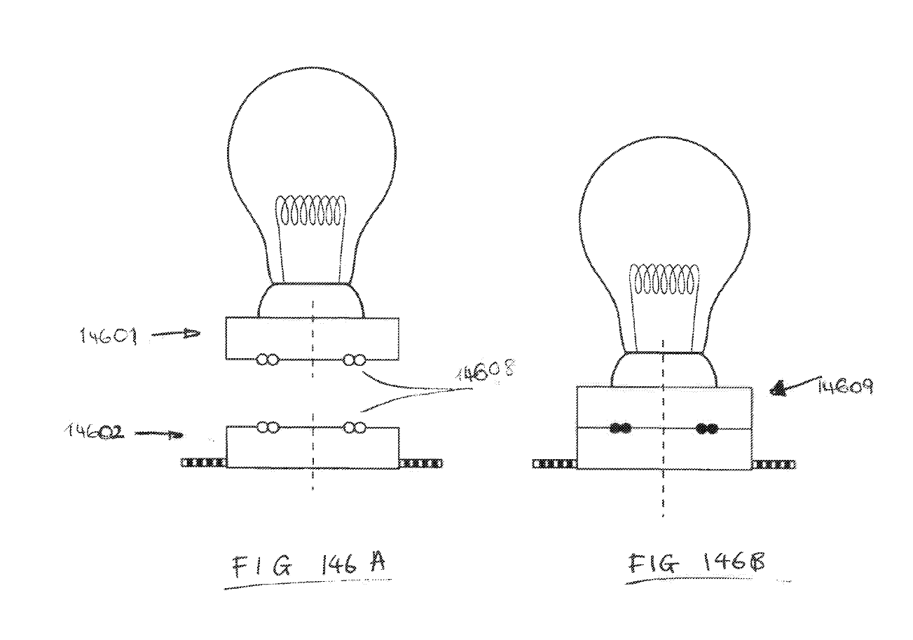

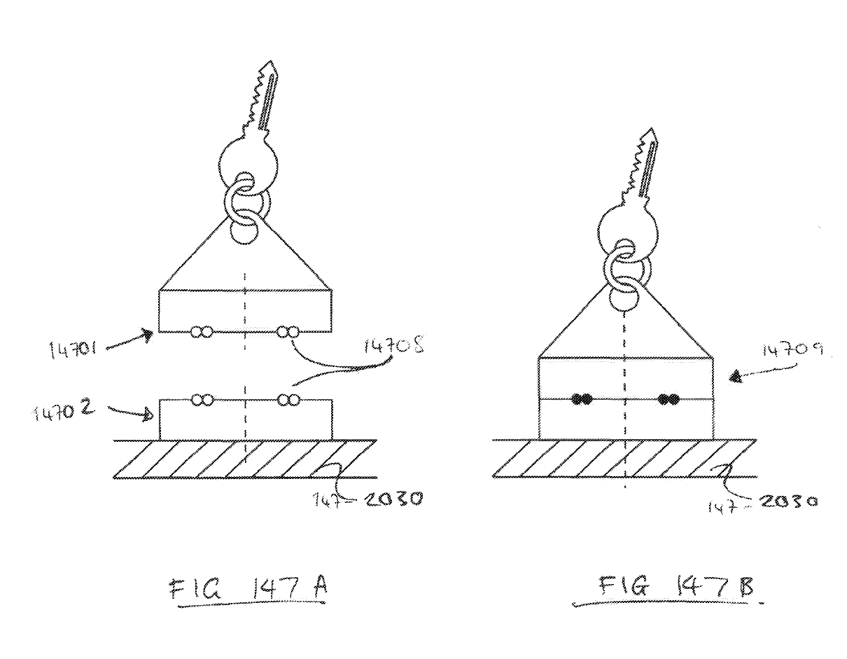

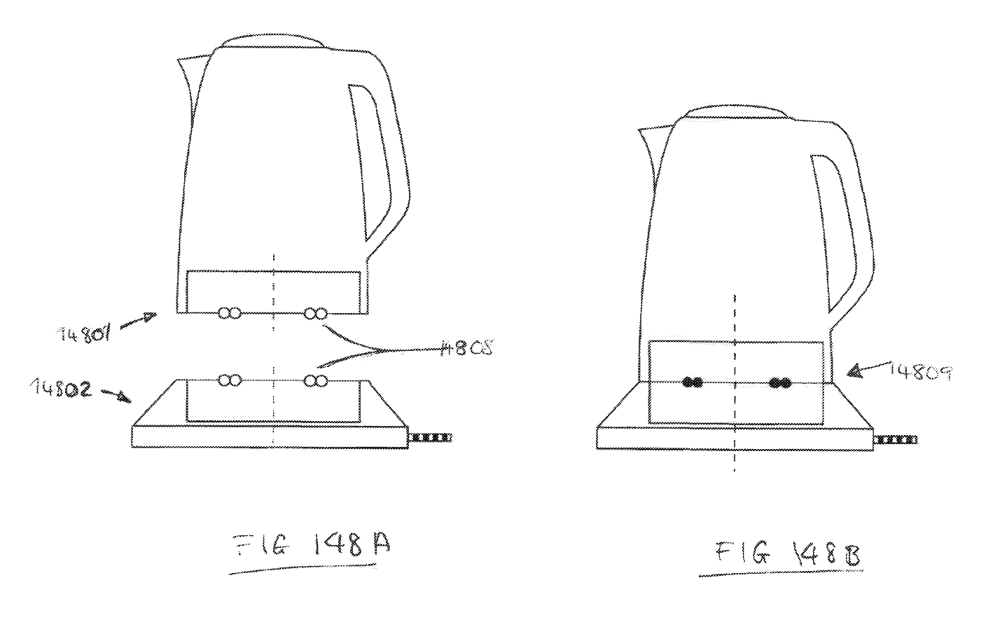

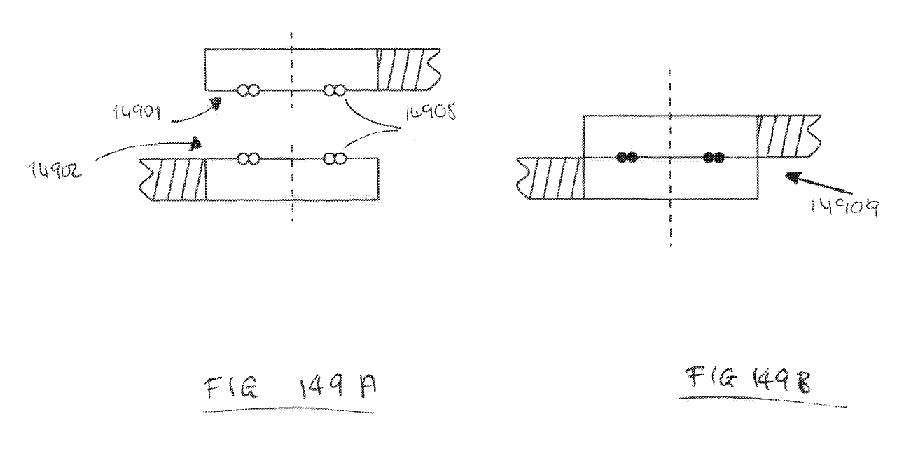

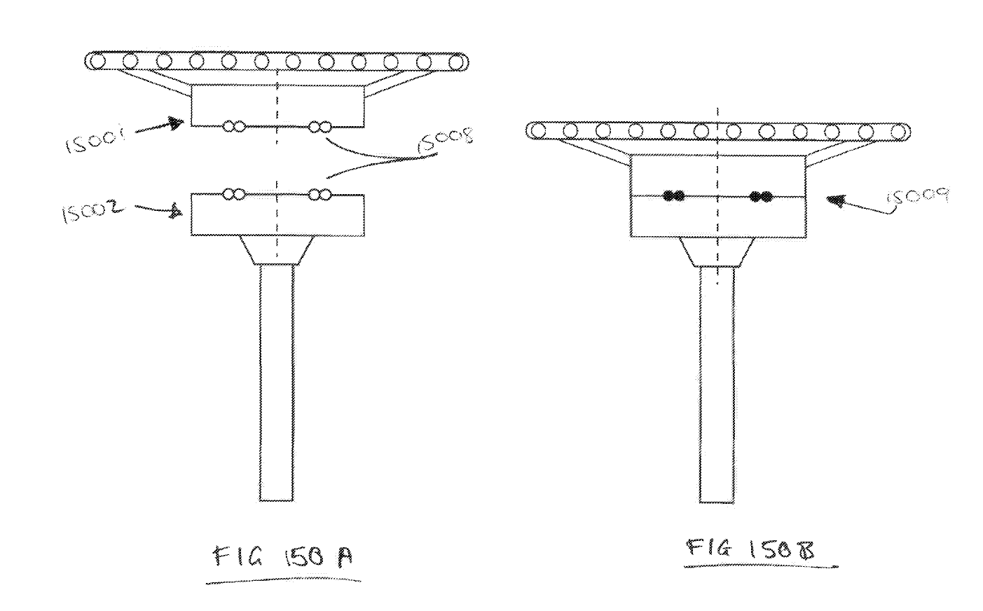

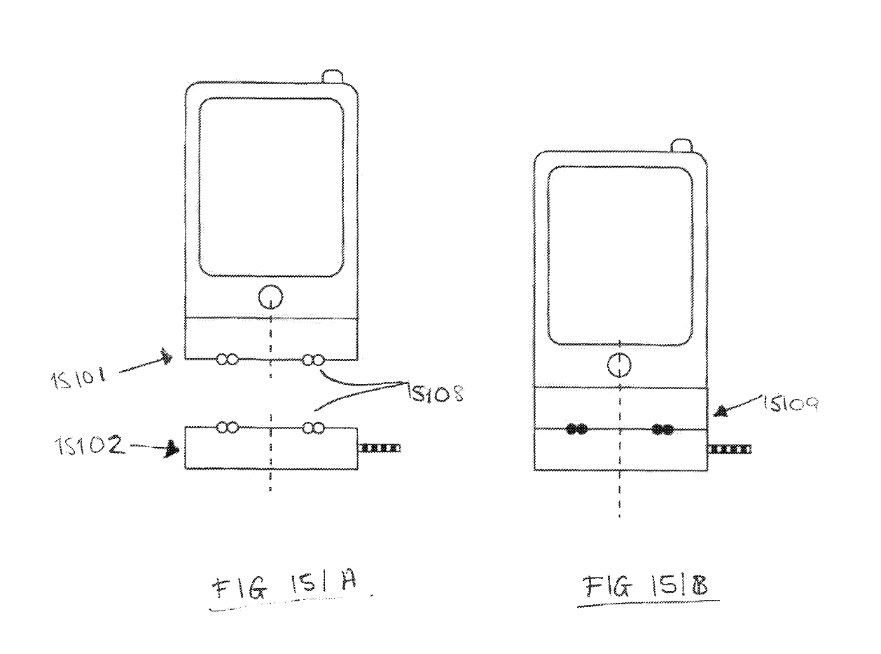

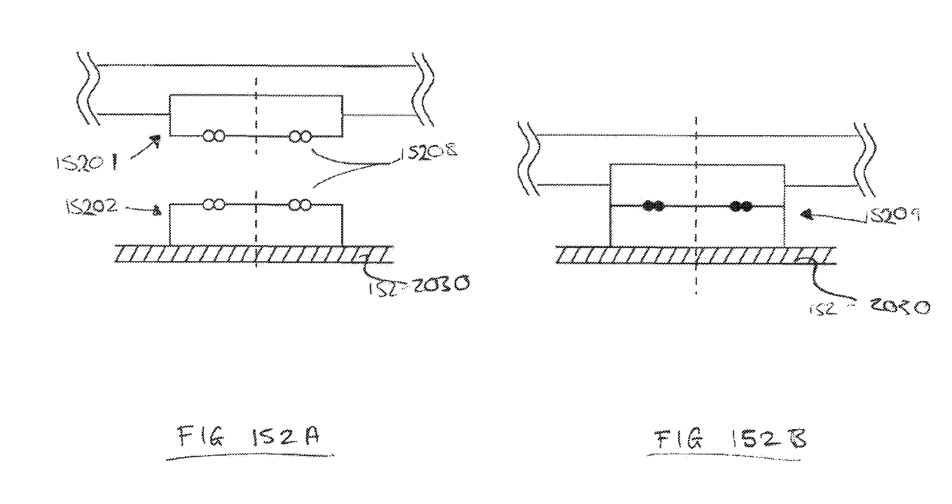

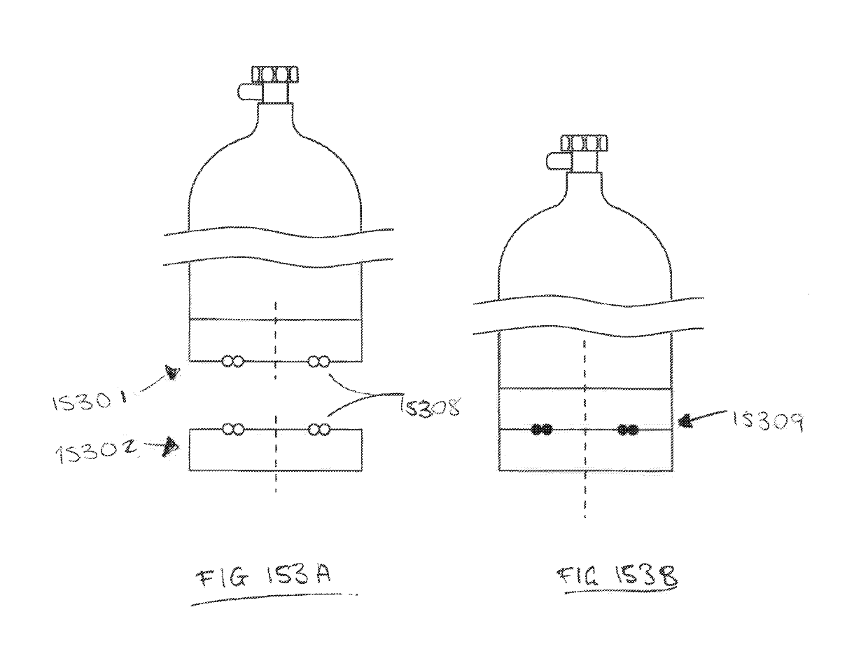

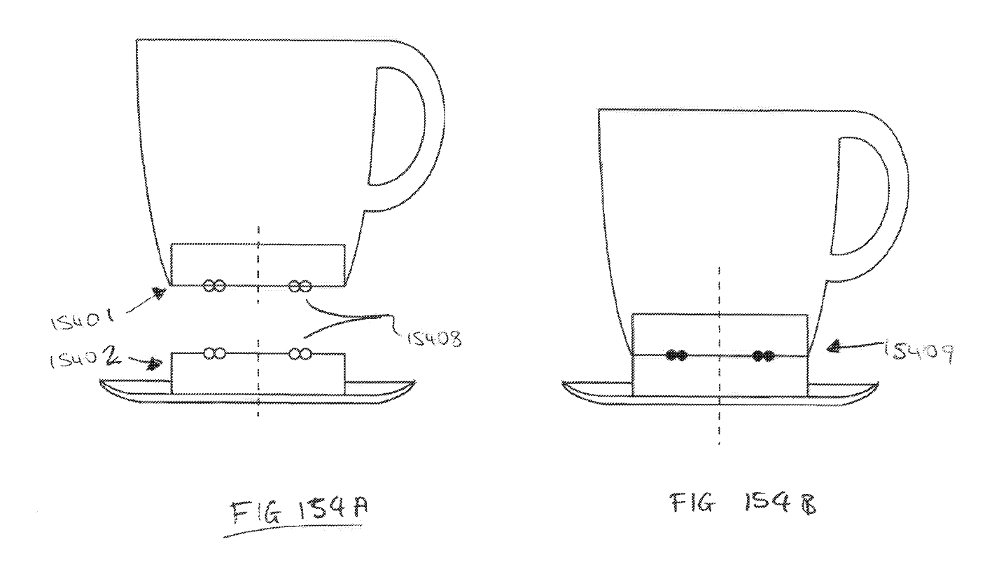

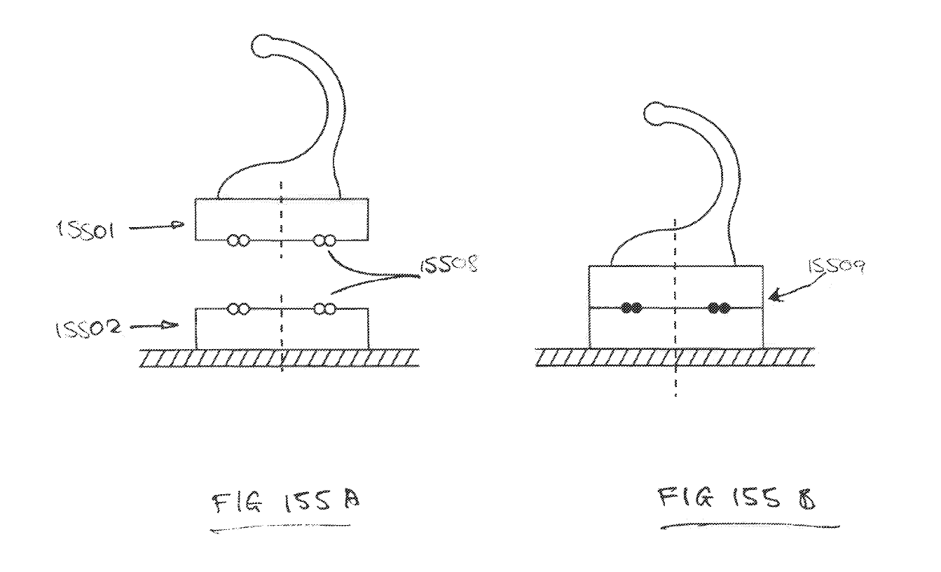

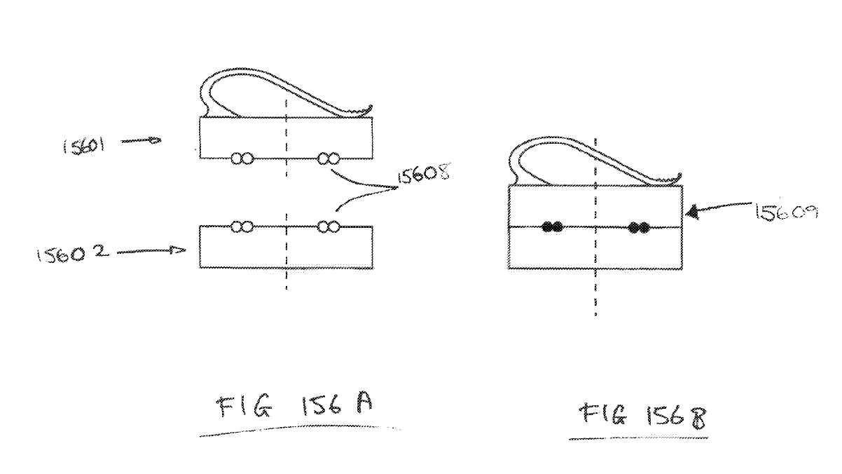

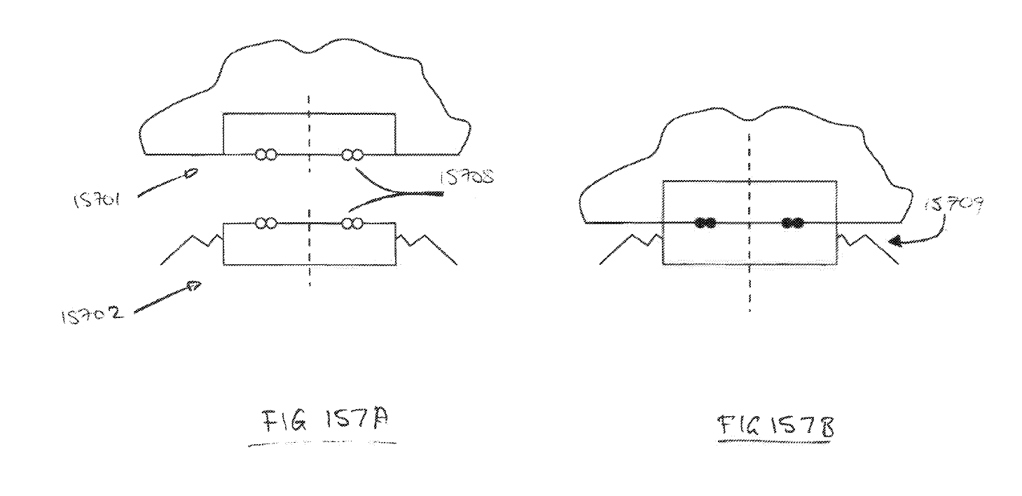

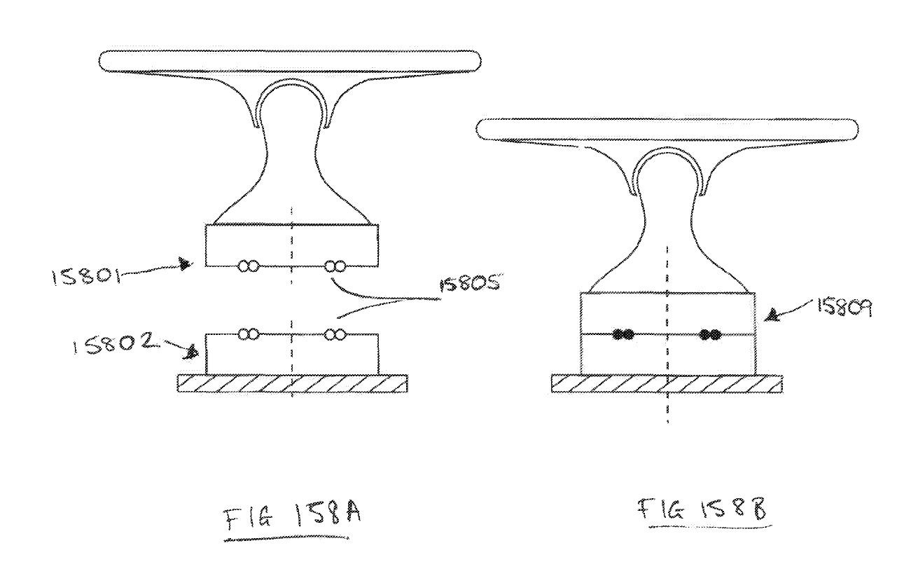

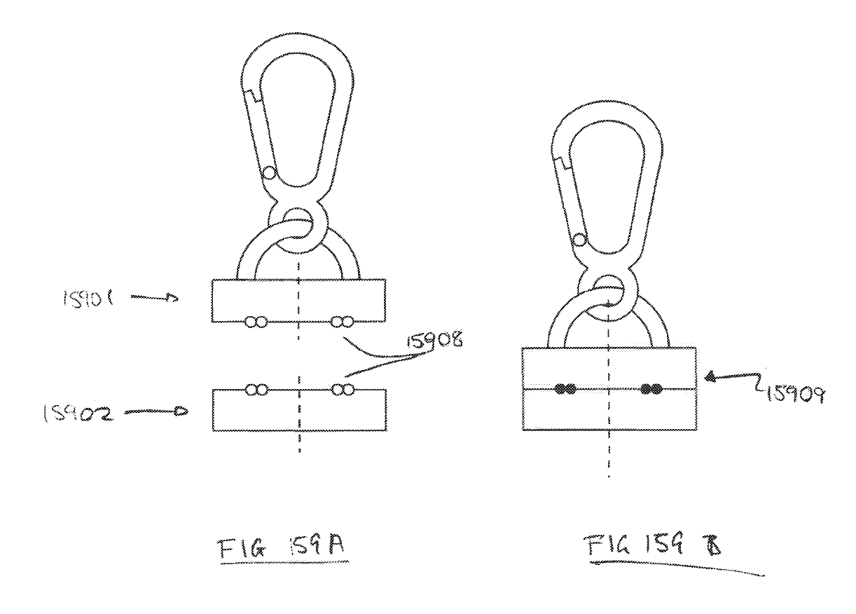

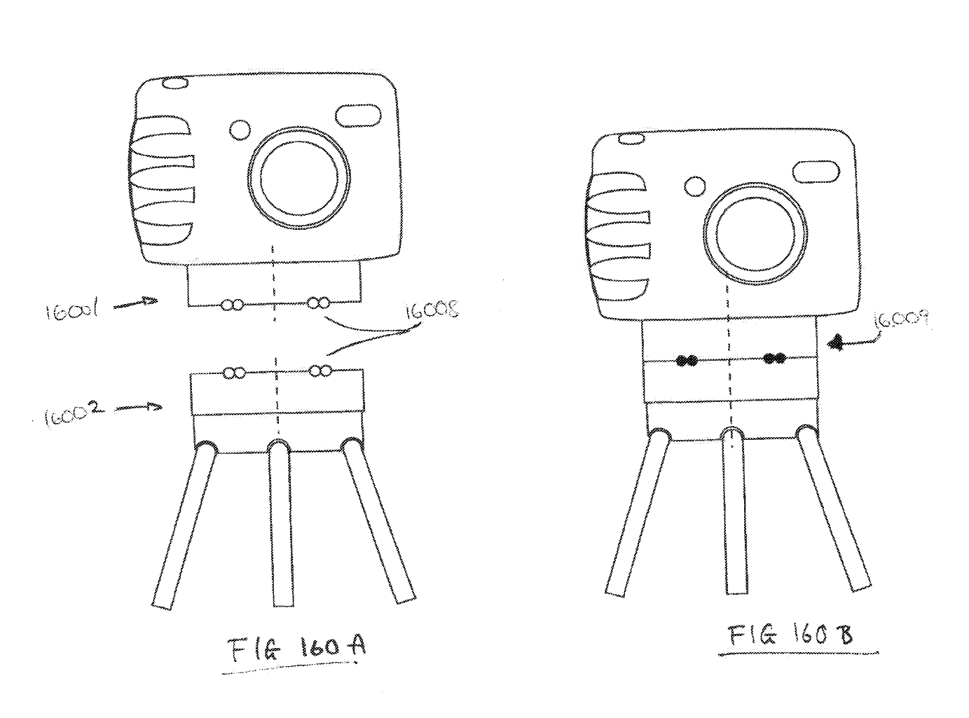

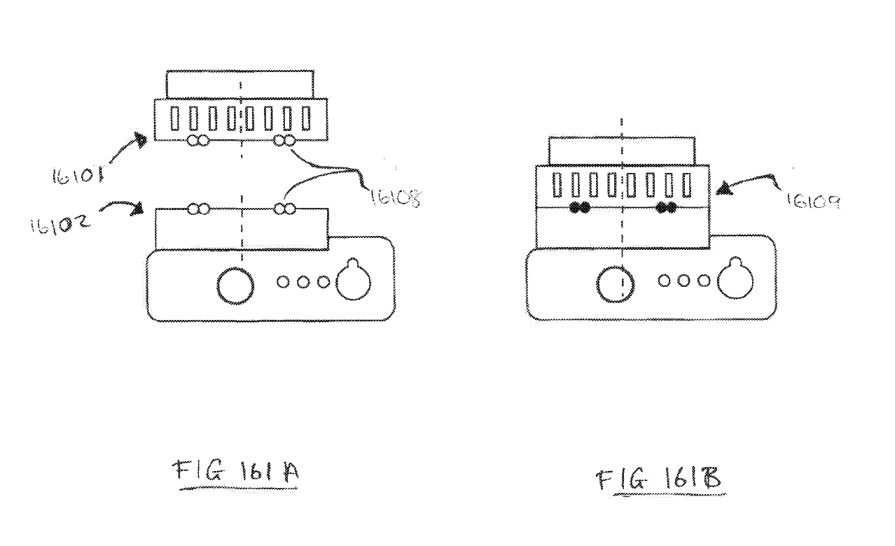

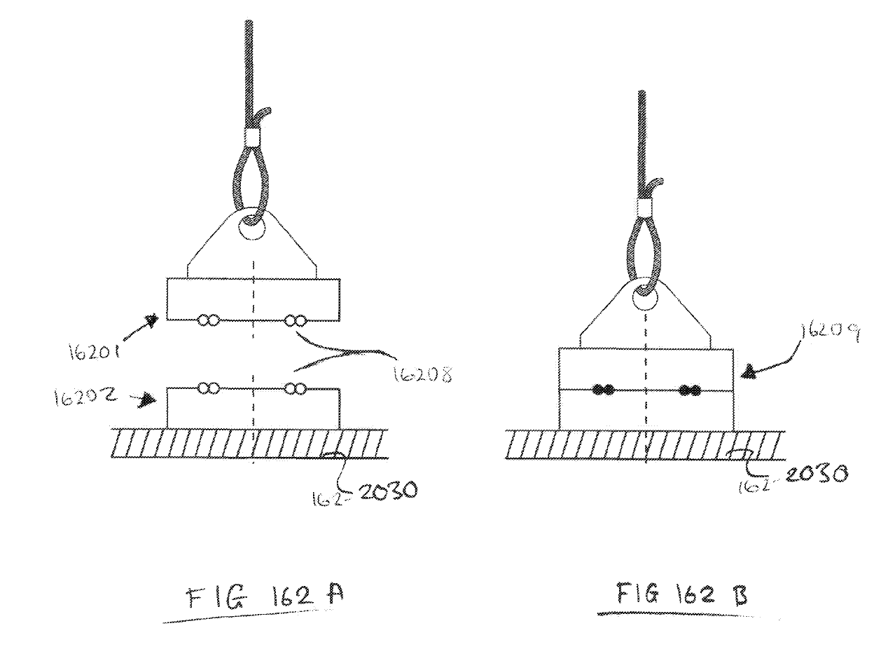

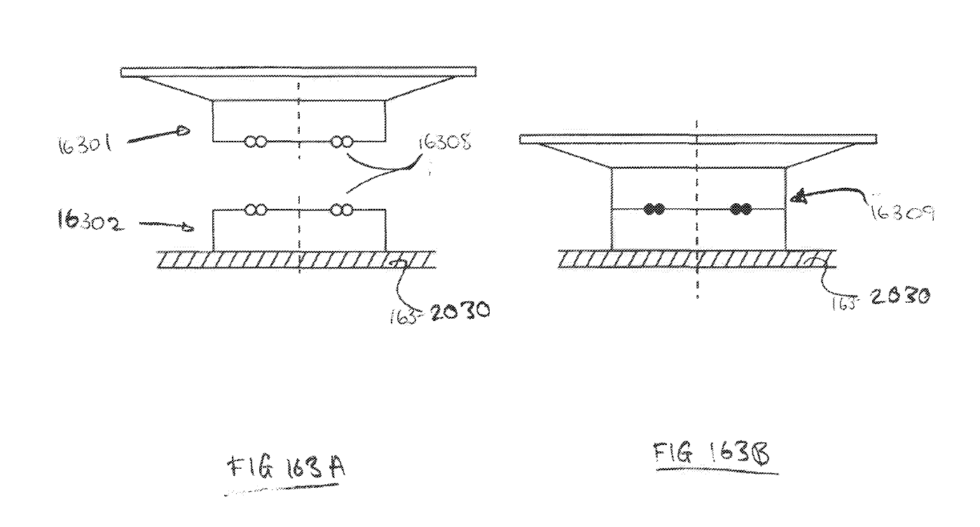

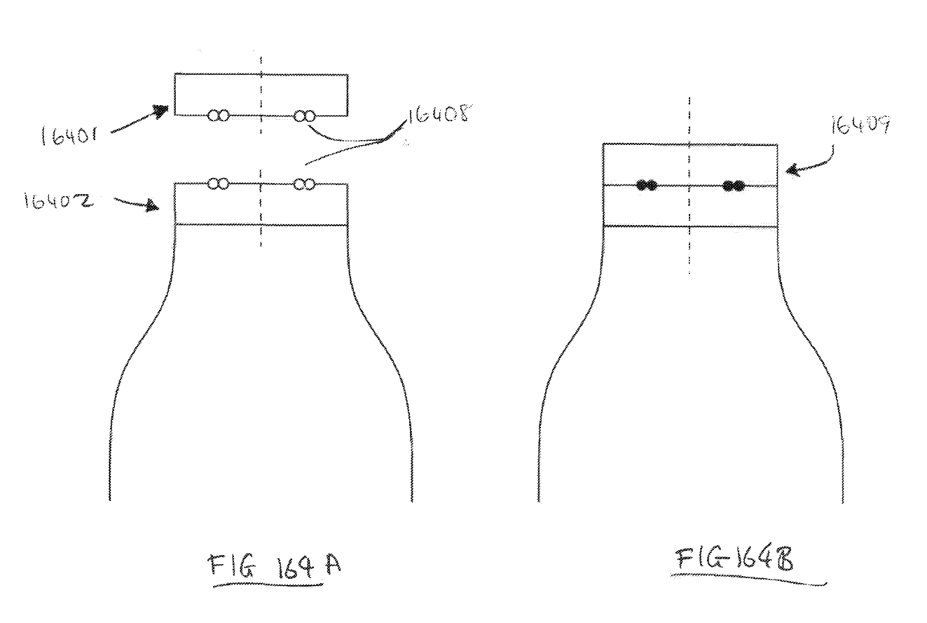

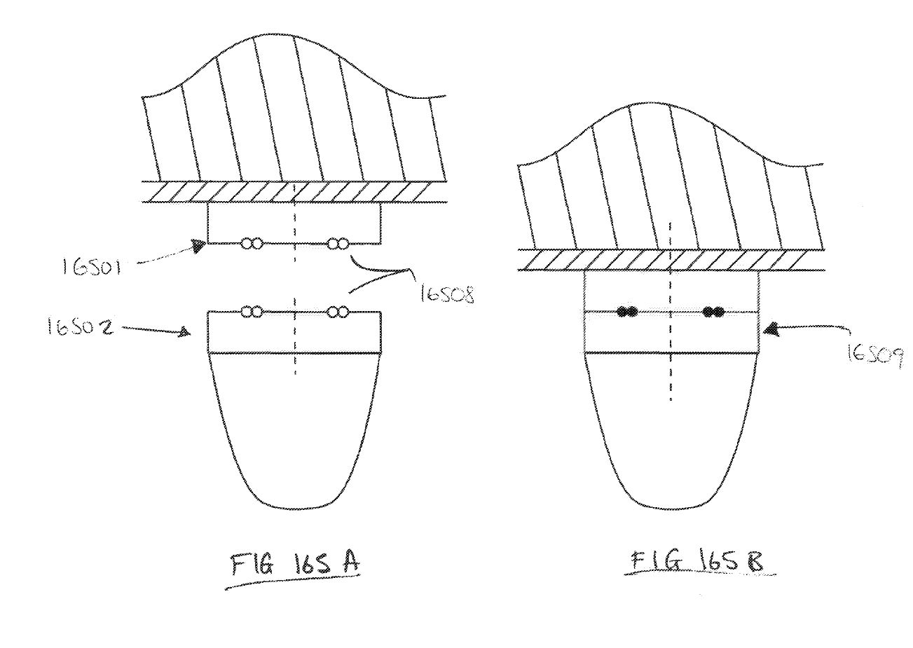

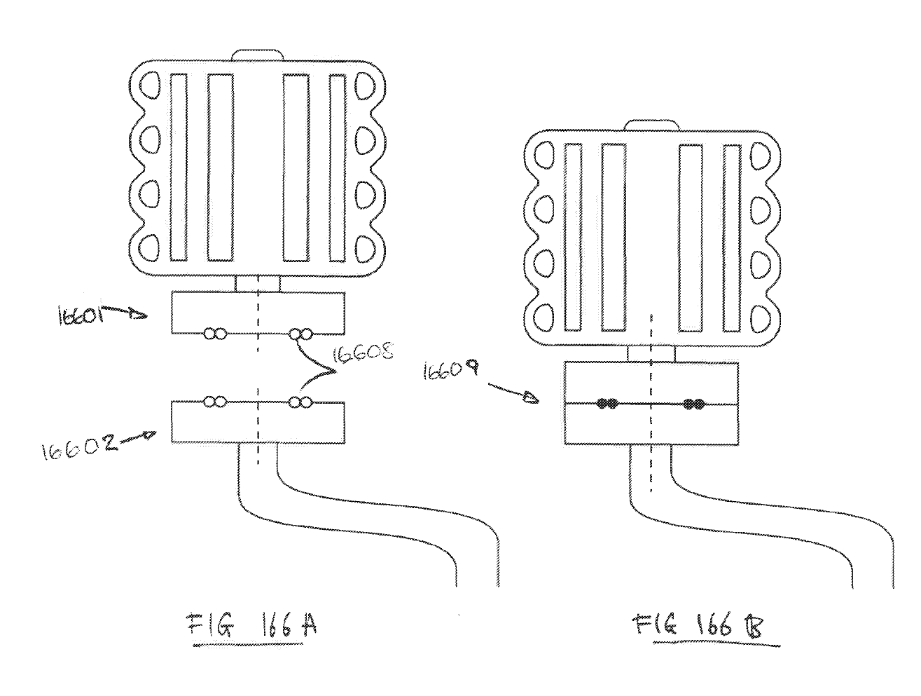

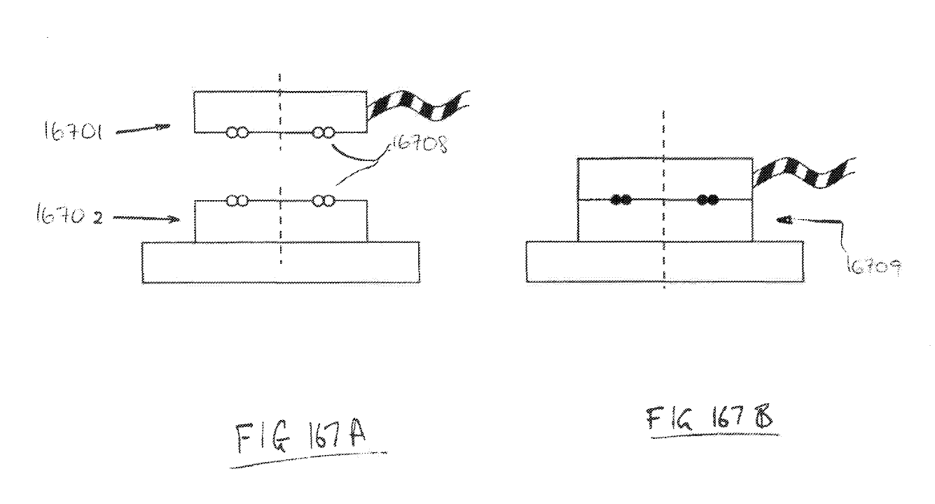

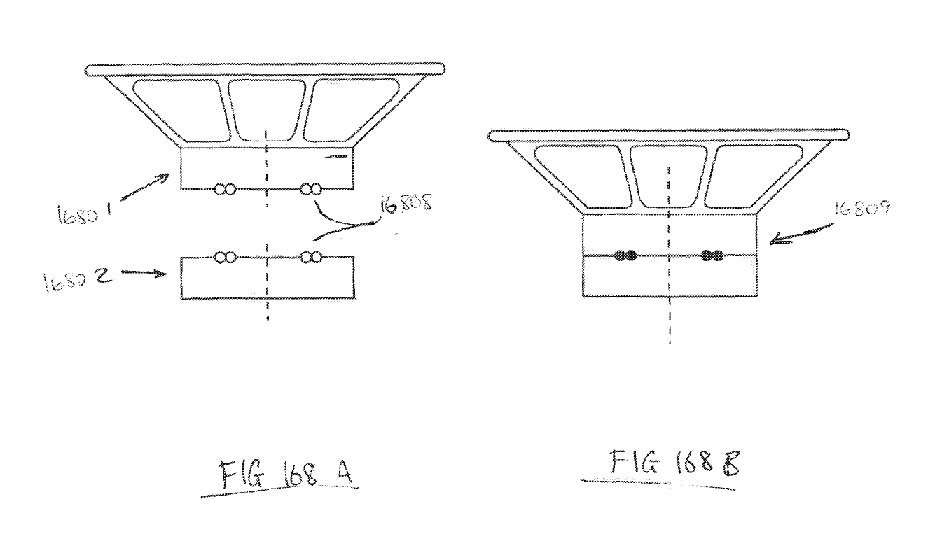

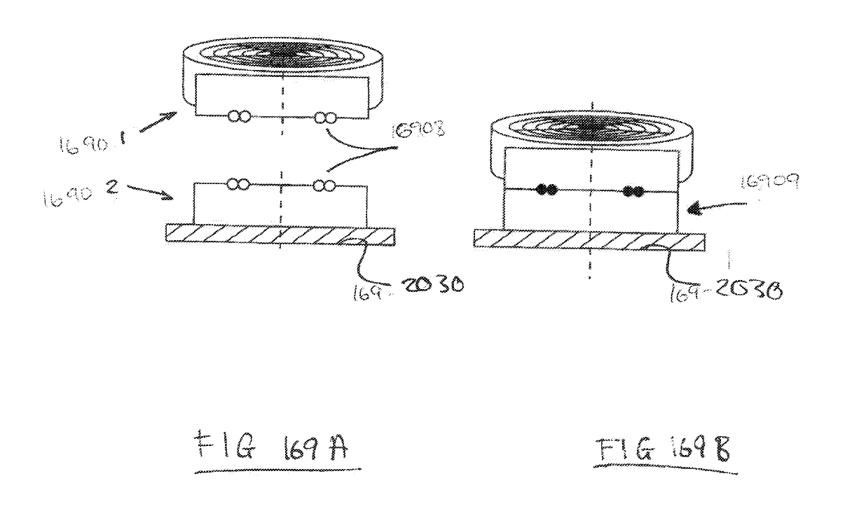

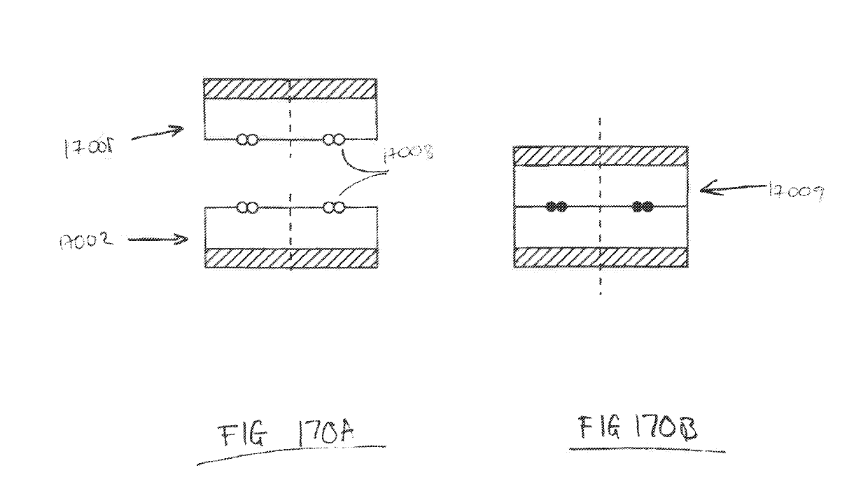

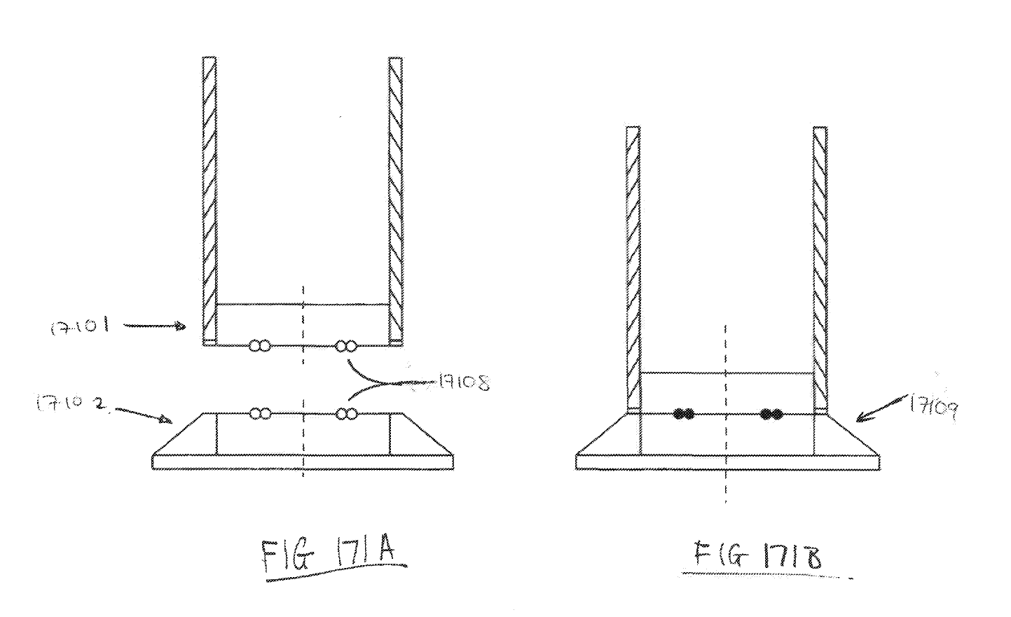

FIG. 106 represents a connector 10609 which is suitable for integration with or attachment to a blow-moulded bottle, or similar receptacle, to enable the receptacle to be attached to another device, for example a wall mounting in a number of different rotational positions. One or more (in the present example two) inter-engagement formations 10608 are provided on a first part 10601 of the connector, which is associated with the receptacle. Each inter-engagement formation has a circumferential extent 106-2004. A second part 10602 of the connector 10609 is associated with another device, for example a wall mounting. The second part 10602 has a plurality of (in this example twelve) inter-engagement formations with which the inter-engagement formations 10608 of the first part 10601 are engageable. The first part 10601 may be offered up to the second part in one of twelve different orientations and may be rotated through an angle corresponding with the extent 106-2004 relative to the second part 10602, to reach one of twelve final positions, and inter-engage with two inter-engagement formations 10608 of the second part, as represented by the portions 106-2011. It will be understood that any number of final positions may be provided by providing an appropriate number of engagement formations 10608 on the second part 10602.

FIG. 107: Coded Pill Container.

A rotary tool 10701 with a coded inter-engagement formation 10708 may be used to initially engage a cap 10702 having a corresponding inter-engagement formation 10708 enabling movement of the cap 10702. Rotational movement of the cap 10702 causes a locking formation 107-2052 to be released, which enables disengagement of a container 107-2053 from a storage position in which the container is connected to a base material 107-2030 (as shown in FIGS. 107A, 107B) and subsequently remove the cap 10702 from the container 107-2053. This example may be advantageous in circumstances where access to drugs is restricted or hierarchical, for example.

FIG. 108: Cosmetic Stacking.

Containers 10809, for example for cosmetics, are shown stacked one on top of the other. Each container includes an a connecting face 10808 on its upper and lower sides for enabling inter-engagement of each container with an adjacent container, so as to hold the containers in a stack. The containers close using rotational inter-engagement formations. The connecting faces 10808 external to their form allow the containers to stack with one another or attach to a shelf 108-2030 for display purposes or for safety in transit.

Tetra Lid.

FIGS. 109A and 109B represent a drinks package closure 10909 wherein a limited amount of material may be used in manufacture, which in turn saves costs. The rotational force and rotational degree needed for inter-engagement between two parts 10901, 10902 may be minimal, making the closure 10909 useful for physically impaired users.

FIG. 110: Product Assembly.

An apparatus 11009 may be used in the assembly of products, thus removing or reducing the need for screws or other fasteners and potentially excluding the use of tools. The inter-engagement formations provided on connecting faces 11008 may also be configured for a poka yoke failsafe assembly system.

Tool Box Closure.

FIGS. 111A-111C represent an apparatus 11109 which is suitable for enabling the closure of a receptacle with a lid, for example a tool box. A circular first part 11101 of the apparatus 11109 is positioned on the receptacle. The first part 11101 includes an inter-engagement formation 11104 having a circumferential extent 111-2004, which in the present example is 180°. A second part 11102 of the apparatus 11109 is positioned on the lid, and has a corresponding inter-engagement formation 11103, such that rotation of one or both of the parts 11101, 11102 relative to one another causes inter-engagement of the two parts 11101, 11102, as shown in FIG. 111C. Such inter-engagement may be used to hold the lid closed against the receptacle.

Consumer Assembly.

FIGS. 112A-112C represent the use of a connector as described above or below in connecting attachments or tools 112-2056 to a tubular part 112-2055 of a vacuum cleaner, or to connect two tubular parts 112-2055 together. The use of a rotary connector as described above or below could require little or no insertion force.

FIG. 113: Suction Actuation.

FIGS. 113A-113C show a device 11309 comprising two parts 11301 and 11302 wherein the first part 11301 serves to extract air from a cavity created between a diaphragm or flanged component 113-2063 and given surface 113-2044. As the first part 11301 of the device 11309 is rotated in a direction which is opposite to the direction of engagement between the parts 11301, 11302, the first part 11301 serves to extract air from the cavity between the component 113-2063 and the surface 113-2044, allowing external positive ambient pressure to force the apparatus towards or on to the surface 113-2044.

The second part 11302 can have axial, universal or ball joint fixings, for example, or a fixed relationship to other fixing devices. A suction device 113-2062 may to be adhered to glass or other smooth surface 113-2044, as illustrated in FIG. 113. Optionally, in the suction device 113-2062 may be activated by a connector of the present invention being used to expel air and create a partial vacuum, for example as an alternative to a lever device commonly used for this purpose in prior art suction devices.

FIGS. 114A and B represent an apparatus 11409 comprising a first part 11401 and a second part 11402, wherein an inlet 114-2064 in the second part 11402 permits ingress of pressurised air or fluid. Said ingress of fluid or air serves to act as the propellant for the device as a rotary actuator. Part 2 FIGS. 114 A and B of device 11409 has integral to its form (but not shown) substantially tubular forms to carry the pressurised air or fluid to one or more enclosures created by the interaction of engagement formations of the first part 11401 with the receiving formations of the second part 11402.

FIGS. 115 B and C represent an apparatus 11509 in conjunction with a series of check valves 115-2065 wherein the apparatus 11509 serves as a pumping device. Upon rotary, or reciprocal rotary action of either part 11501 or 11502 a through-flow of fluid or air shown by arrows 115-2066 may be induced. Connecting faces 11508 of the two parts 11501, 11502 may be separated into sectors, each individually combined with one or more corresponding check valves 115-2065, allowing simultaneous pumping of more than one fluid or gas. The benefits to such a system are that with one simple rotary or reciprocal rotary action, differing substances may be dispensed or pumped at differing volumes or flow rates. This provides a benefit over peristalsis.

FIGS. 116 A and B show a device 11609 comprising of two inter-engageable parts 11601, 11602 each in conjunction with a fibre optic or conductive component 116-2068 shrouded by a sheath 116-2067. When the two parts 11601 and 11602 are inter-engaged, the axes of the corresponding components 116-2068 become aligned, irrespective of whether the components 116-2068 are coaxial with the rotational axis about which the two parts 11601, 11602 are rotated to inter-engage of the two parts 11601, 11602. FIG. 116C shows two component parts 11601, 11602, each including a series of fibre optics or conductive components 116-2068 spaced circumferentially around the respective part 11601, 11602. The purpose of such a device seen in FIG. 116C to is to provide axial alignment of all of the components 116-2068 when the two parts 11601, 11602 are engaged with each other. It should be noted that any number of fibre optic or conductive elements 116-2068 may be aligned by such a device.

FIGS. 117A-C show inter-engageable parts 11701, 11702 of an apparatus 11709 which acts as a device for removing or retracting an insulating sheath 117-2067 of a fibre optic or electrically conductive element 117-2068, by means of incision upon full engagement of the element 117-2068 with the part 11702. The apparatus 11709 is used only to de-sheath the conductive element or elements 117-2068. FIG. 117C shows component parts 51 and 52 subsequently combined to form a device 59 wherein the electrical current is free to pass from one part 11701, 11702 of the apparatus 11709 to the other. The apparatus 11709 may be used as a connector which automatically strips an insulating sheath from wires to be connected together.

FIGS. 118A-C show an apparatus 11809, including a first part 11801 and a second part 11802 in varying stages of inter-engagement. Each part 11801, 11802 includes a connecting face 11808 which has engagement and/or receiving formations. Disposed about the periphery of one or both parts 11801, 11802, are calibration markings 118-2069. Calibration markings 118-2069 are also provided on the connecting face 11808 of the second part 11802, preferably around the engagement and/or receiving formations. One or more markings 118-2069 are provided on the first part 11801 and one or more optional viewing windows 118-2015 may also be provided, for example the or each window 118-2015 may be a cut away section. The purpose of the calibration markings 118-2062 and viewing windows 118-2015 is to indicate the extent of axial movement of the first part 11801 in relation to the second part 11802, when combined to form apparatus 11809, so as to provide a measurement system indicating the overall combined height of the apparatus 11809, irrespective of the rotational extent of inter-engagement.

FIGS. 119A-C show an apparatus 11909 including a first part 11901 and a second part 11902 in varying stages of inter-engagement. Each part 11901, 11902 includes a connecting face 11908 which has engagement and/or receiving formations. The second part 11802 is positioned on or integrally formed with a strap or belt or similar fibrous material 119-2070a. The purpose of the apparatus 11909 is to perform the function of a rotary clamp, wherein the axial compression of the apparatus 11909 holds another member or strap 119-2070b with sufficient resistance or friction to inhibit free movement of the two members 119-2070a, 119-2070b, as shown in FIG. 119C, for example. The two members 119-2070a, 119-2070b may be different parts of the same member 119-2070. FIG. 119B shows the parts 11901, 11902 in partial inter-engagement, wherein the resistance applied to the second strap 119-2070b is sufficient allow the second strap 119-2070b to move relatively freely through the apparatus 11909.

FIG. 120 illustrates a spring biased retractable spool 120-2072, with an appended cable or other substantially linear part 120-2071 within a casing 12009, which includes a first part 12001 and a second part 12002. Each of the two parts 12001, 12002 includes a connecting face 12008, to enable inter-engagement of the two parts 12001, 12002. The casing 12009 is assembled by rotational inter-engagement of the first and second parts 12001, 12002. Each part 12001, 12002 includes inter-engagement formations on its outer surface, to enable a plurality of casings 12009 to stacked and connected to one another. This embodiment could be used as part of a pre-tensioned rigging system, for example.

FIGS. 121A and 121B depict an apparatus 12109 in conjunction with an example of a machine tool 121-2073. FIG. 121A shows a first part 12101 and a second part 12102 of said apparatus 12109, each having a connecting face 12108, prior to rotational inter-engagement. It should be noted that any type of machine tool may be used in conjunction with the apparatus 12109 and its use maybe for tool pick up or tool drive.

FIGS. 122A and 122B show an apparatus 12209 in conjunction with a tool or jig body, wherein the body 122-2074 to be anchored to a machine includes a pair of apparatus 12209 to enable precise positioning of the body 122-2074 relative to the machine in three axes simultaneously. It should be noted that any machine having said apparatus disposed about its machining envelope or elsewhere may have any number of apparatus 12209 working separately from each other or in combination with each other.

FIGS. 123A and 123B show apparatus 12309 in conjunction with a prior art AC/AC Tesla induction charging system. The apparatus 12309 includes a first part 12301 and a second part 12302, having interengaging connecting faces. The second part 12302 has a secondary induction coil 123-2075 located on or in a boss which is receivable in an opening provided in the first part 12301. A primary electrical supply is provided via an induction coil 123-2075 in or around the opening in the first part 12301. When the two parts 12301, 12302 are inter-engaged, the two induction coils are positioned and held concentrically with one another, to permit electrical induction between the primary and secondary coils.

FIGS. 124A-C show an apparatus 12409 having a first part 12401 and a second part 12402. A modification 12410 is provided on the first part, and has a circumferential extent shown by an arrow, which is referred to herein as a “proactive operational range”. The modification 12410 is capable of interacting with a part 12411 of the second part 12402. The part 12411 has a circumferential extent which is referred to herein as a “reactive range” also shown by an arrow. The reactive range may be made of a softer or more pliable or adhesive material than the modification 12410, such that the modification 12410 is able to embed itself into the reactive range 12411, for the purposes of inhibiting counter-rotation of the two parts 12401, 12402. This provides a similar functionality to the insert of a locknut or stop nut, for example to inhibit loosening caused by vibration. FIG. 124C shows a schematic of the modification 12410 immediately prior to the stage of interaction with range 12411.

FIGS. 125A and 125B show a device 12509 wherein a first part 12501 is manufactured from a pliable or flexible material, whilst a second part 12502 is made from a substantially less pliable or a rigid material. The purpose of such a material combination is to promote distortion of the first part 12501, when the relevant amount of peel force or torque is applied to an interface of the device 12509. FIG. 125C shows the device 12509 in a partially disengaged state due to the localised distortion of the first part 12501.

The device shown in FIGS. 126A-C uses a similar arrangement to that described above in relation to FIGS. 125A-C. A first part 12601 of a device 12609 is manufactured from a non-reactive, non-heat-sensitive, and/or non-resin-sensitive material that is pliable, such as pre-cured silicon as used in other moulding processes. FIG. 126A also shows a material 126-2057 which is conformable, pliable or mouldable, prior to a cooling or curing or catalytic reaction. FIG. 126B shows a tool body 126-2059 and a resultant substantially hardened form 126-2058, which results from the material 126-2057 being inserted into the tool body 126-2059 and moulded thereby. FIG. 126C shows the first part 12601 being distorted to remove it from the tool body 126-2059. The resultant cured molded form may then form one part of any other subsequent device.

FIGS. 127A-C show a moulding apparatus including a device 12709, including a first part 12701. The apparatus also includes a tool body 127-2059 which has a first part 127-2059a which is connectable to the first part 12701 by means of corresponding helicoidal formations and a second part 127-2059b. The tool body 127-2059 includes a mould tool cavity 127-2060 in which at least a portion of the second part 127-2057b of the tool body 127-2057 is receivable. The first part 12701 includes a substantially helicoidal projection 127-2034 which is similar to an external thread, and the tool body 127-2059 includes a corresponding formation which is similar to an internal thread and is engageable with the projection on the first part 12701. The first part 12701 can effectively be screwed into the tool body 127-2059. FIG. 127A also shows a fluid, mouldable, pliable, or curable material 127-2057. In order to mould the material 127-2057, the material and the second part 127-2057b of the tool body 127-2057 are at least partially inserted into the cavity 127-2060. As shown in FIG. 127C, the material 2057 has taken the form of engagement and receiving formations provided on a face of the first part 12701 which contacts the material 127-2057. To remove the moulded material from the apparatus, the tool body 127-2059 is unscrewed from the first part 12701, and the first part 12701 is rotated relative to the material 127-2057, so as disengage the connecting face of the first part 12701 from the newly moulded inter-engagement formations 12708 of the material 127-2057. The moulded material 127-2057 effectively becomes a second part 12702 of an inter-engaging apparatus 12709. It should be noted that the pitch of the substantially helicoidal form 127-2034 would ordinarily be the same as the pitch of the helicoidal inter-engaging formation 12708. It should also be noted that an outer edge of an outermost engagement formation, which may be trapezoidal or triangular in cross section, may meet a natural abutment at the end of its rotational extent, wherein part of said engagement formations however numerate, extend and protrude substantially helically around a basal surface, so as to act as the pitch and cross sectional profile of a screw thread 127-2034. Such mechanical tooling as seen in FIG. 127B may contain any number of mechanical interfaces such those seen in this figure. It should also be noted that the mechanical extraction of the first part 12701 from the apparatus need not comply with the direction of pull upon the ejection of the part from the tool due to the mechanical actions of the core being distinct and not dependent on the primary action of the tool and consequently this operation may be performed at any stage during the molding that is advantageous.

FIG. 128B represents a device 12809 comprising two parts 12801, 12802 wherein one or both parts 12801, 12802 has disposed about its surface engagement and/or receiving formations with cross sections such as those seen in FIGS. 69A-E, that are sufficiently intricate or cellular that they may not be machined by traditional milling or electrical discharge machining The parts 12801, 12802 or any of the parts shown in FIGS. 69A-E could be manufactured by an additive process such as selective laser melting or photopolymer curing, atomic layer deposition or other inkjet technologies.

Threaded Rotite End.

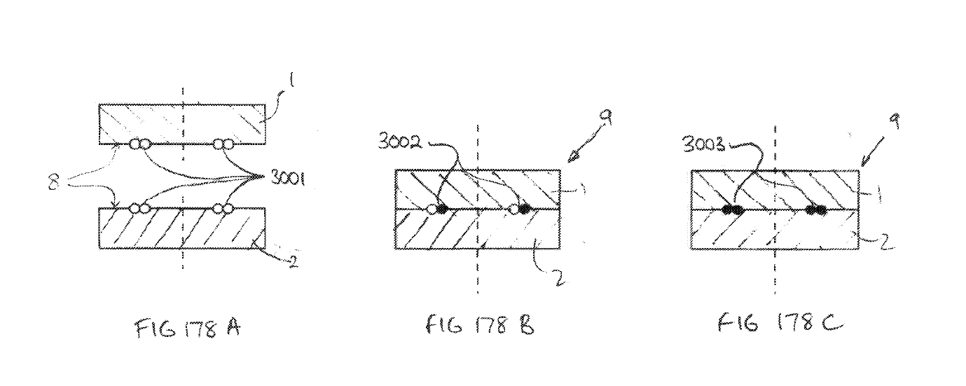

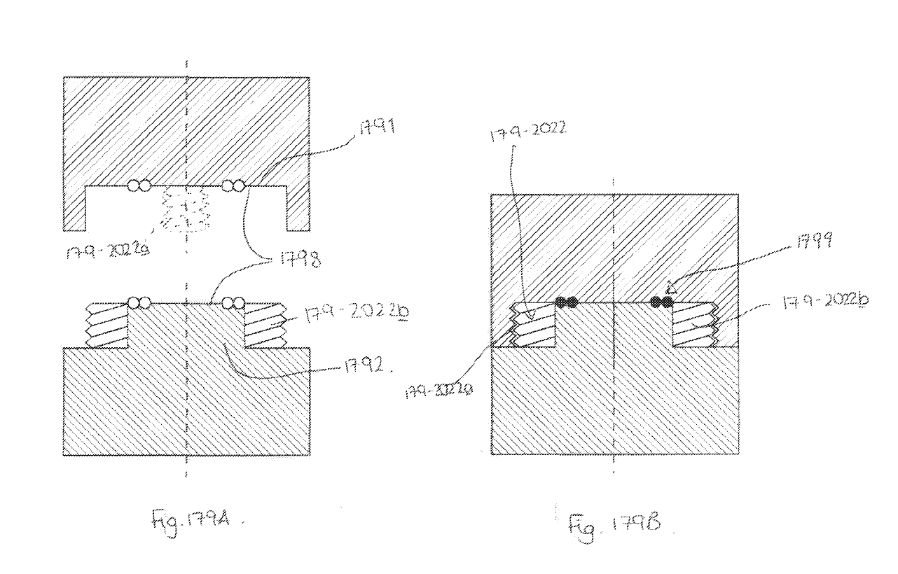

In yet another embodiment, a connector 1799 (shown in FIGS. 179A-C) having two parts 1791, 1792 each including inter-engagement formations on corresponding connecting faces 1798, as described herein, is combined with a conventional helical screw thread 179-2022 which is positioned radially outwardly of the connecting faces 1798. The second part 1792 includes two diametrically opposed externally threaded portions 179-2022b which are engageable with a pair of diametrically opposed internally threaded portions 179-2022a, which are provided on the first part 17901. In FIG. 179A, the two parts 17901, 17902 are oriented at 90° to one another, such that the threaded portions 197-2022a, 179-2022b do not engage or interfere with one another when the two parts 17901, 17902 are brought towards one another. One of the internally threaded portions 179-2022a is shown in dotted lines, to represent its orientation, although it would not be visible in the cross-section shown. Preferably, each threaded portion 179-2022 extends through up to 90°, although it will be appreciated that any number of portions may be provided, with an appropriate circumferential extent. The number of threaded portions provided on each part 17901, 17902 is typically equal to the number of sectors into which the inter-engagement formations of the connecting faces 17908 are divided. In use, the threaded portions only engage one another during rotation of the connector 17909 to engage the connecting faces 17908. The threaded portions do not otherwise engage one another. Optionally a plurality of arc threads can be aligned parallel to the axis of the connection. The pitch of the threaded portions is the same as the pitch of the helicoidal inter-engagement formations provided on the connecting faces 17908. This embodiment is intended to transmit higher bending forces than the connector 17909 alone.

Threaded Sleeve.

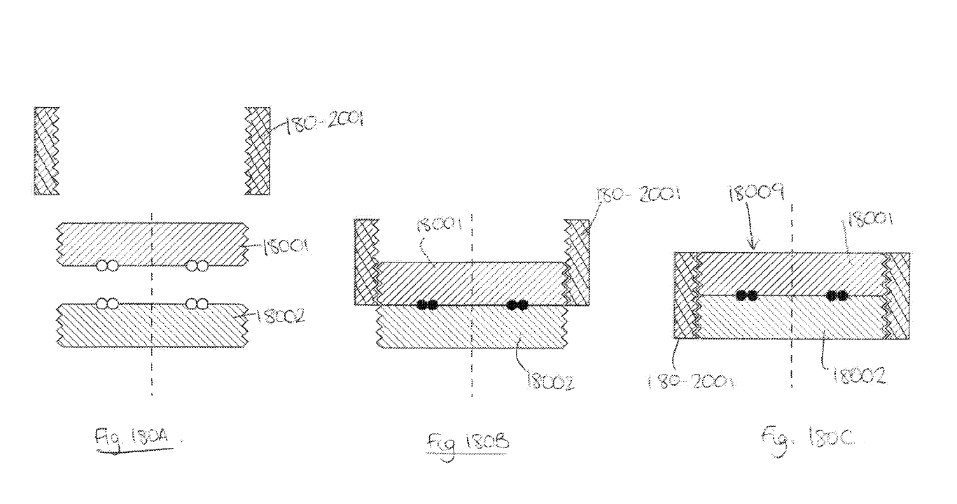

FIGS. 180A-C shows an apparatus 18009 having two inter-engageable parts 18001, 18002, and a sleeve 180-2001. Each of the first part and the second part 18001, 18002 has a connecting face of any type as described above, and an externally threaded portion which extends over at least a portion of its perimeter. The sleeve 180-2001 is substantially annular and has an internally threaded portion which is engageable with the threaded portions of each of the first part 18001 and the second part 18002. The sleeve 180-2001 is a locking member which hold the first and second parts in an inter-engaged condition, as shown in FIG. 180C.

The examples of several of the connectors described above permit relative rotation of the two parts through up to 360°. However, rotation through more than 360° may be achieved by enabling one or more engagement formations of one or more parts of the connector to penetrate or dig into an engagement formation of the other part of the connector.

Each part of each connector may be manufactured from any suitable material, and each part of each connector may be manufactured from a different material. For example, one part of a connector of the type described above may be manufactured from a material which is softer than the material from which the other part is made. The softer material (which may, for example, be an elastomeric material) may be pliable, so as to more easily and more closely inter-engage with the other part.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

The foregoing illustrated embodiments are provided to illustrate the structural and functional principles of embodiments of the present invention and are not intended to be limiting. To the contrary, the principles of the present invention are intended to encompass any and all changes, alterations and/or substitutions within the spirit and scope of the following claims.

1. A method of manufacturing a part of a device including a first part and a second part which are inter-engageable with one another, the first part having a first longitudinal axis and a connecting face which extends substantially transversely to the first longitudinal axis and includes an engagement formation which extends substantially axially, and the second part having a second longitudinal axis and a connecting face which extends substantially transversely to the second longitudinal axis and includes a receiving formation which extends substantially axially and in which the engagement formation of the first part is receivable, wherein each of the engagement formation and the receiving formation includes a substantially helicoidal surface which extends at least partially around the longitudinal axis of the respective part of the device, such that rotation of the two parts relative to one another about the longitudinal axes, when the two parts are substantially co-axially aligned, such that the connecting faces of the two parts face one another in a substantially axial direction, causes engagement of the engagement formation of the first part with the corresponding receiving formation of the second part, the method including:
providing a mould including a body and a connecting face which includes engagement formations corresponding to those of one of the first and the second part of the device, wherein the connecting face is separable from the mould body,
contacting the connecting face of the mould with a mouldable material, to produce engagement formations on a face of the mouldable material, so as to form the other part of the device, and
separating the connecting face from the mould body to remove the moulded part of the device from the mould.

2. A method according to claim 1 wherein at least a part of the connecting face of the mould is flexible, and is flexed to separate the connecting face from the mould body.

3. A method according to claim 1 wherein each of the connecting face and the body include complementary threaded portions which are inter-engageable, and disengaging the threaded portions disengages the connecting face from the body.

4. A method according to claim 3 including removing the moulded part from the connecting face by rotating the moulded part and the connecting face relative to one another.

5. (canceled)

6. A method according to claim 1 wherein the moulded part is subsequently used as a mould for the other part of the device.

7. A method of connecting a first part of a device on a first item and a second part of the device on a second item, the first part of the device including a longitudinal axis, and a connecting face which extends substantially transversely to the longitudinal axis and has an engagement formation which extends substantially axially, and the second part including a longitudinal axis and a connecting face which extends in substantially transversely to the longitudinal axis of the second part, and has a receiving formation which extends substantially axially, and in which the engagement formation of the first part is receivable, wherein each of the engagement formation and the receiving formation includes a substantially helicoidal surface which extends at least partially around the longitudinal axis of the respective part, the method including:
substantially aligning the longitudinal axes of the two parts of the device, such that the connecting faces of the two parts of the device face one another substantially axially, and
rotating the two parts of the device relative to one another about the longitudinal axes, such that the engagement formation of the first part is received in the receiving formation of the second part, the method further comprising:
prior to said alignment and rotation or the two parts, using a tool to rotationally drive the first part into an object, wherein the tool comprises a driving face that is complimentary to the connecting face of the first part such that mating of the connecting face of the first part and the driving face of the tool enables rotational force to be transferred from the tool to the first part,
wherein, when the connecting face of the first part and the driving face of the tool mate, the tool is still axially separable from the first part without requiring rotation of the tool relative to the first part.

8. (canceled)

9. A method of manufacturing a part of a device including a first part and a second part which are inter-engageable with one another, the first part having a first longitudinal axis and a connecting face which extends substantially transversely to the first longitudinal axis and includes an engagement formation which extends substantially axially, and the second part having a second longitudinal axis and a connecting face which extends substantially transversely to the second longitudinal axis and includes a receiving formation which extends substantially axially and in which the engagement formation of the first part is receivable, wherein each of the engagement formation and the receiving formation includes a substantially helicoidal surface which extends at least partially around the longitudinal axis of the respective part of the device, such that rotation of the two parts relative to one another about the longitudinal axes, when the two parts are substantially co-axially aligned, such that the connecting faces of the two parts face one another in a substantially axial direction, causes engagement of the engagement formation of the first part with the corresponding receiving formation of the second part, the method including performing an additive process to build up the engagement formations of the part.

10. A method according to claim 8 wherein the additive process is one of selective laser melting, photopolymer curing, atomic layer deposition and material “jetting”.

11. Any method of manufacturing a device including a first part and a second part which are inter-engageable with one another, the first part having a first longitudinal axis and a connecting face which extends substantially transversely to the first longitudinal axis and includes an engagement formation which extends substantially axially, and the second part having a second longitudinal axis and a connecting face which extends substantially transversely to the second longitudinal axis and includes a receiving formation which extends substantially axially and in which the engagement formation of the first part is receivable, wherein each of the engagement formation and the receiving formation includes a substantially helicoidal surface which extends at least partially around the longitudinal axis of the respective part of the device, such that rotation of the two parts relative to one another about the longitudinal axes, when the two parts are substantially co-axially aligned, such that the connecting faces of the two parts face one another in a substantially axial direction, causes engagement of the engagement formation of the first part with the corresponding receiving formation of the second part, substantially as described herein and/or as shown in the accompanying drawings.

12. (canceled)
